(19) United States
(12) Patent Application Publication
(10) Pub. No.: US 2024/0372679 A1
(43) Pub. Date: Nov. 7, 2024

(54) TCI STATE INDICATION AND UPDATE

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 18/646,527

(22) Filed: Apr. 25, 2024

Related U.S. Application Data
(60) Provisional application No. 63/464,140, filed on May 4, 2023.
(60) Provisional application No. 63/533,496, filed on Aug. 18, 2023.
(60) Provisional application No. 63/533,835, filed on Aug. 21, 2023.
(60) Provisional application No. 63/542,039, filed on Oct. 2, 2023.
(60) Provisional application No. 63/542,670, filed on Oct. 5, 2023.
(60) Provisional application No. 63/546,412, filed on Oct. 30, 2023.
(60) Provisional application No. 63/553,498, filed on Feb. 14, 2024.
(60) Provisional application No. 63/556,614, filed on Feb. 22, 2024.

(51) Int. Cl. H04L 5/00; H04W 72/231

(52) U.S. Cl. CPC H04L 5/0053; H04W 72/231

(57) ABSTRACT

Methods and apparatuses for transmission configuration indication (TCI) state indications and updates. A method performed by a user equipment includes applying a TCI state for UE dedicated control and data channels and receiving, via a medium access control (MAC) control element (CE), a plurality of TCI codepoints. The method further includes identifying a reference TCI codepoint from the plurality of TCI codepoints; determining, from the reference TCI codepoint, one or more TCI states; and determining whether to apply the one or more TCI states or the reference TCI state for the UE dedicated control and data channels.

### CROSS-REFERENCE TO RELATED AND CLAIM OF PRIORITY

The present application claims priority under 35 U.S.C. § 119(e) to U.S. Provisional Patent Application No. 63/464,140 filed on May 4, 2023; U.S. Provisional Patent Application No. 63/533,496 filed on Aug. 18, 2023; U.S. Provisional Patent Application No. 63/533,835 filed on Aug. 21, 2023; U.S. Provisional Patent Application No. 63/542,039 filed on Oct. 2, 2023; U.S. Provisional Patent Application No. 63/542,670 filed on Oct. 5, 2023; U.S. Provisional Patent Application No. 63/546,412 filed on Oct. 30, 2023; U.S. Provisional Patent Application No. 63/553,498 filed on Feb. 14, 2024; and U.S. Provisional Patent Application No. 63/556,614 filed on Feb. 22, 2024, which are hereby incorporated by reference in their entirety.

### TECHNICAL FIELD

The present disclosure relates generally to wireless communication systems and, more specifically, the present disclosure relates to methods and apparatuses for transmission configuration indication (TCI) state indications and updates.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets. “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications. 5G communication systems have been developed and are currently being deployed.

### SUMMARY

The present disclosure relates to TCI state indications and updates.

In one embodiment, a user equipment (UE) is provided. The UE includes a processor configured to apply a reference TCI state for UE dedicated control and data channels. The UE further includes a transceiver operably coupled to the processor, the transceiver configured to receive, via a medium access control (MAC) control element (CE), a plurality of TCI codepoints. The processor is further configured to identify a reference TCI codepoint from the plurality of TCI codepoints: determine, from the reference TCI codepoint, one or more TCI states; and determine whether to apply the one or more TCI states or the reference TCI state for the UE dedicated control and data channels.

In another embodiment, a base station (BS) is provided. The BS includes a processor configured to determine a reference TCI state for UE dedicated control and data channels and a transceiver operably coupled to the processor. The transceiver is configured to transmit the reference TCI state and transmit, via a MAC CE, a plurality of TCI codepoints. The plurality of TCI codepoints include a reference TCI codepoint and the reference TCI codepoint includes one or more TCI states.

In yet another embodiment, a method performed by a UE is provided. The method includes applying a reference TCI state for UE dedicated control and data channels and receiving, via a MAC CE, a plurality of TCI codepoints. The method further includes identifying a reference TCI codepoint from the plurality of TCI codepoints: determining, from the reference TCI codepoint, one or more TCI states; and determining whether to apply the one or more TCI states or the reference TCI state for the UE dedicated control and data channels.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit.” “receive.” and “communicate.” as well as derivatives thereof, encompass both direct and indirect communication. The terms “include” and “comprise.” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of.” when used with a list of items, means that different combinations of one or more of the listed items may be used, and only one item in the list may be needed. For example. “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example multiple transmission-and-reception-point (multi-TRP) system according to embodiments of the present disclosure;

FIG. 8 illustrates a flowchart of an example UE procedure for identifying/using first and second applicable TCI states according to embodiments of the present disclosure;

FIG. 9A illustrates a diagram of an example TCI state(s) activation MAC CE command comprising a single TCI codepoint according to embodiments of the present disclosure;

FIG. 9B illustrates a diagram of an example TCI state(s) activation MAC CE command comprising more than one TCI codepoints according to embodiments of the present disclosure;

FIG. 10 illustrates a flowchart of an example UE procedure for identifying/using first and second applicable TCI states according to embodiments of the present disclosure;

FIG. 11 illustrates a diagram of an example radio resource control (RRC) configuration including two joint/downlink (DL)/uplink (UL) TCI states for a UE according to embodiments of the present disclosure;

FIGS. 12A and 12B illustrate flowcharts of example UE procedures for updating/using applicable TCI states and performing single-TRP and multi-TRP switching according to embodiments of the present disclosure; and

FIG. 13 illustrates a flowchart of an example UE procedure for identifying/using first and second applicable TCI states according to embodiments of the present disclosure.

### DETAILED DESCRIPTION

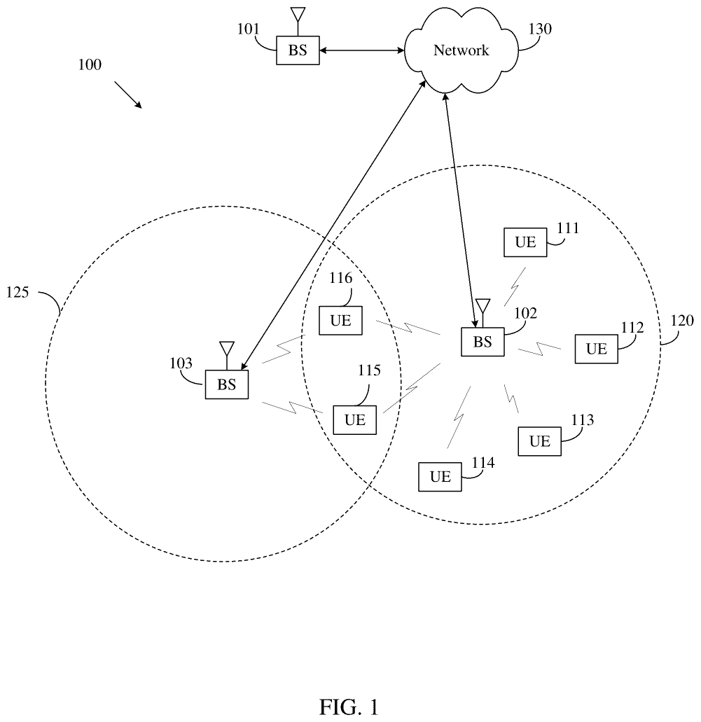

FIGS. 1-13, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications. 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and Channel coding;” [3] 3GPP TS 38.213 v16.1.0, “NR; Physical Layer Procedures for Control;” [4] 3GPP TS 38.214 v16.1.0, “NR; Physical Layer Procedures for Data;” [5] 3GPP TS 38.321 v16.1.0, “NR; Medium Access Control (MAC) protocol specification;” and [6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station. BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence: a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A). WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station.” “subscriber station.” “remote terminal.” “wireless terminal.” “receive point.” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing TCI state indications and updates. In certain embodiments, one or more of the BSs 101-103 include circuitry, programing, or a combination thereof to support TCI state indications and updates.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

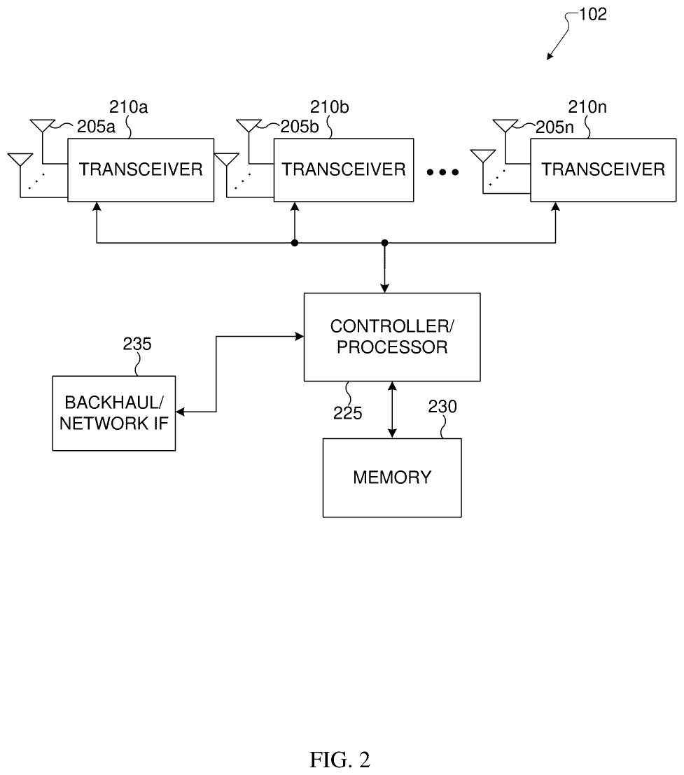

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting TCI state indications and updates. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

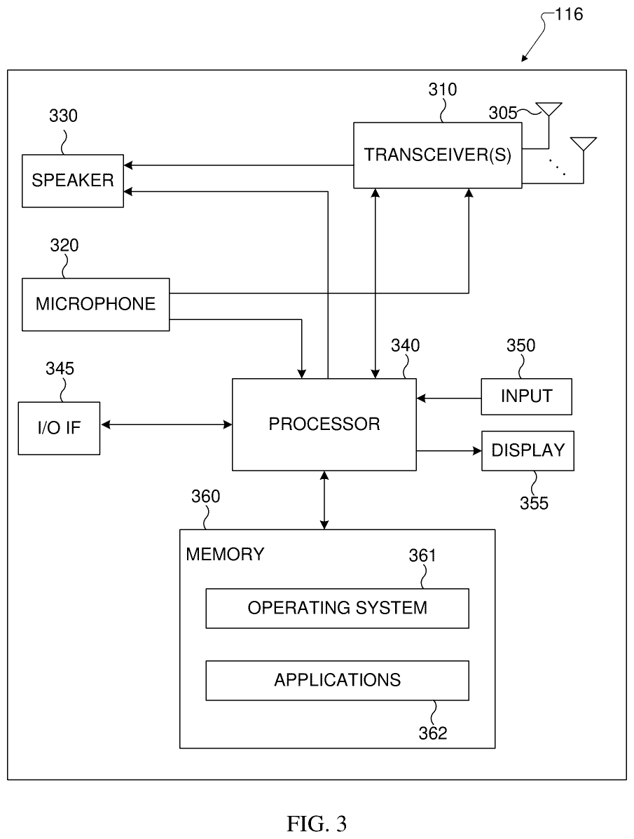

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However. UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify TCI state indications and updates as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone. UEs could be configured to operate as other types of mobile or stationary devices.

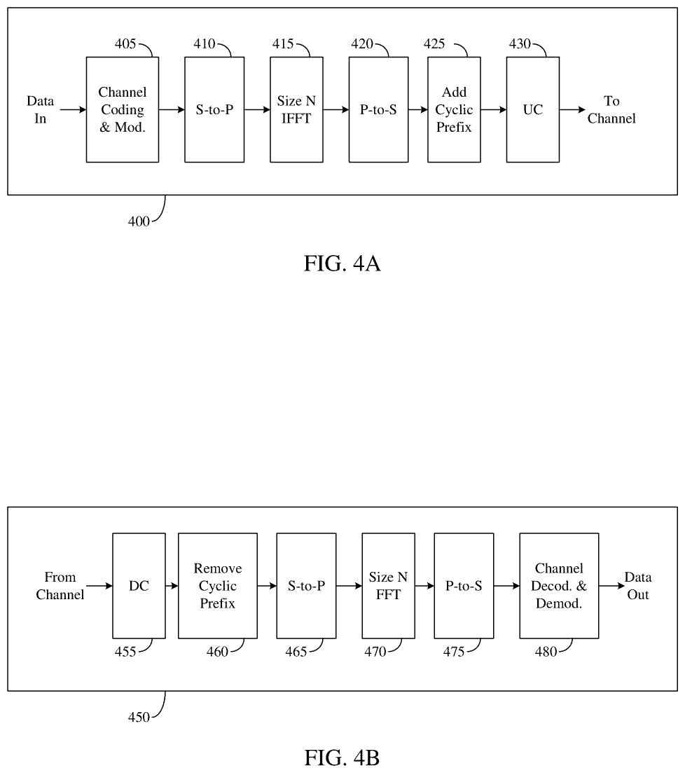

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support TCI state indications and updates as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

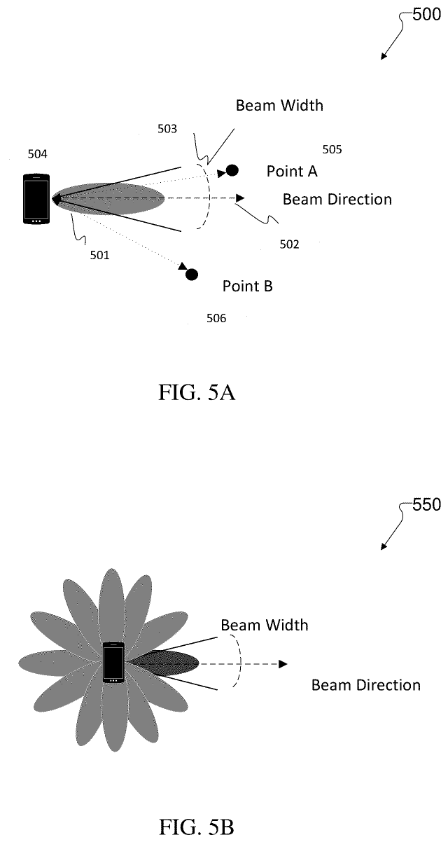

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

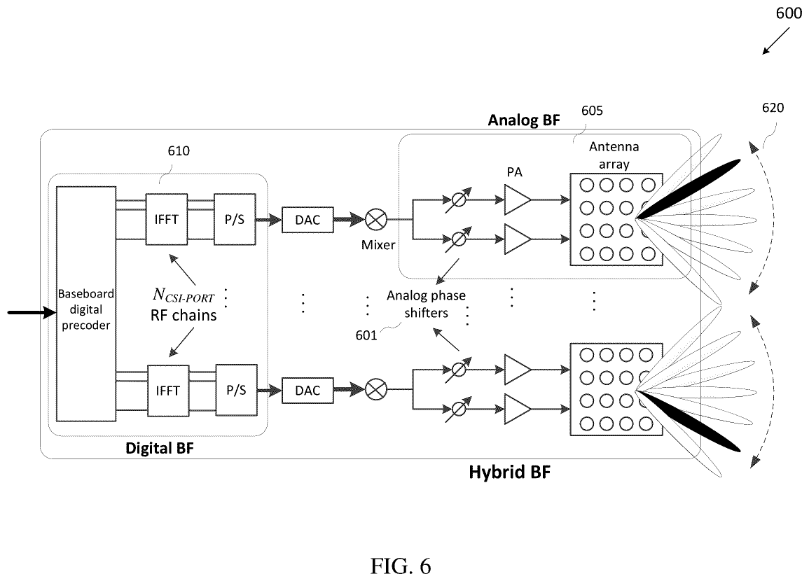

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mm Wave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

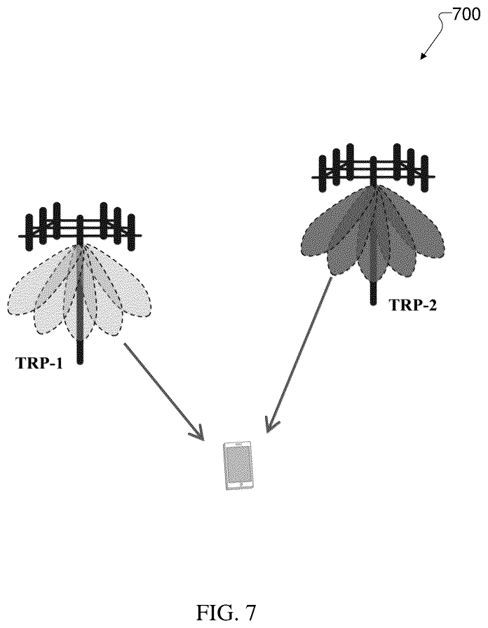

FIG. 7 illustrates an example system 700 for a multi-TRP according to embodiments of the present disclosure. For example, the system 700 may operate within the wireless network 100 in FIG. 1. This example is for illustration only and other embodiments can be used without departing from the scope of the present disclosure.

A UE could simultaneously receive from multiple physically non-co-located TRPs various channels/RSs such as physical downlink control channels (PDCCHs) and/or physical downlink shared channels (PDSCHs) using either a single receive (RX) panel or multiple RX panels. In this disclosure, a RX panel could correspond to a set of RX antenna elements/ports at the UE, a set of measurement RS resources such as sounding reference signal (SRS) resources, a spatial domain RX filter or etc. Furthermore, a TRP in the multi-TRP system can represent a collection of measurement antenna ports, measurement RS resources and/or control resource sets (CORESETs). For example, a TRP could be associated with one or more of:
A plurality of CSI-RS resources
A plurality of CRIs (CSI-RS resource indices/indicators).
A measurement RS resource set, for example, a CSI-RS resource set along with its indicator
A plurality of CORESETs associated with a CORESETPoolIndex
A plurality of CORESETs associated with a TRP-specific index/indicator/identity

A cell/TRP could be a non-serving cell/TRP. In this disclosure, the non-serving cell(s) or the non-serving cell TRP(s) could have/broadcast different physical cell IDs (PCIs) and/or other higher layer signaling index values from that of the serving cell or the serving cell TRP (i.e., the serving cell PCI). In one example, the serving cell or the serving cell TRP could be associated with the serving cell ID (SCI) and/or the serving cell PCI. That is, for the inter-cell operation provided in the present disclosure, different cells/TRPs could broadcast different PCIs and/or one or more cells/TRPs (referred to/defined as non-serving cells/TRPs in the present disclosure) could broadcast different PCIs from that of the serving cell/TRP (i.e., the serving cell PCI) and/or one or more cells/TRPs are not associated with valid SCI (e.g., provided by the higher layer parameter ServCellIndex). In the present disclosure, a non-serving cell PCI can also be referred to as an additional PCI, another PCI, or a different PCI (with respect to the serving cell PCI).

Embodiments of the present disclosure provide various design aspects related to TCI state(s) indication, update, and application under unified TCI framework for single-TRP (STRP) and/or multi-TRP (MTRP) operation(s).

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID.
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a PDSCH. As described in the 3GPP Rel-17:
In one example, a MAC CE could be used to indicate to the UE a beam (i.e., a TCI state and/or a TCI state ID) for the transmission/reception of a PDCCH or a PDSCH.
In another example, a downlink control information (DCI) could be used to indicate to the UE a beam (i.e., a TCI state and/or a TCI state ID) for the transmission/reception of a PDCCH or a PDSCH.
   For example, a DL related DCI (e.g., DCI format 1_0. DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0. DCI format 0_1. DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based physical uplink shared channel (PUSCH) and all of dedicated physical uplink control channel (PUCCH) resources.

In a single-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or all of dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states for at least UE-dedicated reception on PDSCH/PDCCH or dynamic-grant/configured-grant based PUSCH or all of dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter ControlResourceSet that configures a CORESET-a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET. ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET. 10′ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure-could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH-a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH. ‘01’ indicates that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH. ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH. ‘11’ indicates that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure-could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s). ‘01’ indicates that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s). ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource. ‘11’ indicates that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PUSCH transmission in a (single-DCI based) multi-TRP system, a UE could be configured/provided/indicated by the network via higher layer RRC signaling/parameter and/or MAC CE command and/or dynamic DCI based L1 signaling—e.g., in an UL DCI (e.g., DCI format 0_0/0_1/0_2) that schedules the PUSCH—a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH. ‘01’ indicates that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH. ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH. ‘11’ indicates that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

Throughout the present disclosure, the first TCI state(s) described above/herein in the present disclosure can also be denoted/represented/replaced by a/the first applicable TCI state(s), and/or the second TCI state(s) described above/herein in the present disclosure can also be denoted/represented/replaced by a/the second applicable TCI state(s). Throughout the present disclosure, unless otherwise specified, a TCI state could correspond a joint TCI state, a DL TCI state, an UL TCI state, or a pair of two TCI states each corresponding to a joint TCI state or a DL TCI state or an UL TCI state. Throughout the present disclosure, unless otherwise specified, a joint/DL TCI state could be provided by TCI-State or DLorJointTCI-State, and an UL TCI state could be provided UL-TCIState.

In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for or to transmit/receive channels/signals such as PDCCH. PDSCH. PUCCH and PUSCH associated to the same (or different) CORESET pool index value. A pair of TCI states could include/contain a separate DL TCI state provided by TCI-State/DLorJointTCI-State or a separate UL TCI State provided by TCI-State/UL-TCIState indicated for or to transmit/receive channels/signals such as PDCCH. PDSCH. PUCCH and PUSCH associated to the same (or different) CORESET pool index value, under the unified TCI framework.

A UE could be configured/provided/indicated, e.g., via higher layer RRC signaling and/or MAC CE command and/or dynamic DCI based L1 signaling. M≥1 or N≥1 (e.g., M=2 or N=2) groups/lists of TCI states or TCI state IDs with each group/list comprising/containing/including one or more TCI states or TCI state IDs. The bitwidth of the TCI state ID in each group/list could be determined according to the total number of TCI states/TCI state IDs in the corresponding group/list. Alternatively, the bitwidth of the TCI state ID in each group/list could be determined according to the total number of TCI states/TCI state IDs across all the configured groups/lists. Furthermore, the TCI state ID(s) in different groups/lists may not overlap—i.e., different groups/lists may not comprise/include/contain the same TCI state(s) or TCI state ID(s). Additionally, each group/list of TCI states or TCI state IDs could be configured with a (unique) TCI state group/list ID.
For example, an entity index/ID could be provided in the higher layer parameter, e.g., TCI-State or DLorJointTCI-State or UL-TCIState, that configures a joint/DL/UL TCI state as specified herein in the present disclosure. The UE could determine/identify one or more TCI states/TCI state IDs in a (same) group of TCI states/TCI state IDs when/if the entity index(es)/ID(s) provided/configured in the higher layer parameter(s) that configures the one or more TCI states/TCI state IDs—as specified herein in the present disclosure—is the same or identical. In the present disclosure, the entity index/ID could correspond to at least one of: a PCI value, a PCI index pointing to an entry/PCI in a list of PCI that are higher layer configured to the UE, a value of CORESETPoolIndex, a value of CORESETGroupIndex, a one-bit flag indicator, a TRP ID, a TRP-specific higher layer signaling index, a CORESET ID, a resource ID/index, a resource set ID/index, etc. For instance, for M=2 or N=2, the entity index/ID could be a one-bit flag indicator: when/if the entity index/ID associated to a TCI state (e.g., by configuring/providing the entity ID in the higher layer parameter TCI-State that configures the TCI state) is set to ‘0’ (or ‘1’), the UE could determine/identify that the TCI state/TCI state ID belongs to the first group of TCI states/TCI state IDs. When/if the entity index/ID associated to a TCI state (e.g., by configuring/providing the entity ID in the higher layer parameter TCI-State that configures the TCI state) is set to ‘l’ (or ‘0’), the UE could determine/identify that the TCI state/TCI state ID belongs to the second group of TCI states/TCI state IDs. According to the design procedures described herein in the present disclosure, the UE could determine/identify a first group of joint/DL TCI states and/or a second group of joint/DL TCI states, e.g., in the higher layer configuration of dl-OrJoint-TCIStateList. Furthermore, the UE could determine/identify a first group of UL TCI states and/or a second group of UL TCI states, e.g., in the higher layer configuration of dl-OrJoint-TCIStateList or ul-TCIStateList.
For another example, for N=2 or M=2, the UE could be first provided/configured/indicated by the network, e.g., via higher layer RRC signaling/parameter, a list of joint/DL (or UL) TCI states. In the higher layer RRC signaling/parameter that configures/provides the list of joint/DL (or UL) TCI states, the UE could be further configured/provided/indicated by the network the number of TCI states/TCI state IDs (e.g., denoted by Ngroup1) of the first group of TCI states/TCI state IDs in the list and/or the number of TCI states/TCI state IDs (e.g., denoted by Ngroup2) of the second group of TCI states/TCI state IDs in the list. For this design example, the UE could identify/determine that the first Ngroup1 TCI states/TCI state IDs in the list of joint/DL (or UL) TCI states belong to the first group of TCI states/TCI state IDs, and the rest (or last Ngroup2) TCI states/TCI state IDs in the list of joint/DL (or UL) TCI states belong to the second group of TCI states/TCI state IDs. Alternatively, the UE could identify/determine that the last Ngroup2 TCI states/TCI state IDs in the list of joint/DL (or UL) TCI states belong to the second group of TCI states/TCI state IDs, and the rest (or first Ngroup1) TCI states/TCI state IDs in the list of joint/DL (or UL) TCI states belong to the first group of TCI states/TCI state IDs. According to the design procedures described herein in the present disclosure, the UE could determine/identify a first group of joint/DL TCI states and/or a second group of joint/DL TCI states, e.g., in the higher layer configuration of dl-OrJoint-TCIStateList. Furthermore, the UE could determine/identify a first group of UL TCI states and/or a second group of UL TCI states, e.g., in the higher layer configuration of dl-OrJoint-TCIStateList or ul-TCIStateList. The above described UE operations/behaviors could be extended/applied to when N>2 (or M>2) groups of TCI states/TCI state IDs are configured.
Yet for another example, for N=2 or M=2, the UE could be first provided/configured/indicated by the network, e.g., via higher layer RRC signaling/parameter, a list of joint/DL (or UL) TCI states. In the higher layer RRC signaling/parameter that configures/provides the list of joint/DL (or UL) TCI states, the UE could be further configured/provided/indicated by the network the TCI state indexes/IDs or indexes of the TCI state indexes/IDs of the first group of TCI states/TCI state IDs in the list and/or the TCI state indexes/IDs or indexes of the TCI state indexes/IDs of the second group of TCI states/TCI state IDs in the list. According to the design procedures described herein in the present disclosure, the UE could determine/identify a first group of joint/DL TCI states and/or a second group of joint/DL TCI states, e.g., in the higher layer configuration of dl-OrJoint-TCIStateList. Furthermore, the UE could determine/identify a first group of UL TCI states and/or a second group of UL TCI states, e.g., in the higher layer configuration of dl-OrJoint-TCIStateList or ul-TCIStateList. The above described UE operations/behaviors could be extended/applied to when N>2 (or M>2) groups of TCI states/TCI state IDs are configured.

As specified herein in the present disclosure, a UE could be configured/provided/indicated by the network, e.g., via higher layer RRC signaling/parameter (via/in dl-OrJoint-TCIStateList or ul-TCIStateList) and/or MAC CE command and/or dynamic DCI based L1 signaling, configuration-1: a single list/group of TCI state(s) or TCI state ID(s), and configuration-2: multiple lists/groups of TCI states or TCI state IDs. The UE could be configured/provided/indicated by the network, e.g., via higher layer RRC signaling/parameter and/or MAC CE command and/or dynamic DCI based L1 signaling, whether the UE could use/apply the configuration-1 and/or configuration-2. When/if the configuration-1 as specified herein in the present disclosure is used/applied/configured, the UE could operate in a STRP mode; and/or when/if the configuration-2 as specified herein in the present disclosure is used/applied/configured, the UE could operation in a (software-defined cloud interconnection (SDCI) based) MTRP mode. Furthermore, the UE could report to the network a capability signaling indicating that whether the UE could be capable of supporting configuration-1 and/or configuration-2 as specified herein in the present disclosure. For example, the capability signaling/report could indicate that the UE could not support configuration-2. Or equivalently, the UE could only support configuration-1. For another example, the capability signaling/report could indicate that the UE could support configuration-1 and/or configuration-2 as specified herein in the present disclosure. The UE could then be provided/configured/indicated by the network, e.g., via higher layer RRC signaling/parameter and/or MAC CE command and/or dynamic DCI based L1 signaling, the configuration-1 and/or configuration-2 based on the capability signaling/report from the UE.

As specified herein in the present disclosure, in a STRP system or for STRP operation in/on a component carrier (CC) or a set/list/pool/group of CCs, a UE could be indicated or could apply/use only a single TCI state/pair of TCI states for at least UE-dedicated reception on PDSCH/PDCCH or dynamic-grant/configured-grant based PUSCH or all of dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework, when/if one or more of the following conditions are achieved:
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, each of the TCI codepoints could include or comprise or could be mapped to a single joint/DL/UL TCI state/pair of joint/DL/UL TCI states.
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, at least one of the TCI codepoints could include or comprise or could be mapped to a single joint/DL/UL TCI state/pair of joint/DL/UL TCI states. The one of the TCI codepoints that includes/comprises or is mapped to a single joint/DL/UL TCI state/pair of joint/DL/UL TCI states could be determined according to: (i) fixed in the system specifications, e.g., the first/last TCI codepoint or the lowest/highest TCI codepoint (the index of the TCI codepoint is the lowest/highest) among all the TCI codepoints activated by/in the beam indication/activation MAC CE, and/or (2) provided/configured/indicated by the network, e.g., via higher layer RRC signaling/parameter and/or MAC CE command and/or dynamic DCI based L1 signaling, and/or (3) the only TCI codepoint in the beam indication/activation MAC CE that comprises a single joint/DL/UL TCI state/pair of joint/DL/UL TCI states.
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, a TCI codepoint could include or comprise or could be mapped to one or more joint/DL/UL TCI states/pairs of joint/DL/UL TCI states. When a TCI codepoint includes/comprises or is mapped to N>1 (e.g., N=2) joint/DL/UL TCI states/pairs of joint/DL/UL TCI states, the N joint/DL/UL TCI states could be the same/identical, i.e., they could correspond to a same TCI state or TCI state ID, or the N pairs of joint/DL/UL TCI states could be the same/identical, i.e., they could correspond to a same pair of TCI states or pair of TCI state IDs.
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, a TCI codepoint could include or comprise or could be mapped to one or more TCI states/pairs of TCI states. Each TCI state(s)/pair(s) of TCI states in the MAC CE may or may not be associated with an indicator, wherein the indicator (if present/associated to the TCI state(s)/pair(s) of TCI states) could indicate whether the TCI state(s)/pair(s) of TCI states could correspond to the first TCI state/pair of TCI states, the second TCI state/pair of TCI states, and/or etc., among all the TCI states/pairs of TCI states mapped to the same TCI codepoint comprising the TCI state(s)/pair(s) of TCI state(s) activated by/in the MAC CE; furthermore, the indicator (if present/associated to the TCI state(s)/pair(s) of TCI states) could also indicate whether the TCI state(s)/pair(s) of TCI states could be from a first group/list of TCI states/TCI state IDs or a second group/list of TCI states/TCI state IDs. When a TCI codepoint includes/comprises or is mapped to N>1 (e.g., N=2) joint/DL/UL TCI states/pairs of joint/DL/UL TCI states, the N joint/DL/UL TCI states could be the same/identical, i.e., they could correspond to a same TCI state or TCI state ID, or the N pairs of joint/DL/UL TCI states could be the same/identical, i.e., they could correspond to a same pair of TCI states or pair of TCI state IDs.
The UE could receive from the network at least one Rel-18 (enhanced) unified TCI state activation/deactivation MAC CE command that deactivates all of the TCI states/TCI codepoints for MTRP operation.
The UE could receive from the network at least one Rel-17 unified TCI state activation/deactivation MAC CE command that activates one or more TCI states/TCI codepoints for STRP operation.
The UE could be configured by the network, e.g., via higher layer RRC signaling, a single list of joint/DL TCI states and/or a single list of UL TCI states.
The UE could be configured by the network, e.g., via higher layer RRC signaling, a single group of joint/DL TCI states (e.g., within a list of RRC configured joint/DL TCI states) and/or a single group of UL TCI states (e.g., within a list of RRC configured UL TCI states).
The UE could be configured/indicated/provided by the network, e.g., via higher layer RRC signaling and/or MAC CE command and/or dynamic DCI based L1 signaling, that the STRP operation under the unified TCI framework is enabled. For instance, an indicator could be indicated/provided in a MAC CE command, e.g., the (enhanced) unified TCI states activation/deactivation MAC CE command, to indicate a switch between the (SDCI based) MTRP operation and the STRP operation. For this case, when/if the indicator is a one-bit indicator and set to ‘0’ (or ‘1’), the STRP operation is enabled (or the operation mode is switched from the (SDCI based) MTRP operation to the STRP operation).
The first indicator as specified herein in the present disclosure could be configured/set to a particular value (such as ‘00’ or ‘01’ as specified herein in the present disclosure) indicating that one of the (two) TCI states/pairs of TCI states—e.g., the first TCI state(s) or the second TCI state(s)—could be applied for PDCCH reception.
The second indicator as specified herein in the present disclosure could be configured/set to a particular value (such as: ‘00’ or ‘01’ as specified herein in the present disclosure) indicating that one of the (two) TCI states/pairs of TCI states—e.g., the first TCI state(s) or the second TCI state(s)—could be applied for PDSCH reception.
The third indicator as specified herein in the present disclosure could be configured/set to a particular value (such as ‘00’ or ‘01’ as specified herein in the present disclosure) indicating that only one of the (two) TCI states/pairs of TCI states—e.g., the first TCI state(s) or the second TCI state(s)—could be applied for PUCCH transmission.
The fourth indicator—e.g., by repurposing the SRS resource set indicator in DCI format 0_1/0_2—as specified herein in the present disclosure could be configured/set to a particular value (such as ‘00’ or ‘01’ as specified herein in the present disclosure) indicating that only one of the (two) TCI states/pairs of TCI states—e.g., the first TCI state(s) or the second TCI state(s)—could be applied for PUSCH transmission.
The UE could be provided/configured/indicated by the network, e.g., via higher layer RRC signaling, a presence or absence of the first indicator as specified herein in the present disclosure in the corresponding DCI format.
The UE could be provided/configured/indicated by the network, e.g., via higher layer RRC signaling, whether or not the SRS resource set indicator in the DCI format 0_1/0_2 is used as the fourth indicator as specified herein in the present disclosure in the corresponding DCI format.
The UE could be indicated, e.g., in/via time-domain resource allocation (TDRA) field in DCI, only the entry(s) in pdsch-TimeDomainAllocation List containing no repetitionNumber.
The UE may not be configured with the higher layer parameter repetitionNumber or the UE may not be configured by the higher layer parameter repetitionScheme set to ‘tdmSchemeA’, ‘fdmSchemeA’, ‘fdmSchemcB’.
The UE may not be indicated DM-RS port(s) within two code-division multiplexing (CDM) groups in the DCI field ‘Antenna Port(s)’, or the UE could be indicated DM-RS port(s) within a single CDM group in the DCI field ‘Antenna Port(s)’.
The UE may not be configured with the higher layer parameter sfnSchemePdsch set to either ‘sfnSchemeA’ or ‘sfnSchemeB’ for a DL bandwidth part (BWP).
The UE may not be configured with the higher layer parameter sfnSchemePdcch.

As specified herein in the present disclosure, in a (SDCI based) MTRP system or for (SDCI based) MTRP operation in/on a component carrier (CC) or a list/set/pool/group of CCs, a UE could be indicated or could apply/use one or more (e.g., N>1) TCI states/pairs of TCI states for at least UE-dedicated reception on PDSCH/PDCCH or dynamic-grant/configured-grant based PUSCH or all of dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework, when/if one or more of the following conditions are achieved:
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, each of the TCI codepoints could include or comprise or could be mapped to N>1 (e.g., N=2) joint/DL/UL TCI states/pairs of joint/DL/UL TCI states. The N joint/DL/UL TCI states could be different from each other, i.e., they could correspond to different TCI states or TCI state IDs, or the N pairs of joint/DL/UL TCI states could be different from each other, i.e., they could correspond to different pairs of TCI states or pairs of TCI state IDs.
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, at least one of the TCI codepoints could include or comprise or could be mapped to N>1 (e.g., N=2) joint/DL/UL TCI states/pairs of joint/DL/UL TCI states. The one of the TCI codepoints that includes/comprises or is mapped to N>1 (e.g., N=2) joint/DL/UL TCI states/pairs of joint/DL/UL TCI states could be determined according to: (i) fixed in the system specifications, e.g., the first/last TCI codepoint or the lowest/highest TCI codepoint (the index of the TCI codepoint is the lowest/highest) among all the TCI codepoints activated by/in the beam indication/activation MAC CE, and/or (2) provided/configured/indicated by the network, e.g., via higher layer RRC signaling/parameter and/or MAC CE command and/or dynamic DCI based L1 signaling, and/or (3) the only TCI codepoint in the beam indication/activation MAC CE that comprises N>1 (e.g., N=2) joint/DL/UL TCI states/pairs of joint/DL/UL TCI states. The N joint/DL/UL TCI states could be different from each other, i.e., they could correspond to different TCI states or TCI state IDs, or the N pairs of joint/DL/UL TCI states could be different from each other, i.e., they could correspond to different pairs of TCI states or pairs of TCI state IDs.
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, a TCI codepoint could include or comprise or could be mapped to one or more TCI states/pairs of TCI states. Each TCI state(s)/pair(s) of TCI states in the MAC CE may or may not be associated with an indicator, wherein the indicator (if present/associated to the TCI state(s)/pair(s) of TCI states) could indicate whether the TCI state(s)/pair(s) of TCI states could correspond to the first TCI state/pair of TCI states, the second TCI state/pair of TCI states, and/or etc., among all the TCI states/pairs of TCI states mapped to the same TCI codepoint comprising the TCI state(s)/pair(s) of TCI state(s) activated by/in the MAC CE; furthermore, the indicator (if present/associated to the TCI state(s)/pair(s) of TCI states) could also indicate whether the TCI state(s)/pair(s) of TCI states could be from a first group/list of TCI states/TCI state IDs or a second group/list of TCI states/TCI state IDs. When a TCI codepoint includes/comprises or is mapped to N>1 (e.g., N=2) joint/DL/UL TCI states/pairs of TCI states, the N joint/DL/UL TCI states could be different from each other, i.e., they could correspond to different TCI states or TCI state IDs, or the N pairs of joint/DL/UL TCI states could be different from each other, i.e., they could correspond to different pairs of TCI states or pairs of TCI state IDs.
The UE could receive from the network at least one Rel-18 (enhanced) unified TCI state activation/deactivation MAC CE command that activates one or more TCI states/TCI codepoints for MTRP operation.
The UE could receive from the network at least one Rel-17 unified TCI state activation/deactivation MAC CE command that deactivates all of the TCI states/pairs of TCI states for STRP operation.
The UE could be configured by the network, e.g., via higher layer RRC signaling, one or more lists of joint/DL TCI states and/or one or more lists of UL TCI states. For instance, for M=2 or N=2, the UE could be configured by the network, e.g., via higher layer RRC signaling, a first and a second lists of joint/DL TCI states and/or a first and a second lists of UL TCI states.
The UE could be configured by the network, e.g., via higher layer RRC signaling, one or more groups of joint/DL TCI states (e.g., within a list of RRC configured joint/DL TCI states) and/or one or more groups of UL TCI states (e.g., within a list of RRC configured UL TCI states). For instance, for M=2 or N=2, the UE could be configured by the network, e.g., via higher layer RRC signaling, a first and a second groups of joint/DL TCI states (e.g., within a list of RRC configured joint/DL TCI states) and/or a first and a second groups of UL TCI states (e.g., within a list of RRC configured UL TCI states).
The UE could be configured/indicated/provided by the network, e.g., via higher layer RRC signaling and/or MAC CE command and/or dynamic DCI based L1 signaling, that the (SDCI based) MTRP operation under the unified TCI framework is enabled. For instance, an indicator could be indicated/provided in a MAC CE command, e.g., the (enhanced) unified TCI states activation/deactivation MAC CE command, to indicate a switch between the STRP operation and the (SDCI based) MTRP operation. For this case, when/if the indicator is a one-bit indicator and set to ‘1’ (or ‘0’), the (SDCI based) MTRP operation is enabled (or the operation mode is switched from the STRP operation to the (SDCI based) MTRP operation).
The first indicator as specified herein in the present disclosure could be configured/set to a particular value (such as ‘00’ or ‘01’ as specified herein in the present disclosure) indicating that one of the (two) TCI states/pairs of TCI states—e.g., the first TCI state(s) or the second TCI state(s)—could be applied for PDCCH reception.
The first indicator as specified herein in the present disclosure could be configured/set to a particular value (such as ‘10’ or ‘11’ as specified herein in the present disclosure) indicating that both of the (two) TCI states/pairs of TCI states—e.g., the first TCI state(s) and the second TCI state(s)—could be applied for PDCCH reception.
The second indicator as specified herein in the present disclosure could be configured/set to a particular value (such as ‘00’ or ‘01’ as specified herein in the present disclosure) indicating that one of the (two) TCI states/pairs of TCI states—e.g., the first TCI state(s) or the second TCI state(s)—could be applied for PDSCH reception.
The second indicator as specified herein in the present disclosure could be configured/set to a particular value (such as ‘10’ or ‘11’ as specified herein in the present disclosure) indicating that both of the (two) TCI states/pairs of TCI states—e.g., the first TCI state(s) and the second TCI state(s)—could be applied for PDSCH reception.
The third indicator as specified herein in the present disclosure could be configured/set to a particular value (such as ‘00’ or ‘01’ as specified herein in the present disclosure) indicating that only one of the (two) TCI states/pairs of TCI states—e.g., the first TCI state(s) or the second TCI state(s)—could be applied for PUCCH transmission.
The third indicator as specified herein in the present disclosure could be configured/set to a particular value (such as ‘10’ or ‘11’ as specified herein in the present disclosure) indicating that both of the (two) TCI states/pairs of TCI states—e.g., the first TCI state(s) and the second TCI state(s)—could be applied for PUCCH transmission.
The fourth indicator—e.g., by repurposing the SRS resource set indicator in DCI format 0_1/0_2—as specified herein in the present disclosure could be configured/set to a particular value (such as ‘00’ or ‘01’ as specified herein in the present disclosure) indicating that only one of the (two) TCI states/pairs of TCI states—e.g., the first TCI state(s) or the second TCI state(s)—could be applied for PUSCH transmission.
The fourth indicator—e.g., by repurposing the SRS resource set indicator in DCI format 0_1/0_2—as specified herein in the present disclosure could be configured/set to a particular value (such as ‘10’ or ‘11’ as specified herein in the present disclosure) indicating that both of the (two) TCI states/pairs of TCI states—e.g., the first TCI state(s) and the second TCI state(s)—could be applied for PUSCH transmission.
The UE could be provided/configured/indicated by the network, e.g., via higher layer RRC signaling, a presence or absence of the first indicator as specified herein in the present disclosure in the corresponding DCI format.
The UE could be provided/configured/indicated by the network, e.g., via higher layer RRC signaling, whether or not the SRS resource set indicator in the DCI format 0_1/0_2 is used as the fourth indicator as specified herein in the present disclosure in the corresponding DCI format.
The UE could be indicated, e.g., in/via time-domain resource allocation (TDRA) field by DCI, at least one entry in pdsch-TimeDomainAllocationList containing repetition Number (e.g., >1).
The UE could be indicated, e.g., in/via time-domain resource allocation (TDRA) field by DCI, one entry in pdsch-TimeDomainAllocationList containing no repetitionNumber, but at least one entry in pdsch-TimeDomainAllocation List containing repetitionNumber (e.g., >1).
The UE could be indicated, e.g., in/via time-domain resource allocation (TDRA) field in DCI, only the entry(s) in pdsch-TimeDomainAllocationList containing no repetitionNumber.
The UE could be configured with the higher layer parameter repetitionNumber or the UE could be configured by the higher layer parameter repetitionScheme set to ‘tdmSchemeA’, ‘fdmSchemeA’, ‘fdmSchemeB’.
The UE could be indicated DM-RS port(s) within two CDM groups in the DCI field ‘Antenna Port(s)’.
The UE could be configured with the higher layer parameter sfnSchemePdsch set to either ‘sfnSchemeA’ or ‘sfnSchemeB’ for a DL BWP.
The UE could be configured with the higher layer parameter sfnSchemePdcch.

As specified herein in the present disclosure, in a (MDCI based) MTRP system or for (MDCI based) MTRP operation in/on a component carrier (CC) or a list/set/pool/group of CCs, the UE could be provided/configured/indicated by the network (e.g., the network 130), e.g., via higher layer RRC signaling/parameter (e.g., in PDCCH-Config) and/or MAC CE command and/or dynamic DCI based L1 signaling, two values (i.e., 0 and 1) of CORESETPoolIndex each configured for/associated to one or more CORESETs, wherein each CORESET could be configured/associated with a value (i.e., 0 or 1) of CORESETPoolIndex.

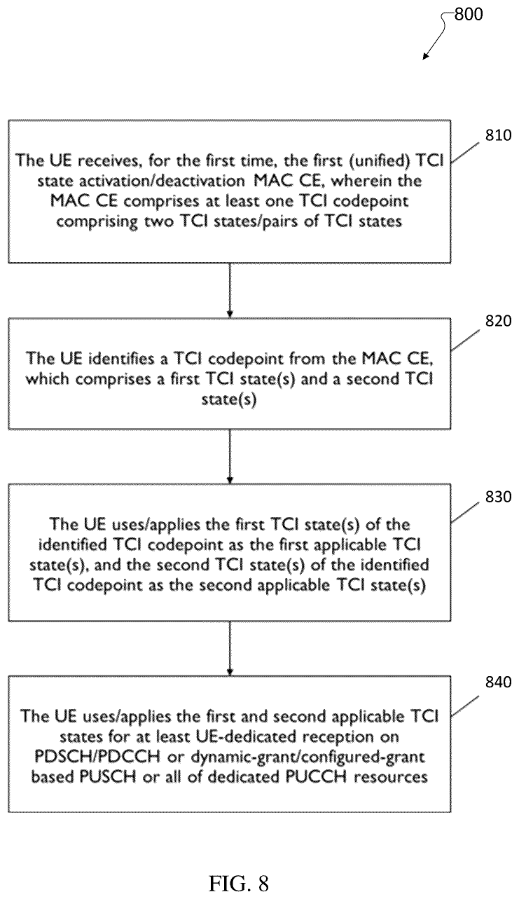

FIG. 8 illustrates a flowchart of an example UE procedure 800 for identifying/using first and second applicable TCI states according to embodiments of the present disclosure. For example, procedure 800 for identifying/using first and second applicable TCI states can be performed by any of the UEs 111-116 of FIG. 1. This example is for illustration only and other embodiments can be used without departing from the scope of the present disclosure.

The procedure begins in 810, the UE receives, for the first time, the first (unified) TCI state activation/deactivation MAC CE, wherein the MAC CE comprises at least one TCI codepoint comprising two TCI states/pairs of TCI states. In 820, the UE identifies a TCI codepoint from the MAC CE, which comprises a first TCI state(s) and a second TCI state(s). In 830, the UE uses/applies the first TCI state(s) of the identified TCI codepoint as the first applicable TCI state(s), and the second TCI state(s) of the identifies TCI codepoint as the second applicable TCI state(s). In 840, the UE uses/applies the first second applicable TCI states for at least UE-dedicated reception on PDSCH/PDCCH or dynamic-grant/configured-grant based PUSCH or all of dedicated PUCCH resources.

In one embodiment, during an initial operation phase—e.g., before a UE receives from the network (e.g., the network 130) any TCI state(s) activation/deactivation MAC CE(s) and/or TCI state(s) indication DCI(s) or before the UE (e.g., the UE 116) could apply/use any of the configured/activated/indicated TCI state(s), e.g., before a time duration or beam application time (BAT) upon receiving TCI state(s) activation/deactivation/indication MAC CE(s)/DCI(s) for the first time, the UE may not operate in either STRP mode or MTRP mode according to one or more of the conditions specified herein in the present disclosure, or the UE may not be configured/provided/activated/indicated by the network, e.g., via any (enhanced) unified TCI state(s) activation/deactivation MAC CE command(s) and/or beam indication DCI(s), any TCI state(s)/pair(s) of TCI states yet to use/apply for at least UE-dedicated reception on PDSCH/PDCCH or dynamic-grant/configured-grant based PUSCH or all of dedicated PUCCH resources, or the UE may not have/maintain/track any TCI state(s)/pair(s) of TCI states yet to use/apply for at least UE-dedicated reception on PDSCH/PDCCH or dynamic-grant/configured-grant based PUSCH or all of dedicated PUCCH resources. After the initial operation phase—e.g., after the UE has received from the network at least one TCI state(s) activation/deactivation MAC CE and/or TCI state(s) indication DCI or after the UE could apply/use one or more of the configured/activated/indicated TCI states, e.g., after a time duration or beam application time (BAT) upon receiving TCI state(s) activation/deactivation/indication MAC CE(s)/DCI(s) for the first time, the UE could operate in the MTRP mode according to one or more of the conditions specified herein in the present disclosure. For this design example, the UE could receive from the network, for the first time, a/the first beam indication/activation MAC CE, e.g., unified TCI state activation/deactivation MAC CE, wherein the (unified) TCI states activated/provided/indicated in the first MAC CE could be used to map up to Ncp (e.g., Ncp=8) TCI codepoints of one or more TCI fields in a/the first beam indication DCI; here, a TCI codepoint could include or comprise or could be mapped to one or more joint/DL/UL TCI states/pairs of joint/DL/UL TCI states. Furthermore, each TCI state(s)/pair(s) of TCI states in the first MAC CE could be associated with an indicator, wherein the indicator could indicate whether the TCI state(s)/pair(s) of TCI states could correspond to the first TCI state/pair of TCI states, the second TCI state/pair of TCI states, and/or etc., among all the TCI states/pairs of TCI states mapped to the same TCI codepoint comprising the TCI state(s)/pair(s) of TCI state(s) activated by/in the first MAC CE; furthermore, the indicator could also indicate whether the TCI state(s)/pair(s) of TCI states could be from a first group/list of TCI states/TCI state IDs or a second group/list of TCI states/TCI state IDs. For the MTRP operation mode with N=2 or M=2, the UE could determine/identify, based on the TCI state(s)/pair(s) of TCI states activated/indicated by/in the first MAC CE and/or the first DCI, a first applicable TCI state(s) and/or a second applicable TCI state(s) to use for at least UE-dedicated reception on PDSCH/PDCCH or dynamic-grant/configured-grant based PUSCH or all of dedicated PUCCH resources.
In one example, when the UE is indicated, for the first time, e.g., via the TCI field(s) in the first TCI state(s) indication DCI as specified herein in the present disclosure, a TCI codepoint comprising a single TCI state/pair of TCI states, and the indicator associated to the TCI state/pair of TCI states indicates that the TCI state/pair of TCI states corresponds to the first TCI state/pair of TCI states among all the TCI states/pairs of TCI states mapped to the same TCI codepoint comprising the TCI state/pair of TCI states activated/provided/indicated in/by the first unified TCI state activation/deactivation MAC CE as specified herein in the present disclosure, after the indicated TCI state(s) has become applicable—e.g., after a time duration or beam application time (BAT) upon receiving the TCI state(s) activation/deactivation/indication MAC CE(s)/DCI(s) for the first time:
   For example, the UE could use/apply only the indicated TCI state/pair of TCI states for at least UE-dedicated reception on PDSCH/PDCCH or dynamic-grant/configured-grant based PUSCH or all of dedicated PUCCH resources.
   For another example, the UE could use/apply the indicated TCI state/pair of TCI states—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the first MAC CE that comprises at least one TCI state/pair of TCI states with the corresponding/associated indicator indicating that the at least one TCI state/pair of TCI states is the second TCI state/pair of TCI states among all the TCI states/pairs of TCI states mapped to the same TCI codepoint, among one or more of the TCI codepoints in the first MAC CE, wherein, e.g., each of those TCI codepoints could comprise at least one TCI state/pair of TCI states with the corresponding/associated indicator indicating that the at least one TCI state/pair of TCI states is the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the first MAC CE that comprises a single TCI state/pair of TCI states with the corresponding/associated indicator indicating that the TCI state/pair of TCI states is the second TCI state/pair of TCI states among all the TCI states/pairs of TCI states mapped to the same TCI codepoint, among one or more of the TCI codepoints in the first MAC CE, wherein, e.g., each of those TCI codepoints could comprise a single TCI state/pair of TCI states with the corresponding/associated indicator indicating that the TCI state/pair of TCI states is the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the first MAC CE that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, among one or more of the TCI codepoints in the first MAC CE, wherein, e.g., each of those TCI codepoints could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In another example, the UE could identify, from the first (unified) TCI state activation/deactivation MAC CE as specified herein in the present disclosure, a TCI codepoint comprising at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint. In this design example, the TCI codepoint to be identified could correspond to a fixed TCI codepoint in the first MAC CE, e.g., the first or last TCI codepoint in the first MAC CE (or the first or last TCI codepoint among one or more TCI codepoints in the first MAC CE, wherein each of the one or more TCI codepoints could be mapped to/could comprise at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint), or the only TCI codepoint in the first MAC CE that comprises at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint, or the only TCI codepoint in the first MAC CE that comprise at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint, or the lowest/highest TCI codepoint (the index of the TCI codepoint could be the lowest/highest) among one or more TCI codepoints in the first MAC CE, wherein the one or more TCI codepoints could correspond to all the TCI codepoints in the first MAC CE or the one or more TCI codepoints could correspond to those in the first MAC CE each comprising at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint, or the only TCI codepoint in the first MAC CE that comprises at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint. Optionally, the UE could be indicated/provided/configured by the network, e.g., via higher layer RRC signaling/parameter and/or MAC CE command and/or dynamic DCI based L1 signaling. (index of) the TCI codepoint to be identified among one or more TCI codepoints from/in the first MAC CE; for this case, the one or more TCI codepoints could correspond to all the TCI codepoints from/in the first MAC CE, or the one or more TCI codepoints could correspond to those from/in the first MAC CE each comprising at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint. After the TCI state(s) mapped to the identified TCI codepoint has become applicable—e.g., after a time duration or beam application time (BAT) upon receiving the TCI state(s) activation/deactivation/indication MAC CE(s)/DCI(s) for the first time:
   For example, the UE could only use/apply the first TCI state/pair of TCI states among all the TCI states/pairs of TCI states mapped to the identified TCI codepoint for at least UE-dedicated reception on PDSCH/PDCCH or dynamic-grant/configured-grant based PUSCH or all of dedicated PUCCH resources.
   For another example, the UE could use/apply the first TCI state/pair of TCI states among all the TCI states/pairs of TCI states mapped to the identified TCI codepoint—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the first MAC CE that comprises at least one TCI state/pair of TCI states with the corresponding/associated indicator indicating that the at least one TCI state/pair of TCI states is the second TCI state/pair of TCI states among all the TCI states/pairs of TCI states mapped to the same TCI codepoint, among one or more of the TCI codepoints in the first MAC CE, wherein, e.g., each of those TCI codepoints could comprise at least one TCI state/pair of TCI states with the corresponding/associated indicator indicating that the at least one TCI state/pair of TCI states is the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the first TCI state/pair of TCI states among all the TCI states/pairs of TCI states mapped to the identified TCI codepoint—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the first MAC CE that comprises a single TCI state/pair of TCI states with the corresponding/associated indicator indicating that the TCI state/pair of TCI states is the second TCI state/pair of TCI states among all the TCI states/pairs of TCI states mapped to the same TCI codepoint, among one or more of the TCI codepoints in the first MAC CE, wherein, e.g., each of those TCI codepoints could comprise a single TCI state/pair of TCI states with the corresponding/associated indicator indicating that the TCI state/pair of TCI states is the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the first TCI state/pair of TCI states among all the TCI states/pairs of TCI states mapped to the identified TCI codepoint—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the first MAC CE that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, among one or more of the TCI codepoints in the first MAC CE, wherein, e.g., each of those TCI codepoints could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, when the UE is indicated, for the first time, e.g., via the TCI field(s) in the first TCI state(s) indication DCI as specified herein in the present disclosure, a TCI codepoint comprising a single TCI state/pair of TCI states, and the indicator associated to the TCI state/pair of TCI states indicates that the TCI state/pair of TCI states corresponds to the second TCI state/pair of TCI states among all the TCI states/pairs of TCI states mapped to the same TCI codepoint comprising the TCI state/pair of TCI states activated/provided/indicated in/by the first unified TCI state activation/deactivation MAC CE as specified herein in the present disclosure, after the indicated TCI state(s) has become applicable—e.g., after a time duration or beam application time (BAT) upon receiving the TCI state(s) activation/deactivation/indication MAC CE(s)/DCI(s) for the first time:
   For example, the UE could use/apply only the indicated TCI state/pair of TCI states for at least UE-dedicated reception on PDSCH/PDCCH or dynamic-grant/configured-grant based PUSCH or all of dedicated PUCCH resources.
   For another example, the UE could use/apply the indicated TCI state/pair of TCI states—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the first MAC CE that comprises at least one TCI state/pair of TCI states with the corresponding/associated indicator indicating that the at least one TCI state/pair of TCI states is the first TCI state/pair of TCI states among all the TCI states/pairs of TCI states mapped to the same TCI codepoint, among one or more of the TCI codepoints in the first MAC CE, wherein, e.g., each of those TCI codepoints could comprise at least one TCI state/pair of TCI states with the corresponding/associated indicator indicating that the at least one TCI state/pair of TCI states is the first TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the first MAC CE that comprises a single TCI state/pair of TCI states with the corresponding/associated indicator indicating that the TCI state/pair of TCI states is the first TCI state/pair of TCI states among all the TCI states/pairs of TCI states mapped to the same TCI codepoint, among one or more of the TCI codepoints in the first MAC CE, wherein, e.g., each of those TCI codepoints could comprise a single TCI state/pair of TCI states with the corresponding/associated indicator indicating that the TCI state/pair of TCI states is the first TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the first MAC CE that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, among one or more of the TCI codepoints in the first MAC CE, wherein, e.g., each of those TCI codepoints could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, the UE could identify, from the first (unified) TCI state activation/deactivation MAC CE as specified herein in the present disclosure, a TCI codepoint comprising at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint. In this design example, the TCI codepoint to be identified could correspond to a fixed TCI codepoint in the first MAC CE, e.g., the first or last TCI codepoint in the first MAC CE (or the first or last TCI codepoint among one or more TCI codepoints in the first MAC CE, wherein each of the one or more TCI codepoints could be mapped to/could comprise at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint), or the only TCI codepoint in the first MAC CE that comprises at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint, or the lowest/highest TCI codepoint (the index of the TCI codepoint could be the lowest/highest) among one or more TCI codepoints in the first MAC CE, wherein the one or more TCI codepoints could correspond to all the TCI codepoints in the first MAC CE or the one or more TCI codepoints could correspond to those in the first MAC CE each comprising at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint. Optionally, the UE could be indicated/provided/configured by the network, e.g., via higher layer RRC signaling/parameter and/or MAC CE command and/or dynamic DCI based L1 signaling, (index of) the TCI codepoint to be identified among one or more TCI codepoints from/in the first MAC CE; for this case, the one or more TCI codepoints could correspond to all the TCI codepoints from/in the first MAC CE, or the one or more TCI codepoints could correspond to those from/in the first MAC CE each comprising at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint. After the TCI state(s) mapped to the identified TCI codepoint has become applicable—e.g., after a time duration or beam application time (BAT) upon receiving the TCI state(s) activation/deactivation/indication MAC CE(s)/DCI(s) for the first time:
   For example, the UE could only use/apply the second TCI state/pair of TCI states among all the TCI states/pairs of TCI states mapped to the identified TCI codepoint for at least UE-dedicated reception on PDSCH/PDCCH or dynamic-grant/configured-grant based PUSCH or all of dedicated PUCCH resources.
   For another example, the UE could use/apply the second TCI state/pair of TCI states among all the TCI states/pairs of TCI states mapped to the identified TCI codepoint—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the first MAC CE that comprises at least one TCI state/pair of TCI states with the corresponding/associated indicator indicating that the at least one TCI state/pair of TCI states is the first TCI state/pair of TCI states among all the TCI states/pairs of TCI states mapped to the same TCI codepoint, among one or more of the TCI codepoints in the first MAC CE, wherein, e.g., each of those TCI codepoints could comprise at least one TCI state/pair of TCI states with the corresponding/associated indicator indicating that the at least one TCI state/pair of TCI states is the first TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the second TCI state/pair of TCI states among all the TCI states/pairs of TCI states mapped to the identified TCI codepoint—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the first MAC CE that comprises a single TCI state/pair of TCI states with the corresponding/associated indicator indicating that the TCI state/pair of TCI states is the first TCI state/pair of TCI states among all the TCI states/pairs of TCI states mapped to the same TCI codepoint, among one or more of the TCI codepoints in the first MAC CE, wherein, e.g., each of those TCI codepoints could comprise a single TCI state/pair of TCI states with the corresponding/associated indicator indicating that the TCI state/pair of TCI states is the first TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the second TCI state/pair of TCI states among all the TCI states/pairs of TCI states mapped to the identified TCI codepoint—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the first MAC CE that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, among one or more of the TCI codepoints in the first MAC CE, wherein, e.g., each of those TCI codepoints could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, when the UE is indicated, for the first time, e.g., via the TCI field(s) in the first TCI state(s) indication DCI as specified herein in the present disclosure, a TCI codepoint comprising multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, after the indicated TCI state(s) has become applicable—e.g., after a time duration or beam application time (BAT) upon receiving the TCI state(s) activation/deactivation/indication MAC CE(s)/DCI(s) for the first time, the UE could use/apply the indicated first TCI state/pair of TCI states—as the first applicable TCI state(s)—and the indicated second TCI state/pair of TCI states—as the second applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, the UE could identify, from the first (unified) TCI state activation/deactivation MAC CE as specified herein in the present disclosure, a TCI codepoint comprising multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. In this design example, the TCI codepoint to be identified could correspond to a fixed TCI codepoint in the first MAC CE, e.g., the first or last TCI codepoint in the first MAC CE (or the first or last TCI codepoint among one or more TCI codepoints in the first MAC CE, wherein each of the one or more TCI codepoints could be mapped to/could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, or the only TCI codepoint in the first MAC CE that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, or the lowest/highest TCI codepoint (the index of the TCI codepoint could be the lowest/highest) among all the TCI codepoints in the first MAC CE each comprising multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, or the only TCI codepoint in the first MAC CE that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. Optionally, the UE could be indicated/provided/configured by the network, e.g., via higher layer RRC signaling/parameter and/or MAC CE command and/or dynamic DCI based L1 signaling. (index of) the TCI codepoint to be identified among one or more TCI codepoints from/in the first MAC CE; for this case, the one or more TCI codepoints could correspond to all the TCI codepoints from/in the first MAC CE, or the one or more TCI codepoints could correspond to those from/in the first MAC CE each comprising multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. For this design example, after the TCI state(s) mapped to the identified TCI codepoint has become applicable—e.g., after a time duration or beam application time (BAT) upon receiving the TCI state(s) activation/deactivation/indication MAC CE(s)/DCI(s) for the first time, the UE could use/apply the first TCI state/pair of TCI states of the identified TCI codepoint from/in the first MAC CE as specified herein in the present disclosure—as the first applicable TCI state(s)—and the second TCI state/pair of TCI states of the identified TCI codepoint from/in the first MAC CE as specified herein in the present disclosure—as the second applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, the UE could be indicated, for the first time, e.g., via the TCI field(s) in the first TCI state(s) indication DCI as specified herein in the present disclosure, a TCI codepoint comprising one or more TCI states/pairs of TCI states, wherein the indicated TCI codepoint (and therefore, the corresponding one or more TCI states/pairs of TCI states) could be (selected/determined) from/in the first unified TCI state(s) activation/deactivation MAC CE as specified herein in the present disclosure.
   For example, before the TCI state(s) activated/provided/indicated in/by the first TCI state(s) activation/deactivation MAC CE becomes applicable/active—e.g., before a time duration or beam application time (BAT) upon receiving the first TCI state(s) activation/deactivation MAC CE for the first time, or before the indicated TCI state(s) becomes applicable—e.g., before a time duration or beam application time (BAT) upon receiving the first TCI state(s) indication DCI for the first time, the UE could use/apply one or more starting TCI states/pairs of TCI states for at least UE-dedicated reception on PDSCH/PDCCH or dynamic-grant/configured-grant based PUSCH or all of dedicated PUCCH resources.
   For another example, after the TCI state(s) activated/provided/indicated in/by the first TCI state(s) activation/deactivation MAC CE has become applicable/active—e.g., after a time duration or beam application time (BAT) upon receiving the first TCI state(s) activation/deactivation MAC CE for the first time, and/or before the indicated TCI state(s) becomes applicable—e.g., before a time duration or beam application time (BAT) upon receiving the first TCI state(s) indication DCI for the first time, the UE could follow one or more of the design examples specified herein in the present disclosure to determine/use/apply the first applicable TCI state(s) and/or the second applicable TCI state(s) for at least UE-dedicated reception on PDSCH/PDCCH or dynamic-grant/configured-grant based PUSCH or all of dedicated PUCCH resources.
   Yet for another example, after the indicated TCI state(s) has become applicable—e.g., after a time duration or beam application time (BAT) upon receiving the first TCI state(s) indication DCI for the first time (or, after the TCI state(s) activated/provided/indicated in/by the first TCI state(s) activation/deactivation MAC CE has become applicable/active—e.g., after a time duration or beam application time (BAT) upon receiving the first TCI state(s) activation/deactivation MAC CE for the first time), the UE could follow one or more of the design examples specified herein in the present disclosure to determine/use/apply the first applicable TCI state(s) and/or the second applicable TCI state(s) for at least UE-dedicated reception on PDSCH/PDCCH or dynamic-grant/configured-grant based PUSCH or all of dedicated PUCCH resources. This design example could be for when the number of TCI state(s)/pair(s) of TCI states indicated by the first TCI state(s) indication DCI is one.
   Yet for another example, after the indicated TCI state(s) has become applicable—e.g., after a time duration or beam application time (BAT) upon receiving the first TCI state(s) indication DCI for the first time (or, after the TCI state(s) activated/provided/indicated in/by the first TCI state(s) activation/deactivation MAC CE has become applicable/active—e.g., after a time duration or beam application time (BAT) upon receiving the first TCI state(s) activation/deactivation MAC CE for the first time), the UE could follow one or more of the design examples specified herein in the present disclosure to determine/use/apply the first applicable TCI state(s) and/or the second applicable TCI state(s) for at least UE-dedicated reception on PDSCH/PDCCH or dynamic-grant/configured-grant based PUSCH or all of dedicated PUCCH resources. This design example could be for when the number of TCI state(s)/pair(s) of TCI states indicated by the first TCI state(s) indication DCI is greater than one (e.g., 2).

For the described/specified design examples herein the present disclosure, and for a (multi-DCI based) multi-TRP system as specified herein in the present disclosure, wherein a UE could be indicated/provided/configured by the network (e.g., the network 130), e.g., in PDCCH-Config, two values (i.e., 0 and 1) of CORESET pool index (denoted by CORESETPoolIndex) with each CORESET configured with a value of CORESETPoolIndex:
The first MAC CE or the first (unified) TCI state(s) activation/deactivation MAC CE as specified herein in the present disclosure could be associated to/with or could be specific to a value of coresetPoolIndex (i.e., either 0 or 1)—assuming that the UE is provided in PDCCH-Config, two values of coresetpoolIndex (i.e., 0 and 1) in the corresponding/respective CORESET(s). For instance, a value/field of coresetPoolIndex (e.g., 0 or 1), when configured, could be provided/indicated in the first MAC CE or the first (unified) TCI state(s) activation/deactivation MAC CE as specified herein in the present disclosure.
The first beam indication DCI or the first TCI state(s) indication DCI as specified herein in the present disclosure could be associated to/with or could be specific to a value of coresetPoolIndex (i.e., either 0 or 1)—assuming that the UE is provided in PDCCH-Config, two values of coresetpoolIndex (i.e., 0 and 1) in the corresponding/respective CORESET(s). For instance, when/if the first beam indication DCI/the first TCI state(s) indication DCI as specified herein in the present disclosure is received in CORESET(s) configured/associated with a value of coresetPoolIndex (i.e., either 0 or 1), the first beam indication DCI/the first TCI state(s) indication DCI could be associated to/with or could be specific to the same value of coresetPoolIndex.
The initial TCI state/pair of TCI states, the first TCI state/pair of TCI states, e.g., among one or more TCI states/pairs of TCI states mapped to a TCI codepoint or an identified TCI codepoint according to those specified herein in the present disclosure, the second TCI state/pair of TCI states, e.g., among one or more TCI states/pairs of TCI states mapped to a TCI codepoint or an identified TCI codepoint according to those specified herein in the present disclosure, the first applicable TCI state(s) according to those specified herein in the present disclosure, and/or the second applicable TCI state(s) according to those specified herein in the present disclosure, could be associated with/to or specific to a value of coresetPoolIndex (i.e., either 0) or 1), when/if, e.g., the first MAC CE or the first (unified) TCI state(s) activation/deactivation MAC CE that activates/provides/indicates the above TCI state(s) is associated to/with or specific to the value of coresetPoolIndex according to those specified herein in the present disclosure, and/or the first beam indication DCI or the first TCI state(s) indication DCI that indicates/provides the above TCI state(s) is associated to/with or specific to the value of coresetPoolIndex according to those specified herein in the present disclosure.
The applicable channels/signals as specified herein in the present disclosure-including, e.g., at least the UE-dedicated reception on PDSCH/PDCCH or dynamic-grant/configured-grant based PUSCH or all of dedicated PUCCH resources-could be associated with/to or specific to a value of coresetPoolIndex (e.g., 0 or 1). For instance, a PDCCH is associated to/with or specific to a value of coresetPoolIndex (e.g., 0 or 1) if the PDCCH is received in CORESET(s) associated to/with or specific to the (same) value of coresetPoolIndex. A PDSCH is associated to/with or specific to a value of coresetPoolIndex (e.g., 0 or 1) if the PDSCH is activated/scheduled by PDCCH(s) received in CORESET(s) associated to/with or specific to the (same) value of coresetPoolIndex. A PUCCH or a PUSCH (e.g., CG Type-1 PUSCH) is associated to/with or specific to a value of coresetPoolIndex (e.g., 0 or 1) if an indicator (e.g., with value 0 or 1) provided/indicated/configured in the higher layer parameter(s) that provides/configures the PUCCH or the PUSCH (e.g., CG Type-1 PUSCH) is associated with/to or specific to the (same) value of coresetPoolIndex—e.g., the indicator could indicate/provide the same value (i.e., 0 or 1) as that of the coresetpoolIndex. A PUSCH (e.g., CG Type-2 PUSCH or dynamic grant (DG) PUSCH) is associated to/with or specific to a value of coresetPoolIndex (e.g., 0 or 1) if the PUSCH (e.g., CG Type-2 PUSCH or dynamic grant (DG) PUSCH) is activated/scheduled by PDCCH(s) received in CORESET(s) associated to/with or specific to the (same) value of coresetPoolIndex.

According to those specified herein in the present disclosure, the value(s) of coresetPoolIndex (i.e., 0 and/or 1) associated/specific to the first MAC control element (CE) (or the first (unified) TCI state(s) activation/deactivation MAC CE) or the first beam indication DCI (or the first TCI state(s) indication DCI) or the first/second (applicable) TCI state(s) or the initial TCI state(s) as specified herein in the present disclosure could be the same as or different from the value(s) of coresetPoolIndex (i.e., 0 and/or 1) associated/specific to the applicable channels/signals as specified herein in the present disclosure. For instance, the first MAC CE (or the first (unified) TCI state(s) activation/deactivation MAC CE) could be associated with/to or specific to value 0 of coresetPoolIndex (e.g., by providing/indicating value 0 of coresetPoolIndex—e.g., as a field—in the first MAC CE or the first (unified) TCI state(s) activation/deactivation MAC CE as specified herein in the present disclosure), while the applicable channels/signals could be associated with/to or specific to value 1 of coresetPoolIndex according to those specified herein in the present disclosure.

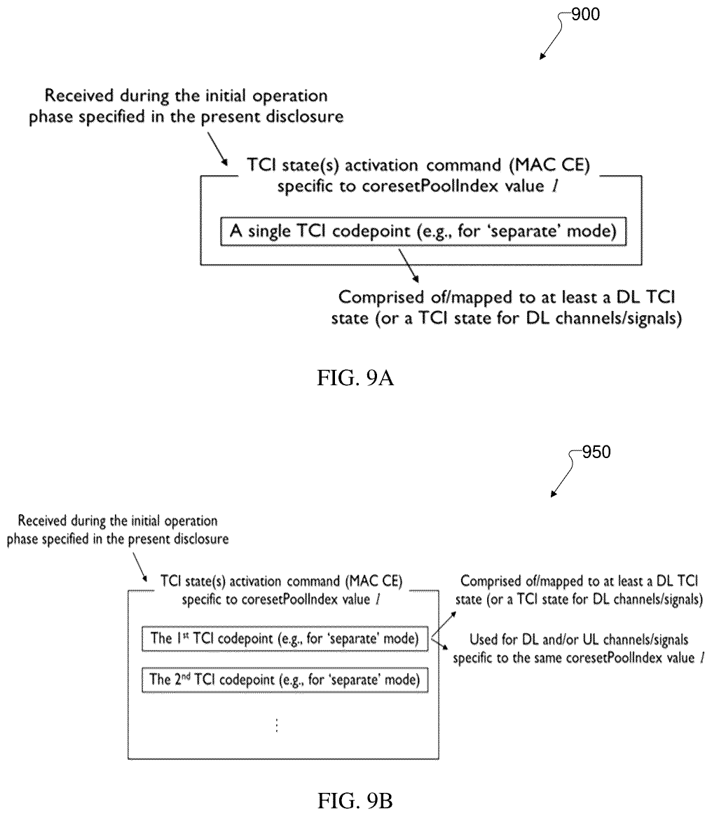

FIG. 9A illustrate a diagram of an example TCI state(s) activation MAC CE command comprising a single TCI codepoint 900, and a diagram of an example TCI state(s) activation MAC CE command comprising more than one TCI codepoints 950, respectively, according to embodiments of the present disclosure. For example, single TCI codepoint 900 may be described as being received by the UE 111 of FIG. 1, while first and second TCI codepoints 950 may be described as being received by the UE 116 of FIG. 3. This example is for illustration only and other embodiments can be used without departing from the scope of the present disclosure.

According to those specified herein in the present disclosure, in a multi-DCI based multi-TRP system, wherein a UE could be provided in PDCCH-Config two values of CORESET pool index (i.e., 0 and 1) and/or configured by the higher layer parameter PDCCH-Config that contains two different values of coresetPoolIndex (e.g., 0 and 1) in ControlResourceSet, for a coresetPoolIndex value (e.g., 1), during an initial operation phase—e.g., after the UE has received from the network a (unified) TCI state(s) activation/deactivation MAC CE—e.g., the first MAC CE or the first (unified) TCI state(s) activation/deactivation MAC CE as specified herein in the present disclosure-associated/specific to the coresetPoolIndex value (e.g., 1) and/or after the TCI state(s)/TCI codepoint(s) activated/provided/indicated in/by the (unified) TCI state(s) activation/deactivation MAC CE has become applicable, e.g., after a time duration or beam application time (BAT) upon receiving the (unified) TCI state(s) activation/deactivation MAC CE, but before the UE receives from the network a TCI state(s) indication DCI(s) and/or before the UE could apply/use any of the TCI state(s) indicated/provided in the TCI state(s) indication DCI(s), e.g., before a time duration or beam application time (BAT) upon receiving the TCI state(s) indication DCI(s) for the first time, wherein, e.g., the TCI state(s) indication DCI(s) or the beam indication DCI(s) could be specific to the coresetPoolIndex value (e.g., 1) such that the TCI state(s)/beam indication DCI(s) could be received in CORESET(s) associated/configured with the coresetPoolIndex value (e.g., 1 in this case), and/or when one or more of the following conditions are held/satisfied/achieved:
After a UE receives an initial higher layer configuration of one or more or more than one TCI state(s) for DL channel(s)/signal(s), and before application of an indicated TCI state specific to a value of coresetPoolIndex (e.g., 1 in this case) from the configured TCI states to DL channel(s)/signal(s) specific to the same value of coresetPoolIndex (e.g., 1 in this case);
After a UE receives an initial higher layer configuration of one or more or more than one TCI state(s) for DL channels/signals and/or UL channels/signals, and before application of an indicated TCI state specific to a value of coresetPoolIndex (e.g., 1 in this case) from the configured TCI states to DL and/or UL channel(s)/signal(s) specific to the same value of coresetPoolIndex (e.g., 1 in this case);
After a UE receives a higher layer configuration of one or more or more than one TCI state(s) for DL channel(s)/signal(s) as part of a Reconfiguration with sync procedure, and before application of an indicated TCI state specific to a value of coresetPoolIndex (e.g., 1 in this case) from the configured TCI states to DL channel(s)/signal(s) specific to the same value of coresetPoolIndex (e.g., 1 in this case);
After a UE receives a higher layer configuration of one or more or more than one TCI state(s) for DL channels/signals and/or UL channels/signals as part of Reconfiguration with sync procedure, and before application of an indicated TCI state specific to a value of coresetPoolIndex (e.g., 1 in this case) from the configured TCI states to DL and/or UL channel(s)/signal(s) specific to the same value of coresetPoolIndex (e.g., 1 in this case);
After a UE receives an initial higher layer configuration (e.g., in PDCCH-Config) of two values of coresetPoolIndex (i.e., 0 and 1) in ControlResourceSet, or a single value of coresetPoolIndex (e.g., 1) in ControlResourceSet;
After a UE receives a higher layer configuration (e.g., in PDCCH-Config) of two values of coresetPoolIndex (i.e., 0 and 1) in ControlResourceSet, or a single value of coresetPoolIndex (e.g., 1) in ControlResourceSet, as part of a Reconfiguration with sync precoder:
   and/or when the UE is provided/configured with dl-OrJointTCI-StateList and/or ul-TCI-StateList:
The UE could expect or assume that the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could comprise/indicate/activate/provide/include/contain a single TCI codepoint comprising at least one joint/DL/UL TCI state (or at least one joint/DL/UL TCI state mapped to a single TCI codepoint). Or equivalently, the UE may not expect or assume that the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could comprise/indicate/activate/provide/include/contain more than one TCI codepoints. Furthermore, when/if the UE is provided/configured with dl-OrJointTCI-State List and/or ul-TCI-StateList, and/or when/if the UE is configured/provided that the TCI codepoint(s) activated by/in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could be comprised of/mapped to only DL TCI state(s) and/or UL TCI state(s)—i.e., TCI state(s) for DL channels/signals and/or TCI state(s) for UL channels/signals (i.e., the ‘separate’ mode for TCI state(s) configuration, activation and/or indication), the UE could expect or assume that the single TCI codepoint is comprised of/mapped to at least a DL TCI state or a TCI state for DL channels/signals (or at least a DL TCI state or a TCI state for DL channels/signals is mapped to the single TCI codepoint); i.e., the UE may not expect or assume that the single TCI codepoint would be comprised of/mapped to only UL TCI state(s) or TCI state(s) for UL channels/signals. When/if the UE is provided/configured with only ul-TCI-StateList, the UE could expect or assume that the single TCI codepoint is comprised of/mapped to a UL TCI state or a TCI state for UL channels/signals (or a UL TCI state or a TCI state for UL channels/signals is mapped to the single TCI codepoint). In addition, when/if the UE is provided/configured with dl-OrJointTCI-StateList, and/or when/if the UE is configured/provided that the TCI codepoint(s) activated by/in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could be comprised of/mapped to only joint TCI state(s)—i.e., TCI state(s) for both DL and UL channels/signals (i.e., the joint mode for TCI state(s) configuration, activation and/or indication), the UE could expect or assume that the single TCI codepoint is comprised of/mapped to a joint TCI state or a TCI state for both DL and UL channels/signals (or a joint TCI state or a TCI state for both DL and UL channels/signals is mapped to the single TCI codepoint). For this case, the UE could use/apply the at least one joint/DL/UL TCI state (or the corresponding single TCI codepoint) for or to transmit/receive channels/signals, including, e.g., at least the UE-dedicated reception on PDSCH/PDCCH or dynamic-grant/configured-grant based PUSCH or all of dedicated PUCCH resources associated/specific to the same value of coresetPoolIndex (e.g., 1 in this case).
The (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex (e.g., value 1 in this case) could comprise/indicate/activate/provide/include/contain one or more TCI codepoints each comprising at least one joint/DL/UL TCI state (or one or more sets of joint/DL/UL TCI state(s) each comprising at least one joint/DL/UL TCI state and mapped to a TCI codepoint of a TCI field in a beam indication DCI). For this case, the UE could determine/identify which of the activated/indicated/provided TCI state(s) to use/apply for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case), according to/based on the number of TCI codepoints/TCI states/sets of TCI states activated/indicated/provided in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case),
   When/if the number of TCI codepoints/TCI states/sets of TCI states as specified herein in the present disclosure activated/indicated/provided in the (unified) TCI state(s) activation/deactivation MAC CE is one, the UE could use/apply the one TCI codepoint/TCI state/set of TCI state(s) activated/indicated/provided in the (unified) TCI state(s) activation/deactivation MAC CE for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case). As discussed/specified herein in the present disclosure, when/if the UE is provided/configured with dl-OrJointTCI-StateList and/or ul-TCI-StateList, and/or when/if the UE is configured/provided that the TCI codepoint(s) activated by/in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could be comprised of/mapped to only DL TCI state(s) and/or UL TCI state(s)—i.e., TCI state(s) for DL channels/signals and/or TCI state(s) for UL channels/signals (i.e., the ‘separate’ mode for TCI state(s) configuration, activation and/or indication), the UE could expect or assume that the one TCI codepoint/TCI state/set of TCI state(s) activated/indicated/provided in the (unified) TCI state(s) activation/deactivation MAC CE is comprised of/mapped to at least a DL TCI state or a TCI state for DL channels/signals (or at least a DL TCI state or a TCI state for DL channels/signals is mapped to/comprised in the one TCI codepoint/TCI state/set of TCI state(s)); i.e., the UE may not expect or assume that the one TCI codepoint/TCI state/set of TCI state(s) activated/indicated/provided in the (unified) TCI state(s) activation/deactivation MAC CE would be comprised of/mapped to only UL TCI state(s) or TCI state(s) for UL channels/signals. When/if the UE is provided/configured with only ul-TCI-StateList, the UE could expect or assume that the one TCI codepoint/TCI state/set of TCI state(s) activated/indicated/provided in the (unified) TCI state(s) activation/deactivation MAC CE is comprised of/mapped to a UL TCI state or a TCI state for UL channels/signals (or a UL TCI state or a TCI state for UL channels/signals is mapped to/comprised in the one TCI codepoint/TCI state/set of TCI state(s)). In addition, when/if the UE is provided/configured with dl-OrJointTCI-StateList, and/or when/if the UE is configured/provided that the TCI codepoint(s) activated by/in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could be comprised of/mapped to only joint TCI state(s)—i.e., TCI state(s) for both DL and UL channels/signals (i.e., the ‘joint’ mode for TCI state(s) configuration, activation and/or indication), the UE could expect or assume that the one TCI codepoint/TCI state/set of TCI state(s) is comprised of/mapped to a joint TCI state or a TCI state for both DL and UL channels/signals (or a joint TCI state or a TCI state for both DL and UL channels/signals is mapped to/comprised in the one TCI codepoint/TCI state/set of TCI state(s)).
   When/if the number of TCI codepoints/TCI states/sets of TCI states as specified herein in the present disclosure activated/indicated/provided in the (unified) TCI state(s) activation/deactivation MAC CE is greater than one, the UE could use/apply one or more of:
      The first (or second/last) TCI state or the TCI state with the lowest (or second lowest/highest) TCI state ID among the TCI states activated/indicated/provided in the (unified) TCI state(s) activation/deactivation MAC CE;
      The first (or second/last) set of TCI states (and therefore, the (e.g., first/second/last) TCI state(s) (e.g., with the lowest/second lowest/highest) TCI state ID(s)) provided/indicated/activated therein) or the set of TCI states with the lowest (or second lowest/highest) TCI state (set) ID (and therefore, the (e.g., first/second/last) TCI state(s) (e.g., with the lowest/second lowest/highest TCI state ID(s)) provided/indicated/activated therein) among the sets of TCI states activated/indicated/provided in the (unified) TCI state(s) activation/deactivation MAC CE;
      The first (or second/last) TCI state or the TCI state with the lowest (or second lowest/highest) TCI state ID among the TCI state(s) in the first (or second/last) set of TCI state(s) or in the set of TCI state(s) with the lowest (or second lowest/highest) TCI state (set) ID among the sets of TCI states activated/indicated/provided in the (unified) TCI state(s) activation/deactivation MAC CE;
      The TCI state that is indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The TCI state—among the TCI states activated/indicated/provided in the (unified) TCI state(s) activation/deactivation MAC CE and/or among the TCI state(s) in the first (or second/last) set of TCI state(s) or in the set of TCI state(s) with the lowest (or second lowest/highest) TCI state (set) ID among the sets of TCI states activated/indicated/provided in the (unified) TCI state(s) activation/deactivation MAC CE—that has the same TCI state ID/index as that for the TCI state indicated by/in another unified TCI state(s) activation/deactivation MAC CE command and/or another beam indication DCI specific to another (or a different) value of coresetPoolIndex (i.e., 0) in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The set of TCI state(s) (and therefore, the (e.g., first/second/last) TCI state(s) (e.g., with the lowest/second lowest/highest) TCI state ID(s)) provided/indicated/activated therein) that is indicated by/in another unified TCI state(s) activation/deactivation MAC CE command and/or another beam indication DCI specific to another (or a different) value of coresetPoolIndex (i.e., 0) in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The set of TCI state(s) (and therefore, the (e.g., first/second/last) TCI state(s) (e.g., with the lowest/second lowest/highest) TCI state ID(s)) provided/indicated/activated therein)—among the sets of TCI states activated/indicated/provided in the (unified) TCI state(s) activation/deactivation MAC CE—that has the same TCI state (set) ID/index as that for the set of TCI state(s) indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The TCI state—among the TCI states activated/indicated/provided in the set of TCI state(s) among the sets of TCI states activated/indicated/provided in the (unified) TCI state(s) activation/deactivation MAC CE that has the same TCI state (set) ID/index as that for the set of TCI state(s) indicated by/in another unified TCI state(s) activation/deactivation MAC CE command and/or another beam indication DCI specific to another (or a different) value of coresetPoolIndex (i.e., 0 in this case)—that has the same TCI state ID/index as that for the TCI state indicated by/in the another unified TCI state(s) activation/deactivation MAC CE command and/or the another beam indication DCI specific to the another (or the different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The first (or second/last) TCI codepoint (and therefore, the (e.g., first/second last) TCI state(s) (e.g., with the lowest/second lowest/highest TCI state ID(s)) mapped to the TCI codepoint) or the lowest (or second lowest/highest) TCI codepoint (and therefore, the (e.g., first/second/last) TCI state(s) (e.g., with the lowest/second lowest/highest TCI state ID(s)) mapped to the TCI codepoint) or the TCI codepoint with the lowest (or second lowest/highest) TCI codepoint ID/index (and therefore, the (e.g., first/second/last) TCI state(s) (e.g., with the lowest/second lowest/highest TCI state ID(s)) mapped to the TCI codepoint) among the TCI codepoints activated/indicated/provided in the (unified) TCI state(s) activation/deactivation MAC CE;
      The TCI codepoint (and therefore, the (e.g., first/second/last) TCI state(s) (e.g., with the lowest/second lowest/highest) TCI state ID(s)) mapped to the TCI codepoint) that is indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The TCI codepoint (and therefore, the (e.g., first/second/last) TCI state(s) (e.g., with the lowest/second lowest/highest) TCI state ID(s)) mapped to the TCI codepoint)—among the TCI codepoints activated/indicated/provided in the (unified) TCI state(s) activation/deactivation MAC CE—that has the same TCI codepoint ID/index as that for the TCI codepoint indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The TCI state(s)—mapped to the TCI codepoint among the TCI codepoints activated/indicated/provided in the (unified) TCI state(s) activation/deactivation MAC CE that has the same TCI codepoint ID/index as that for the TCI codepoint indicated by/in another unified TCI state(s) activation/deactivation MAC CE command and/or another beam indication DCI specific to another (or a different) value of coresetPoolIndex (i.e., 0 in this case)—that has the same TCI state ID/index as that for the TCI state indicated by/in the another unified TCI state(s) activation/deactivation MAC CE command and/or the another beam indication DCI specific to the another (or the different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The set of TCI state(s) (and therefore, the (e.g., first/second/last) TCI state(s) (e.g., with the lowest/second lowest/highest TCI state ID(s)) provided/indicated/activated therein)—mapped to the TCI codepoint among the TCI codepoints activated/indicated/provided in the (unified) TCI state(s) activation/deactivation MAC CE that has the same TCI codepoint ID/index as that for the TCI codepoint indicated by/in another unified TCI state(s) activation/deactivation MAC CE command and/or another beam indication DCI specific to another (or a different) value of coresetPoolIndex (i.e., 0 in this case)—that has the same TCI state (set) ID/index as that for the set of TCI state(s) indicated by/in the another unified TCI state(s) activation/deactivation MAC CE command and/or the another beam indication DCI specific to the another (or the different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The first (or second/last) TCI state or the TCI state with the lowest (or second lowest/highest) TCI state ID among the TCI state(s) mapped to the first (or second/last) TCI codepoint or mapped to the lowest (or second lowest/highest) TCI codepoint or mapped to the TCI codepoint with the lowest (or second lowest/highest) TCI codepoint ID/index among the TCI codepoints activated/indicated/provided in the (unified) TCI state(s) activation/deactivation MAC CE;
      The TCI state(s)—mapped to the first (or second/last) TCI codepoint or mapped to the lowest (or second lowest/highest) TCI codepoint or mapped to the TCI codepoint with the lowest (or second lowest/highest) TCI codepoint ID/index among the TCI codepoints activated/indicated/provided in the (unified) TCI state(s) activation/deactivation MAC CE—that has the same TCI state ID/index as that for the TCI state indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0) of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The set of TCI state(s) (and therefore, the (e.g., first/second/last) TCI state(s) (e.g., with the lowest/second lowest/highest TCI state ID(s)) provided/indicated/activated therein) mapped to the first (or second/last) TCI codepoint or mapped to the lowest (or second lowest/highest) TCI codepoint or mapped to the TCI codepoint with the lowest (or second lowest/highest) TCI codepoint ID/index among the TCI codepoints activated/indicated/provided in the (unified) TCI state(s) activation/deactivation MAC CE;
      The set of TCI state(s) (and therefore, the (e.g., first/second/last) TCI state(s) (e.g., with the lowest/second lowest/highest TCI state ID(s)) provided/indicated/activated therein)—mapped to the first (or second/last) TCI codepoint or mapped to the lowest (or second lowest/highest) TCI codepoint or mapped to the TCI codepoint with the lowest (or second lowest/highest) TCI codepoint ID/index among the TCI codepoints activated/indicated/provided in the (unified) TCI state(s) activation/deactivation MAC CE—that has the same TCI state (set) ID/index as that for the set of TCI state(s) indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The first (or second/last) TCI state or the TCI state with the lowest (or second lowest/highest) TCI state ID among the TCI state(s) in the set of TCI state(s) mapped to the first (or second/last) TCI codepoint or mapped to the lowest (or second lowest/highest) TCI codepoint or mapped to the TCI codepoint with the lowest (or second lowest/highest) TCI codepoint ID/index among the TCI codepoints activated/indicated/provided in the (unified) TCI state(s) activation/deactivation MAC CE:
      The TCI state—among the TCI state(s) in the set of TCI state(s)—determined according to those specified herein in the present disclosure—mapped to the first (or second/last) TCI codepoint or mapped to the lowest (or second lowest/highest) TCI codepoint or mapped to the TCI codepoint with the lowest (or second lowest/highest) TCI codepoint ID/index among the TCI codepoints activated/indicated/provided in the (unified) TCI state(s) activation/deactivation MAC CE—that has the same TCI state ID/index as that for the TCI state indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The TCI state/TCI state ID or index configured/activated/indicated/provided by/in higher layer RRC signaling(s)/parameter(s) and/or MAC CE command(s) and/or dynamic DCI based L1 signaling(s):
      The set of TCI state(s) (and therefore, the (e.g., first/second/last) TCI state(s) (e.g., with the lowest/second lowest/highest TCI state ID(s)) provided/indicated/activated therein) configured/activated/indicated/provided by/in higher layer RRC signaling(s)/parameter(s) and/or MAC CE command(s) and/or dynamic DCI based L1 signaling(s); and/or
      The TCI codepoint (and therefore, the (e.g., first/second/last) TCI state(s) (e.g., with the lowest/second lowest/highest TCI state ID(s) mapped to the TCI codepoint) configured/activated/indicated/provided by/in higher layer RRC signaling(s)/parameter(s) and/or MAC CE command(s) and/or dynamic DCI based L1 signaling(s).
         for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case). For this case, as specified herein in the present disclosure, when/if the UE is provided/configured with dl-OrJointTCI-StateList and/or ul-TCI-StateList, and/or when/if the UE is configured/provided that the TCI codepoint(s) activated by/in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could be comprised of/mapped to only DL TCI state(s) and/or UL TCI state(s)—i.e., TCI state(s) for DL channels/signals and/or TCI state(s) for UL channels/signals (i.e., the ‘separate’ mode for TCI state(s) configuration, activation and/or indication), the UE could expect or assume that the TCI codepoint/TCI state/set of TCI state(s)—determined according to those specified/described herein in the present disclosure—to use/apply for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case) as specified herein in the present disclosure is comprised of/mapped to at least a DL TCI state or a TCI state for DL channels/signals (or at least a DL TCI state or a TCI state for DL channels/signals is mapped to/comprised in the TCI codepoint/TCI state/set of TCI state(s)); i.e., the UE may not expect or assume that the TCI codepoint/TCI state/set of TCI state(s)—determined according to those specified/described herein in the present disclosure—to use/apply for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case) as specified herein in the present disclosure would be comprised of/mapped to only UL TCI state(s) or TCI state(s) for UL channels/signals. When/if the UE is provided/configured with only ul-TCI-StateList, the UE could expect or assume that the TCI codepoint/TCI state/set of TCI state(s)—determined according to those specified/described herein in the present disclosure—to use/apply for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case) as specified herein in the present disclosure is comprised of/mapped to a UL TCI state or a TCI state for UL channels/signals (or a UL TCI state or a TCI state for UL channels/signals is mapped to/comprised in the TCI codepoint/TCI state/set of TCI state(s)). In addition, when/if the UE is provided/configured with dl-OrJointTCI-StateList, and/or when/if the UE is configured/provided that the TCI codepoint(s) activated by/in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could be comprised of/mapped to only joint TCI state(s)—i.e., TCI state(s) for both DL and UL channels/signals (i.e., the ‘joint’ mode for TCI state(s) configuration, activation and/or indication), the UE could expect or assume that the TCI codepoint/TCI state/set of TCI state(s)—determined according to those specified/described herein in the present disclosure—to use/apply for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case) as specified herein in the present disclosure is comprised of/mapped to a joint TCI state or a TCI state for both DL and UL channels/signals (or a joint TCI state or a TCI state for both DL and UL channels/signals is mapped to/comprised in the TCI codepoint/TCI state/set of TCI state(s)).

According to those specified herein in the present disclosure, in a multi-DCI based multi-TRP system wherein a UE could be provided in PDCCH-Config two values of CORESET pool index (i.e., 0 and 1) and/or configured by the higher layer parameter PDCCH-Config that contains two different values of coresetPoolIndex (e.g., 0 and 1) in ControlResourceSet, when/if the DCI field ‘Transmission Configuration Indication’ is present in DCI format 1_2, and/or when/if the number of codepoints S in the DCI field ‘Transmission Configuration Indication’ of the DCI format 1_2 specific to a value of coresetPoolIndex (e.g., 1) is smaller than the number of TCI codepoints that are activated by the (unified) TCI state(s) activation MAC CE command—e.g., the first MAC CE or the first (unified) TCI state(s) activation/deactivation MAC CE command as specified herein in the present disclosure-specific to the same value of coresetPoolIndex (e.g., 1 in this case), only the first S activated TCI codepoints or the first S sets of TCI state(s)—e.g., out of the total TCI codepoints or total sets of TCI states activated by the (unified) TCI state(s) activation MAC CE command as specified herein specific to the same value of coresetPoolIndex (e.g., 1 in this case)—are applied to the DCI field ‘Transmission Configuration Indication’ of/for the DCI format 1_2 specific to the same value of coresetPoolIndex (e.g., 1 in this case), wherein as specified herein in the present disclosure, a set of TCI state(s) could comprise/include/contain one joint/DL/UL TCI state or a pair of DL and UL TCI states mapped to a TCI codepoint in the TCI field of a beam indication DCI, and the DCI format 1_2 is specific to a value of coresetPoolIndex when/if the PDCCH candidate(s) that carries the DCI format 1_2 is received in CORESET(s) associated/configured/specific to/with the same value of coresetPoolIndex. According to those specified herein in the present disclosure, for a coresetPoolIndex value (e.g., 1), during an initial operation phase—e.g., after the UE has received from the network a (unified) TCI state(s) activation/deactivation MAC CE—e.g., the first MAC CE or the first (unified) TCI state(s) activation/deactivation MAC CE as specified herein in the present disclosure—associated/specific to the coresetPoolIndex value (e.g., 1) and/or after the TCI state(s)/TCI codepoint(s) activated/provided/indicated in/by the (unified) TCI state(s) activation/deactivation MAC CE has become applicable, e.g., after a time duration or beam application time (BAT) upon receiving the (unified) TCI state(s) activation/deactivation MAC CE, but before the UE receives from the network a TCI state(s) indication DCI(s) and/or before the UE could apply/use any of the TCI state(s) indicated/provided in the TCI state(s) indication DCI(s), e.g., before a time duration or beam application time (BAT) upon receiving the TCI state(s) indication DCI(s) for the first time, wherein, e.g., the TCI state(s) indication DCI(s) or the beam indication DCI(s) could be specific to the coresetPoolIndex value (e.g., 1) such that the TCI state(s)/beam indication DCI(s) could be received in CORESET(s) associated/configured with the coresetPoolIndex value (e.g., 1 in this case), and/or when one or more of the following conditions are held/satisfied/achieved:
After a UE receives an initial higher layer configuration of one or more or more than one TCI state(s) for DL channel(s)/signal(s), and before application of an indicated TCI state specific to a value of coresetPoolIndex (e.g., 1 in this case) from the configured TCI states to DL channel(s)/signal(s) specific to the same value of coresetPoolIndex (e.g., 1 in this case):
After a UE receives an initial higher layer configuration of one or more or more than one TCI state(s) for DL channels/signals and/or UL channels/signals, and before application of an indicated TCI state specific to a value of coresetPoolIndex (e.g., 1 in this case) from the configured TCI states to DL and/or UL channel(s)/signal(s) specific to the same value of coresetPoolIndex (e.g., 1 in this case);
After a UE receives a higher layer configuration of one or more or more than one TCI state(s) for DL channel(s)/signal(s) as part of a Reconfiguration with sync procedure, and before application of an indicated TCI state specific to a value of coresetPoolIndex (e.g., 1 in this case) from the configured TCI states to DL channel(s)/signal(s) specific to the same value of coresetPoolIndex (e.g., 1 in this case);
After a UE receives a higher layer configuration of one or more or more than one TCI state(s) for DL channels/signals and/or UL channels/signals as part of Reconfiguration with sync procedure, and before application of an indicated TCI state specific to a value of coresetPoolIndex (e.g., 1 in this case) from the configured TCI states to DL and/or UL channel(s)/signal(s) specific to the same value of coresetPoolIndex (e.g., 1 in this case);
After a UE receives an initial higher layer configuration (e.g., in PDCCH-Config) of two values of coresetPoolIndex (i.e., 0 and 1) in ControlResourceSet, or a single value of coresetPoolIndex (e.g., 1) in ControlResourceSet;
After a UE receives a higher layer configuration (e.g., in PDCCH-Config) of two values of coresetPoolIndex (i.e., 0 and 1) in ControlResourceSet, or a single value of coresetPoolIndex (e.g., 1) in ControlResourceSet, as part of a Reconfiguration with sync procedure:
   and/or when the UE is provided/configured with dl-OrJointTCI-StateList and/or ul-TCI-StateList, and/or when/if the DCI field ‘Transmission Configuration Indication’ is present in DCI format 1_2, and/or when/if the number of codepoints S in the DCI field ‘Transmission Configuration Indication’ of the DCI format 1_2 specific to the value of coresetPoolIndex (e.g., 1) is smaller than the number of TCI codepoints that are activated by the (unified) TCI state(s) activation MAC CE command—e.g., the first MAC CE or the first (unified) TCI state(s) activation/deactivation MAC CE command as specified herein in the present disclosure-specific to the same value of coresetPoolIndex (e.g., 1 in this case):
The UE could expect or assume that the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could comprise/indicate/activate/provide/include/contain a single TCI codepoint comprising at least one joint/DL/UL TCI state (or at least one joint/DL/UL TCI state mapped to a single TCI codepoint). Or equivalently, the UE may not expect or assume that the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could comprise/indicate/activate/provide/include/contain than one TCI codepoints. Furthermore, when/if the UE is provided/configured with dl-OrJointTCI-State List and/or ul-TCI-State List, and/or when/if the UE is configured/provided that the TCI codepoint(s) activated by/in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could be comprised of/mapped to only DL TCI state(s) and/or UL TCI state(s)—i.e., TCI state(s) for DL channels/signals and/or TCI state(s) for UL channels/signals (i.e., the ‘separate’ mode for TCI state(s) configuration, activation and/or indication), the UE could expect or assume that the single TCI codepoint is comprised of/mapped to at least a DL TCI state or a TCI state for DL channels/signals (or at least a DL TCI state or a TCI state for DL channels/signals is mapped to the single TCI codepoint); i.e., the UE may not expect or assume that the single TCI codepoint would be comprised of/mapped to only UL TCI state(s) or TCI state(s) for UL channels/signals. When/if the UE is provided/configured with only ul-TCI-StateList, the UE could expect or assume that the single TCI codepoint is comprised of/mapped to a UL TCI state or a TCI state for UL channels/signals (or a UL TCI state or a TCI state for UL channels/signals is mapped to the single TCI codepoint). In addition, when/if the UE is provided/configured with dl-OrJointTCI-StateList, and/or when/if the UE is configured/provided that the TCI codepoint(s) activated by/in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could be comprised of/mapped to only joint TCI state(s)—i.e., TCI state(s) for both DL and UL channels/signals (i.e., the ‘joint’ mode for TCI state(s) configuration, activation and/or indication), the UE could expect or assume that the single TCI codepoint is comprised of/mapped to a joint TCI state or a TCI state for both DL and UL channels/signals (or a joint TCI state or a TCI state for both DL and UL channels/signals is mapped to the single TCI codepoint). For this case, the UE could use/apply the at least one joint/DL/UL TCI state (or the corresponding single TCI codepoint) for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case).
The (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could comprise/indicate/activate/provide/include/contain one or more TCI codepoints each comprising at least one joint/DL/UL TCI state (or one or more sets of joint/DL/UL TCI state(s) each comprising at least one joint/DL/UL TCI state and mapped to a TCI codepoint of a TCI field in a beam indication DCI). For this case, the UE could determine/identify which of the activated/indicated/provided TCI state(s) to use/apply for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case), according to/based on the number of TCI codepoints/TCI states/sets of TCI states activated/indicated/provided in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case).
   When/if the number of TCI codepoints/TCI states/sets of TCI states as specified herein in the present disclosure activated/indicated/provided in the (unified) TCI state(s) activation/deactivation MAC CE is one, the UE could use/apply the one TCI codepoint/TCI state/set of TCI state(s) activated/indicated/provided in the (unified) TCI state(s) activation/deactivation MAC CE for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case). As discussed/specified herein in the present disclosure, when/if the UE is provided/configured with dl-OrJointTCI-StateList and/or ul-TCI-StateList, and/or when/if the UE is configured/provided that the TCI codepoint(s) activated by/in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could be comprised of/mapped to only DL TCI state(s) and/or UL TCI state(s)—i.e., TCI state(s) for DL channels/signals and/or TCI state(s) for UL channels/signals (i.e., the ‘separate’ mode for TCI state(s) configuration, activation and/or indication), the UE could expect or assume that the one TCI codepoint/TCI state/set of TCI state(s) activated/indicated/provided in the (unified) TCI state(s) activation/deactivation MAC CE is comprised of/mapped to at least a DL TCI state or a TCI state for DL channels/signals (or at least a DL TCI state or a TCI state for DL channels/signals is mapped to the single TCI codepoint); i.e., the UE may not expect or assume that the one TCI codepoint/TCI state/set of TCI state(s) activated/indicated/provided in the (unified) TCI state(s) activation/deactivation MAC CE would be comprised of/mapped to only UL TCI state(s) or TCI state(s) for UL channels/signals. When/if the UE is provided/configured with only ul-TCI-StateList, the UE could expect or assume that the one TCI codepoint/TCI state/set of TCI state(s) activated/indicated/provided in the (unified) TCI state(s) activation/deactivation MAC CE is comprised of/mapped to a UL TCI state or a TCI state for UL channels/signals (or a UL TCI state or a TCI state for UL channels/signals is mapped to the one TCI codepoint). In addition, when/if the UE is provided/configured with dl-OrJointTCI-StateList, and/or when/if the UE is configured/provided that the TCI codepoint(s) activated by/in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could be comprised of/mapped to only joint TCI state(s)—i.e., TCI state(s) for both DL and UL channels/signals (i.e., the joint mode for TCI state(s) configuration, activation and/or indication), the UE could expect or assume that the one TCI codepoint/TCI state/set of TCI state(s) is comprised of/mapped to a joint TCI state or a TCI state for both DL and UL channels/signals (or a joint TCI state or a TCI state for both DL and UL channels/signals is mapped to/comprised in the one TCI codepoint/TCI state/set of TCI state(s)).
   When/if the number of TCI codepoints/TCI states/sets of TCI states as specified herein in the present disclosure activated/indicated/provided in the (unified) TCI state(s) activation/deactivation MAC CE is greater than one (e.g., greater than S), the UE could use/apply one or more of:
      The first (or second/last) TCI state or the TCI state with the lowest (or second lowest/highest) TCI state ID among the TCI states mapped to/comprised in the first S activated TCI codepoints/the first S sets of TCI states activated/indicated/provided in the (unified) TCI state(s) activation/deactivation MAC CE applied to/for the DCI field ‘Transmission Configuration Indication’ of/for the DCI format 1_2;
      The first (or second/last) set of TCI states (and therefore, the (e.g., first/second/last) TCI state(s) (e.g., with the lowest/second lowest/highest) TCI state ID(s)) provided/indicated/activated therein) or the set of TCI states with the lowest (or second lowest/highest) TCI state (set) ID (and therefore, the (e.g., first/second/last) TCI state(s) (e.g., with the lowest/second lowest/highest TCI state ID(s)) provided/indicated/activated therein) among the first S of sets TCI states activated/indicated/provided in the (unified) TCI state(s) activation/deactivation MAC CE applied to/for the DCI field ‘Transmission Configuration Indication’ of/for the DCI format 1_2;
      The first (or second/last) TCI state or the TCI state with the lowest (or second lowest/highest) TCI state ID among the TCI state(s) in the first (or second/last) set of TCI state(s) or in the set of TCI state(s) with the lowest (or second lowest/highest) TCI state (set) ID among the first S sets of TCI states activated/indicated/provided in the (unified) TCI state(s) activation/deactivation MAC CE applied to/for the DCI field ‘Transmission Configuration Indication’ of/for the DCI format 1_2;
      The TCI state that is indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The TCI state—among the TCI states mapped to/comprised in the first S activated TCI codepoints/the first S sets of TCI states activated/indicated/provided in the (unified) TCI state(s) activation/deactivation MAC CE applied to/for the DCI field ‘Transmission Configuration Indication’ of/for the DCI format 1_2 and/or among the TCI state(s) in the first (or second/last) set of TCI state(s) or in the set of TCI state(s) with the lowest (or second lowest/highest) TCI state (set) ID among the first S sets of TCI states activated/indicated/provided in the (unified) TCI state(s) activation/deactivation MAC CE applied to/for the DCI field ‘Transmission Configuration Indication’ of/for the DCI format 1_2—that has the same TCI state ID/index as that for the TCI state indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The set of TCI state(s) (and therefore, the (e.g., first/second/last) TCI state(s) (e.g., with the lowest/second lowest/highest) TCI state ID(s)) provided/indicated/activated therein) that is indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The set of TCI state(s) (and therefore, the (e.g., first/second/last) TCI state(s) (e.g., with the lowest/second lowest/highest) TCI state ID(s)) provided/indicated/activated therein)—among the first S sets of TCI states activated/indicated/provided in the (unified) TCI state(s) activation/deactivation MAC CE applied to/for the DCI field ‘Transmission Configuration Indication’ of/for the DCI format 1_2—that has the same TCI state (set) ID/index as that for the set of TCI state(s) indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The TCI state—among the TCI states activated/indicated/provided in the set of TCI state(s) among the first S sets of TCI states activated/indicated/provided in the (unified) TCI state(s) activation/deactivation MAC CE applied to/for the DCI field ‘Transmission Configuration Indication’ of/for the DCI format 1_2 that has the same TCI state (set) ID/index as that for the set of TCI state(s) indicated by/in another unified TCI state(s) activation/deactivation MAC CE command and/or another beam indication DCI specific to another (or a different) value of coresetPoolIndex (i.e., 0 in this case)—that has the same TCI state ID/index as that for the TCI state indicated by/in the another unified TCI state(s) activation/deactivation MAC CE command and/or the another beam indication DCI specific to the another (or the different) value of coresetPoolIndex (i.e., 0 in this case), wherein the another unified TCI state(s) activation/deactivation MAC CE specific to value (of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The first (or second/last) TCI codepoint (and therefore, the (e.g., first/second/last) TCI state(s) (e.g., with the lowest/second lowest/highest TCI state ID(s)) mapped to the TCI codepoint) or the lowest (or second lowest/highest) TCI codepoint (and therefore, the (e.g., first/second/last) TCI state(s) (e.g., with the lowest/second lowest/highest TCI state ID(s)) mapped to the TCI codepoint) or the TCI codepoint with the lowest (or second lowest/highest) TCI codepoint ID/index (and therefore, the (e.g., first/second/last) TCI state(s) (e.g., with the lowest/second lowest/highest TCI state ID(s)) mapped to the TCI codepoint) among the first S activated TCI codepoints activated/indicated/provided in the (unified) TCI state(s) activation/deactivation MAC CE applied to/for the DCI field ‘Transmission Configuration Indication’ of/for the DCI format 1_2;
      The TCI codepoint (and therefore, the (e.g., first/second/last) TCI state(s) (e.g., with the lowest/second lowest/highest) TCI state ID(s)) mapped to the TCI codepoint) that is indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The TCI codepoint (and therefore, the (e.g., first/second/last) TCI state(s) (e.g., with the lowest/second lowest/highest) TCI state ID(s)) mapped to the TCI codepoint)—among the first S activated TCI codepoints activated/indicated/provided in the (unified) TCI state(s) activation/deactivation MAC CE applied to/for the DCI field ‘Transmission Configuration Indication’ of/for the DCI format 1_2—that has the same TCI codepoint ID/index as that for the TCI codepoint indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The TCI state(s)—mapped to the TCI codepoint among the first S activated TCI codepoints activated/indicated/provided in the (unified) TCI state(s) activation/deactivation MAC CE applied to/for the DCI field ‘Transmission Configuration Indication’ of/for the DCI format 1_2 that has the same TCI codepoint ID/index as that for the TCI codepoint indicated by/in another unified TCI state(s) activation/deactivation MAC CE command and/or another beam indication DCI specific to another (or a different) value of coresetPoolIndex (i.e., 0 in this case)—that has the same TCI state ID/index as that for the TCI state indicated by/in the another unified TCI state(s) activation/deactivation MAC CE command and/or the another beam indication DCI specific to the another (or the different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The set of TCI state(s) (and therefore, the (e.g., first/second/last) TCI state(s) (e.g., with the lowest/second lowest/highest TCI state ID(s)) provided/indicated/activated therein)—mapped to the TCI codepoint among the first S activated TCI codepoints activated/indicated/provided in the (unified) TCI state(s) activation/deactivation MAC CE applied to/for the DCI field ‘Transmission Configuration Indication’ of/for the DCI format 1_2 that has the same TCI codepoint ID/index as that for the TCI codepoint indicated by/in another unified TCI state(s) activation/deactivation MAC CE command and/or another beam indication DCI specific to another (or a different) value of coresetPoolIndex (i.e., 0 in this case)—that has the same TCI state (set) ID/index as that for the set of TCI state(s) indicated by/in the another unified TCI state(s) activation/deactivation MAC CE command and/or the another beam indication DCI specific to the another (or the different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The first (or second/last) TCI state or the TCI state with the lowest (or second lowest/highest) TCI state ID among the TCI state(s) mapped to the first (or second/last) TCI codepoint or mapped to the lowest (or second lowest/highest) TCI codepoint or mapped to the TCI codepoint with the lowest (or second lowest/highest) TCI codepoint ID/index among the first S activated TCI codepoints activated/indicated/provided in the (unified) TCI state(s) activation/deactivation MAC CE applied to/for the DCI field ‘Transmission Configuration Indication’ of/for the DCI format 1_2;
      The TCI state(s)—mapped to the first (or second/last) TCI codepoint or mapped to the lowest (or second lowest/highest) TCI codepoint or mapped to the TCI codepoint with the lowest (or second lowest/highest) TCI codepoint ID/index among the first S activated TCI codepoints activated/indicated/provided in the (unified) TCI state(s) activation/deactivation MAC CE applied to/for the DCI field ‘Transmission Configuration Indication’ of/for the DCI format 1_2—that has the same TCI state ID/index as that for the TCI state indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The set of TCI state(s) (and therefore, the (e.g., first/second/last) TCI state(s) (e.g., with the lowest/second lowest/highest TCI state ID(s)) provided/indicated/activated therein) mapped to the first (or second/last) TCI codepoint or mapped to the lowest (or second lowest/highest) TCI codepoint or mapped to the TCI codepoint with the lowest (or second lowest/highest) TCI codepoint ID/index among the first S activated TCI codepoints activated/indicated/provided in the (unified) TCI state(s) activation/deactivation MAC CE applied to/for the DCI field ‘Transmission Configuration Indication’ of/for the DCI format 1_2;
      The set of TCI state(s) (and therefore, the (e.g., first/second/last) TCI state(s) (e.g., with the lowest/second lowest/highest TCI state ID(s)) provided/indicated/activated therein)—mapped to the first (or second/last) TCI codepoint or mapped to the lowest (or second lowest/highest) TCI codepoint or mapped to the TCI codepoint with the lowest (or second lowest/highest) TCI codepoint ID/index among the first S activated TCI codepoints activated/indicated/provided in the (unified) TCI state(s) activation/deactivation MAC CE applied to/for the DCI field ‘Transmission Configuration Indication’ of/for the DCI format 1_2—that has the same TCI state (set) ID/index as that for the set of TCI state(s) indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The first (or second/last) TCI state or the TCI state with the lowest (or second lowest/highest) TCI state ID among the TCI state(s) in the set of TCI state(s) mapped to the first (or second/last) TCI codepoint or mapped to the lowest (or second lowest/highest) TCI codepoint or mapped to the TCI codepoint with the lowest (or second lowest/highest) TCI codepoint ID/index among the first S activated TCI codepoints activated/indicated/provided in the (unified) TCI state(s) activation/deactivation MAC CE applied to/for the DCI field ‘Transmission Configuration Indication’ of/for the DCI format 1_2;
      The TCI state—among the TCI state(s) in the set of TCI state(s)—determined according to those specified herein in the present disclosure-mapped to the first (or second/last) TCI codepoint or mapped to the lowest (or second lowest/highest) TCI codepoint or mapped to the TCI codepoint with the lowest (or second lowest/highest) TCI codepoint ID/index among the first S activated TCI codepoints activated/indicated/provided in the (unified) TCI state(s) activation/deactivation MAC CE applied to/for the DCI field ‘Transmission Configuration Indication’ of/for the DCI format 1_2—that has the same TCI state ID/index as that for the TCI state indicated by/in another unified TCI state(s) activation/deactivation MAC CE command and/or another beam indication DCI specific to another (or a different) value of coresetPoolIndex (i.e., 0 in this case), wherein the another unified TCI state(s) activation/deactivation MAC CE specific to value 0 of coresetPoolIndex could indicate/provide/contain/include value 0 of coresetPoolIndex, and the another beam indication DCI specific to value 0 of coresetPoolIndex could be received in CORESET(s) associated/configured with value 0 of coresetPoolIndex;
      The TCI state/TCI state ID or index configured/activated/indicated/provided by/in higher layer RRC signaling(s)/parameter(s) and/or MAC CE command(s) and/or dynamic DCI based L1 signaling(s):
      The set of TCI state(s) (and therefore, the (e.g., first/second/last) TCI state(s) (e.g., with the lowest/second lowest/highest TCI state ID(s)) provided/indicated/activated therein) configured/activated/indicated/provided by/in higher layer RRC signaling(s)/parameter(s) and/or MAC CE command(s) and/or dynamic DCI based L1 signaling(s); and/or
      The TCI codepoint (and therefore, the (e.g., first/second/last) TCI state(s) (e.g., with the lowest/second lowest/highest TCI state ID(s) mapped to the TCI codepoint) configured/activated/indicated/provided by/in higher layer RRC signaling(s)/parameter(s) and/or MAC CE command(s) and/or dynamic DCI based L1 signaling(s).
         for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case)—e.g., scheduled/activated by the DCI format 1_2 received in CORESET(s) associated/configured with the same value of coresetPoolIndex (e.g., 1 in this case). For this case, as specified herein in the present disclosure, when/if the UE is provided/configured with dl-OrJointTCI-StateList and/or ul-TCI-StateList, and/or when/if the UE is configured/provided that the TCI codepoint(s) activated by/in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could be comprised of/mapped to only DL TCI state(s) and/or UL TCI state(s)—i.e., TCI state(s) for DL channels/signals and/or TCI state(s) for UL channels/signals (i.e., the ‘separate’ mode for TCI state(s) configuration, activation and/or indication), the UE could expect or assume that the TCI codepoint/TCI state/set of TCI state(s)—determined according to those specified/described herein in the present disclosure—to use/apply for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case) as specified herein in the present disclosure is comprised of/mapped to at least a DL TCI state or a TCI state for DL channels/signals (or at least a DL TCI state or a TCI state for DL channels/signals is mapped to/comprised in the TCI codepoint/TCI state/set of TCI state(s)); i.e., the UE may not expect or assume that the TCI codepoint/TCI state/set of TCI state(s)—determined according to those specified/described herein in the present disclosure—to use/apply for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case) as specified herein in the present disclosure would be comprised of/mapped to only UL TCI state(s) or TCI state(s) for UL channels/signals. When/if the UE is provided/configured with only ul-TCI-StateList, the UE could expect or assume that the TCI codepoint/TCI state/set of TCI state(s)—determined according to those specified/described herein in the present disclosure—to use/apply for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case) as specified herein in the present disclosure is comprised of/mapped to a UL TCI state or a TCI state for UL channels/signals (or a UL TCI state or a TCI state for UL channels/signals is mapped to the TCI codepoint/TCI state/set of TCI state(s)). In addition, when/if the UE is provided/configured with dl-OrJointTCI-StateList, and/or when/if the UE is configured/provided that the TCI codepoint(s) activated by/in the (unified) TCI state(s) activation/deactivation MAC CE—e.g., the first MAC CE or the first (unified) TCI state(s) activation/deactivation MAC CE as specified herein in the present disclosure—that is associated/specific to the coresetPoolIndex value (e.g., 1 in this case) could be comprised of/mapped to only joint TCI state(s)—i.e., TCI state(s) for both DL and UL channels/signals (i.e., the joint mode for TCI state(s) configuration, activation and/or indication), the UE could expect or assume that the TCI codepoint/TCI state/set of TCI state(s)—determined according to those specified/described herein in the present disclosure—to use/apply for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case) as specified herein in the present disclosure is comprised of/mapped to a joint TCI state or a TCI state for both DL and UL channels/signals (or a joint TCI state or a TCI state for both DL and UL channels/signals is mapped to/comprised in the TCI codepoint/TCI state/set of TCI state(s)).

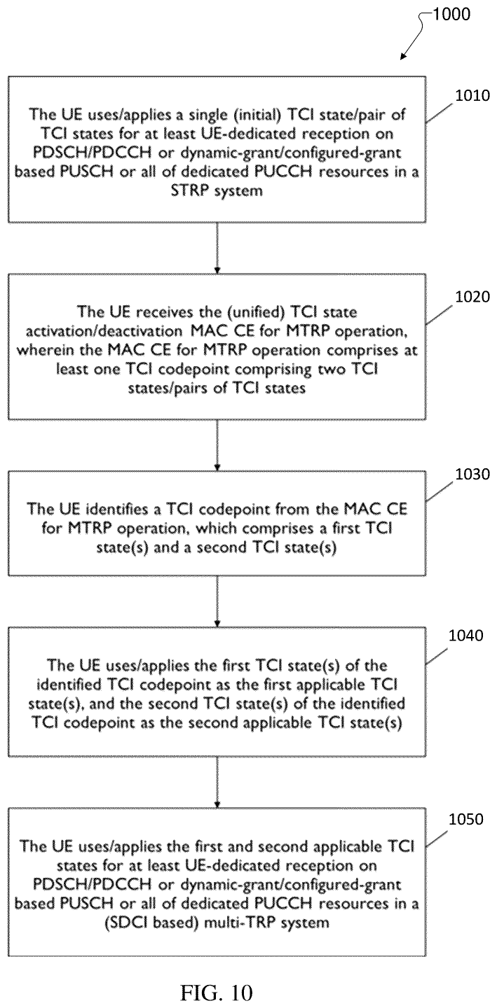

FIG. 10 illustrates a flowchart of an example UE procedure 1000 for identifying/using first and second applicable TCI states according to embodiments of the present disclosure. For example, procedure 1000 for identifying/using first and second applicable TCI states may be performed by the UE 112 of FIG. 1. This example is for illustration only and other embodiments can be used without departing from the scope of the present disclosure.

The procedure begins in 1010, the UE uses/applies a single (initial) TCI state/pair of TCI states for at least UE-dedicated reception on PDSCH/PDCCH or dynamic-grant/configured-grant based PUSCH or all of dedicated PUCCH resources in a STRP system. In 1020, the UE receives the (unified) TCI state activation/deactivation MAC CE for MTRP operation, wherein the MAC CE for MTRP operation comprises at least one TCI codepoint comprising two TCI states/pairs of TCI states. In 1030, the UE identifies a TCI codepoint from the MAC CE for MTRP operation, which comprises a first TCI state(s) and a second TCI state(s). In 1040, the UE uses/applies the first TCI state(s) of the identified TCI codepoints as the first applicable TCI state(s), and the second TCI state(s) of the identified TCI codepoint as the second TCI state(s). In 1050, the UE uses/applies the first and second applicable TCI states for at least UE-dedicate reception on PDSCH/PDCCH or dynamic-grant/configured-grant based PUSCH or all of dedicated PUCCH resources in a (SDCI based) multi-TRP system.

In one embodiment, a UE (e.g., the UE 116) could first operate in STRP mode according to one or more of the conditions specified herein in the present disclosure. The UE could then switch to MTRP mode according to one or more of the conditions specified herein in the present disclosure. For this design example, under the STRP operation mode according to one or more of the conditions specified herein in the present disclosure, the UE could first use/apply a single TCI state/pair of TCI states-denoted by initial TCI state/pair of TCI states—for at least UE-dedicated reception on PDSCH/PDCCH or dynamic-grant/configured-grant based PUSCH or all of dedicated PUCCH resources. The UE could then receive from the network, a beam indication/activation MAC CE for MTRP operation, e.g., unified TCI state activation/deactivation MAC CE for MTRP operation, wherein the (unified) TCI states activated/provided/indicated in the MAC CE for MTRP operation could be used to map up to Nep (e.g., Ncp=8) TCI codepoints of one or more TCI fields in a beam indication DCI for MTRP operation: here, a TCI codepoint could include or comprise or could be mapped to one or more joint/DL/UL TCI states/pairs of joint/DL/UL TCI states. Furthermore, each TCI state(s)/pair(s) of TCI states in the MAC CE for MTRP operation could be associated with an indicator, wherein the indicator could indicate whether the TCI state(s)/pair(s) of TCI states could correspond to the first TCI state/pair of TCI states, the second TCI state/pair of TCI states, and/or etc., among all the TCI states/pairs of TCI states mapped to the same TCI codepoint comprising the TCI state(s)/pair(s) of TCI state(s) activated by/in the MAC CE for MTRP operation: furthermore, the indicator could also indicate whether the TCI state(s)/pair(s) of TCI states could be from a first group/list of TCI states/TCI state IDs or a second group/list of TCI states/TCI state IDs. For the MTRP operation mode with N=2 or M=2, the UE could determine/identify, based on the TCI state(s)/pair(s) of TCI states activated/indicated by/in the MAC CE and/or the beam indication DCI for MTRP operation, a first applicable TCI state(s) and/or a second applicable TCI state(s) to use for at least UE-dedicated reception on PDSCH/PDCCH or dynamic-grant/configured-grant based PUSCH or all of dedicated PUCCH resources.
In one example, when the UE is indicated, e.g., via the TCI field(s) in the TCI state(s) indication DCI for MTRP operation as specified herein in the present disclosure, a TCI codepoint comprising a single TCI state/pair of TCI states, and the indicator associated to the TCI state/pair of TCI states indicates that the TCI state/pair of TCI states corresponds to the first TCI state/pair of TCI states among all the TCI states/pairs of TCI states mapped to the same TCI codepoint comprising the TCI state/pair of TCI states activated/provided/indicated in/by the unified TCI state activation/deactivation MAC CE for MTRP operation as specified herein in the present disclosure, after the indicated TCI state(s) has become applicable—e.g., after a time duration or beam application time (BAT) upon receiving the TCI state(s) activation/deactivation/indication MAC CE(s)/DCI(s) for MTRP operation:
   For example, the UE could use/apply only the indicated TCI state/pair of TCI states for at least UE-dedicated reception on PDSCH/PDCCH or dynamic-grant/configured-grant based PUSCH or all of dedicated PUCCH resources.
   For another example, the UE could use/apply the indicated TCI state/pair of TCI states—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises at least one TCI state/pair of TCI states with the corresponding/associated indicator indicating that the at least one TCI state/pair of TCI states is the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise at least one TCI state/pair of TCI states with the corresponding/associated indicator indicating that the at least one TCI state/pair of TCI states is the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises a single TCI state/pair of TCI states with the corresponding/associated indicator indicating that the TCI state/pair of TCI states is the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise a single TCI state/pair of TCI states with the corresponding/associated indicator indicating that the TCI state/pair of TCI states is the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the first applicable TCI state(s)—and the initial TCI state/pair of TCI states as specified herein in the present disclosure—as the second applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In another example, the UE could identify, from the (unified) TCI state activation/deactivation MAC CE for MTRP operation as specified herein in the present disclosure, a TCI codepoint comprising at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint. In this design example, the TCI codepoint to be identified could correspond to a fixed TCI codepoint in the MAC CE for MTRP operation, e.g., the first or last TCI codepoint in the MAC CE for MTRP operation (or the first or last TCI codepoint among one or more TCI codepoints in the MAC CE for MTRP operation, wherein each of the one or more TCI codepoints could be mapped to/could comprise at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint), or the only TCI codepoint in the MAC CE for MTRP operation that comprises at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint, or the lowest/highest TCI codepoint (the index of the TCI codepoint could be the lowest/highest) among one or more TCI codepoints in the MAC CE for MTRP operation, wherein the one or more TCI codepoints could correspond to all the TCI codepoints in the MAC CE for MTRP operation or the one or more TCI codepoints could correspond to those in the MAC CE for MTRP operation each comprising at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint. Optionally, the UE could be indicated/provided/configured by the network, e.g., via higher layer RRC signaling/parameter and/or MAC CE command and/or dynamic DCI based L1 signaling. (index of) the TCI codepoint to be identified among one or more TCI codepoints from/in the MAC CE for MTRP operation: for this case, the one or more TCI codepoints could correspond to all the TCI codepoints from/in the MAC CE for MTRP operation, or the one or more TCI codepoints could correspond to those from/in the MAC CE for MTRP operation each comprising at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint. After the TCI state(s) mapped to the identified TCI codepoint has become applicable—e.g., after a time duration or beam application time (BAT) upon receiving the TCI state(s) activation/deactivation/indication MAC CE(s)/DCI(s) for MTRP operation.
   For example, the UE could only use/apply the first TCI state/pair of TCI states among all the TCI states/pairs of TCI states mapped to the identified TCI codepoint for at least UE-dedicated reception on PDSCH/PDCCH or dynamic-grant/configured-grant based PUSCH or all of dedicated PUCCH resources.
   For another example, the UE could use/apply the first TCI state/pair of TCI states among all the TCI states/pairs of TCI states mapped to the identified TCI codepoint—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises at least one TCI state/pair of TCI states with the corresponding/associated indicator indicating that the at least one TCI state/pair of TCI states is the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise at least one TCI state/pair of TCI states with the corresponding/associated indicator indicating that the at least one TCI state/pair of TCI states is the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the first TCI state/pair of TCI states among all the TCI states/pairs of TCI states mapped to the identified TCI codepoint—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises a single TCI state/pair of TCI states with the corresponding/associated indicator indicating that the TCI state/pair of TCI states is the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise a single TCI state/pair of TCI states with the corresponding/associated indicator indicating that the TCI state/pair of TCI states is the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the first TCI state/pair of TCI states among all the TCI states/pairs of TCI states mapped to the identified TCI codepoint—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the first TCI state/pair of TCI states among all the TCI states/pairs of TCI states mapped to the identified TCI codepoint in/from the MAC CE for MTRP operation—as the first applicable TCI state(s)—and the initial TCI state/pair of TCI states as specified herein in the present disclosure—as the second applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, when the UE is indicated, e.g., via the TCI field(s) in the TCI state(s) indication DCI for MTRP operation as specified herein in the present disclosure, a TCI codepoint comprising a single TCI state/pair of TCI states, and the indicator associated to the TCI state/pair of TCI states indicates that the TCI state/pair of TCI states corresponds to the second TCI state/pair of TCI states among all the TCI states/pairs of TCI states mapped to the same TCI codepoint comprising the TCI state/pair of TCI states activated/provided/indicated in/by the unified TCI state activation/deactivation MAC CE for MTRP operation as specified herein in the present disclosure, after the indicated TCI state(s) has become applicable—e.g., after a time duration or beam application time (BAT) upon receiving the TCI state(s) activation/deactivation/indication MAC CE(s)/DCI(s) for MTRP operation:
   For example, the UE could use/apply only the indicated TCI state/pair of TCI states for at least UE-dedicated reception on PDSCH/PDCCH or dynamic-grant/configured-grant based PUSCH or all of dedicated PUCCH resources.
   For another example, the UE could use/apply the indicated TCI state/pair of TCI states—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises at least one TCI state/pair of TCI states with the corresponding/associated indicator indicating that the at least one TCI state/pair of TCI states is the first TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise at least one TCI state/pair of TCI states with the corresponding/associated indicator indicating that the at least one TCI state/pair of TCI states is the first TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises a single TCI state/pair of TCI states with the corresponding/associated indicator indicating that the TCI state/pair of TCI states is the first TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise a single TCI state/pair of TCI states with the corresponding/associated indicator indicating that the TCI state/pair of TCI states is the first TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the second applicable TCI state(s)—and the initial TCI state/pair of TCI states as specified herein in the present disclosure—as the first applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, the UE could identify, from the (unified) TCI state activation/deactivation MAC CE for MTRP operation as specified herein in the present disclosure, a TCI codepoint comprising at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint. In this design example, the TCI codepoint to be identified could correspond to a fixed TCI codepoint in the MAC CE for MTRP operation, e.g., the first or last TCI codepoint in the MAC CE for MTRP operation (or the first or last TCI codepoint among one or more TCI codepoints in the MAC CE for MTRP operation, wherein each of the one or more TCI codepoints could be mapped to/could comprise at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint), or the only TCI codepoint in the MAC CE for MTRP operation that comprises at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint, or the lowest/highest TCI codepoint (the index of the TCI codepoint could be the lowest/highest) among one or more TCI codepoints in the MAC CE for MTRP operation, wherein the one or more TCI codepoints could correspond to all the TCI codepoints in the MAC CE for MTRP operation or the one or more TCI codepoints could correspond to those in the MAC CE for MTRP operation each comprising at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint. Optionally, the UE could be indicated/provided/configured by the network, e.g., via higher layer RRC signaling/parameter and/or MAC CE command and/or dynamic DCI based L1 signaling. (index of) the TCI codepoint to be identified among one or more TCI codepoints from/in the MAC CE for MTRP operation: for this case, the one or more TCI codepoints could correspond to all the TCI codepoints from/in the MAC CE for MTRP operation, or the one or more TCI codepoints could correspond to those from/in the MAC CE for MTRP operation each comprising at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint. After the TCI state(s) mapped to the identified TCI codepoint has become applicable—e.g., after a time duration or beam application time (BAT) upon receiving the TCI state(s) activation/deactivation/indication MAC CE(s)/DCI(s) for MTRP operation:
   For example, the UE could only use/apply the second TCI state/pair of TCI states among all the TCI states/pairs of TCI states mapped to the identified TCI codepoint for at least UE-dedicated reception on PDSCH/PDCCH or dynamic-grant/configured-grant based PUSCH or all of dedicated PUCCH resources.
   For another example, the UE could use/apply the second TCI state/pair of TCI states among all the TCI states/pairs of TCI states mapped to the identified TCI codepoint—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises at least one TCI state/pair of TCI states with the corresponding/associated indicator indicating that the at least one TCI state/pair of TCI states is the first TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise at least one TCI state/pair of TCI states with the corresponding/associated indicator indicating that the at least one TCI state/pair of TCI states is the first TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the second TCI state/pair of TCI states among all the TCI states/pairs of TCI states mapped to the identified TCI codepoint—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises a single TCI state/pair of TCI states with the corresponding/associated indicator indicating that the TCI state/pair of TCI states is the first TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise a single TCI state/pair of TCI states with the corresponding/associated indicator indicating that the TCI state/pair of TCI states is the first TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the second TCI state/pair of TCI states among all the TCI states/pairs of TCI states mapped to the identified TCI codepoint—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the second TCI state/pair of TCI states among all the TCI states/pairs of TCI states mapped to the identified TCI codepoint in/from the MAC CE for MTRP operation—as the second applicable TCI state(s)—and the initial TCI state/pair of TCI states as specified herein in the present disclosure—as the first applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, when the UE is indicated, e.g., via the TCI field(s) in the TCI state(s) indication DCI for MTRP operation as specified herein in the present disclosure, a TCI codepoint comprising multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, after the indicated TCI state(s) has become applicable—e.g., after a time duration or beam application time (BAT) upon receiving the TCI state(s) activation/deactivation/indication MAC CE(s)/DCI(s) for MTRP operation, the UE could use/apply the indicated first TCI state/pair of TCI states—as the first applicable TCI state(s)—and the indicated second TCI state/pair of TCI states—as the second applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, the UE could identify, from the (unified) TCI state activation/deactivation MAC CE for MTRP operation as specified herein in the present disclosure, a TCI codepoint comprising multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. In this design example, the TCI codepoint to be identified could correspond to a fixed TCI codepoint in the MAC CE for MTRP operation, e.g., the first or last TCI codepoint in the MAC CE for MTRP operation (or the first or last TCI codepoint among one or more TCI codepoints in the MAC CE for MTRP operation, wherein each of the one or more TCI codepoints could be mapped to/could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint), or the only TCI codepoint in the MAC CE for MTRP operation that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, or the lowest/highest TCI codepoint (the index of the TCI codepoint could be the lowest/highest) among all the TCI codepoints in the MAC CE for MTRP operation each comprising multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. Optionally, the UE could be indicated/provided/configured by the network, e.g., via higher layer RRC signaling/parameter and/or MAC CE command and/or dynamic DCI based L1 signaling. (index of) the TCI codepoint to be identified among one or more TCI codepoints from/in the MAC CE for MTRP operation: for this case, the one or more TCI codepoints could correspond to all the TCI codepoints from/in the MAC CE for MTRP operation, or the one or more TCI codepoints could correspond to those from/in the MAC CE for MTRP operation each comprising multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. For this design example, after the TCI state(s) mapped to the identified TCI codepoint has become applicable—e.g., after a time duration or beam application time (BAT) upon receiving the TCI state(s) activation/deactivation/indication MAC CE(s)/DCI(s) for MTRP operation, the UE could use/apply the first TCI state/pair of TCI states of the identified TCI codepoint from/in the MAC CE for MTRP operation as specified herein in the present disclosure—as the first applicable TCI state(s)—and the second TCI state/pair of TCI states of the identified TCI codepoint from/in the MAC CE for MTRP operation as specified herein in the present disclosure—as the second applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, the UE could be indicated, e.g., via the TCI field(s) in the TCI state(s) indication DCI for MTRP operation as specified herein in the present disclosure, a TCI codepoint comprising one or more TCI states/pairs of TCI states, wherein the indicated TCI codepoint (and therefore, the corresponding one or more TCI states/pairs of TCI states) could be (selected/determined) from/in the unified TCI state(s) activation/deactivation MAC CE for MTRP operation as specified herein in the present disclosure.
   For example, before the TCI state(s) activated/provided/indicated in/by the TCI state(s) activation/deactivation MAC CE for MTRP operation becomes applicable/active—e.g., before a time duration or beam application time (BAT) upon receiving the TCI state(s) activation/deactivation MAC CE for MTRP operation, or before the indicated TCI state(s) becomes applicable—e.g., before a time duration or beam application time (BAT) upon receiving the TCI state(s) indication DCI for MTRP operation, the UE could use/apply the initial TCI state/pair of TCI states for at least UE-dedicated reception on PDSCH/PDCCH or dynamic-grant/configured-grant based PUSCH or all of dedicated PUCCH resources.
   For another example, after the TCI state(s) activated/provided/indicated in/by the TCI state(s) activation/deactivation MAC CE for MTRP operation has become applicable/active—e.g., after a time duration or beam application time (BAT) upon receiving the TCI state(s) activation/deactivation MAC CE for MTRP operation, and/or before the indicated TCI state(s) becomes applicable—e.g., before a time duration or beam application time (BAT) upon receiving the TCI state(s) indication DCI for MTRP operation, the UE could follow one or more of the design examples specified herein in the present disclosure to determine/use/apply the first applicable TCI state(s) and/or the second applicable TCI state(s) for at least UE-dedicated reception on PDSCH/PDCCH or dynamic-grant/configured-grant based PUSCH or all of dedicated PUCCH resources.
   Yet for another example, after the indicated TCI state(s) has become applicable—e.g., after a time duration or beam application time (BAT) upon receiving the TCI state(s) indication DCI for MTRP operation (or, after the TCI state(s) activated/provided/indicated in/by the TCI state(s) activation/deactivation MAC CE for MTRP operation has become applicable/active—e.g., after a time duration or beam application time (BAT) upon receiving the TCI state(s) activation/deactivation MAC CE for MTRP operation), the UE could follow one or more of the design examples specified herein in the present disclosure to determine/use/apply the first applicable TCI state(s) and/or the second applicable TCI state(s) for at least UE-dedicated reception on PDSCH/PDCCH or dynamic-grant/configured-grant based PUSCH or all of dedicated PUCCH resources. This design example could be for when the number of TCI state(s)/pair(s) of TCI states indicated by the TCI state(s) indication DCI for MTRP operation is one.
   Yet for another example, after the indicated TCI state(s) has become applicable—e.g., after a time duration or beam application time (BAT) upon receiving the TCI state(s) indication DCI for MTRP operation (or, after the TCI state(s) activated/provided/indicated in/by the TCI state(s) activation/deactivation MAC CE for MTRP operation has become applicable/active—e.g., after a time duration or beam application time (BAT) upon receiving the TCI state(s) activation/deactivation MAC CE for MTRP operation), the UE could follow one or more of the design examples specified herein in the present disclosure to determine/use/apply the first applicable TCI state(s) and/or the second applicable TCI state(s) for at least UE-dedicated reception on PDSCH/PDCCH or dynamic-grant/configured-grant based PUSCH or all of dedicated PUCCH resources. This design example could be for when the number of TCI state(s)/pair(s) of TCI states indicated by the TCI state(s) indication DCI for MTRP operation is greater than one (e.g., 2).

For the described/specified design examples herein the present disclosure, and for a (multi-DCI based) multi-TRP system as specified herein in the present disclosure, wherein a UE could be indicated/provided/configured by the network (e.g., the network 130), e.g., in PDCCH-Config, two values (i.e., 0 and 1) of CORESET pool index (denoted by CORESETPoolIndex) with each CORESET configured with a value of CORESETPoolIndex:
The MAC CE for MTRP operation or the (unified) TCI state(s) activation/deactivation MAC CE for MTRP operation as specified herein in the present disclosure could be associated to/with or could be specific to a value of coresetPoolIndex (i.e., either 0 or 1)—assuming that the UE is provided in PDCCH-Config, two values of coresetpoolIndex (i.e., 0 and 1) in the corresponding/respective CORESET(s). For instance, a value/field of coresetPoolIndex (e.g., 0 or 1), when configured, could be provided/indicated in the MAC CE for MTRP operation or the (unified) TCI state(s) activation/deactivation MAC CE for MTRP operation as specified herein in the present disclosure.
The beam indication DCI for MTRP operation or the (unified) TCI state(s) indication DCI as specified herein in the present disclosure could be associated to/with or could be specific to a value of coresetPoolIndex (i.e., either 0 or 1)—assuming that the UE is provided in PDCCH-Config, two values of coresetpoolIndex (i.e., 0 and 1) in the corresponding/respective CORESET(s). For instance, when/if the beam indication DCI for MTRP operation or the (unified) TCI state(s) indication DCI as specified herein in the present disclosure is received in CORESET(s) configured/associated with a value of coresetPoolIndex (i.e., either 0 or 1), the beam indication DCI for MTRP operation or the (unified) TCI state(s) indication DCI could be associated to/with or could be specific to the same value of coresetPoolIndex.
The initial TCI state/pair of TCI states, the first TCI state/pair of TCI states, e.g., among one or more TCI states/pairs of TCI states mapped to a TCI codepoint or an identified TCI codepoint according to those specified herein in the present disclosure, the second TCI state/pair of TCI states, e.g., among one or more TCI states/pairs of TCI states mapped to a TCI codepoint or an identified TCI codepoint according to those specified herein in the present disclosure, the first applicable TCI state(s) according to those specified herein in the present disclosure, and/or the second applicable TCI state(s) according to those specified herein in the present disclosure, could be associated with/to or specific to a value of coresetPoolIndex (i.e., either 0 or 1), when/if, e.g., the MAC CE for MTRP operation or the (unified) TCI state(s) activation/deactivation MAC CE for MTRP operation that activates/provides/indicates the above TCI state(s) is associated to/with or specific to the value of coresetPoolIndex according to those specified herein in the present disclosure, and/or the beam indication DCI for MTRP operation or the (unified) TCI state(s) indication DCI that indicates/provides the above TCI state(s) is associated to/with or specific to the value of coresetPoolIndex according to those specified herein in the present disclosure.
The applicable channels/signals as specified herein in the present disclosure-including, e.g., at least the UE-dedicated reception on PDSCH/PDCCH or dynamic-grant/configured-grant based PUSCH or all of dedicated PUCCH resources-could be associated with/to or specific to a value of coresetPoolIndex (e.g., 0 or 1). For instance, a PDCCH is associated to/with or specific to a value of coresetPoolIndex (e.g., 0 or 1) if the PDCCH is received in CORESET(s) associated to/with or specific to the (same) value of coresetPoolIndex. A PDSCH is associated to/with or specific to a value of coresetPoolIndex (e.g., 0 or 1) if the PDSCH is activated/scheduled by PDCCH(s) received in CORESET(s) associated to/with or specific to the (same) value of coresetPoolIndex. A PUCCH or a PUSCH (e.g., cell group (CG) Type-1 PUSCH) is associated to/with or specific to a value of coresetPoolIndex (e.g., 0 or 1) if an indicator (e.g., with value 0 or 1) provided/indicated/configured in the higher layer parameter(s) that provides/configures the PUCCH or the PUSCH (e.g., CG Type-1 PUSCH) is associated with/to or specific to the (same) value of coresetPoolIndex—e.g., the indicator could indicate/provide the same value (i.e., 0 or 1) as that of the coresetpoolIndex. A PUSCH (e.g., CG Type-2 PUSCH or dynamic grant (DG) PUSCH) is associated to/with or specific to a value of coresetPoolIndex (e.g., 0 or 1) if the PUSCH (e.g., CG Type-2 PUSCH or dynamic grant (DG) PUSCH) is activated/scheduled by PDCCH(s) received in CORESET(s) associated to/with or specific to the (same) value of coresetPoolIndex.

According to those specified herein in the present disclosure, the value(s) of coresetPoolIndex (i.e., 0 and/or 1) associated/specific to the MAC CE for MTRP operation (or the (unified) TCI state(s) activation/deactivation MAC CE for MTRP operation) or the beam indication DCI for MTRP operation (or the (unified) TCI state(s) indication DCI for MTRP operation) or the first/second (applicable) TCI state(s) or the initial TCI state(s) as specified herein in the present disclosure could be the same as or different from the value(s) of coresetPoolIndex (i.e., 0 and/or 1) associated/specific to the applicable channels/signals as specified herein in the present disclosure. For instance, the MAC CE for MTRP operation (or the (unified) TCI state(s) activation/deactivation MAC CE for MTRP operation) could be associated with/to or specific to value 0 of coresetPoolIndex (e.g., by providing/indicating value 0 of coresetPoolIndex—e.g., as a field—in the MAC CE for MTRP operation or the (unified) TCI state(s) activation/deactivation MAC CE for MTRP operation as specified herein in the present disclosure), while the applicable channels/signals could be associated with/to or specific to value 1 of coresetPoolIndex according to those specified herein in the present disclosure.

According to those specified herein in the present disclosure, in a multi-DCI based multi-TRP system wherein a UE could be provided in PDCCH-Config two values of CORESET pool index (i.e., 0 and 1) and/or configured by the higher layer parameter PDCCH-Config that contains two different values of coresetPoolIndex (e.g., 0 and 1) in ControlResourceSet, for a coresetPoolIndex value (e.g., 1), during an initial operation phase—e.g., after the UE has received from the network a (unified) TCI state(s) activation/deactivation MAC CE—e.g., the MAC CE for MTRP operation or the (unified) TCI state(s) activation/deactivation MAC CE for MTRP operation as specified herein in the present disclosure-associated/specific to the coresetPoolIndex value (e.g., 1) and/or after the TCI state(s)/TCI codepoint(s) activated/provided/indicated in/by the (unified) TCI state(s) activation/deactivation MAC CE has become applicable, e.g., after a time duration or beam application time (BAT) upon receiving the (unified) TCI state(s) activation/deactivation MAC CE, but before the UE receives from the network a TCI state(s) indication DCI(s) and/or before the UE could apply/use any of the TCI state(s) indicated/provided in the TCI state(s) indication DCI(s), e.g., before a time duration or beam application time (BAT) upon receiving the TCI state(s) DCI(s) for the first time.
The UE could expect or assume that the (unified) TCI state(s) activation/deactivation MAC CE—e.g., the MAC CE for MTRP operation or the (unified) TCI state(s) activation/deactivation MAC CE for MTRP operation as specified herein in the present disclosure—that is associated/specific to the coresetPoolIndex value (e.g., 1 in this case) could comprise/indicate/activate/provide/include/contain a single TCI codepoint comprising at least one joint/DL/UL TCI state (or at least one joint/DL/UL TCI state mapped to a single TCI codepoint). For this case, the UE could use/apply the at least one joint/DL/UL TCI state (or the corresponding single TCI codepoint) for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case).
The (unified) TCI state(s) activation/deactivation MAC CE—e.g., the MAC CE for MTRP operation or the (unified) TCI state(s) activation/deactivation MAC CE for MTRP operation as specified herein in the present disclosure—that is associated/specific to the coresetPoolIndex value (e.g., 1 in this case) could comprise/indicate/activate/provide/include/contain one or more TCI codepoints each comprising at least one joint/DL/UL TCI state (or one or more sets of joint/DL/UL TCI state(s) each comprising at least one joint/DL/UL TCI state and mapped to a TCI codepoint of a TCI field in a beam indication DCI). For this case, the UE could determine/identify which of the activated/indicated/provided TCI state(s) to use/apply for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case), according to/based on the number of TCI codepoints/TCI states/sets of TCI states activated/indicated/provided in the (unified) TCI state(s) activation/deactivation MAC CE—e.g., the MAC CE for MTRP operation or the (unified) TCI state(s) activation/deactivation MAC CE for MTRP operation as specified herein in the present disclosure—that is associated/specific to the coresetPoolIndex value (e.g., 1 in this case).
   When/if the number of TCI codepoints/TCI states/sets of TCI states as specified herein in the present disclosure activated/indicated/provided in the (unified) TCI state(s) activation/deactivation MAC CE is one, the UE could use/apply the one TCI codepoint/TCI state/set of TCI state activated/indicated/provided in the (unified) TCI state(s) activation/deactivation MAC CE for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case).
   When/if the number of TCI codepoints/TCI states/sets of TCI states as specified herein in the present disclosure activated/indicated/provided in the (unified) TCI state(s) activation/deactivation MAC CE is greater than one, the UE could use/apply one or more of:
      The first (or last) TCI state or the TCI state with the lowest (or highest) TCI state ID among the TCI states activated/indicated/provided in the (unified) TCI state(s) activation/deactivation MAC CE:
      The first (or last) set of TCI states (and therefore, the TCI state(s) provided/indicated/activated therein) or the set of TCI states with the lowest (or highest) TCI state (set) ID (and therefore, the TCI state(s) provided/indicated/activated therein) among the sets of TCI states activated/indicated/provided in the (unified) TCI state(s) activation/deactivation MAC CE;
      The first (or last) TCI state or the TCI state with the lowest (or highest) TCI state ID among the TCI state(s) in the first (or last) set of TCI state(s) or in the set of TCI state(s) with the lowest (or highest) TCI state (set) ID among the sets of TCI states activated/indicated/provided in the (unified) TCI state(s) activation/deactivation MAC CE;
      The first (or last) TCI codepoint (and therefore, the TCI state(s) mapped to the TCI codepoint) or the lowest (or highest) TCI codepoint (and therefore, the TCI state(s) mapped to the TCI codepoint) or the TCI codepoint with the lowest (or highest) TCI codepoint ID/index (and therefore, the TCI state(s) mapped to the TCI codepoint) among the TCI codepoints activated/indicated/provided in the (unified) TCI state(s) activation/deactivation MAC CE;
      The first (or last) TCI state or the TCI state with the lowest (or highest) TCI state ID among the TCI state(s) mapped to the first (or last) TCI codepoint or mapped to the lowest (or highest) TCI codepoint or mapped to the TCI codepoint with the lowest (or highest) TCI codepoint ID/index among the TCI codepoints activated/indicated/provided in the (unified) TCI state(s) activation/deactivation MAC CE;
      The set of TCI state(s)—and therefore, the TCI state(s) provided/indicated/activated therein—mapped to the first (or last) TCI codepoint or mapped to the lowest (or highest) TCI codepoint or mapped to the TCI codepoint with the lowest (or highest) TCI codepoint ID/index among the TCI codepoints activated/indicated/provided in the (unified) TCI state(s) activation/deactivation MAC CE; and/or
      The first (or last) TCI state or the TCI state with the lowest (or highest) TCI state ID among the TCI state(s) in the set of TCI state(s) mapped to the first (or last) TCI codepoint or mapped to the lowest (or highest) TCI codepoint or mapped to the TCI codepoint with the lowest (or highest) TCI codepoint ID/index among the TCI codepoints activated/indicated/provided in the (unified) TCI state(s) activation/deactivation MAC CE.
for or to transmit/receive channels/signals, including, e.g., at least the UE-dedicated reception on PDSCH/PDCCH or dynamic-grant/configured-grant based PUSCH or all of dedicated PUCCH resources, associated/specific to the same value of coresetPoolIndex (e.g., 1 in this case).

In one embodiment, a UE (e.g., the UE 116) could first operate in MTRP mode according to one or more of the conditions specified herein in the present disclosure. The UE could then switch to STRP mode according to one or more of the conditions specified herein in the present disclosure. For this design example, under the MTRP operation mode according to one or more of the conditions specified herein in the present disclosure, the UE could first use a/the first applicable TCI state(s) and/or a/the second applicable TCI state(s) as specified herein in the present disclosure for at least UE-dedicated reception on PDSCH/PDCCH or dynamic-grant/configured-grant based PUSCH or all of dedicated PUCCH resources. The UE could then receive from the network (e.g., the network 130), a beam indication/activation MAC CE for STRP operation, e.g., unified TCI state activation/deactivation MAC CE for STRP operation, wherein the (unified) TCI states activated/provided/indicated in the MAC CE for STRP operation could be used to map up to Ncp (e.g., Ncp=8) TCI codepoints of one or more TCI fields in a beam indication DCI for STRP operation: here, each of the TCI codepoints could include or comprise or could be mapped to only a single joint/DL/UL TCI state/pair of joint/DL/UL TCI states.
In one example, when the UE is indicated, e.g., via the TCI field(s) in the TCI state(s) indication DCI for STRP operation as specified herein in the present disclosure, a TCI codepoint comprising a single TCI state/pair of TCI states, after the indicated TCI state(s) has become applicable—e.g., after a time duration or beam application time (BAT) upon receiving the TCI state(s) activation/deactivation/indication MAC CE(s)/DCI(s) for STRP operation, the UE could use/apply only the indicated TCI state/pair of TCI states for at least UE-dedicated reception on PDSCH/PDCCH or dynamic-grant/configured-grant based PUSCH or all of dedicated PUCCH resources.
In another example, the UE could identify, from the (unified) TCI state activation/deactivation MAC CE for STRP operation as specified herein in the present disclosure, a TCI codepoint comprising a single TCI state/pair of TCI states. In this design example, the TCI codepoint to be identified could correspond to a fixed TCI codepoint in the MAC CE for STRP operation, e.g., the first or last TCI codepoint in the MAC CE for STRP operation (or the first or last TCI codepoint among one or more TCI codepoints in the MAC CE for STRP operation, wherein each of the one or more TCI codepoints could be mapped to/could comprise a single TCI state/pair of TCI states), or the only TCI codepoint in the MAC CE for STRP operation that comprises a single TCI state/pair of TCI states, or the lowest/highest TCI codepoint (the index of the TCI codepoint could be the lowest/highest) among all the TCI codepoints in the MAC CE for STRP operation each comprising a single TCI state/pair of TCI states. Optionally, the UE could be indicated/provided/configured by the network, e.g., via higher layer RRC signaling/parameter and/or MAC CE command and/or dynamic DCI based L1 signaling. (index of) the TCI codepoint to be identified among one or more TCI codepoints from/in the MAC CE for STRP operation: for this case, the one or more TCI codepoints could correspond to all the TCI codepoints from/in the MAC CE for STRP operation, or the one or more TCI codepoints could correspond to those from/in the MAC CE for STRP operation each comprising a single TCI states/pairs of TCI states. For this design example, after the TCI state(s) mapped to the identified TCI codepoint has become applicable—e.g., after a time duration or beam application time (BAT) upon receiving the TCI state(s) activation/deactivation/indication MAC CE(s)/DCI(s) for STRP operation, the UE could use/apply the TCI state/pair of TCI states of the identified TCI codepoint from/in the MAC CE for STRP operation as specified herein in the present disclosure for at least UE-dedicated reception on PDSCH/PDCCH or dynamic-grant/configured-grant based PUSCH or all of dedicated PUCCH resources.
In yet another example, the UE could be indicated, e.g., via the TCI field(s) in the TCI state(s) indication DCI for STRP operation as specified herein in the present disclosure, a TCI codepoint comprising a single TCI state/pair of TCI states, wherein the indicated TCI codepoint (and therefore, the corresponding TCI state/pair of TCI states) could be (selected/determined) from/in the unified TCI state(s) activation/deactivation MAC CE for STRP operation as specified herein in the present disclosure.
   For example, before the TCI state(s) activated/provided/indicated in/by the TCI state(s) activation/deactivation MAC CE for STRP operation becomes applicable/active—e.g., before a time duration or beam application time (BAT) upon receiving the TCI state(s) activation/deactivation MAC CE for STRP operation, or before the indicated TCI state(s) becomes applicable—e.g., before a time duration or beam application time (BAT) upon receiving the TCI state(s) indication DCI for STRP operation, the UE could use/apply the first applicable TCI state(s) and/or the second applicable TCI state(s) for at least UE-dedicated reception on PDSCH/PDCCH or dynamic-grant/configured-grant based PUSCH or all of dedicated PUCCH resources.
   For another example, after the TCI state(s) activated/provided/indicated in/by the TCI state(s) activation/deactivation MAC CE for STRP operation has become applicable/active—e.g., after a time duration or beam application time (BAT) upon receiving the TCI state(s) activation/deactivation MAC CE for STRP operation, and/or before the indicated TCI state(s) becomes applicable—e.g., before a time duration or beam application time (BAT) upon receiving the TCI state(s) indication DCI for STRP operation, the UE could follow one or more of the design examples specified herein in the present disclosure to determine/use/apply one or more TCI states—e.g., the TCI state/pair of TCI states of the identified TCI codepoint—for at least UE-dedicated reception on PDSCH/PDCCH or dynamic-grant/configured-grant based PUSCH or all of dedicated PUCCH resources.
   Yet for another example, after the indicated TCI state(s) has become applicable—e.g, after a time duration or beam application time (BAT) upon receiving the TCI state(s) indication DCI for STRP operation (or, after the TCI state(s) activated/provided/indicated in/by the TCI state(s) activation/deactivation MAC CE for STRP operation has become applicable/active—e.g., after a time duration or beam application time (BAT) upon receiving the TCI state(s) activation/deactivation MAC CE for STRP operation), the UE could follow one or more of the design examples specified herein in the present disclosure to determine/use/apply one or more TCI states—e.g., the TCI state/pair of TCI states of the identified TCI codepoint—for at least UE-dedicated reception on PDSCH/PDCCH or dynamic-grant/configured-grant based PUSCH or all of dedicated PUCCH resources.
   Yet for another example, after the indicated TCI state(s) has become applicable—e.g, after a time duration or beam application time (BAT) upon receiving the TCI state(s) indication DCI for STRP operation (or, after the TCI state(s) activated/provided/indicated in/by the TCI state(s) activation/deactivation MAC CE for STRP operation has become applicable/active—e.g., after a time duration or beam application time (BAT) upon receiving the TCI state(s) activation/deactivation MAC CE for STRP operation), the UE could follow one or more of the design examples specified herein in the present disclosure to determine/use/apply one or more TCI states—e.g., the indicated TCI state/pair of TCI states—for at least UE-dedicated reception on PDSCH/PDCCH or dynamic-grant/configured-grant based PUSCH or all of dedicated PUCCH resources.

Throughout the present disclosure, a/the first TCI codepoint—e.g., among one or more (or all) TCI codepoints in a MAC CE for TCI state(s) indication/activation/deactivation according to those specified herein in the present disclosure—could also correspond to or could also be referred to as the lowest/highest TCI codepoint (the index of the TCI codepoint could be the lowest/highest) among one or more (or all) TCI codepoints in the MAC CE for TCI state(s) indication/activation/deactivation according to those specified herein in the present disclosure, or vice versa. A/the last TCI codepoint—e.g., among one or more (or all) TCI codepoints in a MAC CE for TCI state(s) indication/activation/deactivation according to those specified herein in the present disclosure—could also correspond to or could also be referred to as the lowest/highest TCI codepoint (the index of the TCI codepoint could be the lowest/highest) among one or more (or all) TCI codepoints in the MAC CE for TCI state(s) indication/activation/deactivation according to those specified herein in the present disclosure, or vice versa.

Throughout the present disclosure, the UE could be provided/configured/indicated by the network (e.g., the network 130), e.g., via higher layer RRC signaling/parameter and/or MAC CE command and/or dynamic DCI based L1 signaling, the time duration or the beam application time (BAT) specified herein in the present disclosure. The time duration or the BAT could be determined according to one or more of:
A time offset, e.g., at least 3 ms, after receiving the TCI state(s) activation/deactivation MAC CE or starting from the slot in which the TCI state(s) activation/deactivation MAC CE is received;
A time offset starting from the first slot that is at least timeDurationForQCL symbols after the last symbol of a physical downlink control channel (PDCCH) that carries the beam indication DCI;
A time offset starting from the first slot that is at least BeamAppTime_r17 symbols after the last symbol of a physical uplink control channel (PUCCH) with hybrid automatic repeat request (HARQ)-acknowledgement (ACK) information corresponding to a PDSCH scheduled by the beam indication DCI; and/or
A time offset starting from the first slot that is at least BeamAppTime_r17 symbols after the last symbol of a PUCCH with hybrid automatic repeat request acknowledgement (HARQ-ACK) information corresponding to the beam indication DCI.

The first slot and the BeamAppTime_r17 symbols are both determined on a carrier with the smallest subcarrier spacing (SCS) among carriers applying the beam indication.

A UE could be provided/configured/indicated by the network (e.g., the network 130), e.g., via higher layer RRC signaling/parameter and/or MAC CE command and/or dynamic DCI based L1 signaling, a first group/list of one or more joint/DL/UL TCI states associated to a TRP, and/or a second group/list of one or more joint/DL/UL TCI states associated to another TRP. Alternatively, the UE could be provided/configured/indicated by the network, e.g., via higher layer RRC signaling/parameter and/or MAC CE command and/or dynamic DCI based L1 signaling, a first group/list of one or more synchronization signal blocks (SSBs) associated to a TRP, and/or a second group/list of one or more SSBs associated to another TRP. The first group/list of one or more joint/DL/UL TCI states could be associated with the first group/list of SSBs, while the second group/list of one or more joint/DL/UL TCI states could be associated with the second group/list of SSBs.

After the UE receives one or more initial higher layer configurations of the first group/list of (more than one) joint/DL/UL TCI states, and/or the second group/list of (more than one) joint/DL/UL TCI states, and/or the first group/list of (more than one) SSBs, and/or the second group/list of (more than one) SSBs, and before activation (e.g., by the unified TCI state(s) activation/deactivation MAC CE) of one or more TCI states from the configured TCI states and/or before indication (e.g., by the beam/TCI state(s) indication DCI) of one or more TCI states from the configured/activated TCI states and/or before application of one or more TCI states from the configured/activated/indicated TCI states:
The UE could assume that DM-RS(s) of one or more applicable downlink channels and/or signals including at least DM-RS of PDSCH and DM-RS of PDCCH and the CSI-RS applying the indicated TCI state(s) could be quasi co-located with the SSB(s) the UE identified, e.g., during the initial access procedure, wherein the SSB(s) could be determined/identified according to one or more of:
   In one example, the SSB(s) could be determined/identified from the first or second group/list of SSBs as specified herein in the present disclosure;
   In another example, the SSB(s) could be associated to value 0 or 1 of CORESETPoolIndex provided in PDCCH-Config;
   In yet another example, the SSB(s) could be the source RS(s) in one or more starting TCI states as specified herein in the present disclosure, wherein the one or more starting TCI states could be from the first or second group/list of TCI states as specified herein in the present disclosure; and/or
   In yet another example, the SSB(s) could be the source RS(s) in one or more TCI states determined/identified according to those specified herein in the present disclosure—e.g., the initial TCI state(s) and/or the first/second (applicable) TCI state(s) determined/identified according to one or more examples described herein. When/if the UE is provided in PDCCH-Config, two values of coresetPoolIndex (i.e., 0 and 1)—i.e., the multi-DCI based MTRP operation as specified herein in the present disclosure, the value(s) of coresetPoolIndex (i.e., 0 and/or 1) associated/specific to the one or more TCI states—and therefore, the source RS(s) such as SSB(s) provided/indicated therein—as specified herein in the present disclosure could be the same as or different from the value(s) of coresetPoolIndex (i.e., 0 and/or 1) associated/specific to one or more applicable downlink channels/signals as specified herein in the present disclosure. For instance, the one or more TCI states—and therefore, the source RS(s) such as SSB(s) provided/indicated therein—could be associated with/to or specific to value 0 of coresetPoolIndex, while the applicable downlink channel(s)/signal(s) could be associated with/to or specific to value 1 of coresetPoolIndex according to those specified herein in the present disclosure.
The UE could assume that at least the UL TX spatial filter, if applicable, for one or more applicable uplink channels including at least dynamic-grant and configured-grant based PUSCH and PUCCH, and for one or more applicable uplink signals including at least SRS applying the indicated TCI state(s), is the same as that for a PUSCH transmission scheduled by a random access response (RAR) UL grant during the initial access procedure, wherein the PUSCH transmission scheduled by the RAR UL grant could be determined/identified according to one or more of:
   In one example, the PUSCH transmission scheduled by the RAR UL grant could be associated to the first or second group/list of SSBs as specified herein in the present disclosure;
   In another example, the PUSCH transmission scheduled by the RAR UL grant could be associated to value 0 or 1 of CORESETPoolIndex provided in PDCCH-Config; and/or
   In yet another example, the PUSCH transmission scheduled by the RAR UL grant could be associated to the first or second group/list of TCI states as specified herein in the present disclosure.
The UE could assume that at least the UL TX spatial filter, if applicable, for one or more applicable uplink channels including at least dynamic-grant and configured-grant based PUSCH and PUCCH, and for one or more applicable uplink signals including at least SRS applying the indicated TCI state(s), is determined/identified according to source RS(s) in one or more TCI states determined/identified according to those specified herein in the present disclosure—e.g., the initial TCI state(s) and/or the first/second (applicable) TCI state(s) determined/identified according to one or more examples described herein. When/if the UE is provided in PDCCH-Config, two values of coresetPoolIndex (i.e., 0 and 1)—i.e., the multi-DCI based MTRP operation as specified herein in the present disclosure, the value(s) of coresetPoolIndex (i.e., 0 and/or 1) associated/specific to the one or more TCI states—and therefore, the source RS(s) such as SSB(s) provided/indicated therein—as specified herein in the present disclosure could be the same as or different from the value(s) of coresetPoolIndex (i.e., 0 and/or 1) associated/specific to one or more applicable uplink channels/signals as specified herein in the present disclosure. For instance, the one or more TCI states—and therefore, the source RS(s) such as SSB(s) provided/indicated therein-could be associated with/to or specific to value 0 of coresetPoolIndex, while the applicable uplink channel(s)/signal(s) could be associated with/to or specific to value 1 of coresetPoolIndex according to those specified herein in the present disclosure.

After the UE receives one or more initial higher layer configurations of the first group/list of (more than one) joint/DL/UL TCI states, and/or the second group/list of (more than one) joint/DL/UL TCI states, and/or the first group/list of (more than one) SSBs, and/or the second group/list of (more than one) SSBs as part of a Reconfiguration with sync procedure, and before activation (e.g., by the unified TCI state(s) activation/deactivation MAC CE) of one or more TCI states from the configured TCI states and/or before indication (e.g., by the beam/TCI state(s) indication DCI) of one or more TCI states from the configured/activated TCI states and/or before application of one or more TCI states from the configured/activated/indicated TCI states:
The UE could assume that DM-RS(s) of one or more applicable downlink channels and/or signals including at least DM-RS of PDSCH and DM-RS of PDCCH and the CSI-RS applying the indicated TCI state(s) could be quasi co-located with the SSB(s) or the CSI-RS resource(s) the UE identified, e.g., during the random access procedure initiated by the Reconfiguration with sync procedure, wherein the SSB(s) or the CSI-RS resource(s) could be determined/identified according to one or more of:
   In one example, the SSB(s) could be determined/identified from the first or second group/list of SSBs as specified herein in the present disclosure. Optionally, the CSI-RS resource(s) could be associated to the SSB(s), e.g., via quasi co-location relationship, determined/identified from the first or second group/list of SSBs as specified herein in the present disclosure;
   In another example, the SSB(s) or the CSI-RS resource(s) could be associated to value 0 or 1 of CORESETPoolIndex provided in PDCCH-Config;
   In yet another example, the SSB(s) or the CSI-RS resource(s) could be the source RS(s) in one or more starting TCI states as specified herein in the present disclosure, wherein the one or more starting TCI states could be from the first or second group/list of TCI states as specified herein in the present disclosure; and/or
   In yet another example, the SSB(s) or the CSI-RS resource(s) could be the source RS(s) in one or more TCI states determined/identified according to those specified herein in the present disclosure—e.g., the initial TCI state(s) and/or the first/second (applicable) TCI state(s) determined/identified according to one or more examples described herein. When/if the UE is provided in PDCCH-Config, two values of coresetPoolIndex (i.e., 0 and 1)—i.e., the multi-DCI based MTRP operation as specified herein in the present disclosure, the value(s) of coresetPoolIndex (i.e., 0 and/or 1) associated/specific to the one or more TCI states—and therefore, the source RS(s) such as SSB(s) or CSI-RS resource(s) provided/indicated therein—as specified herein in the present disclosure could be the same as or different from the value(s) of coresetPoolIndex (i.e., 0 and/or 1) associated/specific to one or more applicable downlink channels/signals as specified herein in the present disclosure. For instance, the one or more TCI states—and therefore, the source RS(s) such as SSB(s) or CSI-RS resource(s) provided/indicated therein—could be associated with/to or specific to value 0 of coresetPoolIndex, while the applicable downlink channel(s)/signal(s) could be associated with/to or specific to value 1 of coresetPoolIndex according to those specified herein in the present disclosure.
The UE could assume that at least the UL TX spatial filter, if applicable, for one or more applicable uplink channels including at least dynamic-grant and configured-grant based PUSCH and PUCCH, and for one or more applicable uplink signals including at least SRS applying the indicated TCI state, is the same as that for a PUSCH transmission scheduled by a RAR UL grant during random access procedure initiated by the Reconfiguration with synch procedure, wherein the PUSCH transmission scheduled by the RAR UL grant could be determined/identified according to one or more of:
   In one example, the PUSCH transmission scheduled by the RAR UL grant could be associated to the first or second group/list of SSBs as specified herein in the present disclosure;
   In another example, the PUSCH transmission scheduled by the RAR UL grant could be associated to value 0 or 1 of CORESETPoolIndex provided in PDCCH-Config; and/or
   In yet another example, the PUSCH transmission scheduled by the RAR UL grant could be associated to the first or second group/list of TCI states as specified herein in the present disclosure.
The UE could assume that at least the UL TX spatial filter, if applicable, for one or more applicable uplink channels including at least dynamic-grant and configured-grant based PUSCH and PUCCH, and for one or more applicable uplink signals including at least SRS applying the indicated TCI state(s), is determined/identified according to source RS(s) in one or more TCI states determined/identified according to those specified herein in the present disclosure—e.g., the initial TCI state(s) and/or the first/second (applicable) TCI state(s) determined/identified according to one or more examples described herein. When/if the UE is provided in PDCCH-Config, two values of coresetPoolIndex (i.e., 0 and 1)—i.e., the multi-DCI based MTRP operation as specified herein in the present disclosure, the value(s) of coresetPoolIndex (i.e., 0 and/or 1) associated/specific to the one or more TCI states—and therefore, the source RS(s) such as SSB(s) and CSI-RS resource(s) provided/indicated therein—as specified herein in the present disclosure could be the same as or different from the value(s) of coresetPoolIndex (i.e., 0 and/or 1) associated/specific to one or more applicable uplink channels/signals as specified herein in the present disclosure. For instance, the one or more TCI states—and therefore, the source RS(s) such as SSB(s) and CSI-RS resource(s) provided/indicated therein—could be associated with/to or specific to value 0 of coresetPoolIndex, while the applicable uplink channel(s)/signal(s) could be associated with/to or specific to value 1 of coresetPoolIndex according to those specified herein in the present disclosure.

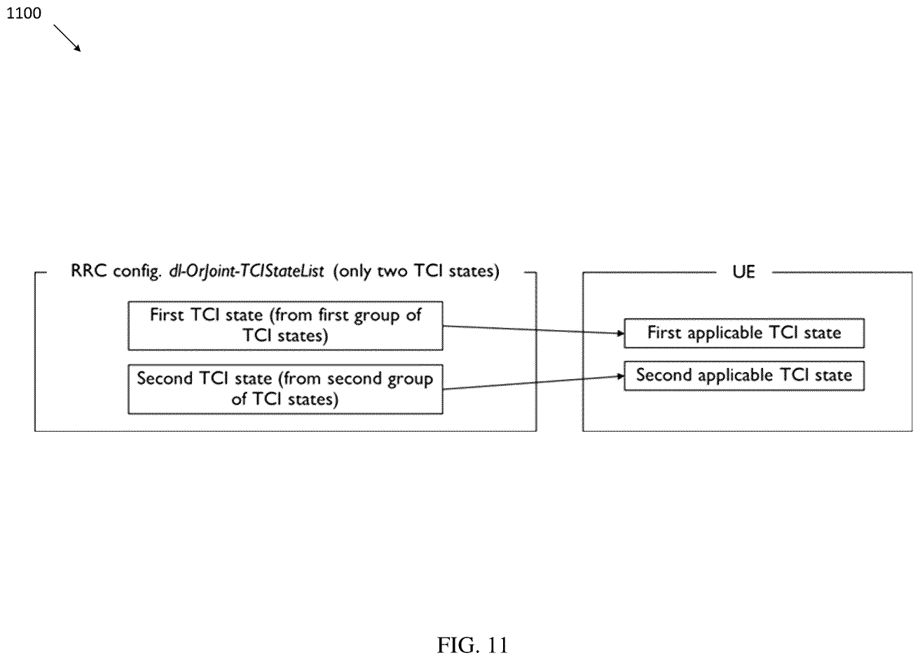

FIG. 11 illustrates a diagram of an example RRC configuration 1100 including two joint/DL/UL TCI states for a UE according to embodiments of the present disclosure. For example, RRC configuration 1100 including two joint/DL/UL TCI states for a UE may be utilized by UEs 111-116 in the wireless network 100 of FIG. 1. This example is for illustration only and other embodiments can be used without departing from the scope of the present disclosure.

As specified herein in the present disclosure, a UE could maintain/track/apply/use a first applicable TCI state(s) and/or a second applicable TCI state(s) for at least UE-dedicated reception on PDSCH/PDCCH or dynamic-grant/configured-grant based PUSCH or all of dedicated PUCCH resources.
In one example, when/if the UE is configured/provided/indicated by the network, e.g., in the higher layer configuration of dl-OrJoint-TCIStateList, a single TCI state/pair of TCI states that can be used as indicated TCI state(s), the UE could use/apply the configured TCI state(s) as the first applicable TCI state(s) and obtain the quasi-collocation (QCL) assumptions from the configured TCI state(s) along with the second applicable TCI state(s) if present/applicable, for DM-RS of PDCCH and DM-RS of PDSCH, and the CSI-RS applying the indicated TCI state(s).
In another example, when/if the UE is configured/provided/indicated by the network, e.g., in the higher layer configuration of dl-OrJoint-TCIStateList, a single TCI state/pair of TCI states that can be used as indicated TCI state(s), the UE could use/apply the configured TCI state(s) as the second applicable TCI state(s) and obtain the QCL assumptions from the configured TCI state(s) along with the first applicable TCI state(s) if present/applicable, for DM-RS of PDCCH and DM-RS of PDSCH, and the CSI-RS applying the indicated TCI state(s).
In yet another example, the UE could be configured/provided/indicated by the network, e.g., in the higher layer configuration of dl-OrJoint-TCIStateList, a single TCI state/pair of TCI states that can be used as indicated TCI state(s). The UE could also be configured/provided/indicated by the network, e.g., via higher layer RRC signaling/parameter (e.g., in the higher layer configuration of dl-OrJoint-TCIStateList) and/or MAC CE command and/or dynamic DCI based L1 signaling, an (one-bit) indicator. When/if the (one-bit) indicator is set to ‘0’ (or ‘1’), the UE could use/apply the configured TCI state(s) as the first applicable TCI state(s), and obtain the QCL assumptions from the configured TCI state(s), along with the second applicable TCI state(s) if present/applicable, for DM-RS of PDCCH and DM-RS of PDSCH, and the CSI-RS applying the indicated TCI state(s). When/if the (one-bit) indicator is set to ‘1’ (or ‘0’), the UE could use/apply the configured TCI state(s) as the second applicable TCI state(s) and obtain the QCL assumptions from the configured TCI state(s), along with the first applicable TCI state(s) if present/applicable, for DM-RS of PDCCH and DM-RS of PDSCH, and the CSI-RS applying the indicated TCI state(s).
In yet another example, when/if the UE is configured/provided/indicated by the network, e.g., in the higher layer configuration of dl-OrJoint-TCIStateList, a single TCI state/pair of TCI states from the first group of TCI states as specified herein in the present disclosure that can be used as indicated TCI state(s), the UE could use/apply the configured TCI state(s) as the first applicable TCI state(s) and obtain the QCL assumptions from the configured TCI state(s) along with the second applicable TCI state(s) if present/applicable, for DM-RS of PDCCH and DM-RS of PDSCH, and the CSI-RS applying the indicated TCI state(s).
In yet another example, when/if the UE is configured/provided/indicated by the network, e.g., in the higher layer configuration of dl-OrJoint-TCIStateList, a single TCI state/pair of TCI states from the second group of TCI states as specified herein in the present disclosure that can be used as indicated TCI state(s), the UE could use/apply the configured TCI state(s) as the second applicable TCI state(s) and obtain the QCL assumptions from the configured TCI state(s) along with the first applicable TCI state(s) if present/applicable, for DM-RS of PDCCH and DM-RS of PDSCH, and the CSI-RS applying the indicated TCI state(s).
In yet another example, the UE could be configured/provided/indicated by the network, e.g., in the higher layer configuration of dl-OrJoint-TCIStateList, two TCI states/pairs of TCI states-denoted by a first TCI state/pair of TCI states and a second TCI state/pair of TCI states—that can be used as indicated TCI states. The UE could use/apply the configured first TCI state(s) as the first applicable TCI state(s) and the configured second TCI state(s) as the second applicable TCI state(s) and obtain the QCL assumptions from the configured first and second TCI states, for DM-RS of PDCCH and DM-RS of PDSCH, and the CSI-RS applying the indicated TCI state(s).
In yet another example, the UE could be configured/provided/indicated by the network, e.g., in the higher layer configuration of dl-OrJoint-TCIStateList, two TCI states/pairs of TCI states that can be used as indicated TCI states. The UE could use/apply the configured TCI state(s) with the lowest (or highest) TCI state ID(s) as the first applicable TCI state(s) and the configured TCI state(s) with the highest (or lowest) TCI state ID(s) as the second applicable TCI state(s) and obtain the QCL assumptions from the configured TCI states, for DM-RS of PDCCH and DM-RS of PDSCH, and the CSI-RS applying the indicated TCI state(s).
In yet another example, the UE could be configured/provided/indicated by the network, e.g., in the higher layer configuration of dl-OrJoint-TCIStateList, two TCI states/pairs of TCI states-denoted by a first TCI state/pair of TCI states from the first group of TCI states as specified herein in the present disclosure and a second TCI state/pair of TCI states from the second group of TCI states as specified herein in the present disclosure—that can be used as indicated TCI states. The UE could use/apply the configured first TCI state(s) as the first applicable TCI state(s) and the configured second TCI state(s) as the second applicable TCI state(s) and obtain the QCL assumptions from the configured first and second TCI states, for DM-RS of PDCCH and DM-RS of PDSCH, and the CSI-RS applying the indicated TCI state(s).
In yet another example, the UE could be configured/provided/indicated by the network, e.g., in the higher layer configuration of dl-OrJoint-TCIStateList, two TCI states/pairs of TCI states-denoted by a first TCI state/pair of TCI states and a second TCI state/pair of TCI states—that can be used as indicated TCI states. The UE could also be configured/provided/indicated by the network, e.g., via higher layer RRC signaling/parameter (e.g., in the higher layer configuration of dl-OrJoint-TCIStateList) and/or MAC CE command and/or dynamic DCI based L1 signaling, an (one-bit) indicator. When the (one-bit) indicator is set to ‘0’ (or ‘1’), the UE could use/apply the configured first TCI state(s) as the first applicable TCI state(s) and the configured second TCI state(s) as the second applicable TCI state(s) and obtain the QCL assumptions from the configured first and second TCI states, for DM-RS of PDCCH and DM-RS of PDSCH, and the CSI-RS applying the indicated TCI state(s). When the (one-bit) indicator is set to ‘1’ (or ‘0’), the UE could use/apply the configured first TCI state(s) as the second applicable TCI state(s) and the configured second TCI state(s) as the first applicable TCI state(s) and obtain the QCL assumptions from the configured first and second TCI states, for DM-RS of PDCCH and DM-RS of PDSCH, and the CSI-RS applying the indicated TCI state(s).
In yet another example, the UE could be configured/provided/indicated by the network, e.g., in the higher layer configuration of dl-OrJoint-TCIStateList, two TCI states/pairs of TCI states-denoted by a first TCI state/pair of TCI states and a second TCI state/pair of TCI states—that can be used as indicated TCI states. The UE could also be configured/provided/indicated by the network, e.g., via higher layer RRC signaling/parameter (e.g., in the higher layer configuration of dl-OrJoint-TCIStateList) and/or MAC CE command and/or dynamic DCI based L1 signaling, a first (one-bit) indicator associated to the first TCI state/pair of TCI states and a second (one-bit) indicator associated to the second TCI state/pair of TCI states. When the first (one-bit) indicator is set to ‘0’ (or ‘1’), the UE could use/apply the configured first TCI state(s) as the first applicable TCI state(s). When the first (one-bit) indicator is set to ‘1’ (or ‘0’), the UE could use/apply the configured first TCI state(s) as the second applicable TCI state(s). Furthermore, when the second (one-bit) indicator is set to ‘0’ (or ‘1’), the UE could use/apply the configured second TCI state(s) as the first applicable TCI state(s). When the second (one-bit) indicator is set to ‘1’ (or ‘0’), the UE could use/apply the configured second TCI state(s) as the second applicable TCI state(s). The UE could then obtain the QCL assumptions from the configured first and second TCI states for DM-RS of PDCCH and DM-RS of PDSCH, and the CSI-RS applying the indicated TCI state(s).

For this design example, the UE would apply/use the first TCI state (e.g., with the associated/corresponding first indicator set to ‘0’ or from the first group of TCI states as specified herein in the present disclosure) in the RRC configured list of TCI states as the first applicable TCI state, and the second TCI state (e.g., with the associated/corresponding second indicator set to ‘1’ or from the second group of TCI states as specified herein in the present disclosure) in the RRC configured list of TCI states as the second applicable TCI state, for at least UE-dedicated reception on PDSCH/PDCCH or dynamic-grant/configured-grant based PUSCH or all of dedicated PUCCH resources.

As specified herein in the present disclosure, a UE could maintain/track/apply/use a first applicable TCI state(s) and/or a second applicable TCI state(s) for at least UE-dedicated reception on PDSCH/PDCCH or dynamic-grant/configured-grant based PUSCH or all of dedicated PUCCH resources.
In one example, when/if the UE is configured/provided/indicated by the network, e.g., in the higher layer configuration of dl-OrJoint-TCIStateList or ul-TCIStateList, a single TCI state/pair of TCI states that can be used as indicated TCI state(s), the UE could use/apply the configured TCI state(s) as the first applicable TCI state(s), and determine an UL TX spatial filter, if applicable, from the configured TCI state(s), along with the second applicable TCI state(s) if present/applicable, for dynamic-grant and configured-grant based PUSCH and PUCCH, and SRS applying the indicated TCI state(s).
In another example, when/if the UE is configured/provided/indicated by the network, e.g., in the higher layer configuration of dl-OrJoint-TCIStateList or ul-TCIStateList, a single TCI state/pair of TCI states that can be used as indicated TCI state(s), the UE could use/apply the configured TCI state(s) as the second applicable TCI state(s), and determine an UL TX spatial filter, if applicable, from the configured TCI state(s), along with the first applicable TCI state(s) if present/applicable, for dynamic-grant and configured-grant based PUSCH and PUCCH, and SRS applying the indicated TCI state(s).
In yet another example, the UE could be configured/provided/indicated by the network, e.g., in the higher layer configuration of dl-OrJoint-TCIStateList or ul-TCIStateList, a single TCI state/pair of TCI states that can be used as indicated TCI state(s). The UE could also be configured/provided/indicated by the network, e.g., via higher layer RRC signaling/parameter (e.g., in the higher layer configuration of dl-OrJoint-TCIStateList or ul-TCIStateList) and/or MAC CE command and/or dynamic DCI based L1 signaling, an (one-bit) indicator. When/if the (one-bit) indicator is set to ‘0’ (or ‘1’), the UE could use/apply the configured TCI state(s) as the first applicable TCI state(s), and determine an UL TX spatial filter, if applicable, from the configured TCI state(s), along with the second applicable TCI state(s) if present/applicable, for dynamic-grant and configured-grant based PUSCH and PUCCH, and SRS applying the indicated TCI state(s). When/if the (one-bit) indicator is set to ‘1’ (or ‘0’), the UE could use/apply the configured TCI state(s) as the second applicable TCI state(s), and determine an UL TX spatial filter, if applicable, from the configured TCI state(s), along with the first applicable TCI state(s) if present/applicable, for dynamic-grant and configured-grant based PUSCH and PUCCH, and SRS applying the indicated TCI state(s).
In yet another example, when/if the UE is configured/provided/indicated by the network, e.g., in the higher layer configuration of dl-OrJoint-TCIStateList or ul-TCIStateList, a single TCI state/pair of TCI states from the first group of TCI states as specified herein in the present disclosure that can be used as indicated TCI state(s), the UE could use/apply the configured TCI state(s) as the first applicable TCI state(s), and determine an UL TX spatial filter, if applicable, from the configured TCI state(s), along with the second applicable TCI state(s) if present/applicable, for dynamic-grant and configured-grant based PUSCH and PUCCH, and SRS applying the indicated TCI state(s).
In yet another example, when/if the UE is configured/provided/indicated by the network, e.g., in the higher layer configuration of dl-OrJoint-TCIStateList or ul-TCIStateList, a single TCI state/pair of TCI states from the second group of TCI states as specified herein in the present disclosure that can be used as indicated TCI state(s), the UE could use/apply the configured TCI state(s) as the second applicable TCI state(s), and determine an UL TX spatial filter, if applicable, from the configured TCI state(s), along with the first applicable TCI state(s) if present/applicable, for dynamic-grant and configured-grant based PUSCH and PUCCH, and SRS applying the indicated TCI state(s).
In yet another example, the UE could be configured/provided/indicated by the network, e.g., in the higher layer configuration of dl-OrJoint-TCIStateList or ul-TCIStateList, two TCI states/pairs of TCI states-denoted by a first TCI state/pair of TCI states and a second TCI state/pair of TCI states—that can be used as indicated TCI states. The UE could use/apply the configured first TCI state(s) as the first applicable TCI state(s) and the configured second TCI state(s) as the second applicable TCI state(s), and determine an UL TX spatial filter, if applicable, from the configured first and second TCI states for dynamic-grant and configured-grant based PUSCH and PUCCH, and SRS applying the indicated TCI state(s).
In yet another example, the UE could be configured/provided/indicated by the network, e.g., in the higher layer configuration of dl-OrJoint-TCIStateList or ul-TCIStateList, two TCI states/pairs of TCI states that can be used as indicated TCI states. The UE could use/apply the configured TCI state(s) with the lowest (or highest) TCI state ID(s) as the first applicable TCI state(s) and the configured TCI state(s) with the highest (or lowest) TCI state ID(s) as the second applicable TCI state(s), and determine an UL TX spatial filter, if applicable, from the configured TCI states for dynamic-grant and configured-grant based PUSCH and PUCCH, and SRS applying the indicated TCI state(s).
In yet another example, the UE could be configured/provided/indicated by the network, e.g., in the higher layer configuration of dl-OrJoint-TCIStateList or ul-TCIStateList, two TCI states/pairs of TCI states-denoted by a first TCI state/pair of TCI states from the first group of TCI states as specified herein in the present disclosure and a second TCI state/pair of TCI states from the second group of TCI states as specified herein in the present disclosure—that can be used as indicated TCI states. The UE could use/apply the configured first TCI state(s) as the first applicable TCI state(s) and the configured second TCI state(s) as the second applicable TCI state(s), and determine an UL TX spatial filter, if applicable, from the configured first and second TCI states for dynamic-grant and configured-grant based PUSCH and PUCCH, and SRS applying the indicated TCI state(s).
In yet another example, the UE could be configured/provided/indicated by the network, e.g., in the higher layer configuration of dl-OrJoint-TCIStateList or ul-TCIStateList, two TCI states/pairs of TCI states-denoted by a first TCI state/pair of TCI states and a second TCI state/pair of TCI states—that can be used as indicated TCI states. The UE could also be configured/provided/indicated by the network, e.g., via higher layer RRC signaling/parameter (e.g., in the higher layer configuration of dl-OrJoint-TCIStateList or ul-TCIStateList) and/or MAC CE command and/or dynamic DCI based L1 signaling, an (one-bit) indicator. When the (one-bit) indicator is set to ‘0’ (or ‘1’), the UE could use/apply the configured first TCI state(s) as the first applicable TCI state(s) and the configured second TCI state(s) as the second applicable TCI state(s), and determine an UL TX spatial filter, if applicable, from the configured first and second TCI states for dynamic-grant and configured-grant based PUSCH and PUCCH, and SRS applying the indicated TCI state(s). When the (one-bit) indicator is set to ‘1’ (or ‘0’), the UE could use/apply the configured first TCI state(s) as the second applicable TCI state(s) and the configured second TCI state(s) as the first applicable TCI state(s), and determine an UL TX spatial filter, if applicable, from the configured first and second TCI states for dynamic-grant and configured-grant based PUSCH and PUCCH, and SRS applying the indicated TCI state(s).
In yet another example, the UE could be configured/provided/indicated by the network, e.g., in the higher layer configuration of dl-OrJoint-TCIStateList or ul-TCIStateList, two TCI states/pairs of TCI states-denoted by a first TCI state/pair of TCI states and a second TCI state/pair of TCI states—that can be used as indicated TCI states. The UE could also be configured/provided/indicated by the network, e.g., via higher layer RRC signaling/parameter (e.g., in the higher layer configuration of dl-OrJoint-TCIStateList or ul-TCIStateList) and/or MAC CE command and/or dynamic DCI based L1 signaling, a first (one-bit) indicator associated to the first TCI state/pair of TCI states and a second (one-bit) indicator associated to the second TCI state/pair of TCI states. When the first (one-bit) indicator is set to ‘0’ (or ‘1’), the UE could use/apply the configured first TCI state(s) as the first applicable TCI state(s), and when the first (one-bit) indicator is set to ‘1’ (or ‘0’), the UE could use/apply the configured first TCI state(s) as the second applicable TCI state(s). Furthermore, when the second (one-bit) indicator is set to ‘0’ (or ‘1’), the UE could use/apply the configured second TCI state(s) as the first applicable TCI state(s), and when the second (one-bit) indicator is set to ‘1’ (or ‘0’), the UE could use/apply the configured second TCI state(s) as the second applicable TCI state(s). The UE could then determine an UL TX spatial filter, if applicable, from the configured first and second TCI states for dynamic-grant and configured-grant based PUSCH and PUCCH, and SRS applying the indicated TCI state(s).

As specified herein in the present disclosure, the second indicator could be indicated/provided in the beam indication DCI (e.g., DCI format 1_1/1_2 with or without DL assignment) for determining which of the (first and/or second) indicated TCI states to use/apply for PDSCH reception(s). The second indicator could also be referred to as a/the TCI selection field in the corresponding DCI format (e.g., DCI format 1_1/1_2), and presence/absence of the second indicator (TCI selection field) in the corresponding DCI format(s)—e.g., DCI format(s) 1_1 and/or 1_2 as specified herein in the present disclosure—could be configured/provided via RRC (e.g., by configuring a RRC signaling/parameter tciSelection-PresentInDCI and/or setting a RRC signaling/parameter tciSelection-PresentInDCI to ‘1’ or ‘0’ or ‘enabled’ or ‘on’). In this case, the TCI field for TCI state(s) indication/update and the TCI selection field (i.e., the second indicator as specified herein in the present disclosure) for TCI state(s) selection for PDSCH reception(s) could be jointly or separately configured to be present in the corresponding DCI format(s)—e.g., DCI format(s) 1_1/1_2 as specified herein in the present disclosure. That is, the DCI format(s) 1_1/1_2 could provide/indicate/comprise only the TCI field for TCI state(s) indication/update—e.g., the higher layer parameter tci-PresentInDCI is provided/configured and/or set to enabled, but does not provide/indicate/comprise the TCI selection field (the second indicator as specified herein in the present disclosure) for TCI state(s) selection for PDSCH reception(s)—e.g., the higher layer parameter tciSelection-PresentInDCI is not provided/configured and/or is set to disabled, and/or the DCI format(s) 1_1/1_2 could provide/indicate/comprise only the TCI selection field (i.e., the second indicator as specified herein in the present disclosure) for TCI state(s) selection for PDSCH reception(s)—e.g., the higher layer parameter tciSelection-PresentInDCI is provided/configured and/or set to enabled, but does not provide/indicate/comprise the TCI field for TCI state(s) indication/update, e.g., the higher layer parameter tci-PresentInDCI is not provided/configured and/or is set to disabled, and/or the DCI format(s) 1_1/1_2 could provide/indicate/comprise both the TCI field for TCI state(s) indication/update and the TCI selection field (i.e., the second indicator as specified herein in the present disclosure) for TCI state(s) selection for PDSCH reception(s)—e.g., the higher layer parameter teiSelection-PresentInDCI is provided/configured and/or set to enabled, and the higher layer parameter tei-PresentInDCI is also provided/configured and/or set to enabled.
In one example, the UE could expect or assume that the TCI field for TCI state(s) indication/update and the TCI selection field (i.e., the second indicator as specified herein in the present disclosure) for TCI state(s) selection for PDSCH reception(s) are/shall be both indicated/present/provided in DCI format 1_1/1_2—e.g., the UE could expect or assume that the higher layer parameter tciSelection-PresentInDCI is provided/configured and/or set to enabled, and the higher layer parameter tci-PresentInDCI is also provided/configured and/or set to enabled. For this case/design example, when applicable—e.g., after the beam application time as specified herein in the present disclosure, the UE could use/apply the TCI state(s) indicated/provided by the TCI field to update the first applicable TCI state(s) and/or the second applicable TCI state(s) as specified herein in the present disclosure to transmit/receive the corresponding UL channels/signals and/or DL channels/signals such as PDSCH(s); furthermore, when applicable—e.g., after the beam application time as specified herein in the present disclosure, the UE could follow the indicated TCI selection field (or the second indicator as specified herein in the present disclosure) to determine/identify which of the (first and/or second) applicable TCI state(s) to use/apply for receiving the PDSCH(s).
In another example, as specified herein in the present disclosure, the UE could receive from the network a beam indication DCI (e.g., DCI format(s) 1_1/1_2 with or without DL assignment) providing/indicating/comprising only the TCI selection field (i.e., the second indicator as specified herein in the present disclosure) for TCI state(s) selection for PDSCH reception(s)—e.g., the higher layer parameter tciSelection-PresentInDCI is provided/configured and/or set to enabled: however, the beam indication DCI (e.g., DCI format(s) 1_1/1_2) may not provide/indicate/comprise the TCI field for TCI state(s) indication/update—e.g., the higher layer parameter tci-PresentInDCI is not provided/configured and/or is set to disabled. For this case/design example, when applicable—e.g., after the beam application time as specified herein in the present disclosure, the UE could follow the indicated TCI selection field (or the second indicator as specified herein in the present disclosure) to determine/identify which of the (first and/or second) applicable TCI state(s) to use/apply for receiving the PDSCH(s).
In yet another example, the UE could have been applying a TCI selection field (or a second indicator as specified herein in the present disclosure)—denoted by an applied TCI selection field (or an applied second indicator as specified herein in the present disclosure)—to determine/identify which of the (first and/or second) applicable TCI state(s) to use/apply for receiving the PDSCH(s). As specified herein in the present disclosure, the UE could receive from the network a beam indication DCI (e.g., DCI format(s) 1_1/1_2 with or without DL assignment) providing/indicating/comprising only the TCI selection field-denoted by the indicated TCI selection field (i.e., the second indicator as specified herein in the present disclosure-denoted by the indicated second indicator) for TCI state(s) selection for PDSCH reception(s)—e.g., the higher layer parameter tciSelection-PresentInDCI is provided/configured and/or set to enabled; however, the beam indication DCI (e.g., DCI format(s) 1_1/1_2) may not provide/indicate/comprise the TCI field for TCI state(s) indication/update—e.g., the higher layer parameter tci-PresentInDCI is not provided/configured and/or is set to disabled. For this case/design example, the UE could expect or assume that the indicated TCI selection field (or the indicated second indicator as specified herein in the present disclosure) could be different from the applied TCI selection field (or the applied second indicator as specified herein in the present disclosure).
In yet another example, the UE could have been applying a TCI selection field (or a second indicator as specified herein in the present disclosure)—denoted by an applied TCI selection field (or an applied second indicator as specified herein in the present disclosure)—to determine/identify which of the (first and/or second) applicable TCI state(s) to use/apply for receiving the PDSCH(s). As specified herein in the present disclosure, the UE could receive from the network a beam indication DCI (e.g., DCI format(s) 1_1/1_2 with or without DL assignment) providing/indicating/comprising only the TCI field for TCI state(s) indication/update—e.g., the higher layer parameter tci-PresentInDCI is provided/configured and/or set to enabled: however, the beam indication DCI (e.g., DCI format(s) 1_1/1_2) may not provide/indicate/comprise a TCI selection field (i.e., a second indicator as specified herein in the present disclosure) for TCI state(s) selection for PDSCH reception(s)—e.g., the higher layer parameter tciSelection-PresentInDCI is not provided/configured and/or is set to disabled. For this case/design example:
   For example, when/if the applied TCI selection field (or the applied second indicator) indicates/provides that the first applicable TCI state(s) is used for PDSCH reception(s), the UE could expect or assume that the TCI state(s) indicated/provided by/in the TCI field is to update the first applicable TCI state(s), e.g., for PDSCH reception(s)—i.e., the UE may not expect or assume that the TCI state(s) indicated/provided by/in the TCI field is to update the second applicable TCI state(s), e.g., for PDSCH reception(s). Or, when/if the TCI state(s) indicated/provided by/in the TCI field is to update the second applicable TCI state(s), the UE may not expect or assume that the TCI state(s) indicated/provided by/in the TCI field is for PDSCH reception(s)—i.e., the TCI state(s) indicated/provided by/in the TCI field could be for other channels/signals than PDSCH(s).
   For another example, when/if the applied TCI selection field (or the applied second indicator) indicates/provides that the second applicable TCI state(s) is used for PDSCH reception(s), the UE could expect or assume that the TCI state(s) indicated/provided by/in the TCI field is to update the second applicable TCI state(s), e.g., for PDSCH reception(s)—i.e., the UE may not expect or assume that the TCI state(s) indicated/provided by/in the TCI field is to update the first applicable TCI state(s), e.g., for PDSCH reception(s). Or, when/if the TCI state(s) indicated/provided by/in the TCI field is to update the first applicable TCI state(s), the UE may not expect or assume that the TCI state(s) indicated/provided by/in the TCI field is for PDSCH reception(s)—i.e., the TCI state(s) indicated/provided by/in the TCI field could be for other channels/signals than PDSCH(s).
   Yet for another example, when/if the applied TCI selection field (or the applied second indicator) indicates/provides that both of the first and the second applicable TCI states are used for PDSCH reception(s), the UE could use/apply the TCI state(s) indicated/provided by/in the TCI field to update the first applicable TCI state(s) and/or the second applicable TCI state(s) as specified herein in the present disclosure to transmit/receive the corresponding UL channels/signals and/or DL channels/signals such as PDSCH(s).

For this design example/case, the UE could keep using/applying the applied TCI selection field (or the applied second indicator) to determine/identify which of the first and/or second applicable TCI state(s)—in this case, updated by the TCI state(s) indicated/provided by/in the TCI field—to use/apply for the PDSCH reception(s).

Throughout the present disclosure, i.e., for all the design examples/procedures specified herein in the present disclosure, a/the UE could be provided/configured with dl-OrJointTCI-StateList and/or ul-TCI-State List. Furthermore, the first MAC CE/the first (unified) TCI state(s) activation/deactivation MAC CE as specified herein in the present disclosure could be equivalent/identical/correspond to the (unified) TCI state(s) activation/deactivation MAC CE for STRP/MTRP operation as specified herein in the present disclosure, and/or vice versa, such that these terms can be used exchangeable throughout the present disclosure (i.e., for one or more of the design examples/procedures specified herein in the present disclosure). Or the first MAC CE/the first (unified) TCI state(s) activation/deactivation MAC CE or the (unified) TCI state(s) activation/deactivation MAC CE for STRP operation or the (unified) TCI state(s) activation/deactivation MAC CE for MTRP operation as specified herein in the present disclosure could correspond to one of:
A (unified) TCI state(s) activation MAC CE command, used to map up to 8 TCI states and/or pairs of TCI states, with each pair comprising of one TCI state for DL channels/signals and/or one TCI state for UL channels/signals, to the codepoints of the DCI field ‘Transmission Configuration Indication’ for one or for a set of CCs/DL BWPs; and/or
A (unified) TCI state(s) activation MAC CE command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs. An activated TCI codepoint in this MAC CE activation command could be composed/comprised of one of:
   Case 1: a first TCI state for DL channel(s)/signal(s);
   Case 2: a first TCI state for DL channel(s)/signal(s) and a second TCI state for DL channel(s)/signal(s):
   Case 3: a first TCI state for DL channel(s)/signal(s) and a second TCI state for UL channel(s)/signal(s);
   Case 4: a first TCI state for DL channel(s)/signal(s) and a pair of a second TCI state for DL channel(s)/signal(s) and a second TCI state for UL channel(s)/signal(s):
   Case 5: a first TCI state for UL channel(s)/signal(s);
   Case 6: a first TCI state for UL channel(s)/signal(s) and a second TCI state for DL channel(s)/signal(s):
   Case 7: a first TCI state for UL channel(s)/signal(s) and a second TCI state for UL channel(s)/signal(s);
   Case 8: a first TCI state for UL channel(s)/signal(s) and a pair of a second TCI state for DL channel(s)/signal(s) and a second TCI state for UL channel(s)/signal(s):
   Case 9: a pair of a first TCI state for DL channel(s)/signal(s) and a first TCI state for UL channel(s)/signal(s);
   Case 10: a pair of a first TCI state for DL channel(s)/signal(s) and a first TCI state for UL channel(s)/signal(s) and a second TCI state for DL channel(s)/signal(s):
   Case 11: a pair of a first TCI state for DL channel(s)/signal(s) and a first TCI state for UL channel(s)/signal(s) and a second TCI state for UL channel(s)/signal(s);
   Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s):
   Case 13: a second TCI state for DL channel(s)/signal(s);
   Case 14: a second TCI state for UL channel(s)/signal(s);
   Case 15: a pair of a second TCI state for DL channel(s)/signal(s) and a second TCI state for UL channel(s)/signal(s);
   Case 16: a first TCI state for DL channel(s)/signal(s) and UL channel(s)/signal(s);
   Case 17: a second TCI state for DL channel(s)/signal(s) and UL channel(s)/signal(s); and/or
   Case 18: a pair of a first TCI state for DL channel(s)/signal(s) and UL channel(s)/signal(s) and a second TCI state for DL channel(s)/signal(s) and UL channel(s)/signal(s).

As specified herein in the present disclosure, when/if the UE is configured by higher layer parameter PDCCH-Config that contains two different values of coresetPoolIndex (e.g., 0 and 1) in ControlResourceSet, the (unified) TCI state(s) activation command as specified herein in the present disclosure could also incorporate/provide/indicate/include/contain a value of coresetPoolIndex (e.g., 0 or 1). For this case, the TCI state(s)/TCI codepoint(s) activated by/in the (unified) TCI state(s) activation command could be specific to the same coresetPoolIndex value (i.e., 0 or 1) provided/indicated therein.

In one embodiment, when the UE (e.g., the UE 116) is configured dl-OrJointTCI-StateList or TCI-UL-State and is having two indicated TCI-States or TCI-UL-States, and if the UE is configured with followUnifiedTCI-StateSRS to, a periodic, semi-persistent or aperiodic SRS resource set with higher layer parameter usage in SRS-ResourceSet set to ‘codebook’. ‘nonCodebook or antennaSwitching’ or to an aperiodic SRS resource set with higher layer parameter usage in SRS-ResourceSet set to ‘beamManagement’:
The UE may be configured by higher layer parameter applyIndicatedICIState to the SRS resource set to indicate whether the UE shall apply the first or the second indicated TCI-State or TCI-UL-State to the SRS resource set. For this case, when a UE is configured by higher layer parameter PDCCH-Config that contains two different values of coresetPoolIndex in ControlResourceSet, the first and second indicated TCI-States or TCI-UL-States correspond to the indicated TCI-States or TCI-UL-States specific to coresetPoolIndex value 0 and value 1, respectively.
When a UE is configured by higher layer parameter PDCCH-Config that contains two different values of coresetPoolIndex in ControlResourceSet, and the aperiodic (or semi-persistent) SRS resource set which is not configured with higher layer parameter applyIndicatedTCIState and the aperiodic (or semi-persistent) SRS resource set is triggered (or activated) by a PDCCH/DCI format on a CORESET associated with a coresetPoolIndex value, the UE shall apply the indicated TCI-State or TCI-UL-State specific to the coresetPoolIndex value to the aperiodic (or semi-persistent) SRS resource set, wherein the CORESET (1) could be provided/configured with follow UnifiedTCI-State, and/or (2) does not correspond to or include a CORESET with index 0 and is associated only with USS sets and/or Type3-PDCCH CSS sets, or (at least) with CSS sets other than Type3-PDCCH CSS sets.
Or, when a UE is configured by higher layer parameter PDCCH-Config that contains two different values of coresetPoolIndex in ControlResourceSet, and the aperiodic (or semi-persistent) SRS resource set which is not configured with higher layer parameter applyIndicatedICIState and the aperiodic (or semi-persistent) SRS resource set is triggered (or activated) by a PDCCH/DCI format on a CORESET associated with a coresetPoolIndex value, the UE shall apply the indicated TCI-State or TCI-UL-State specific to the coresetPoolIndex value to the aperiodic (or semi-persistent) SRS resource set, wherein the CORESET (or the PDCCH/DCI format) could be (1) provided/configured with follow UnifiedTCI-State, and/or (2) (received) on a search space other than Type0/0A/2 CSS on CORESET #0.

In one embodiment, when a UE (e.g., the UE 116) is configured with dl-OrJointTCI-StateList and is having two indicated TCI-states: regardless of the offset between the reception of the scheduling DCI format 1_0/1_1/1_2 and the scheduled/activated PDSCH reception, if the UE is in frequency range 1, or the UE reports its capability of “two default beams for S-DCI based MTRP” in frequency range 2, or if the UE does not report its capability of “two default beams for S-DCI based MTRP” in frequency range 2 and if the scheduling offset between the reception of the scheduling DCI format 1_0/1_1/1_2 and the scheduled/activated PDSCH reception is equal to or larger than timeDurationForQCL, the UE can be configured by higher layer parameter applyIndicatedTCIState to indicate whether the first, the second, or both of the indicated TCI-state(s) is/are applied to PDSCH reception scheduled or activated by DCI format 1_0.
The UE can be configured with applyIndicatedTCIState with value both (only) when the UE is configured with cjtSchemePDSCH and the UE reports “support for two joint TCI states for PDSCH-CJT” or the UE is configured with sfnSchemePdsch. In that case, the UE shall apply both indicated TCI-states to PDSCH reception scheduled or activated by DCI format 1_0 on a search space other than Type0/0A/2 CSS on CORESET #0.
The UE can be configured with applyIndicatedTCIState with value both (only) when the UE is configured with sps-config (or SPS-Config). In that case, the UE shall apply both indicated TCI-states to PDSCH reception scheduled or activated by DCI format 1_0 on a search space other than Type0/0A/2 CSS on CORESET #0.
The UE can be configured with applyIndicatedTCIState with value both (only) when the UE is configured with sps-config (or SPS-Config) and/or having PDSCH(s) scheduled without corresponding PDCCH transmission using SPS-Config and activated by DCI format 1_0. In that case, the UE shall apply both indicated TCI-states to PDSCH reception scheduled or activated by DCI format 1_0—or more specifically, to PDSCH reception without corresponding PDCCH transmission using SPS-Config and activated by DCI format 1_0—on a search space other than Type0/0A/2 CSS on CORESET #0.
The UE can be configured with applyIndicatedTCIState with value both (only) when the UE is configured with sps-config (or SPS-Config) and/or having PDSCH(s)—scheduled without corresponding PDCCH transmission using SPS-Config—with SPS activated by DCI format 1_0. In that case, the UE shall apply both indicated TCI-states to PDSCH reception scheduled or activated by DCI format 1_0—or more specifically, to PDSCH reception (scheduled without corresponding PDCCH transmission using SPS-Config) with SPS activated by DCI format 1_0—on a search space other than Type0/0A/2 CSS on CORESET #0.
The UE can be configured with applyIndicatedTCIState with value both (only) when the UE is configured with sps-config (or SPS-Config) and/or having PDSCH(s) with SPS activated by DCI format 1_0. In that case, the UE shall apply both indicated TCI-states to PDSCH reception scheduled or activated by DCI format 1_0—or more specifically, to PDSCH reception with SPS activated by DCI format 1_0—on a search space other than Type0/0A/2 CSS on CORESET #0.

In one embodiment, when a UE (e.g., the UE 116) is configured with dl-OrJointTCI-StateList or TCI-UL-State and is having two indicated TCI-States or TCI-UL-States, and/or two SRS resource sets are configured in srs-ResourceSetToAddModList or srs-ResourceSetToAddModListDCI-0-2 with higher layer parameter usage in SRS-ResourceSet set to ‘codebook’ or ‘noncodebook’, the UE configured with a PUSCH transmission corresponding to a Type 1 configured grant (e.g., for PUSCH repetition Type A or Type B as described herein in the present disclosure, or for PUSCH transmission when the higher layer parameter multipanelScheme is set to ‘SDMscheme’ or ‘SFNscheme’) is expected to be configured with the higher layer parameter applyIndicatedTCIState indicating the first, the second or both (or both-1 or both-2) of the indicated TCI states to be applied for the PUSCH transmission. If ‘both’ (or ‘both-1’ or ‘both-2’) TCI states are indicated, the UE should apply the first indicated TCI state to the PUSCH transmission occasion(s) or the PUSCH antenna port(s) associated with the first SRS resource set for codebook (CB)/non-codebook (NCB) transmission, and the second indicated TCI state to the PUSCH transmission occasion(s) or the PUSCH antenna port(s) associated with the second SRS resource set for CB/NCB transmission; otherwise, the UE should apply either the ‘first’ or ‘second’ indicated TCI state to all PUSCH transmission occasions. More specifically, when two SRS resource sets are configured in srs-ResourceSetToAddModList or srs-ResourceSetToAddModListDCI-0-2 with higher layer parameter usage in SRS-ResourceSet set to ‘codebook’ or ‘noncodebook’, for PUSCH repetition Type A, in case K>1, the same symbol allocation is applied across the K consecutive slots and the PUSCH is limited to a single transmission layer. The UE shall repeat the transport block (TB) across the K consecutive slots applying the same symbol allocation in each slot, and the association of the first and second SRS resource set in srs-ResourceSetToAddModList or srs-Resource SetToAddModListDCI-0-2 to each slot is determined as follows:
If a DCI format 0_1 or DCI format 0_2 indicates codepoint “00” for the SRS resource set indicator and/or the higher layer parameter applyIndicatedTCIState as specified/described herein indicates the first of the indicated TCI states to be applied for the PUSCH transmission, the first SRS resource set is associated with all K consecutive slots.
If a DCI format 0_1 or DCI format 0_2 indicates codepoint “01” for the SRS resource set indicator and/or the higher layer parameter applyIndicatedTCIState as specified/described herein indicates the second of the indicated TCI states to be applied for the PUSCH transmission, the second SRS resource set is associated with all K consecutive slots.
If a DCI format 0_1 or DCI format 0_2 indicates codepoint “10” for the SRS resource set indicator and/or the higher layer parameter applyIndicatedTCIState as specified/described herein indicates the both (or both-1) of the indicated TCI states to be applied for the PUSCH transmission, the first and second SRS resource set association to K consecutive slots is determined as follows:
   When K=2, the first and second SRS resource sets are applied to the first and second slot of 2 consecutive slots, respectively.
   When K>2 and cyclicMapping in PUSCH-Config is enabled, the first and second SRS resource sets are applied to the first and second slot of K consecutive slots, respectively, and the same SRS resource set mapping pattern continues to the remaining slots of K consecutive slots.
   When K>2 and sequentialMapping in PUSCH-Config is enabled, first SRS resource set is applied to the first and second slots of K consecutive slots, and the second SRS resource set is applied to the third and fourth slot of K consecutive slots, and the same SRS resource set mapping pattern continues to the remaining slots of K consecutive slots.
Otherwise, a DCI format 0_1 or DCI format 0_2 indicates codepoint “11” for the SRS resource set indicator and/or the higher layer parameter applyIndicatedTCIState as specified/described herein indicates the both (or both-2) of the indicated TCI states to be applied for the PUSCH transmission, and the first and second SRS resource set association to K consecutive slots is determined as follows,
   When K=2, the second and first SRS resource set are applied to the first and second slot of 2 consecutive slots, respectively.
   When K>2 and cyclicMapping in PUSCH-Config is enabled, the second and first SRS resource sets are applied to the first and second slot of K consecutive slots, respectively, and the same SRS resource set mapping pattern continues to the remaining slots of the K consecutive slots.
   When K>2 and sequentialMapping in PUSCH-Config is enabled, the second SRS resource set is applied to the first and second slot of K consecutive slots, and the first SRS resource set is applied to the third and fourth slot of K consecutive slots, and the same SRS resource set mapping pattern continues to the remaining slots of the K consecutive slots.

For PUSCH repetition Type B, when two SRS resource sets are configured in srs-ResourceSetToAddModList or srs-ResourceSetToAddModListDCI-0-2 with higher layer parameter usage in SRS-ResourceSet set to ‘codebook’ or ‘noncodebook’, the SRS resource set association to nominal PUSCH repetitions follows the same method as SRS resource set association to slots in PUSCH Type A repetition by evaluating nominal repetitions instead of slots. Furthermore, throughout the present disclosure, the higher layer parameter applyIndicatedICIState indicating the first is equivalent to applyIndicatedTCIState=‘first’, the higher layer parameter applyIndicatedTCIstate indicating the second is equivalent to applyIndicatedTOIState=‘second, the higher layer parameter applyIndicatedTCIstate indicating the both is equivalent to applyIndicatedICIState=‘both’, the higher layer parameter applyIndicatedTCIstate indicating the both-1 is equivalent to applyIndicatedTCIState=‘both-1’, and the higher layer parameter applyIndicatedTCIstate indicating the both-2 is equivalent to applyIndicatedTCIState=‘both-2’.

In one embodiment, when a UE (e.g., the UE 116) is configured with dl-OrJointTCI-StateList and is having two indicated TCI states and if the offset between the last symbol of the PDCCH carrying the triggering DCI and the first symbol of the aperiodic CSI-RS resources in the aperiodic CSI-RS resource set is smaller than a threshold:
If there is no DL signal in the same symbols as the aperiodic CSI-RS:
   If the higher layer configuration(s) that indicates the first or the second indicated joint/DL TCI state to apply (or to be applied) to the aperiodic CSI-RS or to the aperiodic CSI-RS resource set is provided to the aperiodic CSI-RS resource or to the aperiodic CSI-RS resource set
      If the UE is in frequency range 1, or the UE reports its capability of “two default beams for S-DCI based MTRP” in frequency range 2, the UE could or shall apply the first or the second indicated joint/DL TCI state to the aperiodic CSI-RS or to the aperiodic CSI-RS resource set according to the higher layer configuration(s) provided to the aperiodic CSI-RS resource or to the aperiodic CSI-RS resource set.
      otherwise, the UE could or shall apply the first indicated join/DL TCI state to the aperiodic CSI-RS or to the aperiodic CSI-RS resource set.
   If the higher layer configuration(s) that indicates the first or the second indicated joint/DL TCI state to apply (or to be applied) to the aperiodic CSI-RS or to the aperiodic CSI-RS resource set is not provided to the aperiodic CSI-RS resource or to the aperiodic CSI-RS resource set
      If the UE is in frequency range 1, or the UE reports its capability of “two default beams for S-DCI based MTRP” in frequency range 2, the UE could or shall apply the first indicated joint/DL TCI state to the aperiodic CSI-RS or to the aperiodic CSI-RS resources set.
      Otherwise, the UE could or shall apply the first indicated joint/DL TCI state to the aperiodic CSI-RS or to the aperiodic CSI-RS resource set.
Else, if there is any other DL signal with an indicated TCI state in the same symbols as the CSI-RS, the UE applies the QCL assumption of the other DL signal also when receiving the aperiodic CSI-RS. The other DL signal refers to PDSCH scheduled with offset larger than or equal to the threshold timeDurationForQCL, as defined in [13, TS 38.306], periodic CSI-RS, semi-persistent CSI-RS, aperiodic CSI-RS in a NZP-CSI-RS-ResourceSet scheduled with offset larger than or equal to the UE reported threshold beamSwitchTiming when the reported value is one of the values {14,28,48}·2max (0,μCSIRS-3) and when enableBeamSwitchTiming is not provided or the NZP-CSI-RS-Resource Set is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info scheduled with offset larger than or equal to 48·2 max (0,μCSIRS-3) when the UE provides beamSwitchTiming-r16 and enableBeamSwitchTiming is provided, aperiodic CSI-RS in a NZP-CSI-RS-ResourceSet configured with the higher layer parameter repetition set to ‘on’ scheduled with offset larger than or equal to the UE reported threshold beamSwitchTiming-r16 and enable BeamSwitchTiming is provided. If there is a PDSCH applying two indicated joint/DL TCI states in the same symbols as the AP CSI-RS:
   In one example, the UE could or shall apply the first or the second indicated joint/DL TCI state to the AP CSI-RS or to the AP CSI-RS resource set according to the higher layer configuration(s) provided to the AP CSI-RS resource or to the aperiodic CSI-RS resource set.
   In another example, if the higher layer configuration(s) that indicates the first or the second indicated joint/DL TCI state to apply (or to be applied) to the aperiodic CSI-RS or to the aperiodic CSI-RS resource set is provided to the aperiodic CSI-RS resource or to the aperiodic CSI-RS resource set
      if the UE is in frequency range 1, or the UE reports its capability of “two default beams for S-DCI based MTRP” in frequency range 2, the UE could or shall apply the first or the second indicated joint/DL TCI state to the aperiodic CSI-RS or to the aperiodic CSI-RS resource set according to the higher layer configuration(s) provided to the aperiodic CSI-RS resource or to the aperiodic CSI-RS resource set.
      Otherwise, the UE could or shall apply the first indicated join/DL TCI state—or equivalently, the first indicated joint/DL TCI state among the two indicated joint/DL TCI states applied to the PDSCH—to the aperiodic CSI-RS or to the aperiodic CSI-RS resource set.
   In another example, if the higher layer configuration(s) that indicates the first or the second indicated joint/DL TCI state to apply (or to be applied) to the aperiodic CSI-RS or to the aperiodic CSI-RS resource set is not provided to the aperiodic CSI-RS resource or to the aperiodic CSI-RS resource set:
      If the UE is in frequency range 1, or the UE reports its capability of “two default beams for S-DCI based MTRP” in frequency range 2, the UE could or shall apply the first indicated joint/DL TCI state—or equivalently, the first indicated joint/DL TCI state among the two indicated joint/DL TCI states applied to the PDSCH—to the aperiodic CSI-RS or to the aperiodic CSI-RS resource set.
      Otherwise, the UE could or shall apply the first indicated joint/DL TCI state—or equivalently, the first indicated joint/DL TCI state among the two indicated joint/DL TCI states applied to the PDSCH—to the aperiodic CSI-RS or to the aperiodic CSI-RS resource set.

In one embodiment, when a UE (e.g., the UE 116) is configured with dl-OrJointTCI-StateList, is configured by higher layer parameter PDC CH-Config that contains two different values of coresetPoolIndex in different ControlResourceSets, is having two indicated TCI states and if the offset between the last symbol of the PDCCH carrying the triggering DCI and the first symbol of the aperiodic CSI-RS resources in the aperiodic CSI-RS resource set is smaller than a threshold:
If there is no DL signal in the same symbols as the aperiodic CSI-RS.
   If the higher layer configuration(s) that indicates the first or the second indicated joint/DL TCI state to apply (or to be applied) to the aperiodic CSI-RS or to the aperiodic CSI-RS resource set is provided to the aperiodic CSI-RS resource or to the aperiodic CSI-RS resource set
      If the UE is in frequency range 1, or the UE reports its capability of “default beam per coresetPoolIndex for M-DCI based MTRP” in frequency range 2, or the UE is configured with enableDefaultTCI-StatePerCoresetPoolIndex, the UE could or shall apply the first or the second indicated joint/DL TCI state to the aperiodic CSI-RS or to the aperiodic CSI-RS resource set according to the higher layer configuration(s) provided to the aperiodic CSI-RS resource or to the aperiodic CSI-RS resource set.
      Otherwise, the UE could or shall apply the indicated joint/DL TCI state specific to coresetPoolIndex value 0 to the aperiodic CSI-RS or to the aperiodic CSI-RS resource set; optionally, the UE could or shall apply the indicated TCI-State specific to the same coresetPoolIndex value as the PDCCH triggering the aperiodic CSI-RS to the aperiodic CSI-RS or to the aperiodic CSI-RS resource set, wherein the CORESET (1) could be provided/configured with follow UnifiedTCI-State, and/or (2) does not correspond to or include a CORESET with index 0 and is associated only with USS sets and/or Type3-PDCCH common search space (CSS) sets, or (at least) with CSS sets other than Type3-PDCCH CSS sets.
   If the higher layer configuration(s) that indicates the first or the second indicated joint/DL TCI state to apply (or to be applied) to the aperiodic CSI-RS or to the aperiodic CSI-RS resource set is not provided to the aperiodic CSI-RS resource or to the aperiodic CSI-RS resource set
      If the UE is in frequency range 1, or the UE reports its capability of “default beam per coresetPoolIndex for M-DCI based MTRP” in frequency range 2, or the UE is configured with enableDefaultTCI-StatePerCoresetPoolIndex, the UE could or shall apply the indicated joint/DL TCI state specific to coresetPoolIndex value 0 to the aperiodic CSI-RS or to the aperiodic CSI-RS resource set: optionally, the UE could or shall apply the indicated TCI-State specific to the same coresetPoolIndex value as the PDCCH triggering the aperiodic CSI-RS to the aperiodic CSI-RS or to the aperiodic CSI-RS resource set, wherein the CORESET (1) could be provided/configured with follow UnifiedTCI-State, and/or (2) does not correspond to or include a CORESET with index 0 and is associated only with USS sets and/or Type3-PDCCH CSS sets, or (at least) with CSS sets other than Type3-PDCCH CSS sets.
      Otherwise, the UE could or shall apply the indicated joint/DL TCI state specific to coresetPoolIndex value 0 to the aperiodic CSI-RS or to the aperiodic CSI-RS resource set; optionally, the UE could or shall apply the indicated TCI-State specific to the same coresetPoolIndex value as the PDCCH triggering the aperiodic CSI-RS to the aperiodic CSI-RS or to the aperiodic CSI-RS resource set, wherein the CORESET (1) could be provided/configured with follow UnifiedTCI-State, and/or (2) does not correspond to or include a CORESET with index 0 and is associated only with USS sets and/or Type3-PDCCH CSS sets, or (at least) with CSS sets other than Type3-PDCCH CSS sets.
Else if there is any other DL signal with an indicated TCI state in the same symbols as the CSI-RS.
   If the UE is in frequency range 1, or the UE reports its capability of “default beam per coresetPoolIndex for M-DCI based MTRP” in frequency range 2, or the UE is configured with enableDefaultTCI-StatePerCoresetPoolIndex.
      In one example, the UE could apply the QCL assumption of the other DL signalling also when receiving the aperiodic CSI-RS. For this case, the other DL signal refers to PDSCH scheduled by a PDCCH associated with the same coresetPoolIndex as the PDCCH triggering the aperiodic CSI-RS and scheduled with offset larger than or equal to the threshold timeDurationForQCL, as defined in [13, TS 38.306], aperiodic CSI-RS triggered by a PDCCH associated with the same coresetPoolIndex as the PDCCH triggering the aperiodic CSI-RS and scheduled with offset larger than or equal to the UE reported threshold beamSwitchTiming when the reported value is one of the values {14,28,48}·2^{max(0,μ}^{_{CSIRS}}⁻³⁾ and enable BeamSwitchTiming is not provided, aperiodic CSI-RS triggered by a PDCCH associated with the same coresetPoolIndex as the PDCCH triggering the aperiodic CSI-RS and scheduled with offset larger than or equal to 48·2^{max(0,μ}^{_{CSIRS}}⁻³⁾ when the reported value of beamSwitchTiming-r16 is one of the values {224, 336}·2^{max(0,μ}^{_{CSIRS}}⁻³⁾ and enableBeamSwitchTiming is provided, periodic CSI-RS, semi-persistent CSI-RS. Optionally, e.g., based on a corresponding UE's capability or capability signaling and/or network's configuration(s)/indication(s) via higher layer RRC signaling(s)/parameter(s) and/or MAC CE command(s) and/or dynamic DCI based L1 signaling(s), for example, if there are two PDSCHs—e.g., associated with two different values 0 and 1 of coresetPoolIndex (e.g., a first PDSCH scheduled by a PDCCH associated with value 0 of coresetPoolIndex and a second PDSCH scheduled by a PDCCH associated with value 1 of coresetPoolIndex) respectively applying two indicated joint/DL TCI states (e.g., a/the first indicated joint/DL TCI state specific to value 0 of coresetPoolIndex and a/the second indicated joint/DL TCI state specific to value 1 of coresetPoolIndex), in the same symbols as the AP CSI-RS:
         In one example, the UE could or shall apply the first or the second indicated joint/DL TCI state to the AP CSI-RS or to the AP CSI-RS resource set according to the higher layer configuration(s) provided to the AP CSI-RS resource or to the aperiodic CSI-RS resource set.
         In another example, the UE could or shall apply the QCL assumption of the other DL signal(s)—according to those specified herein in the present disclosure—also when receiving the aperiodic CSI-RS.
         In another example, if the higher layer configuration(s) that indicates the first or the second indicated joint/DL TCI state to apply (or to be applied) to the aperiodic CSI-RS or to the aperiodic CSI-RS resource set is provided to the aperiodic CSI-RS resource or to the aperiodic CSI-RS resource set,
         if the UE is in frequency range 1, or the UE reports its capability of “default beam per coresetPoolIndex for M-DCI based MTRP” in frequency range 2, or the UE is configured with enableDefaultTCI-StatePerCoresetPoolIndex, the UE could or shall apply the first or the second indicated joint/DL TCI state to the aperiodic CSI-RS or to the aperiodic CSI-RS resource set according to the higher layer configuration(s) provided to the aperiodic CSI-RS resource or to the aperiodic CSI-RS resource set,
         Otherwise, the UE could or shall apply the indicated joint/DL TCI state specific to coresetPoolIndex value 0 to the aperiodic CSI-RS or to the aperiodic CSI-RS resource set: optionally, the UE could or shall apply the indicated TCI-State specific to the same coresetPoolIndex value as the PDCCH triggering the aperiodic CSI-RS to the aperiodic CSI-RS or to the aperiodic CSI-RS resource set, wherein the CORESET (1) could be provided/configured with follow UnifiedTCI-State, and/or (2) does not correspond to or include a CORESET with index 0 and is associated only with USS sets and/or Type3-PDCCH CSS sets, or (at least) with CSS sets other than Type3-PDCCH CSS sets.
         In another example, if the higher layer configuration(s) that indicates the first or the second indicated joint/DL TCI state to apply (or to be applied) to the aperiodic CSI-RS or to the aperiodic CSI-RS resource set is not provided to the aperiodic CSI-RS resource or to the aperiodic CSI-RS resource set.
         If the UE is in frequency range 1, or the UE reports its capability of “default beam per coresetPoolIndex for M-DCI based MTRP” in frequency range 2, or the UE is configured with enableDefaultTCI-StatePerCoresetPoolIndex, the UE could or shall apply the indicated joint/DL TCI state specific to coresetPoolIndex value 0 to the aperiodic CSI-RS or to the aperiodic CSI-RS resource set: optionally, the UE could or shall apply the indicated TCI-State specific to the same coresetPoolIndex value as the PDCCH triggering the aperiodic CSI-RS to the aperiodic CSI-RS or to the aperiodic CSI-RS resource set, wherein the CORESET (1) could be provided/configured with followUnifiedTCI-State, and/or (2) does not correspond to or include a CORESET with index 0 and is associated only with USS sets and/or Type3-PDCCH CSS sets, or (at least) with CSS sets other than Type3-PDCCH CSS sets.
         Otherwise, the UE could or shall apply the indicated joint/DL TCI state specific to coresetPoolIndex value 0 to the aperiodic CSI-RS or to the aperiodic CSI-RS resource set: optionally, the UE could or shall apply the indicated TCI-State specific to the same coresetPoolIndex value as the PDCCH triggering the aperiodic CSI-RS to the aperiodic CSI-RS or to the aperiodic CSI-RS resource set, wherein the CORESET (1) could be provided/configured with follow UnifiedTCI-State, and/or (2) does not correspond to or include a CORESET with index 0 and is associated only with USS sets and/or Type3-PDCCH CSS sets, or (at least) with CSS sets other than Type3-PDCCH CSS sets.
      In another example, optionally, e.g., based on a corresponding UE's capability or capability signaling and/or network's configuration(s)/indication(s) via higher layer RRC signaling(s)/parameter(s) and/or MAC CE command(s) and/or dynamic DCI based L1 signaling(s), the UE could apply the QCL assumption of the other DL signal also when receiving the aperiodic CSI-RS, wherein the other DL signal refers to PDSCH(s) scheduled with offset larger than or equal to the threshold timeDurationForQCL, as defined in [13, TS 38.306], periodic CSI-RS, semi-persistent CSI-RS, aperiodic CSI-RS in a NZP-CSI-RS-ResourceSet scheduled with offset larger than or equal to the UE reported threshold beamSwitchTiming when the reported value is one of the values {14,28,48}·2max(0,μCSIRS-3) and when enableBeamSwitchTiming is not provided or the NZP-CSI-RS-ResourceSet is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info scheduled with offset larger than or equal to 48·2max(0,μCSIRS-3) when the UE provides beamSwitchTiming-r16 and enableBeamSwitchTiming is provided. Aperiodic CSI-RS in a NZP-CSI-RS-Resource Set configured with the higher layer parameter repetition set to ‘on’ scheduled with offset larger than or equal to the UE reported threshold beamSwitchTiming-r16 and enableBeamSwitchTiming is provided. If there are two PDSCHs—e.g., associated with two different values 0 and 1 of coresetPoolIndex (e.g., a first PDSCH scheduled by a PDCCH associated with value 0 of coresetPoolIndex and a second PDSCH scheduled by a PDCCH associated with value 1 of coresetPoolIndex) respectively applying two indicated joint/DL TCI states (e.g., a/the first indicated joint/DL TCI state specific to value 0 of coresetPoolIndex and a/the second indicated joint/DL TCI state specific to value 1 of coresetPoolIndex), in the same symbols as the AP CSI-RS:
         In one example, the UE could or shall apply the first or the second indicated joint/DL TCI state to the AP CSI-RS or to the AP CSI-RS resource set according to the higher layer configuration(s) provided to the AP CSI-RS resource or to the aperiodic CSI-RS resource set.
         In another example, if the higher layer configuration(s) that indicates the first or the second indicated joint/DL TCI state to apply (or to be applied) to the aperiodic CSI-RS or to the aperiodic CSI-RS resource set is provided to the aperiodic CSI-RS resource or to the aperiodic CSI-RS resource set.
         If the UE is in frequency range 1, or the UE reports its capability of “default beam per coresetPoolIndex for M-DCI based MTRP” in frequency range 2, or the UE is configured with enableDefaultTCI-StatePerCoresetPoolIndex, the UE could or shall apply the first or the second indicated joint/DL TCI state to the aperiodic CSI-RS or to the aperiodic CSI-RS resource set according to the higher layer configuration(s) provided to the aperiodic CSI-RS resource or to the aperiodic CSI-RS resource set.
         Otherwise, the UE could or shall apply the indicated joint/DL TCI state specific to coresetPoolIndex value 0 to the aperiodic CSI-RS or to the aperiodic CSI-RS resource set: optionally, the UE could or shall apply the indicated TCI-State specific to the same coresetPoolIndex value as the PDCCH triggering the aperiodic CSI-RS to the aperiodic CSI-RS or to the aperiodic CSI-RS resource set, wherein the CORESET (1) could be provided/configured with followUnifiedTCI-State, and/or (2) does not correspond to or include a CORESET with index 0 and is associated only with USS sets and/or Type3-PDCCH CSS sets, or (at least) with CSS sets other than Type3-PDCCH CSS sets.
         In another example, if the higher layer configuration(s) that indicates the first or the second indicated joint/DL TCI state to apply (or to be applied) to the aperiodic CSI-RS or to the aperiodic CSI-RS resource set is not provided to the aperiodic CSI-RS resource or to the aperiodic CSI-RS resource set:
         If the UE is in frequency range 1, or the UE reports its capability of “default beam per coresetPoolIndex for M-DCI based MTRP” in frequency range 2, or the UE is configured with enableDefaultTCI-StatePerCoresetPoolIndex, the UE could or shall apply the indicated joint/DL TCI state specific to coresetPoolIndex value 0 to the aperiodic CSI-RS or to the aperiodic CSI-RS resource set: optionally, the UE could or shall apply the indicated TCI-State specific to the same coresetPoolIndex value as the PDCCH triggering the aperiodic CSI-RS to the aperiodic CSI-RS or to the aperiodic CSI-RS resource set, wherein the CORESET (1) could be provided/configured with followUnifiedTCI-State, and/or (2) does not correspond to or include a CORESET with index 0 and is associated only with USS sets and/or Type3-PDCCH CSS sets, or (at least) with CSS sets other than Type3-PDCCH CSS sets.
         Otherwise, the UE could or shall apply the indicated joint/DL TCI state specific to coresetPoolIndex value 0 to the aperiodic CSI-RS or to the aperiodic CSI-RS resource set: optionally, the UE could or shall apply the indicated TCI-State specific to the same coresetPoolIndex value as the PDCCH triggering the aperiodic CSI-RS to the aperiodic CSI-RS or to the aperiodic CSI-RS resource set, wherein the CORESET (1) could be provided/configured with followUnifiedTCI-State, and/or (2) does not correspond to or include a CORESET with index 0 and is associated only with USS sets and/or Type3-PDCCH CSS sets, or (at least) with CSS sets other than Type3-PDCCH CSS sets.
   Otherwise, the UE could apply the QCL assumption of the other DL signal also when receiving the aperiodic CSI-RS. The other DL signal refers to PDSCH(s) scheduled with offset larger than or equal to the threshold timeDurationForQCL, as defined in [13, TS 38.306], periodic CSI-RS, semi-persistent CSI-RS, aperiodic CSI-RS in a NZP-CSI-RS-ResourceSet scheduled with offset larger than or equal to the UE reported threshold beamSwitchTiming when the reported value is one of the values {14,28,48}·2max(0,μCSIRS-3) and when enableBeamSwitchTiming is not provided or the NZP-CSI-RS-Resource Set is configured with the higher layer parameter trs-Info, aperiodic CSI-RS in a NZP-CSI-RS-Resource Set configured with the higher layer parameter repetition set to ‘off’ or configured without the higher layer parameters repetition and trs-Info scheduled with offset larger than or equal to 48·2max(0,μCSIRS-3) when the UE provides beamSwitchTiming-r16 and enable BeamSwitchTiming is provided. Aperiodic CSI-RS in a NZP-CSI-RS-ResourceSet configured with the higher layer parameter repetition set to ‘on’ scheduled with offset larger than or equal to the UE reported threshold beamSwitchTiming-r16 and enableBeamSwitchTiming is provided. If there are two PDSCHs—e.g., associated with two different values 0 and 1 of coresetPoolIndex (e.g., a first PDSCH scheduled by a PDCCH associated with value 0 of coresetPoolIndex and a second PDSCH scheduled by a PDCCH associated with value 1 of coresetPoolIndex) respectively applying two indicated joint/DL TCI states (e.g., a/the first indicated joint/DL TCI state specific to value 0 of coresetPoolIndex and a/the second indicated joint/DL TCI state specific to value 1 of coresetPoolIndex), in the same symbols as the AP CSI-RS:
      In one example, the UE could or shall apply the first or the second indicated joint/DL TCI state to the AP CSI-RS or to the AP CSI-RS resource set according to the higher layer configuration(s) provided to the AP CSI-RS resource or to the aperiodic CSI-RS resource set.
      In another example, if the higher layer configuration(s) that indicates the first or the second indicated joint/DL TCI state to apply (or to be applied) to the aperiodic CSI-RS or to the aperiodic CSI-RS resource set is provided to the aperiodic CSI-RS resource or to the aperiodic CSI-RS resource set:
         If the UE is in frequency range 1, or the UE reports its capability of “default beam per coresetPoolIndex for M-DCI based MTRP” in frequency range 2, or the UE is configured with enableDefaultTCI-StatePerCoresetPoolIndex, the UE could or shall apply the first or the second indicated joint/DL TCI state to the aperiodic CSI-RS or to the aperiodic CSI-RS resource set according to the higher layer configuration(s) provided to the aperiodic CSI-RS resource or to the aperiodic CSI-RS resource set.
         Otherwise, the UE could or shall apply the indicated joint/DL TCI state specific to coresetPoolIndex value 0 to the aperiodic CSI-RS or to the aperiodic CSI-RS resource set: optionally, the UE could or shall apply the indicated TCI-State specific to the same coresetPoolIndex value as the PDCCH triggering the aperiodic CSI-RS to the aperiodic CSI-RS or to the aperiodic CSI-RS resource set, wherein the CORESET (1) could be provided/configured with follow UnifiedTCI-State, and/or (2) does not correspond to or include a CORESET with index 0 and is associated only with USS sets and/or Type3-PDCCH CSS sets, or (at least) with CSS sets other than Type3-PDCCH CSS sets.
      In another example, if the higher layer configuration(s) that indicates the first or the second indicated joint/DL TCI state to apply (or to be applied) to the aperiodic CSI-RS or to the aperiodic CSI-RS resource set is not provided to the aperiodic CSI-RS resource or to the aperiodic CSI-RS resource set:
         If the UE is in frequency range 1, or the UE reports its capability of “default beam per coresetPoolIndex for M-DCI based MTRP” in frequency range 2, or the UE is configured with enableDefaultTCI-StatePerCoresetPoolIndex, the UE could or shall apply the indicated joint/DL TCI state specific to coresetPoolIndex value 0 to the aperiodic CSI-RS or to the aperiodic CSI-RS resource set: optionally, the UE could or shall apply the indicated TCI-State specific to the same coresetPoolIndex value as the PDCCH triggering the aperiodic CSI-RS to the aperiodic CSI-RS or to the aperiodic CSI-RS resource set, wherein the CORESET (1) could be provided/configured with followUnifiedTCI-State, and/or (2) does not correspond to or include a CORESET with index 0 and is associated only with USS sets and/or Type3-PDCCH CSS sets, or (at least) with CSS sets other than Type3-PDCCH CSS sets.
         Otherwise, the UE could or shall apply the indicated joint/DL TCI state specific to coresetPoolIndex value 0 to the aperiodic CSI-RS or to the aperiodic CSI-RS resource set: optionally, the UE could or shall apply the indicated TCI-State specific to the same coresetPoolIndex value as the PDCCH triggering the aperiodic CSI-RS to the aperiodic CSI-RS or to the aperiodic CSI-RS resource set, wherein the CORESET (1) could be provided/configured with follow UnifiedTCI-State, and/or (2) does not correspond to or include a CORESET with index 0 and is associated only with USS sets and/or Type3-PDCCH CSS sets, or (at least) with CSS sets other than Type3-PDCCH CSS sets.

Throughout the present disclosure, a CSI-RS resource set is equivalent to a CSI resource set. Furthermore, throughout the present disclosure, when a UE is configured with dl-OrJointTCI-StateList, is configured by higher layer parameter PIC CH-Config that contains two different values of coresetPoolIndex in different ControlResourceSets, is having two indicated TCI states:
a/the first indicated joint/DL/UL TCI state could be or could correspond to a/the indicated joint/DL/UL TCI state specific to value 0 of coresetPoolIndex, and a/the second indicated joint/DL/UL TCI state could be or could correspond a/the indicated joint/DL/UL TCI state specific to value 1 of coresetPoolIndex.
a PDCCH could be received on a CORESET associated with a coresetPoolIndex value and provided follow UnifiedTCI-State, that does not include a CORESET with index 0 and are associated only with USS sets and/or Type3-PDCCH CSS sets, or with CSS sets other than Type3-PDCCH CSS sets.

In one embodiment, a UE (e.g., the UE 116) could determine the PUSCH for uplink control information (UCI) multiplexing by applying the following procedure on the candidate PUSCHs:
If the UE is provided enableSTx2PofmDCI, is provided ackNackFeedbackMode=separate, is configured with dl-OrJointTCI-StateList or TCI-UL-State, is configured by higher layer parameter PDCCH-Config that contains two different values of coresetPoolIndex in different ControlResourceSets, is having two indicated TCI-States or TCI-UL-States and would multiplex UCI that includes HARQ-ACK information in a PUSCH, candidate PUSCHs for the UCI multiplexing are the ones associated with same coresetPoolIndex value as for a PUCCH transmission with the HARQ-ACK information, and/or candidate PUSCHs for the UCI multiplexing are the ones applying the indicated joint/UL TCI state(s) specific to same coresetPoolIndex value as that specific to the indicated joint/UL TCI state(s) applied for a PUCCH transmission with the HARQ-ACK information, and/or candidate PUSCHs for the UCI multiplexing are the ones the UE would transmit with spatial domain filter(s) corresponding to the indicated joint/UL TCI state(s) specific to same coresetPoolIndex value as that specific to the indicated joint/UL TCI state(s) used for determining spatial domain filter(s) for transmitting a PUCCH transmission with the HARQ-ACK information.
If the candidate PUSCHs that include first PUSCHs that are scheduled by DCI formats and second PUSCHs configured by respective ConfiguredGrantConfig or semiPersistentOnPUSCH, and the UE would multiplex UCI in one of the candidate PUSCHs, and the candidate PUSCHs fulfil the conditions in clause 9.2.5 in the TS 38.213 [REF3] for UCI multiplexing, the UE multiplexes the UCI in a PUSCH from the first PUSCHs.
If the UE would multiplex UCI in one of the candidate PUSCHs and the UE does not multiplex aperiodic CSI in any of the candidate PUSCHs, the UE multiplexes the UCI in a PUSCH of the serving cell with the smallest ServCellIndex subject to the conditions in clause 9.2.5 in the TS 38.213 [REF3] for UCI multiplexing being fulfilled. If the UE transmits more than one PUSCHs in the slot on the serving cell with the smallest ServCellIndex that fulfil the conditions in clause 9.2.5 in the TS 38.213 [REF3] for UCI multiplexing, the UE multiplexes the UCI in the earliest PUSCH that the UE transmits in the slot. If the UE is provided enableSTx2PofmDCI, is provided ackNackFeedbackMode=joint, is configured with dl-OrJointTCI-StateList or TCI-UL-State, is configured by higher layer parameter PDCCH-Config that contains two different values of coresetPoolIndex in different ControlResourceSets, is having two indicated TCI-States or TCI-UL-States or the UCI does not include HARQ-ACK information, and the UE would transmit two PUSCHs in the slot that start at a same symbol on the serving cell with smallest ServCellIndex and fulfil the conditions in clause 9.2.5 in the TS 38.213 [REF3] for UCI multiplexing, the UE multiplexes the UCI in the PUSCH from the two PUSCHs associated with CORESETs that the UE is not provided coresetPoolIndex or is provided coresetPoolIndex with a value of 0, and/or the UE multiplexes the UCI in the PUSCH from the two PUSCHs applying the indicated joint/UL TCI state(s) specific to coresetPoolIndex with a value of 0 or not specific to any coresetPoolIndex (e.g., not provided), and/or the UE multiplexes the UCI in the PUSCH from the two PUSCHs the UE would transmit with spatial domain filter(s) corresponding to the indicated joint/UL TCI state(s) specific to coresetPoolIndex with a value of 0 or not specific to any coresetPoolIndex (e.g., not provided), wherein a PUCCH transmission with the UCI (for multiplexing) could be associated with CORESETs that the UE is not provided coresetPoolIndex or is provided coresetPoolIndex with a value of 0, and/or a PUCCH transmission with the UCI (for multiplexing) could apply the indicated joint/UL TCI state(s) specific to coresetPoolIndex with a value of 0 or not specific to any coresetPoolIndex (e.g., not provided), and/or a PUCCH with the UCI (for multiplexing) the UE would transmit with spatial domain filter(s) corresponding to the indicated joint/UL TCI state(s) specific to coresetPoolIndex with a value of 0 or not specific to any coresetPoolIndex (e.g., not provided).

In one embodiment (e.g., the UE 116), when a UE configured with dl-OrJointTCI-StateList would transmit a PUCCH with positive HARQ-ACK or a PUSCH with positive HARQ-ACK corresponding to the DCI carrying the TCI State indication and without DL assignment, or corresponding to the PDSCH scheduled by the DCI carrying the TCI State indication, and if the indicated TCI State(s) is/are different from the previously indicated one(s), the indicated TCI-State(s) and/or TCI-UL-State(s) should be applied starting from the first slot that is at least beamAppTime symbols after the last symbol of the PUCCH or the PUSCH, and if the UE receives more than one indicated TCI state for a CC/BWP to be applied starting from the first slot that is at least beamAppTime symbols after the last symbol of the PUCCH or the PUSCH, the indicated TCI state carried in the latest DCI in time corresponding to positive HARQ-ACK value is applied.
If a UE receives a TCI codepoint activated from/in a first MAC CE and mapped with/to a sub-set (e.g., one or two) of the two TCI-States, the UE could keep previously indicated TCI-State(s) that is not updated by the received TCI codepoint, wherein the first MAC CE could correspond to an enhanced unified TCI states activation/deactivation MAC CE for joint TCI states, wherein each of the TCI codepoints provided/indicated/activated in/by the first MAC CE could be mapped to one or two joint TCI states each provided by TCI-State.
If a UE receives a TCI codepoint activated from/in a second MAC CE and mapped with/to a sub-set (e.g., one, two, three or four) of the two TCI-States and two TCI-UL-States, the UE could keep previously indicated TCI-State(s) and/or TCI-UL-State(s) that is not updated by the received TCI codepoint, wherein the second MAC CE could correspond to an enhanced unified TCI states activation/deactivation MAC CE for separate TCI states, wherein each of the TCI codepoints provided/indicated/activated in/by the second MAC CE could be mapped to up to two separate DL TCI states each provided by TCI-State, and/or up to two separate UL TCI states each provided by TCI-UL-State.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a PDSCH. As described in the 3GPP Rel-17.
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH.
   For example, a DL related DCI (e.g., DCI format 1_0. DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0. DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

In a single-TRP system, a UE could be indicated/provided/configured by the network (e.g., the network 130), e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or all of dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

In a (single-DCI based) multi-TRP system, a UE could be indicated/provided/configured by the network (e.g., the network 130), e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states for at least UE-dedicated reception on PDSCH/PDCCH or dynamic-grant/configured-grant based PUSCH or all of dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network (e.g., the network 130) via higher layer RRC signaling/parameter and/or MAC CE command and/or dynamic DCI based L1 signaling—e.g., in higher layer RRC signaling/parameter ControlResourceSet that configures a CORESET-a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET. ‘01’ indicates that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET. ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s). ‘11’ indicates that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure-could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PDSCH reception in a (single-DCI based) multi-TRP system, a UE could be configured/provided/indicated by the network (e.g., the network 130) via higher layer RRC signaling/parameter and/or MAC CE command and/or dynamic DCI based L1 signaling—e.g., in a DL DCI (e.g., DCI format 1_0/1_1/1_2) that schedules the PDSCH—a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH. ‘01’ indicates that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH. ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH. ‘11’ indicates that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the second indicator could be referred to as or could correspond to a TCI selection field in DCI format 1_1/1_2 for PDSCH reception(s), wherein presence or absence of the second indicator/TCI selection field in the corresponding DCI format could be configured/provided by RRC signaling(s). For instance, when/if a higher layer RRC parameter tciSelection-PresentInDCI-r18 in BWP-Downlink Dedicated is set to ‘enabled’, the second indicator, or equivalently, the TCI selection field could be present in the corresponding DCI format(s)—e.g., DCI format 1_1/1_2: otherwise, e.g., when/if the higher layer RRC parameter tciSelection-PresentInDCI-r18 in BWP-DownlinkDedicated is not set to ‘enabled’ or is set to ‘disabled’, the second indicator, or equivalently, the TCI selection field could be absent in/from the corresponding DCI format(s)—e.g., DCI format 1_1/1_2, or the second indicator, or equivalently, the TCI selection field could be a 0-bit field in the corresponding DCI format(s)—e.g., DCI format 1_1/1_2.

For PUCCH transmission in a (single-DCI based) multi-TRP system, a UE could be configured/provided/indicated by the network (e.g., the network 130) via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s). ‘01’ indicates that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s). ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource. ‘11’ indicates that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure-could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PUSCH transmission in a (single-DCI based) multi-TRP system, a UE could be configured/provided/indicated by the network (e.g., the network 130) via higher layer RRC signaling/parameter and/or MAC CE command and/or dynamic DCI based L1 signaling—e.g., in an UL DCI (e.g., DCI format 0_0/0_1/0_2) that schedules the PUSCH-a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH. ‘01’ indicates that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH. ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH. ‘11’ indicates that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure-could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the fourth indicator could be referred to as or could correspond to a SRS resource set indicator field in DCI format 0_1/0_2 for PUSCH transmission(s), wherein presence or absence of the fourth indicator/SRS resource set indicator in the corresponding DCI format could be based on/according to one or more RRC signaling/parameters. For instance, when/if one or more of the following conditions are not achieved/satisfied or do not hold, the fourth indicator, or equivalently, the SRS resource set indicator field could be absent in/from the corresponding DCI format(s)—e.g., DCI format 0_1/0_2, or the fourth indicator, or equivalently, the SRS resource set indicator field could be a 0-bit field in the corresponding DCI format(s)—e.g., DCI format 0_1/0_2.
txConfig=nonCodeBook, and there are two SRS resource sets configured by srs-ResourceSetToAddModList and associated with the usage of value ‘nonCodeBook’, and is not configured with coresetPoolIndex or the value of coresetPoolIndex is the same for all CORESETs if coresetPoolIndex is provided; and/or
txConfig=codebook, and there are two SRS resource sets configured by srs-ResourceSetToAddModList and associated with usage of value ‘codebook’ and is not configured with coresetPoolIndex or the value of coresetPoolIndex is the same for all CORESETs if coresetPoolIndex is provided.

Throughout the present disclosure, the first TCI state(s) described herein in the present disclosure can also be denoted/represented/replaced by a/the first applicable TCI state(s), and/or the second TCI state(s) described herein in the present disclosure can also be denoted/represented/replaced by a/the second applicable TCI state(s). Throughout the present disclosure, unless otherwise specified, a TCI state could correspond a joint TCI state, a DL TCI state, an UL TCI state, or a pair of two TCI states each corresponding to a joint TCI state or a DL TCI state or an UL TCI state. Throughout the present disclosure, unless otherwise specified, a joint/DL TCI state could be provided by TCI-State or DLorJointTCI-State, and an UL TCI state could be provided UL-TCIState.

Furthermore, the UE could send to the network (e.g., the network 130) a capability signaling, e.g., denoted by twoDefaultTCI-States, to indicate to the network that the UE is capable of using/applying two or more (default) joint/DL TCI states—and therefore, the corresponding two or more (default) QCL assumptions—to simultaneously receive one or more PDSCHs, or the UE could send to the network a capability signaling, e.g., denoted by one DefaultTCI-State, to indicate to the network that the UE is capable of using/applying only one (default) joint/DL TCI state—and therefore, the corresponding one (default) QCL assumption—to receive the PDSCH(s). The UE could also be configured by the network, e.g., via a higher layer RRC signaling/parameter denoted by enable TwoDefaultTCI-States, to use/apply two or more (default) joint/DL TCI states—and therefore, the corresponding two or more (default) QCL assumptions—to simultaneously receive one or more PDSCHs. When/if the UE does not send to the network twoDefaultTCI-States, or the UE sends to the network one DefaultTCI-State, or the UE is not configured with enableTwoDefaultTCI-States, the UE could use/apply only one (default) joint/DL TCI state—and therefore, the corresponding one (default) QCL assumption—to receive the PDSCH(s). The default TCI state(s) could be only applied/used when scheduling offset between the scheduling DCI and the scheduled PDSCH is less than a threshold, wherein the threshold could be: (1) configured/provided/indicated by the network, e.g., via higher layer RRC signaling/parameter and/or MAC CE command and/or dynamic DCI based L1 signaling, e.g., threshold=timeDurationForQCL, (2) fixed in the system specifications, e.g., threshold=timeDurationForQCL and/or (3) autonomously determined by the UE and reported to the network.

In a (multi-DCI based) multi-TRP system, a UE could be indicated/provided/configured by the network (e.g., the network 130), e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for channels/signals such as PDCCH. PDSCH. PUCCH and PUSCH associated to the same (or different) CORESET pool index value, and a pair of TCI states could include/contain a separate DL TCI state provided by TCI-State/DLorJointTCI-State or a separate UL TCI State provided by TCI-State/UL-TCIState indicated for channels/signals such as PDCCH. PDSCH. PUCCH and PUSCH associated to the same (or different) CORESET pool index value, under the unified TCI framework.

A UE could be configured/provided/indicated, e.g., via higher layer RRC signaling and/or MAC CE command and/or dynamic DCI based L1 signaling. M≥1 or N≥1 (e.g., M=2 or N=2) groups/lists of TCI states or TCI state IDs with each group/list comprising/containing/including one or more TCI states or TCI state IDs. The bitwidth of the TCI state ID in each group/list could be determined according to the total number of TCI states/TCI state IDs in the corresponding group/list. Alternatively, the bitwidth of the TCI state ID in each group/list could be determined according to the total number of TCI states/TCI state IDs across all the configured groups/lists. Furthermore, the TCI state ID(s) in different groups/lists may not overlap—i.e., different groups/lists may not comprise/include/contain the same TCI state(s) or TCI state ID(s). Additionally, each group/list of TCI states or TCI state IDs could be configured with a (unique) TCI state group/list ID.
For example, an entity index/ID could be provided in the higher layer parameter, e.g., TCI-State or DLorJointTCI-State or UL-TCIState, that configures a joint/DL/UL TCI state as specified herein in the present disclosure. The UE could determine/identify one or more TCI states/TCI state IDs in a (same) group of TCI states/TCI state IDs when/if the entity index(es)/ID(s) provided/configured in the higher layer parameter(s) that configures the one or more TCI states/TCI state IDs—as specified herein in the present disclosure—is the same or identical. In the present disclosure, the entity index/ID could correspond to at least one of: a PCI value, a PCI index pointing to an entry/PCI in a list of PCI that are higher layer configured to the UE, a value of CORESETPoolIndex, a value of CORESETGroupIndex, a one-bit flag indicator, a TRP ID, a TRP-specific higher layer signaling index, a CORESET ID, a resource ID/index, a resource set ID/index and etc. For instance, for M=2 or N=2, the entity index/ID could be a one-bit flag indicator; when/if the entity index/ID associated to a TCI state (e.g., by configuring/providing the entity ID in the higher layer parameter TCI-State that configures the TCI state) is set to ‘0’ (or ‘1’), the UE could determine/identify that the TCI state/TCI state ID belongs to the first group of TCI states/TCI state IDs, and when/if the entity index/ID associated to a TCI state (e.g., by configuring/providing the entity ID in the higher layer parameter TCI-State that configures the TCI state) is set to ‘1’ (or ‘0’), the UE could determine/identify that the TCI state/TCI state ID belongs to the second group of TCI states/TCI state IDs. According to the design procedures described herein in the present disclosure, the UE could determine/identify a first group of joint/DL TCI states and/or a second group of joint/DL TCI states, e.g., in the higher layer configuration of dl-OrJoint-TCIStateList. Furthermore, the UE could determine/identify a first group of UL TCI states and/or a second group of UL TCI states, e.g., in the higher layer configuration of dl-OrJoint-TCIStateList or ul-TCIStateList.
For another example, for N=2 or M=2, the UE could be first provided/configured/indicated by the network, e.g., via higher layer RRC signaling/parameter, a list of joint/DL (or UL) TCI states. In the higher layer RRC signaling/parameter that configures/provides the list of joint/DL (or UL) TCI states, the UE could be further configured/provided/indicated by the network the number of TCI states/TCI state IDs (e.g., denoted by Ngroup1) of the first group of TCI states/TCI state IDs in the list and/or the number of TCI states/TCI state IDs (e.g., denoted by Ngroup2) of the second group of TCI states/TCI state IDs in the list. For this design example, the UE could identify/determine that the first Ngroup1 TCI states/TCI state IDs in the list of joint/DL (or UL) TCI states belong to the first group of TCI states/TCI state IDs, and the rest (or last Ngroup2) TCI states/TCI state IDs in the list of joint/DL (or UL) TCI states belong to the second group of TCI states/TCI state IDs. Alternatively, the UE could identify/determine that the last Ngroup2 TCI states/TCI state IDs in the list of joint/DL (or UL) TCI states belong to the second group of TCI states/TCI state IDs, and the rest (or first Ngroup1) TCI states/TCI state IDs in the list of joint/DL (or UL) TCI states belong to the first group of TCI states/TCI state IDs. According to the design procedures described herein in the present disclosure, the UE could determine/identify a first group of joint/DL TCI states and/or a second group of joint/DL TCI states, e.g., in the higher layer configuration of dl-OrJoint-TCIStateList. Furthermore, the UE could determine/identify a first group of UL TCI states and/or a second group of UL TCI states, e.g., in the higher layer configuration of dl-OrJoint-TCIStateList or ul-TCIStateList. The described UE operations/behaviors herein could be extended/applied to when N>2 (or M>2) groups of TCI states/TCI state IDs are configured.
Yet for another example, for N=2 or M=2, the UE could be first provided/configured/indicated by the network, e.g., via higher layer RRC signaling/parameter, a list of joint/DL (or UL) TCI states. In the higher layer RRC signaling/parameter that configures/provides the list of joint/DL (or UL) TCI states, the UE could be further configured/provided/indicated by the network the TCI state indexes/IDs or indexes of the TCI state indexes/IDs of the first group of TCI states/TCI state IDs in the list and/or the TCI state indexes/IDs or indexes of the TCI state indexes/IDs of the second group of TCI states/TCI state IDs in the list. According to the design procedures described herein in the present disclosure, the UE could determine/identify a first group of joint/DL TCI states and/or a second group of joint/DL TCI states, e.g., in the higher layer configuration of dl-OrJoint-TCIStateList. Furthermore, the UE could determine/identify a first group of UL TCI states and/or a second group of UL TCI states, e.g., in the higher layer configuration of dl-OrJoint-TCIStateList or ul-TCIStateList. The described UE operations/behaviors herein could be extended/applied to when N>2 (or M>2) groups of TCI states/TCI state IDs are configured.

As specified herein in the present disclosure, a UE could be configured/provided/indicated by the network (e.g., the network 130), e.g., via higher layer RRC signaling/parameter (via/in dl-OrJoint-TCIStateList or ul-TCIStateList) and/or MAC CE command and/or dynamic DCI based L1 signaling, configuration-1: a single list/group of TCI state(s) or TCI state ID(s), and configuration-2: multiple lists/groups of TCI states or TCI state IDs. The UE could be configured/provided/indicated by the network, e.g., via higher layer RRC signaling/parameter and/or MAC CE command and/or dynamic DCI based L1 signaling, whether the UE could use/apply the configuration-1 and/or configuration-2. When/if the configuration-1 as specified herein in the present disclosure is used/applied/configured, the UE could operate in a STRP mode; and/or when/if the configuration-2 as specified herein in the present disclosure is used/applied/configured, the UE could operation in a (SDCI based) MTRP mode. Furthermore, the UE could report to the network a capability signaling indicating that whether the UE could be capable of supporting configuration-1 and/or configuration-2 as specified herein in the present disclosure. For example, the capability signaling/report could indicate that the UE could not support configuration-2, or equivalently, the UE could only support configuration-1. For another example, the capability signaling/report could indicate that the UE could support configuration-1 and/or configuration-2 as specified herein in the present disclosure. The UE could then be provided/configured/indicated by the network, e.g., via higher layer RRC signaling/parameter and/or MAC CE command and/or dynamic DCI based L1 signaling, the configuration-1 and/or configuration-2 based on the capability signaling/report from the UE.

As specified herein in the present disclosure, in a STRP system or for STRP operation in/on a component carrier (CC)/BWP or a set/list/pool/group of CCs/BWPs, a UE could be indicated or could apply/use only a single TCI state/pair of TCI states for at least UE-dedicated reception on PDSCH/PDCCH or dynamic-grant/configured-grant based PUSCH or all of dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework, when/if one or more of the following conditions are achieved:
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, each of the TCI codepoints could include or comprise or could be mapped to a single joint/DL/UL TCI state/pair of joint/DL/UL TCI states.
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, at least one of the TCI codepoints could include or comprise or could be mapped to a single joint/DL/UL TCI state/pair of joint/DL/UL TCI states. The one of the TCI codepoints that includes/comprises or is mapped to a single joint/DL/UL TCI state/pair of joint/DL/UL TCI states could be determined according to: (i) fixed in the system specifications, e.g., the first/last TCI codepoint or the lowest/highest TCI codepoint (the index of the TCI codepoint is the lowest/highest) among all the TCI codepoints activated by/in the beam indication/activation MAC CE. (2) and/or provided/configured/indicated by the network, e.g., via higher layer RRC signaling/parameter and/or MAC CE command and/or dynamic DCI based L1 signaling, and/or (3) the only TCI codepoint in the beam indication/activation MAC CE that comprises a single joint/DL/UL TCI state/pair of joint/DL/UL TCI states.
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, a TCI codepoint could include or comprise or could be mapped to one or more joint/DL/UL TCI states/pairs of joint/DL/UL TCI states. When a TCI codepoint includes/comprises or is mapped to N>1 (e.g., N=2) joint/DL/UL TCI states/pairs of joint/DL/UL TCI states, the N joint/DL/UL TCI states could be the same/identical, i.e., they could correspond to a same TCI state or TCI state ID, or the N pairs of joint/DL/UL TCI states could be the same/identical, i.e., they could correspond to a same pair of TCI states or pair of TCI state IDs.
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, a TCI codepoint could include or comprise or could be mapped to one or more TCI states/pairs of TCI states. Each TCI state(s)/pair(s) of TCI states in the MAC CE may or may not be associated with an indicator, wherein the indicator (if present/associated to the TCI state(s)/pair(s) of TCI states) could indicate whether the TCI state(s)/pair(s) of TCI states could correspond to the first TCI state/pair of TCI states, the second TCI state/pair of TCI states, and/or etc., among all the TCI states/pairs of TCI states mapped to the same TCI codepoint comprising the TCI state(s)/pair(s) of TCI state(s) activated by/in the MAC CE; furthermore, the indicator (if present/associated to the TCI state(s)/pair(s) of TCI states) could also indicate whether the TCI state(s)/pair(s) of TCI states could be from a first group/list of TCI states/TCI state IDs or a second group/list of TCI states/TCI state IDs. When a TCI codepoint includes/comprises or is mapped to N>1 (e.g., N=2) joint/DL/UL TCI states/pairs of joint/DL/UL TCI states, the N joint/DL/UL TCI states could be the same/identical, i.e., they could correspond to a same TCI state or TCI state ID, or the N pairs of joint/DL/UL TCI states could be the same/identical, i.e., they could correspond to a same pair of TCI states or pair of TCI state IDs.
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, a TCI codepoint could include or comprise or could be mapped to one or more TCI states/pairs of TCI states. Each TCI state(s)/pair(s) of TCI states in the MAC CE may or may not be associated with an indicator, wherein the indicator (if present/associated to the TCI state(s)/pair(s) of TCI states) could indicate whether the TCI state(s)/pair(s) of TCI states could correspond to the first TCI state/pair of TCI states, the second TCI state/pair of TCI states, and/or etc., among all the TCI states/pairs of TCI states mapped to the same TCI codepoint comprising the TCI state(s)/pair(s) of TCI state(s) activated by/in the MAC CE; furthermore, the indicator (if present/associated to the TCI state(s)/pair(s) of TCI states) could also indicate whether the TCI state(s)/pair(s) of TCI states could be from a first group/list of TCI states/TCI state IDs or a second group/list of TCI states/TCI state IDs. Here, all of the TCI state(s)/pair(s) of TCI states activated by/in the MAC CE and used to map up to Ncp (e.g., Ncp=8) TCI codepoints of one or more TCI fields in a beam indication DCI could correspond to either the first (i.e., 1^{st}) TCI state(s)/pair(s) of TCI states or the second (i.e., 2^{nd}) TCI state(s)/pair(s) of TCI state(s) based on/according to the indicator(s) associated/corresponding to the TCI state(s)/pair(s) of TCI states following those specified herein in the present disclosure.
The UE could receive from the network at least one Rel-18 (enhanced) unified TCI state activation/deactivation MAC CE command that deactivates all of the TCI states/TCI codepoints for MTRP operation.
The UE could receive from the network at least one Rel-17 unified TCI state activation/deactivation MAC CE command that activates one or more TCI states/TCI codepoints for STRP operation.
The UE could be configured by the network, e.g., via higher layer RRC signaling, a single list of joint/DL TCI states and/or a single list of UL TCI states.
The UE could be configured by the network, e.g., via higher layer RRC signaling, a single group of joint/DL TCI states (e.g., within a list of RRC configured joint/DL TCI states) and/or a single group of UL TCI states (e.g., within a list of RRC configured UL TCI states).
The UE could be configured/indicated/provided by the network, e.g., via higher layer RRC signaling and/or MAC CE command and/or dynamic DCI based L1 signaling, that the STRP operation under the unified TCI framework is enabled. For instance, an indicator could be indicated/provided in a MAC CE command, e.g., the (enhanced) unified TCI states activation/deactivation MAC CE command, to indicate a switch between the (SDCI based) MTRP operation and the STRP operation. For this case, when/if the indicator is a one-bit indicator and set to ‘0’ (or ‘1’), the STRP operation is enabled (or the operation mode is switched from the (SDCI based) MTRP operation to the STRP operation).
The first indicator as specified herein in the present disclosure could be configured/set to a particular value (such as ‘00’ or ‘01’ as specified herein in the present disclosure) indicating that one of the (two) TCI states/pairs of TCI states—e.g., the first TCI state(s) or the second TCI state(s)—could be applied for PDCCH reception.
The second indicator as specified herein in the present disclosure could be configured/set to a particular value (such as: ‘00’ or ‘01’ as specified herein in the present disclosure) indicating that one of the (two) TCI states/pairs of TCI states—e.g., the first TCI state(s) or the second TCI state(s)—could be applied for PDSCH reception.
The third indicator as specified herein in the present disclosure could be configured/set to a particular value (such as ‘00’ or ‘01’ as specified herein in the present disclosure) indicating that only one of the (two) TCI states/pairs of TCI states—e.g., the first TCI state(s) or the second TCI state(s)—could be applied for PUCCH transmission.
The fourth indicator—e.g., by repurposing the SRS resource set indicator in DCI format 0_1/0_2—as specified herein in the present disclosure could be configured/set to a particular value (such as ‘00’ or ‘01’ as specified herein in the present disclosure) indicating that only one of the (two) TCI states/pairs of TCI states—e.g., the first TCI state(s) or the second TCI state(s)—could be applied for PUSCH transmission.
The UE could be provided/configured/indicated by the network, e.g., via higher layer RRC signaling, a presence or absence of the second indicator or equivalently the TCI selection field as specified herein in the present disclosure in the corresponding DCI format, e.g., DCI format 1_1/1_2, following those specified herein in the present disclosure.
The UE could be provided/configured/indicated by the network, e.g., via higher layer RRC signaling, a presence or absence of the fourth indicator or equivalently the SRS resource set indicator as specified herein in the present disclosure in the corresponding DCI format, e.g., DCI format 0_1/0_2, following those specified herein in the present disclosure.
The UE could be provided/configured/indicated by the network, e.g., via higher layer RRC signaling, whether or not the SRS resource set indicator in the DCI format 0_1/0_2 is used as the fourth indicator as specified herein in the present disclosure in the corresponding DCI format.
The UE could be indicated, e.g., in/via time-domain resource allocation (TDRA) field in DCI, only the entry(s) in pdsch-TimeDomainAllocation List containing no repetition Number.
The UE may not be configured with the higher layer parameter repetitionNumber or the UE may not be configured by the higher layer parameter repetitionScheme set to ‘tdmSchemeA’, ‘fdmSchemeA’, ‘fdmSchemeB’.
The UE may not be indicated demodulation reference signal (DM-RS) port(s) within two CDM groups in the DCI field ‘Antenna Port(s)’, or the UE could be indicated DM-RS port(s) within a single CDM group in the DCI field ‘Antenna Port(s)’.
The UE may not be configured with the higher layer parameter sfnSchemePdsch set to either ‘sfnSchemeA’ or ‘sfnSchemeB’ for a DL BWP.
The UE may not be configured with the higher layer parameter sfnSchemePdcch.

As specified herein in the present disclosure, in a (SDCI based) MTRP system or for (SDCI based) MTRP operation in/on a component carrier (CC)/BWP or a list/set/pool/group of CCs/BWPs, a UE could be indicated or could apply/use one or more (e.g., N>1) TCI states/pairs of TCI states for at least UE-dedicated reception on PDSCH/PDCCH or dynamic-grant/configured-grant based PUSCH or all of dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework, when/if one or more of the following conditions are achieved:
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, each of the TCI codepoints could include or comprise or could be mapped to N>1 (e.g., N=2) joint/DL/UL TCI states/pairs of joint/DL/UL TCI states. The N joint/DL/UL TCI states could be different from each other, i.e., they could correspond to different TCI states or TCI state IDs, or the N pairs of joint/DL/UL TCI states could be different from each other, i.e., they could correspond to different pairs of TCI states or pairs of TCI state IDs.
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, at least one of the TCI codepoints could include or comprise or could be mapped to N>1 (e.g., N=2) joint/DL/UL TCI states/pairs of joint/DL/UL TCI states. The one of the TCI codepoints that includes/comprises or is mapped to N>1 (e.g., N=2) joint/DL/UL TCI states/pairs of joint/DL/UL TCI states could be determined according to: (i) fixed in the system specifications, e.g., the first/last TCI codepoint or the lowest/highest TCI codepoint (the index of the TCI codepoint is the lowest/highest) among all the TCI codepoints activated by/in the beam indication/activation MAC CE, and/or (2) provided/configured/indicated by the network, e.g., via higher layer RRC signaling/parameter and/or MAC CE command and/or dynamic DCI based L1 signaling, and/or (3) the only TCI codepoint in the beam indication/activation MAC CE that comprises N>1 (e.g., N=2) joint/DL/UL TCI states/pairs of joint/DL/UL TCI states. The N joint/DL/UL TCI states could be different from each other, i.e., they could correspond to different TCI states or TCI state IDs, or the N pairs of joint/DL/UL TCI states could be different from each other, i.e., they could correspond to different pairs of TCI states or pairs of TCI state IDs.
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, a TCI codepoint could include or comprise or could be mapped to one or more TCI states/pairs of TCI states. Each TCI state(s)/pair(s) of TCI states in the MAC CE may or may not be associated with an indicator, wherein the indicator (if present/associated to the TCI state(s)/pair(s) of TCI states) could indicate whether the TCI state(s)/pair(s) of TCI states could correspond to the first TCI state/pair of TCI states, the second TCI state/pair of TCI states, and/or etc., among all the TCI states/pairs of TCI states mapped to the same TCI codepoint comprising the TCI state(s)/pair(s) of TCI state(s) activated by/in the MAC CE; furthermore, the indicator (if present/associated to the TCI state(s)/pair(s) of TCI states) could also indicate whether the TCI state(s)/pair(s) of TCI states could be from a first group/list of TCI states/TCI state IDs or a second group/list of TCI states/TCI state IDs. When a TCI codepoint includes/comprises or is mapped to N>1 (e.g., N=2) joint/DL/UL TCI states/pairs of TCI states, the N joint/DL/UL TCI states could be different from each other, i.e., they could correspond to different TCI states or TCI state IDs, or the N pairs of joint/DL/UL TCI states could be different from each other, i.e., they could correspond to different pairs of TCI states or pairs of TCI state IDs.
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, a TCI codepoint could include or comprise or could be mapped to one or more TCI states/pairs of TCI states. Each TCI state(s)/pair(s) of TCI states in the MAC CE may or may not be associated with an indicator, wherein the indicator (if present/associated to the TCI state(s)/pair(s) of TCI states) could indicate whether the TCI state(s)/pair(s) of TCI states could correspond to the first TCI state/pair of TCI states, the second TCI state/pair of TCI states, and/or etc., among all the TCI states/pairs of TCI states mapped to the same TCI codepoint comprising the TCI state(s)/pair(s) of TCI state(s) activated by/in the MAC CE; furthermore, the indicator (if present/associated to the TCI state(s)/pair(s) of TCI states) could also indicate whether the TCI state(s)/pair(s) of TCI states could be from a first group/list of TCI states/TCI state IDs or a second group/list of TCI states/TCI state IDs. Here, all of the TCI state(s)/pair(s) of TCI states activated by/in the MAC CE and used to map up to Ncp (e.g., Ncp=8) TCI codepoints of one or more TCI fields in a beam indication DCI could correspond to either the first (i.e., 1^{st}) TCI state(s)/pair(s) of TCI states or the second (i.e., 2nd) TCI state(s)/pair(s) of TCI state(s) based on/according to the indicator(s) associated/corresponding to the TCI state(s)/pair(s) of TCI states following those specified herein in the present disclosure.
The UE could receive from the network a beam indication/activation MAC CE, e.g., unified TCI state activation/deactivation MAC CE, wherein the (unified) TCI states activated/provided/indicated in the MAC CE could be used to map up to Ncp (e.g., Ncp=8) TCI codepoints of one or more TCI fields in a beam indication DCI; here, a TCI codepoint could include or comprise or could be mapped to one or more TCI states/pairs of TCI states. Each TCI state(s)/pair(s) of TCI states in the MAC CE may or may not be associated with an indicator, wherein the indicator (if present/associated to the TCI state(s)/pair(s) of TCI states) could indicate whether the TCI state(s)/pair(s) of TCI states could correspond to the first TCI state/pair of TCI states, the second TCI state/pair of TCI states, and/or etc., among all the TCI states/pairs of TCI states mapped to the same TCI codepoint comprising the TCI state(s)/pair(s) of TCI state(s) activated by/in the MAC CE; furthermore, the indicator (if present/associated to the TCI state(s)/pair(s) of TCI states) could also indicate whether the TCI state(s)/pair(s) of TCI states could be from a first group/list of TCI states/TCI state IDs or a second group/list of TCI states/TCI state IDs. Here, at least one activated TCI codepoint could comprise or map to two joint/DL/UL TCI state(s) and/or pair(s) of DL/UL TCI states, i.e., a/the first (1^{st}) and a/the second (2nd) TCI states as specified herein in the present disclosure, or at least one set of two joint/DL/UL TCI state(s) and/or pair(s) of DL/UL TCI states, i.e., a/the first (1st) and a/the second (2nd) TCI states as specified herein in the present disclosure activated by/in the MAC CE could be used to map to a TCI codepoint of one or more TCI fields in a beam indication DCI.
The UE could receive from the network at least one Rel-18 (enhanced) unified TCI state activation/deactivation MAC CE command that activates one or more TCI states/TCI codepoints for MTRP operation.
The UE could receive from the network at least one Rel-17 unified TCI state activation/deactivation MAC CE command that deactivates all of the TCI states/pairs of TCI states for STRP operation.
The UE could be configured by the network, e.g., via higher layer RRC signaling, one or more lists of joint/DL TCI states and/or one or more lists of UL TCI states. For instance, for M=2 or N=2, the UE could be configured by the network, e.g., via higher layer RRC signaling, a first and a second lists of joint/DL TCI states and/or a first and a second lists of UL TCI states.
The UE could be configured by the network, e.g., via higher layer RRC signaling, one or more groups of joint/DL TCI states (e.g., within a list of RRC configured joint/DL TCI states) and/or one or more groups of UL TCI states (e.g., within a list of RRC configured UL TCI states). For instance, for M=2 or N=2, the UE could be configured by the network, e.g., via higher layer RRC signaling, a first and a second groups of joint/DL TCI states (e.g., within a list of RRC configured joint/DL TCI states) and/or a first and a second groups of UL TCI states (e.g., within a list of RRC configured UL TCI states).
The UE could be configured/indicated/provided by the network, e.g., via higher layer RRC signaling and/or MAC CE command and/or dynamic DCI based L1 signaling, that the (SDCI based) MTRP operation under the unified TCI framework is enabled. For instance, an indicator could be indicated/provided in a MAC CE command, e.g., the (enhanced) unified TCI states activation/deactivation MAC CE command, to indicate a switch between the STRP operation and the (SDCI based) MTRP operation. For this case, when/if the indicator is a one-bit indicator and set to ‘1’ (or ‘0’), the (SDCI based) MTRP operation is enabled (or the operation mode is switched from the STRP operation to the (SDCI based) MTRP operation).
The first indicator as specified herein in the present disclosure could be configured/set to a particular value (such as ‘00’ or ‘01’ as specified herein in the present disclosure) indicating that one of the (two) TCI states/pairs of TCI states—e.g., the first TCI state(s) or the second TCI state(s)—could be applied for PDCCH reception.
The first indicator as specified herein in the present disclosure could be configured/set to a particular value (such as ‘10’ or ‘11’ as specified herein in the present disclosure) indicating that both of the (two) TCI states/pairs of TCI states—e.g., the first TCI state(s) and the second TCI state(s)—could be applied for PDCCH reception.
The second indicator as specified herein in the present disclosure could be configured/set to a particular value (such as ‘00’ or ‘01’ as specified herein in the present disclosure) indicating that one of the (two) TCI states/pairs of TCI states—e.g., the first TCI state(s) or the second TCI state(s)—could be applied for PDSCH reception.
The second indicator as specified herein in the present disclosure could be configured/set to a particular value (such as ‘10’ or ‘11’ as specified herein in the present disclosure) indicating that both of the (two) TCI states/pairs of TCI states—e.g., the first TCI state(s) and the second TCI state(s)—could be applied for PDSCH reception.
The third indicator as specified herein in the present disclosure could be configured/set to a particular value (such as ‘00’ or ‘01’ as specified herein in the present disclosure) indicating that only one of the (two) TCI states/pairs of TCI states—e.g., the first TCI state(s) or the second TCI state(s)—could be applied for PUCCH transmission.
The third indicator as specified herein in the present disclosure could be configured/set to a particular value (such as ‘10’ or ‘11’ as specified herein in the present disclosure) indicating that both of the (two) TCI states/pairs of TCI states—e.g., the first TCI state(s) and the second TCI state(s)—could be applied for PUCCH transmission.
The fourth indicator—e.g., by repurposing the SRS resource set indicator in DCI format 0_1/0_2—as specified herein in the present disclosure could be configured/set to a particular value (such as ‘00’ or ‘01’ as specified herein in the present disclosure) indicating that only one of the (two) TCI states/pairs of TCI states—e.g., the first TCI state(s) or the second TCI state(s)—could be applied for PUSCH transmission.
The fourth indicator—e.g., by repurposing the SRS resource set indicator in DCI format 0_1/0_2—as specified herein in the present disclosure could be configured/set to a particular value (such as ‘10’ or ‘11’ as specified herein in the present disclosure) indicating that both of the (two) TCI states/pairs of TCI states—e.g., the first TCI state(s) and the second TCI state(s)—could be applied for PUSCH transmission.
The UE could be provided/configured/indicated by the network, e.g., via higher layer RRC signaling, a presence or absence of the second indicator or equivalently the TCI selection field as specified herein in the present disclosure in the corresponding DCI format, e.g., DCI format 1_1/1_2, following those specified herein in the present disclosure.
The UE could be provided/configured/indicated by the network, e.g., via higher layer RRC signaling, a presence or absence of the fourth indicator or equivalently the SRS resource set indicator as specified herein in the present disclosure in the corresponding DCI format, e.g., DCI format 0_1/0_2, following those specified herein in the present disclosure.
The UE could be provided/configured/indicated by the network, e.g., via higher layer RRC signaling, whether or not the SRS resource set indicator in the DCI format 0_1/0_2 is used as the fourth indicator as specified herein in the present disclosure in the corresponding DCI format.
The UE could be indicated, e.g., in/via time-domain resource allocation (TDRA) field by DCI, at least one entry in pdsch-TimeDomainAllocationList containing repetitionNumber (e.g., >1).
The UE could be indicated, e.g., in/via time-domain resource allocation (TDRA) field by DCI, one entry in pdsch-TimeDomainAllocationList containing no repetitionNumber, but at least one entry in pdsch-TimeDomainAllocation List containing repetitionNumber (e.g., >1).
The UE could be indicated, e.g., in/via time-domain resource allocation (TDRA) field in DCI, only the entry(s) in pdsch-TimeDomainAllocationList containing no repetitionNumber.
The UE could be configured with the higher layer parameter repetitionNumber or the UE could be configured by the higher layer parameter repetitionScheme set to ‘tdmSchemeA’, ‘fdmSchemeA’, ‘fdmSchemeB’.
The UE could be indicated DM-RS port(s) within two CDM groups in the DCI field ‘Antenna Port(s)’.
The UE could be configured with the higher layer parameter sfnSchemePdsch set to either ‘sfnSchemeA’ or ‘sfnSchemeB’ for a DL BWP.
The UE could be configured with the higher layer parameter sfnSchemePdcch.

As specified herein in the present disclosure, in a (MDCI based) MTRP system or for (MDCI based) MTRP operation in/on a component carrier (CC)/BWP or a list/set/pool/group of CCs/BWPs, the UE could be provided/configured/indicated by the network (e.g., the network 130), e.g., via higher layer RRC signaling/parameter (e.g., in PDCCH-Config) and/or MAC CE command and/or dynamic DCI based L1 signaling, two values (i.e., 0 and 1) of CORESETPoolIndex each configured for/associated to one or more CORESETs, wherein each CORESET could be configured/associated with a value (i.e., 0 or 1) of CORESETPoolIndex.

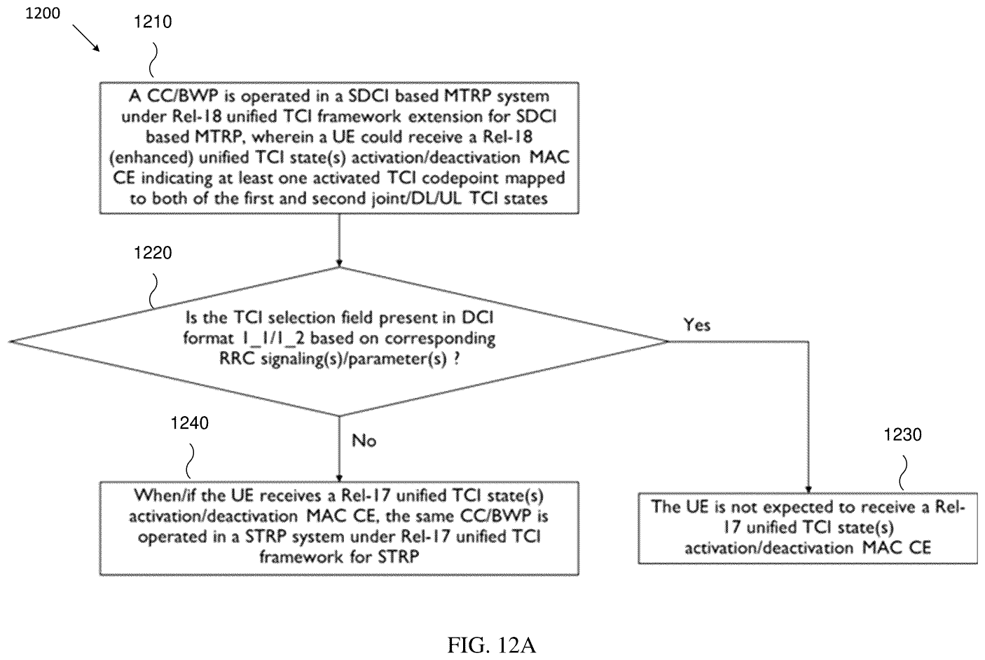

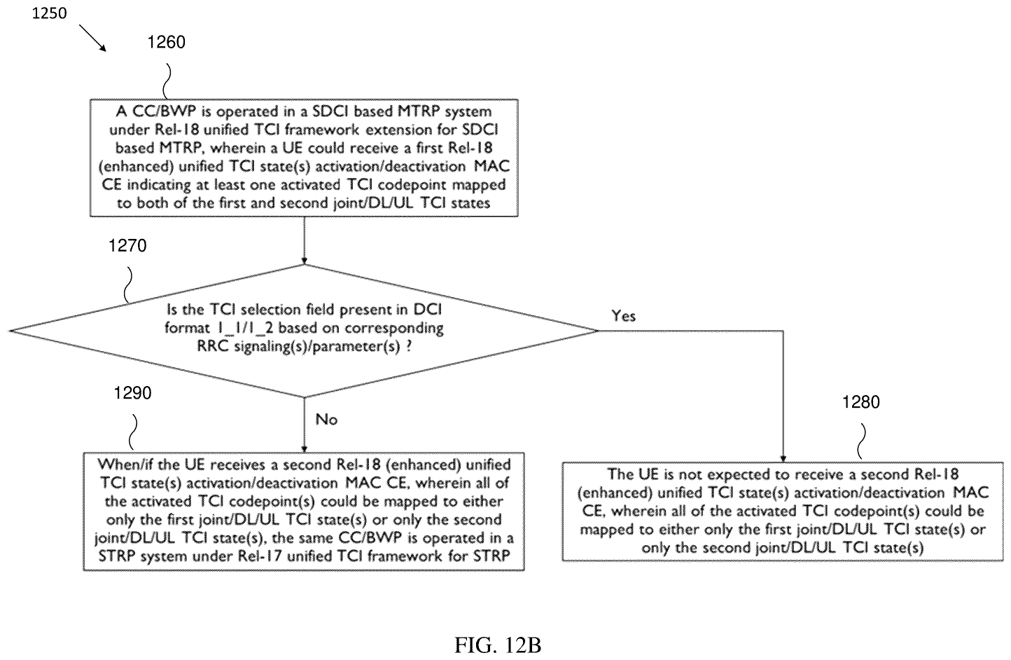

FIGS. 12A and 12B illustrate flowcharts of example UE procedures 1200 and 1250, respectively, for updating/using applicable TCI states and performing single-TRP and multi-TRP switching according to embodiments of the present disclosure. For example, procedures 1200 and 1250 may be performed by the UE 116 of FIG. 3. This example is for illustration only and other embodiments can be used without departing from the scope of the present disclosure.

The procedure in FIG. 12A begins in 1210, a CC/BWP is operated in a SDCI based MTRP system under Rel-18 unified TCI framework extension for SDCI based MTRP, wherein a UE could receive a Rel-18 (enhanced) unified TCI state(s) activation/deactivation MAC CE indicating at least one activated TCI codepoint mapped to both of the first and second joint/DL/UL TCI states. In 1220, the TCI selection field may be present in DCI format 1_1/1_2 based on corresponding RRC signaling(s)/parameter(s). If the TCI selection field is present, in 1230, the UE is not expected to receive a Rel-17 unified TCI state(s) activation/deactivation MAC CE. If the TCI selection field is not present, in 1240, when/if the UE receives a Rel-17 unified TCI state(s) activation/deactivation MAC CE, the same CC/BWP is operated in a STRP system under Rel-17 unified TCI framework for STRP.

The procedure in FIG. 12B begins in 1260, a CC/BWP is operated in a SDCI based MTRP system under Rel-18 unified TCI framework extension for SDCI based MTRP, wherein a UE could receive a Rel-18 (enhanced) unified TCI state(s) activation/deactivation MAC CE indicating at least one activated TCI codepoint mapped to both of the first and second joint/DL/UL TCI states. In 1270, the TCI selection field may be present in DCI format 1_1/1_2 based on corresponding RRC signaling(s)/parameter(s). If the TCI selection field is present, in 1280, the UE is not expected to receive a second Rel-18 (enhanced) unified TCI state(s) activation/deactivation MAC CE, wherein all of the activated TCI codepoint(s) could be mapped to either only the first joint/DL/UL TCI state(s) or only the second joint/DL/UL TCI state(s). If the TCI selection field is not present, in 1290, when/if the UE receives a second Rel-18 (enhanced) unified TCI state(s) activation/deactivation MAC CE, wherein all of the activated TCI codepoint(s) could be mapped to either only the first joint/DL/UL TCI state(s) or only the second joint/DL/UL TCI state(s), the same CC/BWP is operated in a STRP system under Rel-17 unified TCI framework for STRP.

In one embodiment, for a CC/BWP operated under the Rel-18 unified TCI framework extension for SDCI based MTRP, or equivalently, for a CC/BWP operated in a SDCI based MTRP system or for SDCI based MTRP operation according to those specified herein in the present disclosure, a UE could receive from the network (e.g., the network 130) a first Rel-18 (enhanced) unified TCI state(s) activation/deactivation MAC CE providing/indicating/activating one or more sets of joint/DL/UL TCI states with each set comprising one or more joint/DL/UL TCI states and mapped to a TCI codepoint of a TCI field in a beam indication DCI (e.g., DCI format 1_1/1_2 with or without DL assignment): here, the first Rel-18 (enhanced) unified TCI state(s) activation/deactivation MAC CE could provide/indicate/activate at least one set of two joint/DL/UL TCI state(s) and/or pair(s) of joint/DL/UL TCI states—denoted by first joint/DL/UL TCI state(s) and second joint/DL/UL TCI state(s). For the same CC/BWP.
When/if the first Rel-18 (enhanced) unified TCI state(s) activation/deactivation MAC CE activates/provides/indicates a single set of first and/or second joint/DL/UL TCI states as specified herein in the present disclosure, after the first and/or second joint/DL/UL TCI states have become applicable—e.g., after a time duration or beam application time (BAT) upon receiving the first Rel-18 (enhanced) unified TCI state(s) activation/deactivation MAC CE, the UE could update their first applicable joint/DL/UL TCI state(s) and/or second applicable joint/DL/UL TCI state(s) with the indicated first and/or second joint/DL/UL TCI state(s), and then use/apply the first and/or second applicable/indicated joint/DL/UL TCI states for at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator).
When/if the first Rel-18 (enhanced) unified TCI state(s) activation/deactivation MAC CE activates/provides/indicates more than one sets of first and/or second joint/DL/UL TCI state(s) with each set mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of first and/or second joint/DL/UL TCI state(s). After the indicated first and/or second joint/DL/UL TCI state(s) has become applicable—e.g., after a time duration or beam application time (BAT) upon receiving the beam indication DCI, the UE could update their first applicable joint/DL/UL TCI state(s) and/or second applicable joint/DL/UL TCI state(s) with the indicated first and/or second joint/DL/UL TCI state(s), and then use/apply the first and/or second applicable/indicated joint/DL/UL TCI states for at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator).

For the same CC/BWP, when/if the second indicator (or equivalently, the TCI selection field) as specified herein in the present disclosure is not present or is absent in the corresponding DCI format (e.g., DCI format 1_1/1_2)—e.g., when/if a higher layer RRC parameter teiSelection-PresentInDCI-r18 in BWP-Downlink Dedicated is not set to ‘enabled’ or set to ‘disabled’ indicating/providing that the second indicator/TCI selection field is absent in DCI format 1_1/1_2 for the DL BWP and/or when/if the second indicator/TCI selection field in DCI format 1_1/1_2 is (set to) 0 bit, and/or when/if the second indicator (or equivalently, the TCI selection field) as specified herein in the present disclosure is present in the corresponding DCI format (e.g., DCI format 1_1/1_2)—e.g., when/if the higher layer RRC parameter teiSelection-PresentInDCI-r18 in BWP-DownlinkDedicated is set to ‘enabled’ indicating/providing that the second indicator/TCI selection field is present in DCI format 1_1/1_2 for the DL BWP—but the second indicator/TCI selection field has not become applicable—e.g., before the higher layer RRC (re-)configuration and/or the higher layer RRC parameter tciSelection-PresentInDCI-r18 in BWP-DownlinkDedicated becomes applicable, and/or when/if the fourth indicator (or equivalently, the SRS resource set indicator field) as specified herein in the present disclosure is not present or is absent in the corresponding DCI format (e.g., DCI format 0_1/0_2) and/or when/if the fourth indicator/SRS resource set indicator field in DCI format 0_1/0_2 is (set to) 0 bit according to those specified herein in the present disclosure, and/or when/if the fourth indicator (or equivalently, the SRS resource set indicator field) as specified herein in the present disclosure is present in the corresponding DCI format (e.g., DCI format 0_1/0_2), but the fourth indicator/SRS resource set indicator field has not become applicable—e.g., before the higher layer RRC (re-)configuration and/or the corresponding higher layer RRC parameter(s) becomes applicable, and/or when/if the first and/or third indicator(s) as specified herein in the present disclosure for PDCCH reception(s) and/or PUCCH transmission(s) are/is not provided in the corresponding RRC signaling(s)/parameter(s), and/or when/if scheduling offset between PDSCH(s) and the scheduling PDCCH/DCI that provides/indicates the second indicator/TCI selection field is less than or equal to a threshold (e.g., timeDurationForQCL), and/or when/if the UE uses/applies both of the first and second applicable/indicated joint/DL/UL TCI states at least for PDSCH reception(s)—e.g., when/if the second indicator (or equivalently, the TCI selection field) is present in the corresponding DCI format 1_1/1_2 and set to value(s) ‘10’ or ‘11’ indicating/providing that both of the first and second TCI states could be used for PDSCH reception(s), and/or when/if the UE uses/applies the first or second applicable/indicated joint/DL/UL TCI state(s) at least for PDSCH reception(s)—e.g., when/if the second indicator (or equivalently, the TCI selection field) is present in the corresponding DCI format 1_1/1_2 and set to value(s) ‘00’ or ‘01’ indicating/providing that the first or second TCI state(s) could be used for PDSCH reception(s), and/or when/if the UE uses/applies both of the first and second applicable/indicated joint/DL/UL TCI states at least for PUSCH transmission(s)—e.g., when/if the fourth indicator (or equivalently, the SRS resource set indicator field) is present in the corresponding DCI format 0_1/0_2 and set to value(s) ‘10’ or ‘11’ indicating/providing that both of the first and second TCI states could be used for PUSCH transmission(s), and/or when/if the UE uses/applies the first or second applicable/indicated joint/DL/UL TCI state(s) at least for PUSCH transmission(s)—e.g., when/if the fourth indicator (or equivalently, the SRS resource set indicator field) is present in the corresponding DCI format 0_1/0_2 and set to value(s) ‘00’ or ‘01’ indicating/providing that the first or second TCI state(s) could be used for PUSCH transmission(s), and/or when/if the UE uses/applies both of the first and second applicable/indicated joint/DL/UL TCI states at least for PDCCH reception(s)—e.g., when/if the first indicator is provided via the corresponding RRC signaling(s)/parameter(s) and set to value(s) ‘10’ or ‘11’ indicating/providing that both of the first and second TCI states could be used for PDCCH reception(s), and/or when/if the UE uses/applies the first or second applicable/indicated joint/DL/UL TCI state(s) at least for PDCCH reception(s)—e.g., when/if the first indicator is provided in the corresponding RRC signaling(s)/parameter(s) and set to value(s) ‘00’ or ‘01’ indicating/providing that the first or second TCI state(s) could be used for PDCCH reception(s), and/or when/if the UE uses/applies both of the first and second applicable/indicated joint/DL/UL TCI states at least for PUCCH transmission(s)—e.g., when/if the third indicator is provided via the corresponding RRC signaling(s)/parameter(s) and set to value(s) ‘10’ or ‘11’ indicating/providing that both of the first and second TCI states could be used for PUCCH transmission(s), and/or when/if the UE uses/applies the first or second applicable/indicated joint/DL/UL TCI state(s) at least for PUCCH transmission(s)—e.g., when/if the third indicator is provided in the corresponding RRC signaling(s)/parameter(s) and set to value(s) ‘00’ or ‘01’ indicating/providing that the first or second TCI state(s) could be used for PUCCH transmission(s), and/or when/if the UE reports to the network the capability signaling oneDefaultTCI-State, or the UE is configured with enableOneDefaultTCI-State, or the UE does not report to the network the capability signaling twoDefaultTCI-States, or the UE is not configured with enableTwoDefaultTCI-States, or the UE reports to the network the capability signaling twoDefaultTCI-States, or the UE is configured with enableTwoDefaultTCI-States as specified herein in the present disclosure, or for the same CC/BWP regardless any condition(s)/restriction(s), or for the same CC/BWP when/if one or more of the above conditions do not hold or are not achieved/satisfied, e.g., when/if the second indicator (or equivalently, the TCI selection field) as specified herein in the present disclosure is present in the corresponding DCI format (e.g., DCI format 1_1/1_2)—e.g., when/if the higher layer RRC parameter tciSelection-PresentInDCI-r18 in BWP-DownlinkDedicated is set to ‘enabled’ indicating/providing that the second indicator/TCI selection field is present in DCI format 1_1/1_2 for the DL BWP—and is applicable, and/or when/if the fourth indicator (or equivalently, the SRS resource set indicator field) as specified herein in the present disclosure is present in the corresponding DCI format (e.g., DCI format 0_1/0_2) and is applicable, when/if the UE receives from the network a Rel-17 unified TCI state(s) activation/deactivation MAC CE providing/indicating/activating one or more sets of joint/DL/UL TCI states with each set comprising one joint/DL/UL TCI state or a pair of DL and UL TCI states and mapped to a TCI codepoint of a TCI field in a beam indication DCI (e.g., DCI format 1_1/1_2 with or without DL assignment) and/or a second Rel-18 (enhanced) unified TCI state(s) activation/deactivation MAC CE providing/indicating/activating one or more sets of joint/DL/UL TCI states with each set comprising either one or more first (1^{st}) joint/DL/UL TCI states or one or more second (2nd) joint/DL/UL TCI states according to those specified herein in the present disclosure (or the joint/DL/UL TCI states in all sets correspond to either the first (1^{st}) or second (2^{nd}) joint/DL/UL TCI states according to those specified herein in the present disclosure) and mapped to a TCI codepoint of a TCI field in a beam indication DCI (e.g., DCI format 1_1/1_2 with or without DL assignment), the same CC/BWP is operated under the Rel-17 unified TCI framework for STRP, or equivalently, the same CC/BWP is operated in a STRP system or for STRP operation according to those specified herein in the present disclosure such that:
When/if the Rel-17 unified TCI state(s) activation/deactivation MAC CE activates/provides/indicates a single set of joint/DL/UL TCI state(s) as specified herein in the present disclosure, after the joint/DL/UL TCI state(s) has become applicable—e.g., after a time duration or beam application time (BAT) upon receiving the Rel-17 unified TCI state(s) activation/deactivation MAC CE, the UE could use the indicated joint/DL/UL TCI state(s) for at least UE-dedicated reception(s) on PDSCH, or at least UE-dedicated reception(s) on PDCCH and/or PDSCH and/or dynamic-grant/configured-grant based PUSCH and/or all of dedicated PUCCH resources.
When/if the second Rel-18 (enhanced) unified TCI state(s) activation/deactivation MAC CE activates/provides/indicates a single set of only first (1^{st}) or second (2^{nd}) joint/DL/UL TCI state(s) as specified herein in the present disclosure, after the first (1^{st}) or second (2^{nd}) joint/DL/UL TCI state(s) have become applicable—e.g., after a time duration or beam application time (BAT) upon receiving the second Rel-18 (enhanced) unified TCI state(s) activation/deactivation MAC CE, the UE could use the indicated first (1^{st}) or second (2^{nd}) joint/DL/UL TCI state(s) for at least UE-dedicated reception(s) on PDSCH, or at least UE-dedicated reception(s) on PDCCH and/or PDSCH and/or dynamic-grant/configured-grant based PUSCH and/or all of dedicated PUCCH resources.
When/if the Rel-17 unified TCI state(s) activation/deactivation MAC CE activates/provides/indicates more than one sets of joint/DL/UL TCI state(s) with each set comprising a single joint/DL/UL TCI state or a pair of DL and UL TCI states and mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of joint/DL/UL TCI state(s). After the indicated joint/DL/UL TCI state(s) has become applicable—e.g., after a time duration or beam application time (BAT) upon receiving the beam indication DCI, the UE could use the indicated joint/DL/UL TCI state(s) for at least UE-dedicated reception(s) on PDSCH, or at least UE-dedicated reception(s) on PDCCH and/or PDSCH and/or dynamic-grant/configured-grant based PUSCH and/or all of dedicated PUCCH resources.
When/if the second Rel-18 (enhanced) unified TCI state(s) activation/deactivation MAC CE activates/provides/indicates more than one sets of joint/DL/UL TCI state(s) with each set comprising either the first (1^{st}) or second (2^{nd}) joint/DL/UL TCI state(s) according to those specified herein in the present disclosure (or the joint/DL/UL TCI state(s) in all sets correspond to either the first (1^{st}) or second (2^{nd}) joint/DL/UL TCI state(s) according to those specified herein in the present disclosure) and mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of either the first (1^{st}) or second (2^{nd}) joint/DL/UL TCI state(s). After the indicated first (1^{st}) or second (2^{nd}) joint/DL/UL TCI state(s) has become applicable—e.g., after a time duration or beam application time (BAT) upon receiving the beam indication DCI, the UE could use the indicated first (1^{st}) or second (2^{nd}) joint/DL/UL TCI state(s) for at least UE-dedicated reception(s) on PDSCH, or at least UE-dedicated reception(s) on PDCCH and/or PDSCH and/or dynamic-grant/configured-grant based PUSCH and/or all of dedicated PUCCH resources.

Otherwise, i.e., when/if one or more of the above conditions do not hold or are not achieved/satisfied, e.g., when/if the second indicator (or equivalently, the TCI selection field) as specified herein in the present disclosure is present in the corresponding DCI format (e.g., DCI format 1_1/1_2)—e.g., when/if the higher layer RRC parameter teiSelection-PresentInDCI-r18 in BWP-Downlink Dedicated is set to ‘enabled’ indicating/providing that the second indicator/TCI selection field is present in DCI format 1_1/1_2 for the DL BWP—and is applicable, and/or when/if the fourth indicator (or equivalently, the SRS resource set indicator field) as specified herein in the present disclosure is present in the corresponding DCI format (e.g., DCI format 0_1/0_2) and is applicable, and/or when/if the first and/or third indicator(s) as specified herein in the present disclosure are/is provided in the corresponding RRC signaling(s)/parameter(s), for the same CC/BWP:
In one example, the UE may not be expected to receive from the network a Rel-17 unified TCI state(s) activation/deactivation MAC CE providing/indicating/activating one or more sets of joint/DL/UL TCI states with each set comprising one joint/DL/UL TCI state or a pair of DL and UL TCI states and mapped to a TCI codepoint of a TCI field in a beam indication DCI (e.g., DCI format 1_1/1_2 with or without DL assignment), and/or the UE may not be expected to receive a second Rel-18 (enhanced) unified TCI state(s) activation/deactivation MAC CE providing/indicating/activating one or more sets of joint/DL/UL TCI states with each set comprising either one or more first (1^{st}) joint/DL/UL TCI states or one or more second (2^{nd}) joint/DL/UL TCI states according to those specified herein in the present disclosure (or the joint/DL/UL TCI states in all sets correspond to either the first (1^{st}) or second (2^{nd}) joint/DL/UL TCI states according to those specified herein in the present disclosure) and mapped to a TCI codepoint of a TCI field in a beam indication DCI (e.g., DCI format 1_1/1_2 with or without DL assignment).
In another example, when/if the UE receives from the network a Rel-17 unified TCI state(s) activation/deactivation MAC CE providing/indicating/activating one or more sets of joint/DL/UL TCI states with each set comprising one joint/DL/UL TCI state or a pair of DL and UL TCI states and mapped to a TCI codepoint of a TCI field in a beam indication DCI (e.g., DCI format 1_1/1_2 with or without DL assignment) and/or a second Rel-18 (enhanced) unified TCI state(s) activation/deactivation MAC CE providing/indicating/activating one or more sets of joint/DL/UL TCI states with each set comprising either one or more first (1^{st}) joint/DL/UL TCI states or one or more second (2^{nd}) joint/DL/UL TCI states according to those specified herein in the present disclosure (or the joint/DL/UL TCI states in all sets correspond to either the first (1^{st}) or second (2^{nd}) joint/DL/UL TCI states according to those specified herein in the present disclosure) and mapped to a TCI codepoint of a TCI field in a beam indication DCI (e.g., DCI format 1_1/1_2 with or without DL assignment), the same CC/BWP would still be operated under the Rel-18 unified TCI framework extension for SDCI based MTRP, or equivalently, operated in a SDCI based MTRP system or for SDCI based MTRP operation according to those specified herein in the present disclosure such that:
   When/if the Rel-17 unified TCI state(s) activation/deactivation MAC CE activates/provides/indicates a single set of joint/DL/UL TCI state(s) as specified herein in the present disclosure, after the joint/DL/UL TCI state(s) has become applicable—e.g., after a time duration or beam application time (BAT) upon receiving the Rel-17 unified TCI state(s) activation/deactivation MAC CE, the UE could first determine/identify, e.g., based on/according to indicator(s) associated/corresponding to the joint/DL/UL TCI state(s) in the MAC CE, whether the indicated joint/DL/UL TCI state(s) correspond to the first TCI state(s) or the second TCI state(s). The UE could update their first applicable joint/DL/UL TCI state(s) or second applicable joint/DL/UL TCI state(s) with the indicated first or second joint/DL/UL TCI state(s), and then use/apply the first and/or second applicable/indicated joint/DL/UL TCI states for at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator), or at least channel(s)/signal(s) other than PDSCH(s)—e.g., UE-dedicated reception(s) on PDCCH (e.g., according to the first indicator) and/or dynamic-grant/configured-grant based PUSCH (e.g., according to the fourth indicator) and/or all of dedicated PUCCH resources (e.g., according to the fourth indicator) other than UE-dedicated reception(s) on PDSCH (e.g., according to the second indicator).
   When/if the second Rel-18 (enhanced) unified TCI state(s) activation/deactivation MAC CE activates/provides/indicates a single set of only first (1^{st}) or second (2^{nd}) joint/DL/UL TCI state(s) as specified herein in the present disclosure, after the first (1^{st}) or second (2^{nd}) joint/DL/UL TCI state(s) have become applicable—e.g., after a time duration or beam application time (BAT) upon receiving the second Rel-18 (enhanced) unified TCI state(s) activation/deactivation MAC CE, the UE could update their first applicable joint/DL/UL TCI state(s) or second applicable joint/DL/UL TCI state(s) with the indicated first or second joint/DL/UL TCI state(s), and then use/apply the first and/or second applicable/indicated joint/DL/UL TCI states for at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator), or at least channel(s)/signal(s) other than PDSCH(s)—e.g., UE-dedicated reception(s) on PDCCH (e.g., according to the first indicator) and/or dynamic-grant/configured-grant based PUSCH (e.g., according to the fourth indicator) and/or all of dedicated PUCCH resources (e.g., according to the fourth indicator) other than UE-dedicated reception(s) on PDSCH (e.g., according to the second indicator).
   When/if the Rel-17 unified TCI state(s) activation/deactivation MAC CE activates/provides/indicates more than one sets of joint/DL/UL TCI state(s) with each set comprising a single joint/DL/UL TCI state or a pair of DL and UL TCI states and mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of joint/DL/UL TCI state(s). After the indicated joint/DL/UL TCI state(s) has become applicable—e.g., after a time duration or beam application time (BAT) upon receiving the beam indication DCI, the UE could first determine/identify, e.g., based on/according to indicator(s) associated/corresponding to the indicated joint/DL/UL TCI state(s) in the MAC CE, whether the indicated joint/DL/UL TCI state(s) correspond to the first TCI state(s) or the second TCI state(s). The UE could update their first applicable joint/DL/UL TCI state(s) or second applicable joint/DL/UL TCI state(s) with the indicated first or second joint/DL/UL TCI state(s), and then use/apply the first and/or second applicable/indicated joint/DL/UL TCI states for at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator), or at least channel(s)/signal(s) other than PDSCH(s)—e.g., UE-dedicated reception(s) on PDCCH (e.g., according to the first indicator) and/or dynamic-grant/configured-grant based PUSCH (e.g., according to the fourth indicator) and/or all of dedicated PUCCH resources (e.g., according to the fourth indicator) other than UE-dedicated reception(s) on PDSCH (e.g., according to the second indicator).
   When/if the second Rel-18 (enhanced) unified TCI state(s) activation/deactivation MAC CE activates/provides/indicates more than one sets of joint/DL/UL TCI state(s) with each set comprising either the first (1^{st}) or second (2^{nd}) joint/DL/UL TCI state(s) according to those specified herein in the present disclosure (or the joint/DL/UL TCI state(s) in all sets correspond to either the first (1^{st}) or second (2^{nd}) joint/DL/UL TCI state(s) according to those specified herein in the present disclosure) and mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of either the first (1^{st}) or second (2^{nd}) joint/DL/UL TCI state(s). After the indicated first (1^{st}) or second (2^{nd}) joint/DL/UL TCI state(s) has become applicable—e.g., after a time duration or beam application time (BAT) upon receiving the beam indication DCI, the UE could update their first applicable joint/DL/UL TCI state(s) or second applicable joint/DL/UL TCI state(s) with the indicated first or second joint/DL/UL TCI state(s), and then use/apply the first and/or second applicable/indicated joint/DL/UL TCI states for at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator), or at least channel(s)/signal(s) other than PDSCH(s)—e.g., UE-dedicated reception(s) on PDCCH (e.g., according to the first indicator) and/or dynamic-grant/configured-grant based PUSCH (e.g., according to the fourth indicator) and/or all of dedicated PUCCH resources (e.g., according to the fourth indicator) other than UE-dedicated reception(s) on PDSCH (e.g., according to the second indicator).

In one embodiment, for a CC/BWP operated under the Rel-17 unified TCI framework for STRP, or equivalently, for a CC/BWP operated in a STRP system or for STRP operation according to those specified herein in the present disclosure, a UE could receive from the network (e.g., the network 130) a Rel-17 unified TCI state(s) activation/deactivation MAC CE providing/indicating/activating one or more sets of joint/DL/UL TCI states with each set comprising one joint/DL/UL TCI state or a pair of DL and UL TCI states and mapped to a TCI codepoint of a TCI field in a beam indication DCI (e.g., DCI format 1_1/1_2 with or without DL assignment) and/or a second Rel-18 (enhanced) unified TCI state(s) activation/deactivation MAC CE providing/indicating/activating one or more sets of joint/DL/UL TCI states with each set comprising either one or more first (1^{st}) joint/DL/UL TCI states or one or more second (2^{nd}) joint/DL/UL TCI states according to those specified herein in the present disclosure (or the joint/DL/UL TCI states in all sets correspond to either the first (1^{st}) or second (2^{nd}) joint/DL/UL TCI states according to those specified herein in the present disclosure) and mapped to a TCI codepoint of a TCI field in a beam indication DCI (e.g., DCI format 1_1/1_2 with or without DL assignment). For the same CC/BWP:
When/if the Rel-17 unified TCI state(s) activation/deactivation MAC CE activates/provides/indicates a single set of joint/DL/UL TCI state(s) as specified herein in the present disclosure, after the joint/DL/UL TCI state(s) has become applicable—e.g., after a time duration or beam application time (BAT) upon receiving the Rel-17 unified TCI state(s) activation/deactivation MAC CE, the UE could use the indicated joint/DL/UL TCI state(s) for at least UE-dedicated reception(s) on PDCCH and/or PDSCH and/or dynamic-grant/configured-grant based PUSCH and/or all of dedicated PUCCH resources.
When/if the second Rel-18 (enhanced) unified TCI state(s) activation/deactivation MAC CE activates/provides/indicates a single set of only first (1^{st}) or second (2^{nd}) joint/DL/UL TCI state(s) as specified herein in the present disclosure, after the first (1^{st}) or second (2^{nd}) joint/DL/UL TCI state(s) have become applicable—e.g., after a time duration or beam application time (BAT) upon receiving the second Rel-18 (enhanced) unified TCI state(s) activation/deactivation MAC CE, the UE could use the indicated first (1^{st}) or second (2^{nd}) joint/DL/UL TCI state(s) for at least UE-dedicated reception(s) on PDCCH and/or PDSCH and/or dynamic-grant/configured-grant based PUSCH and/or all of dedicated PUCCH resources.
When/if the Rel-17 unified TCI state(s) activation/deactivation MAC CE activates/provides/indicates more than one sets of joint/DL/UL TCI state(s) with each set comprising a single joint/DL/UL TCI state or a pair of DL and UL TCI states and mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of joint/DL/UL TCI state(s). After the indicated joint/DL/UL TCI state(s) has become applicable—e.g., after a time duration or beam application time (BAT) upon receiving the beam indication DCI, the UE could use the indicated joint/DL/UL TCI state(s) for at least UE-dedicated reception(s) on PDCCH and/or PDSCH and/or dynamic-grant/configured-grant based PUSCH and/or all of dedicated PUCCH resources.
When/if the second Rel-18 (enhanced) unified TCI state(s) activation/deactivation MAC CE activates/provides/indicates more than one sets of joint/DL/UL TCI state(s) with each set comprising either the first (1^{st}) or second (2^{nd}) joint/DL/UL TCI state(s) according to those specified herein in the present disclosure (or the joint/DL/UL TCI state(s) in all sets correspond to either the first (1^{st}) or second (2^{nd}) joint/DL/UL TCI state(s) according to those specified herein in the present disclosure) and mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of either the first (1^{st}) or second (2^{nd}) joint/DL/UL TCI state(s). After the indicated first (1^{st}) or second (2^{nd}) joint/DL/UL TCI state(s) has become applicable—e.g., after a time duration or beam application time (BAT) upon receiving the beam indication DCI, the UE could use the indicated first (1^{st}) or second (2^{nd}) joint/DL/UL TCI state(s) for at least UE-dedicated reception(s) on PDCCH and/or PDSCH and/or dynamic-grant/configured-grant based PUSCH and/or all of dedicated PUCCH resources.

For the same CC/BWP, when/if the second indicator (or equivalently, the TCI selection field) as specified herein in the present disclosure is not present or is absent in the corresponding DCI format (e.g., DCI format 1_1/1_2)—e.g., when/if a higher layer RRC parameter tciSelection-PresentInDCI-r18 in BWP-Downlink Dedicated is not set to ‘enabled’ or set to ‘disabled’ indicating/providing that the second indicator/TCI selection field is absent in DCI format 1_1/1_2 for the DL BWP and/or when/if the second indicator/TCI selection field in DCI format 1_1/1_2 is (set to) 0) bit, and/or when/if the second indicator (or equivalently, the TCI selection field) as specified herein in the present disclosure is present in the corresponding DCI format (e.g., DCI format 1_1/1_2)—e.g., when/if the higher layer RRC parameter tciSelection-PresentInDCI-r18 in BWP-DownlinkDedicated is set to ‘enabled’ indicating/providing that the second indicator/TCI selection field is present in DCI format 1_1/1_2 for the DL BWP—but the second indicator/TCI selection field has not become applicable—e.g., before the higher layer RRC (re-)configuration and/or the higher layer RRC parameter tciSelection-PresentInDCI-r18 in BWP-Downlink Dedicated becomes applicable, and/or when/if the fourth indicator (or equivalently, the SRS resource set indicator field) as specified herein in the present disclosure is not present or is absent in the corresponding DCI format (e.g., DCI format 0_1/0_2) and/or when/if the fourth indicator/SRS resource set indicator field in DCI format 0_1/0_2 is (set to) (bit according to those specified herein in the present disclosure, and/or when/if the fourth indicator (or equivalently, the SRS resource set indicator field) as specified herein in the present disclosure is present in the corresponding DCI format (e.g., DCI format 0_1/0_2) but the fourth indicator/SRS resource set indicator field has not become applicable—e.g., before the higher layer RRC (re-)configuration and/or the corresponding higher layer RRC parameter(s) becomes applicable, and/or when/if the first and/or third indicator(s) as specified herein in the present disclosure for PDCCH reception(s) and/or PUCCH transmission(s) are/is not provided in the corresponding RRC signaling(s)/parameter(s), and/or when/if scheduling offset between PDSCH(s) and the scheduling PDCCH/DCI that provides/indicates the second indicator/TCI selection field is less than or equal to a threshold (e.g., timeDurationForQCL), and/or when/if the UE uses/applies both of the first and second applicable/indicated joint/DL/UL TCI states at least for PDSCH reception(s)—e.g., when/if the second indicator (or equivalently, the TCI selection field) is present in the corresponding DCI format 1_1/1_2 and set to value(s) ‘10’ or ‘11’ indicating/providing that both of the first and second TCI states could be used for PDSCH reception(s), and/or when/if the UE uses/applies the first or second applicable/indicated joint/DL/UL TCI state(s) at least for PDSCH reception(s)—e.g., when/if the second indicator (or equivalently, the TCI selection field) is present in the corresponding DCI format 1_1/1_2 and set to value(s) ‘00’ or ‘01’ indicating/providing that the first or second TCI state(s) could be used for PDSCH reception(s), and/or when/if the UE uses/applies both of the first and second applicable/indicated joint/DL/UL TCI states at least for PUSCH transmission(s)—e.g., when/if the fourth indicator (or equivalently, the SRS resource set indicator field) is present in the corresponding DCI format 0_1/0_2 and set to value(s) ‘10’ or ‘11’ indicating/providing that both of the first and second TCI states could be used for PUSCH transmission(s), and/or when/if the UE uses/applies the first or second applicable/indicated joint/DL/UL TCI state(s) at least for PUSCH transmission(s)—e.g., when/if the fourth indicator (or equivalently, the SRS resource set indicator field) is present in the corresponding DCI format 0_1/0_2 and set to value(s) ‘00’ or ‘01’ indicating/providing that the first or second TCI state(s) could be used for PUSCH transmission(s), and/or when/if the UE uses/applies both of the first and second applicable/indicated joint/DL/UL TCI states at least for PDCCH reception(s)—e.g., when/if the first indicator is provided via the corresponding RRC signaling(s)/parameter(s) and set to value(s) ‘10’ or ‘11’ indicating/providing that both of the first and second TCI states could be used for PDCCH reception(s), and/or when/if the UE uses/applies the first or second applicable/indicated joint/DL/UL TCI state(s) at least for PDCCH reception(s)—e.g., when/if the first indicator is provided in the corresponding RRC signaling(s)/parameter(s) and set to value(s) ‘00’ or ‘01’ indicating/providing that the first or second TCI state(s) could be used for PDCCH reception(s), and/or when/if the UE uses/applies both of the first and second applicable/indicated joint/DL/UL TCI states at least for PUCCH transmission(s)—e.g., when/if the third indicator is provided via the corresponding RRC signaling(s)/parameter(s) and set to value(s) ‘10’ or ‘11’ indicating/providing that both of the first and second TCI states could be used for PUCCH transmission(s), and/or when/if the UE uses/applies the first or second applicable/indicated joint/DL/UL TCI state(s) at least for PUCCH transmission(s)—e.g., when/if the third indicator is provided in the corresponding RRC signaling(s)/parameter(s) and set to value(s) ‘00’ or ‘01’ indicating/providing that the first or second TCI state(s) could be used for PUCCH transmission(s), and/or when/if the UE reports to the network the capability signaling oneDefaultTCI-State, or the UE is configured with enableOneDefaultTCI-State, or the UE does not report to the network the capability signaling twoDefaultTCI-States, or the UE is not configured with enable TwoDefaultTCI-States, or the UE reports to the network the capability signaling twoDefaultTCI-States, or the UE is configured with enableTwoDefaultTCI-States as specified herein in the present disclosure, or for the same CC/BWP regardless any condition(s)/restriction(s), or for the same CC/BWP when/if one or more of the above conditions do not hold or are not achieved/satisfied, e.g., when/if the second indicator (or equivalently, the TCI selection field) as specified herein in the present disclosure is present in the corresponding DCI format (e.g., DCI format 1_1/1_2)—e.g., when/if the higher layer RRC parameter tciSelection-PresentInDCI-r18 in BWP-DownlinkDedicated is set to ‘enabled’ indicating/providing that the second indicator/TCI selection field is present in DCI format 1_1/1_2 for the DL BWP—and is applicable, and/or when/if the fourth indicator (or equivalently, the SRS resource set indicator field) as specified herein in the present disclosure is present in the corresponding DCI format (e.g., DCI format 0_1/0_2) and is applicable, when/if the UE receives from the network a first Rel-18 (enhanced) unified TCI state(s) activation/deactivation MAC CE providing/indicating/activating one or more sets of joint/DL/UL TCI states with each set comprising one or more joint/DL/UL TCI states and mapped to a TCI codepoint of a TCI field in a beam indication DCI (e.g., DCI format 1_1/1_2 with or without DL assignment) and at least one set providing/comprising two joint/DL/UL TCI state(s) and/or pair(s) of joint/DL/UL TCI states-denoted by first joint/DL/UL TCI state(s) and second joint/DL/UL TCI state(s), the same CC/BWP is operated under the Rel-18 unified TCI framework extension for SDCI based MTRP, or equivalently, operated in a SDCI based MTRP system or for SDCI based MTRP operation according to those specified herein in the present disclosure such that:
When/if the first Rel-18 (enhanced) unified TCI state(s) activation/deactivation MAC CE activates/provides/indicates a single set of first and/or second joint/DL/UL TCI states as specified herein in the present disclosure, after the first and/or second joint/DL/UL TCI states have become applicable—e.g., after a time duration or beam application time (BAT) upon receiving the first Rel-18 (enhanced) unified TCI state(s) activation/deactivation MAC CE, the UE could update their first applicable joint/DL/UL TCI state(s) and/or second applicable joint/DL/UL TCI state(s) with the indicated first and/or second joint/DL/UL TCI state(s), and then use/apply the first and/or second applicable/indicated joint/DL/UL TCI states for at least UE-dedicated reception(s) on PDSCH (e.g., according to the second indicator), or for at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator).
When/if the first Rel-18 (enhanced) unified TCI state(s) activation/deactivation MAC CE activates/provides/indicates more than one sets of first and/or second joint/DL/UL TCI state(s) with each set mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of first and/or second joint/DL/UL TCI state(s). After the indicated first and/or second joint/DL/UL TCI state(s) has become applicable—e.g., after a time duration or beam application time (BAT) upon receiving the beam indication DCI, the UE could update their first applicable joint/DL/UL TCI state(s) and/or second applicable joint/DL/UL TCI state(s) with the indicated first and/or second joint/DL/UL TCI state(s), and then use/apply the first and/or second applicable/indicated joint/DL/UL TCI states for at least UE-dedicated reception(s) on PDSCH (e.g., according to the second indicator), or at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator).

Otherwise, i.e., when/if one or more of the above conditions do not hold or are not achieved/satisfied, e.g, when/if the second indicator (or equivalently, the TCI selection field) as specified herein in the present disclosure is present in the corresponding DCI format (e.g., DCI format 1_1/1_2)—e.g., when/if the higher layer RRC parameter tciSelection-PresentInDCI-r18 in BWP-DownlinkDedicated is set to ‘enabled’ indicating/providing that the second indicator/TCI selection field is present in DCI format 1_1/1_2 for the DL BWP—and is applicable, and/or when/if the fourth indicator (or equivalently, the SRS resource set indicator field) as specified herein in the present disclosure is present in the corresponding DCI format (e.g., DCI format 0_1/0_2) and is applicable, and/or when/if the first and/or third indicator(s) as specified herein in the present disclosure are/is provided in the corresponding RRC signaling(s)/parameter(s), for the same CC/BWP:
In one example, the UE may not be expected to receive from the network a first Rel-18 (enhanced) unified TCI state(s) activation/deactivation MAC CE providing/indicating/activating one or more sets of joint/DL/UL TCI states with each set comprising one or more joint/DL/UL TCI states and mapped to a TCI codepoint of a TCI field in a beam indication DCI (e.g., DCI format 1_1/1_2 with or without DL assignment) and at least one set providing/comprising two joint/DL/UL TCI state(s) and/or pair(s) of joint/DL/UL TCI states—denoted by first joint/DL/UL TCI state(s) and second joint/DL/UL TCI state(s).
In another example, when/if the UE receives from the network a first Rel-18 (enhanced) unified TCI state(s) activation/deactivation MAC CE providing/indicating/activating one or more sets of joint/DL/UL TCI states with each set comprising one or more joint/DL/UL TCI states and mapped to a TCI codepoint of a TCI field in a beam indication DCI (e.g., DCI format 1_1/1_2 with or without DL assignment) and at least one set providing/comprising two joint/DL/UL TCI state(s) and/or pair(s) of joint/DL/UL TCI states-denoted by first joint/DL/UL TCI state(s) and second joint/DL/UL TCI state(s), the same CC/BWP would still be operated under the Rel-17 unified TCI framework for STRP, or equivalently, operated in a STRP system or for STRP operation according to those specified herein in the present disclosure such that:
   When/if the first Rel-18 (enhanced) unified TCI state(s) activation/deactivation MAC CE activates/provides/indicates a single set of first and/or second joint/DL/UL TCI states as specified herein in the present disclosure, after the first and/or second joint/DL/UL TCI states have become applicable—e.g., after a time duration or beam application time (BAT) upon receiving the first Rel-18 (enhanced) unified TCI state(s) activation/deactivation MAC CE, the UE could use the indicated first or second joint/DL/UL TCI state(s)—e.g., based on/according to network's configuration(s)/indication(s) via higher layer RRC signaling(s)/parameter(s) and/or MAC CE command(s) and/or dynamic DCI based L1 signaling(s)—for at least UE-dedicated reception(s) on PDCCH and/or PDSCH and/or dynamic-grant/configured-grant based PUSCH and/or all of dedicated PUCCH resources, or at least channel(s)/signal(s) other than PDSCH(s)—e.g., UE-dedicated reception(s) on PDCCH and/or dynamic-grant/configured-grant based PUSCH and/or all of dedicated PUCCH resources other than UE-dedicated reception(s) on PDSCH.
   When/if the first Rel-18 (enhanced) unified TCI state(s) activation/deactivation MAC CE activates/provides/indicates more than one sets of first and/or second joint/DL/UL TCI state(s) with each set mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of first and/or second joint/DL/UL TCI state(s). After the indicated first and/or second joint/DL/UL TCI state(s) has become applicable—e.g., after a time duration or beam application time (BAT) upon receiving the beam indication DCI, the UE could use the indicated first or second joint/DL/UL TCI state(s)—e.g., based on/according to network's configuration(s)/indication(s) via higher layer RRC signaling(s)/parameter(s) and/or MAC CE command(s) and/or dynamic DCI based L1 signaling(s)—for at least UE-dedicated reception(s) on PDCCH and/or PDSCH and/or dynamic-grant/configured-grant based PUSCH and/or all of dedicated PUCCH resources, or at least channel(s)/signal(s) other than PDSCH(s)—e.g., UE-dedicated reception(s) on PDCCH and/or dynamic-grant/configured-grant based PUSCH and/or all of dedicated PUCCH resources other than UE-dedicated reception(s) on PDSCH.

In one embodiment, for a CC/BWP operated under the Rel-18 unified TCI framework extension for SDCI based MTRP, or equivalently, for a CC/BWP operated in a SDCI based MTRP system or for SDCI based MTRP operation according to those specified herein in the present disclosure, a UE could receive from the network (e.g., the network 130) a first Rel-18 (enhanced) unified TCI state(s) activation/deactivation MAC CE providing/indicating/activating one or more sets of joint/DL/UL TCI states with each set comprising one or more joint/DL/UL TCI states and mapped to a TCI codepoint of a TCI field in a beam indication DCI (e.g., DCI format 1_1/1_2 with or without DL assignment); here, the first Rel-18 (enhanced) unified TCI state(s) activation/deactivation MAC CE could provide/indicate/activate at least one set of two joint/DL/UL TCI state(s) and/or pair(s) of joint/DL/UL TCI states-denoted by first joint/DL/UL TCI state(s) and second joint/DL/UL TCI state(s), and/or a UE could receive from the network a second Rel-18 (enhanced) unified TCI state(s) activation/deactivation MAC CE providing/indicating/activating one or more sets of joint/DL/UL TCI states with each set comprising either one or more first (1^{st}) joint/DL/UL TCI states or one or more second (2^{nd}) joint/DL/UL TCI states according to those specified herein in the present disclosure (or the joint/DL/UL TCI states in all sets correspond to either the first (1^{st}) or second (2^{nd}) joint/DL/UL TCI states according to those specified herein in the present disclosure) and mapped to a TCI codepoint of a TCI field in a beam indication DCI (e.g., DCI format 1_1/1_2 with or without DL assignment). For the same CC/BWP:
When/if the first Rel-18 (enhanced) unified TCI activation/deactivation MAC CE activates/provides/indicates a single set of first and/or second joint/DL/UL TCI states as specified herein in the present disclosure, after the first and/or second joint/DL/UL TCI states have become applicable—e.g., after a time duration or beam application time (BAT) upon receiving the first Rel-18 (enhanced) unified TCI state(s) activation/deactivation MAC CE, the UE could update their first applicable joint/DL/UL TCI state(s) and/or second applicable joint/DL/UL TCI state(s) with the indicated first and/or second joint/DL/UL TCI state(s), and then use/apply the first and/or second applicable/indicated joint/DL/UL TCI states for at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator).
When/if the first Rel-18 (enhanced) unified TCI state(s) activation/deactivation MAC CE activates/provides/indicates more than one sets of first and/or second joint/DL/UL TCI state(s) with each set mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of first and/or second joint/DL/UL TCI state(s). After the indicated first and/or second joint/DL/UL TCI state(s) has become applicable—e.g., after a time duration or beam application time (BAT) upon receiving the beam indication DCI, the UE could update their first applicable joint/DL/UL TCI state(s) and/or second applicable joint/DL/UL TCI state(s) with the indicated first and/or second joint/DL/UL TCI state(s), and then use/apply the first and/or second applicable/indicated joint/DL/UL TCI states for at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator).
When/if the second Rel-18 (enhanced) unified TCI state(s) activation/deactivation MAC CE activates/provides/indicates a single set of only first (1^{st}) or second (2^{nd}) joint/DL/UL TCI state(s) as specified herein in the present disclosure, after the first (1^{st}) or second (2^{nd}) joint/DL/UL TCI state(s) have become applicable—e.g., after a time duration or beam application time (BAT) upon receiving the second Rel-18 (enhanced) unified TCI state(s) activation/deactivation MAC CE, the UE could update their first applicable joint/DL/UL TCI state(s) or second applicable joint/DL/UL TCI state(s) with the indicated first or second joint/DL/UL TCI state(s), and then use/apply the first and/or second applicable/indicated joint/DL/UL TCI states for at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator).
When/if the second Rel-18 (enhanced) unified TCI state(s) activation/deactivation MAC CE activates/provides/indicates more than one sets of joint/DL/UL TCI state(s) with each set comprising either the first (1^{st}) or second (2^{nd}) joint/DL/UL TCI state(s) according to those specified herein in the present disclosure (or the joint/DL/UL TCI state(s) in all sets correspond to either the first (1^{st}) or second (2^{nd}) joint/DL/UL TCI state(s) according to those specified herein in the present disclosure) and mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of either the first (1^{st}) or second (2^{nd}) joint/DL/UL TCI state(s). After the indicated first (1^{st}) or second (2^{nd}) joint/DL/UL TCI state(s) has become applicable—e.g., after a time duration or beam application time (BAT) upon receiving the beam indication DCI, the UE could update their first applicable joint/DL/UL TCI state(s) or second applicable joint/DL/UL TCI state(s) with the indicated first or second joint/DL/UL TCI state(s), and then use/apply the first and/or second applicable/indicated joint/DL/UL TCI states for at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator).

For the same CC/BWP, when/if the second indicator (or equivalently, the TCI selection field) as specified herein in the present disclosure is not present or is absent in the corresponding DCI format (e.g., DCI format 1_1/1_2)—e.g., when/if a higher layer RRC parameter tciSelection-PresentInDCI-r18 in BWP-Downlink Dedicated is not set to ‘enabled’ or set to ‘disabled’ indicating/providing that the second indicator/TCI selection field is absent in DCI format 1_1/1_2 for the DL BWP and/or when/if the second indicator/TCI selection field in DCI format 1_1/1_2 is (set to) 0 bit, and/or when/if the second indicator (or equivalently, the TCI selection field) as specified herein in the present disclosure is present in the corresponding DCI format (e.g., DCI format 1_1/1_2)—e.g., when/if the higher layer RRC parameter tciSelection-PresentInDCI-r18 in BWP-DownlinkDedicated is set to ‘enabled’ indicating/providing that the second indicator/TCI selection field is present in DCI format 1_1/1_2 for the DL BWP—but the second indicator/TCI selection field has not become applicable—e.g., before the higher layer RRC (re-)configuration and/or the higher layer RRC parameter tciSelection-PresentInDCI-r18 in BWP-DownlinkDedicated becomes applicable, and/or when/if the fourth indicator (or equivalently, the SRS resource set indicator field) as specified herein in the present disclosure is not present or is absent in the corresponding DCI format (e.g., DCI format 0_1/0_2) and/or when/if the fourth indicator/SRS resource set indicator field in DCI format 0_1/0_2 is (set to) 0 bit according to those specified herein in the present disclosure, and/or when/if the fourth indicator (or equivalently, the SRS resource set indicator field) as specified herein in the present disclosure is present in the corresponding DCI format (e.g., DCI format 0_1/0_2) but the fourth indicator/SRS resource set indicator field has not become applicable—e.g., before the higher layer RRC (re-)configuration and/or the corresponding higher layer RRC parameter(s) becomes applicable, and/or when/if the first and/or third indicator(s) as specified herein in the present disclosure for PDCCH reception(s) and/or PUCCH transmission(s) are/is not provided in the corresponding RRC signaling(s)/parameter(s), and/or when/if scheduling offset between PDSCH(s) and the scheduling PDCCH/DCI that provides/indicates the second indicator/TCI selection field is less than or equal to a threshold (e.g., timeDurationForQCL), and/or when/if the UE uses/applies both of the first and second applicable/indicated joint/DL/UL TCI states at least for PDSCH reception(s)—e.g., when/if the second indicator (or equivalently, the TCI selection field) is present in the corresponding DCI format 1_1/1_2 and set to value(s) ‘10’ or ‘11’ indicating/providing that both of the first and second TCI states could be used for PDSCH reception(s), and/or when/if the UE uses/applies the first or second applicable/indicated joint/DL/UL TCI state(s) at least for PDSCH reception(s)—e.g., when/if the second indicator (or equivalently, the TCI selection field) is present in the corresponding DCI format 1_1/1_2 and set to value(s) ‘00’ or ‘01’ indicating/providing that the first or second TCI state(s) could be used for PDSCH reception(s), and/or when/if the UE uses/applies both of the first and second applicable/indicated joint/DL/UL TCI states at least for PUSCH transmission(s)—e.g., when/if the fourth indicator (or equivalently, the SRS resource set indicator field) is present in the corresponding DCI format 0_1/0_2 and set to value(s) ‘10’ or ‘11’ indicating/providing that both of the first and second TCI states could be used for PUSCH transmission(s), and/or when/if the UE uses/applies the first or second applicable/indicated joint/DL/UL TCI state(s) at least for PUSCH transmission(s)—e.g., when/if the fourth indicator (or equivalently, the SRS resource set indicator field) is present in the corresponding DCI format 0_1/0_2 and set to value(s) ‘00’ or ‘01’ indicating/providing that the first or second TCI state(s) could be used for PUSCH transmission(s), and/or when/if the UE uses/applies both of the first and second applicable/indicated joint/DL/UL TCI states at least for PDCCH reception(s)—e.g., when/if the first indicator is provided via the corresponding RRC signaling(s)/parameter(s) and set to value(s) ‘10’ or ‘11’ indicating/providing that both of the first and second TCI states could be used for PDCCH reception(s), and/or when/if the UE uses/applies the first or second applicable/indicated joint/DL/UL TCI state(s) at least for PDCCH reception(s)—e.g., when/if the first indicator is provided in the corresponding RRC signaling(s)/parameter(s) and set to value(s) ‘00’ or ‘01’ indicating/providing that the first or second TCI state(s) could be used for PDCCH reception(s), and/or when/if the UE uses/applies both of the first and second applicable/indicated joint/DL/UL TCI states at least for PUCCH transmission(s)—e.g., when/if the third indicator is provided via the corresponding RRC signaling(s)/parameter(s) and set to value(s) ‘10’ or ‘11’ indicating/providing that both of the first and second TCI states could be used for PUCCH transmission(s), and/or when/if the UE uses/applies the first or second applicable/indicated joint/DL/UL TCI state(s) at least for PUCCH transmission(s)—e.g., when/if the third indicator is provided in the corresponding RRC signaling(s)/parameter(s) and set to value(s) ‘00’ or ‘01’ indicating/providing that the first or second TCI state(s) could be used for PUCCH transmission(s), and/or when/if the UE reports to the network the capability signaling oneDefaultTCI-State, or the UE is configured with enableOneDefaultTCI-State, or the UE does not report to the network the capability signaling twoDefaultTCI-States, or the UE is not configured with enable TwoDefaultTCI-States, or the UE reports to the network the capability signaling twoDefaultTCI-States, or the UE is configured with enableTwoDefaultTCI-States as specified herein in the present disclosure, or for the same CC/BWP regardless any condition(s)/restriction(s), or for the same CC/BWP when/if one or more of the above conditions do not hold or are not achieved/satisfied, e.g., when/if the second indicator (or equivalently, the TCI selection field) as specified herein in the present disclosure is present in the corresponding DCI format (e.g., DCI format 1_1/1_2)—e.g., when/if the higher layer RRC parameter tciSelection-PresentInDCI-r18 in BWP-DownlinkDedicated is set to ‘enabled’ indicating/providing that the second indicator/TCI selection field is present in DCI format 1_1/1_2 for the DL BWP—and is applicable, and/or when/if the fourth indicator (or equivalently, the SRS resource set indicator field) as specified herein in the present disclosure is present in the corresponding DCI format (e.g., DCI format 0_1/0_2) and is applicable, when/if the UE receives from the network a Rel-17 unified TCI state(s) activation/deactivation MAC CE providing/indicating/activating one or more sets of joint/DL/UL TCI states with each set comprising one joint/DL/UL TCI state or a pair of DL and UL TCI states and mapped to a TCI codepoint of a TCI field in a beam indication DCI (e.g., DCI format 1_1/1_2 with or without DL assignment), the same CC/BWP is operated under the Rel-17 unified TCI framework for STRP, or equivalently, the same CC/BWP is operated in a STRP system or for STRP operation according to those specified herein in the present disclosure such that:
When/if the Rel-17 unified TCI state(s) activation/deactivation MAC CE activates/provides/indicates a single set of joint/DL/UL TCI state(s) as specified herein in the present disclosure, after the joint/DL/UL TCI state(s) has become applicable—e.g., after a time duration or beam application time (BAT) upon receiving the Rel-17 unified TCI state(s) activation/deactivation MAC CE, the UE could use the indicated joint/DL/UL TCI state(s) for at least UE-dedicated reception(s) on PDSCH, or at least UE-dedicated reception(s) on PDCCH and/or PDSCH and/or dynamic-grant/configured-grant based PUSCH and/or all of dedicated PUCCH resources.
When/if the Rel-17 unified TCI state(s) activation/deactivation MAC CE activates/provides/indicates more than one sets of joint/DL/UL TCI state(s) with each set comprising a single joint/DL/UL TCI state or a pair of DL and UL TCI states and mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of joint/DL/UL TCI state(s). After the indicated joint/DL/UL TCI state(s) has become applicable—e.g., after a time duration or beam application time (BAT) upon receiving the beam indication DCI, the UE could use the indicated joint/DL/UL TCI state(s) for at least UE-dedicated reception(s) on PDSCH, or at least UE-dedicated reception(s) on PDCCH and/or PDSCH and/or dynamic-grant/configured-grant based PUSCH and/or all of dedicated PUCCH resources.

Otherwise, i.e., when/if one or more of the above conditions do not hold or are not achieved/satisfied, e.g., when/if the second indicator (or equivalently, the TCI selection field) as specified herein in the present disclosure is present in the corresponding DCI format (e.g., DCI format 1_1/1_2)—e.g., when/if the higher layer RRC parameter teiSelection-PresentInDCI-r18 in BWP-Downlink Dedicated is set to ‘enabled’ indicating/providing that the second indicator/TCI selection field is present in DCI format 1_1/1_2 for the DL BWP—and is applicable, and/or when/if the fourth indicator (or equivalently, the SRS resource set indicator field) as specified herein in the present disclosure is present in the corresponding DCI format (e.g., DCI format 0_1/0_2) and is applicable, and/or when/if the first and/or third indicator(s) as specified herein in the present disclosure are/is provided in the corresponding RRC signaling(s)/parameter(s), for the same CC/BWP:
In one example, the UE may not be expected to receive from the network a Rel-17 unified TCI state(s) activation/deactivation MAC CE providing/indicating/activating one or more sets of joint/DL/UL TCI states with each set comprising one joint/DL/UL TCI state or a pair of DL and UL TCI states and mapped to a TCI codepoint of a TCI field in a beam indication DCI (e.g., DCI format 1_1/1_2 with or without DL assignment).
In another example, when/if the UE receives from the network a Rel-17 unified TCI state(s) activation/deactivation MAC CE providing/indicating/activating one or more sets of joint/DL/UL TCI states with each set comprising one joint/DL/UL TCI state or a pair of DL and UL TCI states and mapped to a TCI codepoint of a TCI field in a beam indication DCI (e.g., DCI format 1_1/1_2 with or without DL assignment), the same CC/BWP would still be operated under the Rel-18 unified TCI framework extension for SDCI based MTRP, or equivalently, operated in a SDCI based MTRP system or for SDCI based MTRP operation according to those specified herein in the present disclosure such that:
   When/if the Rel-17 unified TCI state(s) activation/deactivation MAC CE activates/provides/indicates a single set of joint/DL/UL TCI state(s) as specified herein in the present disclosure, after the joint/DL/UL TCI state(s) has become applicable—e.g., after a time duration or beam application time (BAT) upon receiving the Rel-17 unified TCI state(s) activation/deactivation MAC CE, the UE could first determine/identify, e.g., based on/according to indicator(s) associated/corresponding to the joint/DL/UL TCI state(s) in the MAC CE, whether the indicated joint/DL/UL TCI state(s) correspond to the first TCI state(s) or the second TCI state(s). The UE could update their first applicable joint/DL/UL TCI state(s) or second applicable joint/DL/UL TCI state(s) with the indicated first or second joint/DL/UL TCI state(s), and then use/apply the first and/or second applicable/indicated joint/DL/UL TCI states for at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator), or at least channel(s)/signal(s) other than PDSCH(s)—e.g., UE-dedicated reception(s) on PDCCH (e.g., according to the first indicator) and/or dynamic-grant/configured-grant based PUSCH (e.g., according to the fourth indicator) and/or all of dedicated PUCCH resources (e.g., according to the fourth indicator) other than UE-dedicated reception(s) on PDSCH (e.g., according to the second indicator).
   When/if the Rel-17 unified TCI state(s) activation/deactivation MAC CE activates/provides/indicates more than one sets of joint/DL/UL TCI state(s) with each set comprising a single joint/DL/UL TCI state or a pair of DL and UL TCI states and mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of joint/DL/UL TCI state(s). After the indicated joint/DL/UL TCI state(s) has become applicable—e.g., after a time duration or beam application time (BAT) upon receiving the beam indication DCI, the UE could first determine/identify, e.g., based on/according to indicator(s) associated/corresponding to the indicated joint/DL/UL TCI state(s) in the MAC CE, whether the indicated joint/DL/UL TCI state(s) correspond to the first TCI state(s) or the second TCI state(s). The UE could update their first applicable joint/DL/UL TCI state(s) or second applicable joint/DL/UL TCI state(s) with the indicated first or second joint/DL/UL TCI state(s), and then use/apply the first and/or second applicable/indicated joint/DL/UL TCI states for at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator), or at least channel(s)/signal(s) other than PDSCH(s)—e.g., UE-dedicated reception(s) on PDCCH (e.g., according to the first indicator) and/or dynamic-grant/configured-grant based PUSCH (e.g., according to the fourth indicator) and/or all of dedicated PUCCH resources (e.g., according to the fourth indicator) other than UE-dedicated reception(s) on PDSCH (e.g., according to the second indicator).

In one embodiment, for a CC/BWP operated under the Rel-17 unified TCI framework for STRP, or equivalently, for a CC/BWP operated in a STRP system or for STRP operation according to those specified herein in the present disclosure, a UE could receive from the network (e.g., the network 130) a Rel-17 unified TCI state(s) activation/deactivation MAC CE providing/indicating/activating one or more sets of joint/DL/UL TCI states with each set comprising one joint/DL/UL TCI state or a pair of DL and UL TCI states and mapped to a TCI codepoint of a TCI field in a beam indication DCI (e.g., DCI format 1_1/1_2 with or without DL assignment. For the same CC/BWP:
When/if the Rel-17 unified TCI state(s) activation/deactivation MAC CE activates/provides/indicates a single set of joint/DL/UL TCI state(s) as specified herein in the present disclosure, after the joint/DL/UL TCI state(s) has become applicable—e.g., after a time duration or beam application time (BAT) upon receiving the Rel-17 unified TCI state(s) activation/deactivation MAC CE, the UE could use the indicated joint/DL/UL TCI state(s) for at least UE-dedicated reception(s) on PDCCH and/or PDSCH and/or dynamic-grant/configured-grant based PUSCH and/or all of dedicated PUCCH resources.
When/if the Rel-17 unified TCI state(s) activation/deactivation MAC CE activates/provides/indicates more than one sets of joint/DL/UL TCI state(s) with each set comprising a single joint/DL/UL TCI state or a pair of DL and UL TCI states and mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of joint/DL/UL TCI state(s). After the indicated joint/DL/UL TCI state(s) has become applicable—e.g., after a time duration or beam application time (BAT) upon receiving the beam indication DCI, the UE could use the indicated joint/DL/UL TCI state(s) for at least UE-dedicated reception(s) on PDCCH and/or PDSCH and/or dynamic-grant/configured-grant based PUSCH and/or all of dedicated PUCCH resources.

For the same CC/BWP, when/if the second indicator (or equivalently, the TCI selection field) as specified herein in the present disclosure is not present or is absent in the corresponding DCI format (e.g., DCI format 1_1/1_2)—e.g., when/if a higher layer RRC parameter tciSelection-PresentInDCI-r18 in BWP-Downlink Dedicated is not set to ‘enabled’ or set to ‘disabled’ indicating/providing that the second indicator/TCI selection field is absent in DCI format 1_1/1_2 for the DL BWP and/or when/if the second indicator/TCI selection field in DCI format 1_1/1_2 is (set to) 0 bit, and/or when/if the second indicator (or equivalently, the TCI selection field) as specified herein in the present disclosure is present in the corresponding DCI format (e.g., DCI format 1_1/1_2)—e.g., when/if the higher layer RRC parameter tciSelection-PresentInDCI-r18 in BWP-DownlinkDedicated is set to ‘enabled’ indicating/providing that the second indicator/TCI selection field is present in DCI format 1_1/1_2 for the DL BWP—but the second indicator/TCI selection field has not become applicable—e.g., before the higher layer RRC (re-)configuration and/or the higher layer RRC parameter tciSelection-PresentInDCI-r18 in BWP-Downlink Dedicated becomes applicable, and/or when/if the fourth indicator (or equivalently, the SRS resource set indicator field) as specified herein in the present disclosure is not present or is absent in the corresponding DCI format (e.g., DCI format 0_1/0_2) and/or when/if the fourth indicator/SRS resource set indicator field in DCI format 0_1/0_2 is (set to) 0 bit according to those specified herein in the present disclosure, and/or when/if the fourth indicator (or equivalently, the SRS resource set indicator field) as specified herein in the present disclosure is present in the corresponding DCI format (e.g., DCI format 0_1/0_2), but the fourth indicator/SRS resource set indicator field has not become applicable—e.g., before the higher layer RRC (re-)configuration and/or the corresponding higher layer RRC parameter(s) becomes applicable, and/or when/if the first and/or third indicator(s) as specified herein in the present disclosure for PDCCH reception(s) and/or PUCCH transmission(s) are/is not provided in the corresponding RRC signaling(s)/parameter(s), and/or when/if scheduling offset between PDSCH(s) and the scheduling PDCCH/DCI that provides/indicates the second indicator/TCI selection field is less than or equal to a threshold (e.g., timeDurationForQCL), and/or when/if the UE uses/applies both of the first and second applicable/indicated joint/DL/UL TCI states at least for PDSCH reception(s)—e.g., when/if the second indicator (or equivalently, the TCI selection field) is present in the corresponding DCI format 1_1/1_2 and set to value(s) ‘10’ or ‘11’ indicating/providing that both of the first and second TCI states could be used for PDSCH reception(s), and/or when/if the UE uses/applies the first or second applicable/indicated joint/DL/UL TCI state(s) at least for PDSCH reception(s)—e.g., when/if the second indicator (or equivalently, the TCI selection field) is present in the corresponding DCI format 1_1/1_2 and set to value(s) ‘00’ or ‘01’ indicating/providing that the first or second TCI state(s) could be used for PDSCH reception(s), and/or when/if the UE uses/applies both of the first and second applicable/indicated joint/DL/UL TCI states at least for PUSCH transmission(s)—e.g., when/if the fourth indicator (or equivalently, the SRS resource set indicator field) is present in the corresponding DCI format 0_1/0_2 and set to value(s) ‘10’ or ‘11’ indicating/providing that both of the first and second TCI states could be used for PUSCH transmission(s), and/or when/if the UE uses/applies the first or second applicable/indicated joint/DL/UL TCI state(s) at least for PUSCH transmission(s)—e.g., when/if the fourth indicator (or equivalently, the SRS resource set indicator field) is present in the corresponding DCI format 0_1/0_2 and set to value(s) ‘00’ or ‘01’ indicating/providing that the first or second TCI state(s) could be used for PUSCH transmission(s), and/or when/if the UE uses/applies both of the first and second applicable/indicated joint/DL/UL TCI states at least for PDCCH reception(s)—e.g., when/if the first indicator is provided via the corresponding RRC signaling(s)/parameter(s) and set to value(s) ‘10’ or ‘11’ indicating/providing that both of the first and second TCI states could be used for PDCCH reception(s), and/or when/if the UE uses/applies the first or second applicable/indicated joint/DL/UL TCI state(s) at least for PDCCH reception(s)—e.g., when/if the first indicator is provided in the corresponding RRC signaling(s)/parameter(s) and set to value(s) ‘00’ or ‘01’ indicating/providing that the first or second TCI state(s) could be used for PDCCH reception(s), and/or when/if the UE uses/applies both of the first and second applicable/indicated joint/DL/UL TCI states at least for PUCCH transmission(s)—e.g., when/if the third indicator is provided via the corresponding RRC signaling(s)/parameter(s) and set to value(s) ‘10’ or ‘11’ indicating/providing that both of the first and second TCI states could be used for PUCCH transmission(s), and/or when/if the UE uses/applies the first or second applicable/indicated joint/DL/UL TCI state(s) at least for PUCCH transmission(s)—e.g., when/if the third indicator is provided in the corresponding RRC signaling(s)/parameter(s) and set to value(s) ‘00’ or ‘01’ indicating/providing that the first or second TCI state(s) could be used for PUCCH transmission(s), and/or when/if the UE reports to the network the capability signaling oneDefaultTCI-State, or the UE is configured with enableOneDefaultTCI-State, or the UE does not report to the network the capability signaling twoDefaultTCI-States, or the UE is not configured with enable TwoDefaultTCI-States, or the UE reports to the network the capability signaling twoDefaultTCI-States, or the UE is configured with enableTwoDefaultTCI-States as specified herein in the present disclosure, or for the same CC/BWP regardless any condition(s)/restriction(s), or for the same CC/BWP when/if one or more of the above conditions do not hold or are not achieved/satisfied, e.g., when/if the second indicator (or equivalently, the TCI selection field) as specified herein in the present disclosure is present in the corresponding DCI format (e.g., DCI format 1_1/1_2)—e.g., when/if the higher layer RRC parameter tciSelection-PresentInDCI-r18 in BWP-DownlinkDedicated is set to ‘enabled’ indicating/providing that the second indicator/TCI selection field is present in DCI format 1_1/1_2 for the DL BWP—and is applicable, and/or when/if the fourth indicator (or equivalently, the SRS resource set indicator field) as specified herein in the present disclosure is present in the corresponding DCI format (e.g., DCI format 0_1/0_2) and is applicable, when/if the UE receives from the network a first Rel-18 (enhanced) unified TCI state(s) activation/deactivation MAC CE providing/indicating/activating one or more sets of joint/DL/UL TCI states with each set comprising one or more joint/DL/UL TCI states and mapped to a TCI codepoint of a TCI field in a beam indication DCI (e.g., DCI format 1_1/1_2 with or without DL assignment) and at least one set providing/comprising two joint/DL/UL TCI state(s) and/or pair(s) of joint/DL/UL TCI states-denoted by first joint/DL/UL TCI state(s) and second joint/DL/UL TCI state(s), and/or when/if the UE receives from the network a second Rel-18 (enhanced) unified TCI state(s) activation/deactivation MAC CE providing/indicating/activating one or more sets of joint/DL/UL TCI states with each set comprising either one or more first (1^{st}) joint/DL/UL TCI states or one or more second (2^{nd}) joint/DL/UL TCI states according to those specified herein in the present disclosure (or the joint/DL/UL TCI states in all sets correspond to either the first (1^{st}) or second (2^{nd}) joint/DL/UL TCI states according to those specified herein in the present disclosure) and mapped to a TCI codepoint of a TCI field in a beam indication DCI (e.g., DCI format 1_1/1_2 with or without DL assignment), the same CC/BWP is operated under the Rel-18 unified TCI framework extension for SDCI based MTRP, or equivalently, operated in a SDCI based MTRP system or for SDCI based MTRP operation according to those specified herein in the present disclosure such that:
When/if the first Rel-18 (enhanced) unified TCI state(s) activation/deactivation MAC CE activates/provides/indicates a single set of first and/or second joint/DL/UL TCI states as specified herein in the present disclosure, after the first and/or second joint/DL/UL TCI states have become applicable—e.g., after a time duration or beam application time (BAT) upon receiving the first Rel-18 (enhanced) unified TCI state(s) activation/deactivation MAC CE, the UE could update their first applicable joint/DL/UL TCI state(s) and/or second applicable joint/DL/UL TCI state(s) with the indicated first and/or second joint/DL/UL TCI state(s), and then use/apply the first and/or second applicable/indicated joint/DL/UL TCI states for at least UE-dedicated reception(s) on PDSCH (e.g., according to the second indicator), or at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator).
When/if the first Rel-18 (enhanced) unified TCI state(s) activation/deactivation MAC CE activates/provides/indicates more than one sets of first and/or second joint/DL/UL TCI state(s) with each set mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of first and/or second joint/DL/UL TCI state(s). After the indicated first and/or second joint/DL/UL TCI state(s) has become applicable—e.g., after a time duration or beam application time (BAT) upon receiving the beam indication DCI, the UE could update their first applicable joint/DL/UL TCI state(s) and/or second applicable joint/DL/UL TCI state(s) with the indicated first and/or second joint/DL/UL TCI state(s), and then use/apply the first and/or second applicable/indicated joint/DL/UL TCI states for at least UE-dedicated reception(s) on PDSCH (e.g., according to the second indicator), or at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator).
When/if the second Rel-18 (enhanced) unified TCI state(s) activation/deactivation MAC CE activates/provides/indicates a single set of only first (1^{st}) or second (2^{nd}) joint/DL/UL TCI state(s) as specified herein in the present disclosure, after the first (1^{st}) or second (2^{nd}) joint/DL/UL TCI state(s) have become applicable—e.g., after a time duration or beam application time (BAT) upon receiving the second Rel-18 (enhanced) unified TCI state(s) activation/deactivation MAC CE, the UE could update their first applicable joint/DL/UL TCI state(s) or second applicable joint/DL/UL TCI state(s) with the indicated first or second joint/DL/UL TCI state(s), and then use/apply the first and/or second applicable/indicated joint/DL/UL TCI states for at least UE-dedicated reception(s) on PDSCH (e.g., according to the second indicator), or at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator).
When/if the second Rel-18 (enhanced) unified TCI state(s) activation/deactivation MAC CE activates/provides/indicates more than one sets of joint/DL/UL TCI state(s) with each set comprising either the first (1^{st}) or second (2^{nd}) joint/DL/UL TCI state(s) according to those specified herein in the present disclosure (or the joint/DL/UL TCI state(s) in all sets correspond to either the first (1^{st}) or second (2^{nd}) joint/DL/UL TCI state(s) according to those specified herein in the present disclosure) and mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of either the first (1^{st}) or second (2^{nd}) joint/DL/UL TCI state(s). After the indicated first (1^{st}) or second (2^{nd}) joint/DL/UL TCI state(s) has become applicable—e.g., after a time duration or beam application time (BAT) upon receiving the beam indication DCI, the UE could update their first applicable joint/DL/UL TCI state(s) or second applicable joint/DL/UL TCI state(s) with the indicated first or second joint/DL/UL TCI state(s), and then use/apply the first and/or second applicable/indicated joint/DL/UL TCI states for at least UE-dedicated reception(s) on PDSCH (e.g., according to the second indicator), or at least UE-dedicated reception(s) on PDCCH (e.g., according to the first indicator) and/or PDSCH (e.g., according to the second indicator) and/or dynamic-grant/configured-grant based PUSCH (e.g., according to the fourth indicator) and/or all of dedicated PUCCH resources (e.g., according to the third indicator).

Otherwise, i.e., when/if one or more of the above conditions do not hold or are not achieved/satisfied, e.g., when/if the second indicator (or equivalently, the TCI selection field) as specified herein in the present disclosure is present in the corresponding DCI format (e.g., DCI format 1_1/1_2)—e.g., when/if the higher layer RRC parameter teiSelection-PresentInDCI-r18 in BWP-Downlink Dedicated is set to ‘enabled’ indicating/providing that the second indicator/TCI selection field is present in DCI format 1_1/1_2 for the DL BWP—and is applicable, and/or when/if the fourth indicator (or equivalently, the SRS resource set indicator field) as specified herein in the present disclosure is present in the corresponding DCI format (e.g., DCI format 0_1/0_2) and is applicable, and/or when/if the first and/or third indicator(s) as specified herein in the present disclosure arc/is provided in the corresponding RRC signaling(s)/parameter(s), for the same CC/BWP:
In one example, the UE may not be expected to receive from the network (e.g., the network 130) a first Rel-18 (enhanced) unified TCI state(s) activation/deactivation MAC CE providing/indicating/activating one or more sets of joint/DL/UL TCI states with each set comprising one or more joint/DL/UL TCI states and mapped to a TCI codepoint of a TCI field in a beam indication DCI (e.g., DCI format 1_1/1_2 with or without DL assignment) and at least one set providing/comprising two joint/DL/UL TCI state(s) and/or pair(s) of joint/DL/UL TCI states-denoted by first joint/DL/UL TCI state(s) and second joint/DL/UL TCI state(s), and/or the UE may not be expected to receive a second Rel-18 (enhanced) unified TCI state(s) activation/deactivation MAC CE providing/indicating/activating one or more sets of joint/DL/UL TCI states with each set comprising either one or more first (1^{st}) joint/DL/UL TCI states or one or more second (2^{nd}) joint/DL/UL TCI states according to those specified herein in the present disclosure (or the joint/DL/UL TCI states in all sets correspond to either the first (1^{st}) or second (2^{nd}) joint/DL/UL TCI states according to those specified herein in the present disclosure) and mapped to a TCI codepoint of a TCI field in a beam indication DCI (e.g., DCI format 1_1/1_2 with or without DL assignment).
In another example, when/if the UE receives from the network a first Rel-18 (enhanced) unified TCI state(s) activation/deactivation MAC CE providing/indicating/activating one or more sets of joint/DL/UL TCI states with each set comprising one or more joint/DL/UL TCI states and mapped to a TCI codepoint of a TCI field in a beam indication DCI (e.g., DCI format 1_1/1_2 with or without DL assignment) and at least one set providing/comprising two joint/DL/UL TCI state(s) and/or pair(s) of joint/DL/UL TCI states-denoted by first joint/DL/UL TCI state(s) and second joint/DL/UL TCI state(s) and/or a second Rel-18 (enhanced) unified TCI state(s) activation/deactivation MAC CE providing/indicating/activating one or more sets of joint/DL/UL TCI states with each set comprising either one or more first (1^{st}) joint/DL/UL TCI states or one or more second (2^{nd}) joint/DL/UL TCI states according to those specified herein in the present disclosure (or the joint/DL/UL TCI states in all sets correspond to either the first (1^{st}) or second (2^{nd}) joint/DL/UL TCI states according to those specified herein in the present disclosure) and mapped to a TCI codepoint of a TCI field in a beam indication DCI (e.g., DCI format 1_1/1_2 with or without DL assignment), the same CC/BWP would still be operated under the Rel-17 unified TCI framework for STRP, or equivalently, operated in a STRP system or for STRP operation according to those specified herein in the present disclosure such that:
   When/if the first Rel-18 (enhanced) unified TCI state(s) activation/deactivation MAC CE activates/provides/indicates a single set of first and/or second joint/DL/UL TCI states as specified herein in the present disclosure, after the first and/or second joint/DL/UL TCI states have become applicable—e.g., after a time duration or beam application time (BAT) upon receiving the first Rel-18 (enhanced) unified TCI state(s) activation/deactivation MAC CE, the UE could use the indicated first or second joint/DL/UL TCI state(s)—e.g., based on/according to network's configuration(s)/indication(s) via higher layer RRC signaling(s)/parameter(s) and/or MAC CE command(s) and/or dynamic DCI based L1 signaling(s)—for at least UE-dedicated reception(s) on PDCCH and/or PDSCH and/or dynamic-grant/configured-grant based PUSCH and/or all of dedicated PUCCH resources, or at least channel(s)/signal(s) other than PDSCH(s)—e.g., UE-dedicated reception(s) on PDCCH and/or dynamic-grant/configured-grant based PUSCH and/or all of dedicated PUCCH resources other than UE-dedicated reception(s) on PDSCH.
   When/if the first Rel-18 (enhanced) unified TCI state(s) activation/deactivation MAC CE activates/provides/indicates more than one sets of first and/or second joint/DL/UL TCI state(s) with each set mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of first and/or second joint/DL/UL TCI state(s). After the indicated first and/or second joint/DL/UL TCI state(s) has become applicable—e.g., after a time duration or beam application time (BAT) upon receiving the beam indication DCI, the UE could use the indicated first or second joint/DL/UL TCI state(s)—e.g., based on/according to network's configuration(s)/indication(s) via higher layer RRC signaling(s)/parameter(s) and/or MAC CE command(s) and/or dynamic DCI based L1 signaling(s)—for at least UE-dedicated reception(s) on PDCCH and/or PDSCH and/or dynamic-grant/configured-grant based PUSCH and/or all of dedicated PUCCH resources, or at least channel(s)/signal(s) other than PDSCH(s)—e.g., UE-dedicated reception(s) on PDCCH and/or dynamic-grant/configured-grant based PUSCH and/or all of dedicated PUCCH resources other than UE-dedicated reception(s) on PDSCH.
   When/if the second Rel-18 (enhanced) unified TCI state(s) activation/deactivation MAC CE activates/provides/indicates a single set of only first (1^{st}) or second (2^{nd}) joint/DL/UL TCI state(s) as specified herein in the present disclosure, after the first (1^{st}) or second (2^{nd}) joint/DL/UL TCI state(s) have become applicable—e.g., after a time duration or beam application time (BAT) upon receiving the second Rel-18 (enhanced) unified TCI state(s) activation/deactivation MAC CE, the UE could use the indicated first (1^{st}) or second (2^{nd}) joint/DL/UL TCI state(s) for at least UE-dedicated reception(s) on PDCCH and/or PDSCH and/or dynamic-grant/configured-grant based PUSCH and/or all of dedicated PUCCH resources, or at least channel(s)/signal(s) other than PDSCH(s)—e.g., UE-dedicated reception(s) on PDCCH and/or dynamic-grant/configured-grant based PUSCH and/or all of dedicated PUCCH resources other than UE-dedicated reception(s) on PDSCH.
   When/if the second Rel-18 (enhanced) unified TCI state(s) activation/deactivation MAC CE activates/provides/indicates more than one sets of joint/DL/UL TCI state(s) with each set comprising either the first (1^{st}) or second (2^{nd}) joint/DL/UL TCI state(s) according to those specified herein in the present disclosure (or the joint/DL/UL TCI state(s) in all sets correspond to either the first (1^{st}) or second (2^{nd}) joint/DL/UL TCI state(s) according to those specified herein in the present disclosure) and mapped to a TCI codepoint of a TCI field in a beam indication DCI, the UE could be indicated/provided by the network, e.g., via a TCI field in a beam indication DCI (e.g., DCI format 1_1/1_2 with or without DL assignment), a TCI codepoint comprising a set of either the first (1^{st}) or second (2^{nd}) joint/DL/UL TCI state(s). After the indicated first (1^{st}) or second (2^{nd}) joint/DL/UL TCI state(s) has become applicable—e.g., after a time duration or beam application time (BAT) upon receiving the beam indication DCI, the UE could use the indicated first (1^{st}) or second (2^{nd}) joint/DL/UL TCI state(s) for at least UE-dedicated reception(s) on PDCCH and/or PDSCH and/or dynamic-grant/configured-grant based PUSCH and/or all of dedicated PUCCH resources, or at least channel(s)/signal(s) other than PDSCH(s)—e.g., UE-dedicated reception(s) on PDCCH and/or dynamic-grant/configured-grant based PUSCH and/or all of dedicated PUCCH resources other than UE-dedicated reception(s) on PDSCH.

Throughout the present disclosure, according to those specified herein in the present disclosure, all of the activated TCI codepoint(s) provided/indicated in a second Rel-18 (enhanced) unified TCI state(s) activation/deactivation MAC CE could be mapped to either only the first (or 1^{st}) joint/DL/UL TCI state(s) or only the second (or 2^{nd}) joint/DL/UL TCI state(s). Furthermore, all of the joint/DL/UL TCI state(s)/pair(s) of TCI states activated/provided/indicated by/in a first Rel-18 (enhanced) unified TCI state(s) activation/deactivation MAC CE and/or a Rel-17 unified TCI state(s) activation/deactivation MAC CE and/or a second Rel-18 (enhanced) unified TCI state(s) activation/deactivation MAC CE and/or other TCI state(s) activation/deactivation MAC CE(s) as described/specified herein in the present disclosure could be used to map up to Ncp (e.g., Ncp=8) TCI codepoints of one or more TCI fields in a beam indication DCI (e.g., DCI format 1_1/1_2 with or without DL assignment). In addition, there may not be any restriction(s) to the TCI codepoint(s) mapping for a first Rel-18 (enhanced) unified TCI state(s) activation/deactivation MAC CE; or a first Rel-18 (enhanced) unified TCI state(s) activation/deactivation MAC CE could provide/indicate/activate up to Ncp (e.g., Ncp=8) sets of joint/DL/UL TCI state(s) with each set used to map to a TCI codepoint of a TCI field in the beam indication DCI and comprising only the first (or 1^{st}) joint/DL/UL TCI state or pair of DL and UL TCI states, or the second (or 2^{nd}) joint/DL/UL TCI state or pair of DL and UL TCI states, or both of the first (or 1^{st}) joint/DL/UL TCI state or pair of DL and UL TCI states and the second (or 2^{nd}) joint/DL/UL TCI state or pair of DL and UL TCI states: or equivalently, an activated TCI codepoint in a first Rel-18 (enhanced) unified TCI state(s) activation/deactivation MAC CE could map to or could be mapped with only the first (or 1^{st}) joint/DL/UL TCI state or pair of DL and UL TCI states, or the second (or 2^{nd}) joint/DL/UL TCI state or pair of DL and UL TCI states, or both of the first (or 1^{st}) joint/DL/UL TCI state or pair of DL and UL TCI states and the second (or 2^{nd}) joint/DL/UL TCI state or pair of DL and UL TCI states.

For a CC/BWP operated under the Rel-18 unified TCI framework extension for SDCI based MTRP, or equivalently, for a CC/BWP operated in a SDCI based MTRP system or for SDCI based MTRP operation according to those specified herein in the present disclosure, and/or for a CC/BWP operated under the Rel-17 unified TCI framework for STRP, or equivalently, for a CC/BWP operated in a STRP system or for STRP operation according to those specified herein in the present disclosure, and/or when/if a UE receives and applies a first Rel-18 (enhanced) unified TCI state(s) activation/deactivation MAC CE as specified herein in the present disclosure to a/the CC/BWP, and/or when/if a UE receives and applies a second Rel-18 (enhanced) unified TCI state(s) activation/deactivation MAC CE as specified herein in the present disclosure to a/the BWP, and/or when/if a UE receives and applies a Rel-17 unified TCI state(s) activation/deactivation MAC CE to a/the CC/BWP according to those specified herein in the present disclosure:
The second indicator or the TCI selection field could be present or absent in DCI format 1_1/1_2 according to/based on the corresponding RRC signaling(s)/parameter(s) on the CC/BWP.
The first indicator as specified herein in the present disclosure for PDCCH reception(s) could be provided or not by the network via RRC signaling(s)/parameter(s) on the CC/BWP.
The third indicator as specified herein in the present disclosure for PUCCH transmission(s) could be provided or not by the network via RRC signaling(s)/parameter(s) on the CC/BWP.
The fourth indicator or the SRS resource set indicator field could be present or absent in DCI format 0_1/0_2 according to/based on the corresponding RRC signaling(s)/parameter(s) on the CC/BWP.

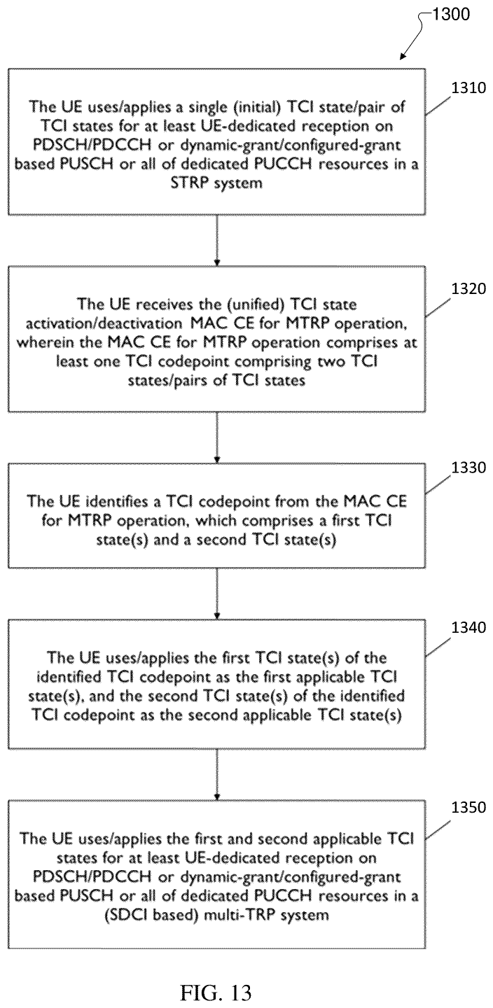

FIG. 13 illustrates a flowchart of an example UE procedure 1300 for identifying/using first and second applicable TCI states according to embodiments of the present disclosure. For example, procedure 1300 for identifying/using first and second applicable TCI states can be performed by the UE 112 of FIG. 1. This example is for illustration only and other embodiments can be used without departing from the scope of the present disclosure.

The procedure begins in 1310, the UE uses/applies a single (initial) TCI state/pair of TCI states for at least UE-dedicated reception on PDSCH/PDCCH or dynamic-grant/configured-grant based PUSCH or all of dedicated PUCCH resources in a STRP system. In 1320, the UE receives the (unified) TCI state activation/deactivation MAC CE for MTRP operation, wherein the MAC CE for MTRP operation comprises at least one TCI codepoint comprising two TCI states/pairs of TCI states. In 1330, the UE identifies a TCI codepoint from the MAC CE for MTRP operation, which comprises a first TCI state(s) and a second TCI state(s). In 1340, the UE uses/applies the first TCI state(s) of the identified TCI codepoint as the first applicable TCI state(s), and the second TCI state(s) of the identified TCI codepoint as the second applicable TCI state(s). In 1350, the UE uses/applies the first and second applicable TCI states for at least UE-dedicated reception on PDSCH/PDCCH or dynamic-grant/configured-grant based PUSCH or all of dedicated PUCCH resources in a (SDCI based) multi-TRP system.

In one embodiment, a UE (e.g., the UE 116) could first operate in STRP mode according to one or more of the conditions specified herein in the present disclosure. The UE could then switch to MTRP mode according to one or more of the conditions specified herein in the present disclosure—i.e., when/if one or more of the above described/specified conditions are achieved/satisfied or hold, e.g., when/if the second indicator (or equivalently, the TCI selection field) as specified herein in the present disclosure is not present or is absent in the corresponding DCI format (e.g., DCI format 1_1/1_2)—e.g., when/if a higher layer RRC parameter tciSelection-PresentInDCI-r18 in BWP-DownlinkDedicated is not set to ‘enabled’ or set to ‘disabled’ indicating/providing that the second indicator/TCI selection field is absent in DCI format 1_1/1_2 for the DL BWP and/or when/if the second indicator/TCI selection field in DCI format 1_1/1_2 is (set to) 0 bit, and/or when/if the second indicator (or equivalently, the TCI selection field) as specified herein in the present disclosure is present in the corresponding DCI format (e.g., DCI format 1_1/1_2)—e.g., when/if the higher layer RRC parameter tciSelection-PresentInDCI-r18 in BWP-DownlinkDedicated is set to ‘enabled’ indicating/providing that the second indicator/TCI selection field is present in DCI format 1_1/1_2 for the DL BWP—but the second indicator/TCI selection field has not become applicable—e.g., before the higher layer RRC (re-)configuration and/or the higher layer RRC parameter tciSelection-PresentInDCI-r18 in BWP-Downlink Dedicated becomes applicable, and/or when/if the fourth indicator (or equivalently, the SRS resource set indicator field) as specified herein in the present disclosure is not present or is absent in the corresponding DCI format (e.g., DCI format 0_1/0_2) and/or when/if the fourth indicator/SRS resource set indicator field in DCI format 0_1/0_2 is (set to) 0 bit according to those specified herein in the present disclosure, and/or when/if the fourth indicator (or equivalently, the SRS resource set indicator field) as specified herein in the present disclosure is present in the corresponding DCI format (e.g., DCI format 0_1/0_2), but the fourth indicator/SRS resource set indicator field has not become applicable—e.g., before the higher layer RRC (re-)configuration and/or the corresponding higher layer RRC parameter(s) becomes applicable, the UE could switch from the STRP mode to the MTRP mode, wherein the STRP mode and the MTRP mode are specified herein in the present disclosure. For this design example, under the STRP operation mode according to one or more of the conditions specified herein in the present disclosure, the UE could first use/apply a single TCI state/pair of TCI states-denoted by initial TCI state/pair of TCI states—for at least UE-dedicated reception on PDSCH/PDCCH or dynamic-grant/configured-grant based PUSCH or all of dedicated PUCCH resources. The UE could then receive from the network (e.g., the network 130), a beam indication/activation MAC CE for MTRP operation, e.g., unified TCI state activation/deactivation MAC CE for MTRP operation, wherein the (unified) TCI states activated/provided/indicated in the MAC CE for MTRP operation could be used to map up to Ncp (e.g., Ncp=8) TCI codepoints of one or more TCI fields in a beam indication DCI for MTRP operation: here, a TCI codepoint could include or comprise or could be mapped to one or more joint/DL/UL TCI states/pairs of joint/DL/UL TCI states. Furthermore, each TCI state(s)/pair(s) of TCI states in the MAC CE for MTRP operation could be associated with an indicator, wherein the indicator could indicate whether the TCI state(s)/pair(s) of TCI states could correspond to the first TCI state/pair of TCI states, the second TCI state/pair of TCI states, and/or etc., among all the TCI states/pairs of TCI states mapped to the same TCI codepoint comprising the TCI state(s)/pair(s) of TCI state(s) activated by/in the MAC CE for MTRP operation; furthermore, the indicator could also indicate whether the TCI state(s)/pair(s) of TCI states could be from a first group/list of TCI states/TCI state IDs or a second group/list of TCI states/TCI state IDs. For the MTRP operation mode with N=2 or M=2, the UE could determine/identify, based on the TCI state(s)/pair(s) of TCI states activated/indicated by/in the MAC CE and/or the beam indication DCI for MTRP operation, a first applicable TCI state(s) and/or a second applicable TCI state(s) to use for at least UE-dedicated reception on PDSCH/PDCCH or dynamic-grant/configured-grant based PUSCH or all of dedicated PUCCH resources.
In one example, when the UE is indicated, e.g., via the TCI field(s) in the TCI state(s) indication DCI for MTRP operation as specified herein in the present disclosure, a TCI codepoint comprising a single TCI state/pair of TCI states, and the indicator associated to the TCI state/pair of TCI states indicates that the TCI state/pair of TCI states corresponds to the first TCI state/pair of TCI states among all the TCI states/pairs of TCI states mapped to the same TCI codepoint comprising the TCI state/pair of TCI states activated/provided/indicated in/by the unified TCI state activation/deactivation MAC CE for MTRP operation as specified herein in the present disclosure, after the indicated TCI state(s) has become applicable—e.g., after a time duration or beam application time (BAT) upon receiving the TCI state(s) activation/deactivation/indication MAC CE(s)/DCI(s) for MTRP operation:
   For example, the UE could use/apply only the indicated TCI state/pair of TCI states for at least UE-dedicated reception on PDSCH/PDCCH or dynamic-grant/configured-grant based PUSCH or all of dedicated PUCCH resources.
   For another example, the UE could use/apply the indicated TCI state/pair of TCI states—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises at least one TCI state/pair of TCI states with the corresponding/associated indicator indicating that the at least one TCI state/pair of TCI states is the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise at least one TCI state/pair of TCI states with the corresponding/associated indicator indicating that the at least one TCI state/pair of TCI states is the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises a single TCI state/pair of TCI states with the corresponding/associated indicator indicating that the TCI state/pair of TCI states is the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise a single TCI state/pair of TCI states with the corresponding/associated indicator indicating that the TCI state/pair of TCI states is the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the first applicable TCI state(s)—and the initial TCI state/pair of TCI states as specified herein in the present disclosure—as the second applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In another example, the UE could identify, from the (unified) TCI state activation/deactivation MAC CE for MTRP operation as specified herein in the present disclosure, a TCI codepoint comprising at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint. In this design example, the TCI codepoint to be identified could correspond to a fixed TCI codepoint in the MAC CE for MTRP operation, e.g., the first or last TCI codepoint in the MAC CE for MTRP operation, or the only TCI codepoint in the MAC CE for MTRP operation that comprises at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint, or the lowest/highest TCI codepoint (the index of the TCI codepoint could be the lowest/highest) among one or more TCI codepoints in the MAC CE for MTRP operation, wherein the one or more TCI codepoints could correspond to all the TCI codepoints in the MAC CE for MTRP operation or the one or more TCI codepoints could correspond to those in the MAC CE for MTRP operation each comprising at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint. Optionally, the UE could be indicated/provided/configured by the network, e.g., via higher layer RRC signaling/parameter and/or MAC CE command and/or dynamic DCI based L1 signaling. (index of) the TCI codepoint to be identified among one or more TCI codepoints from/in the MAC CE for MTRP operation: for this case, the one or more TCI codepoints could correspond to all the TCI codepoints from/in the MAC CE for MTRP operation, or the one or more TCI codepoints could correspond to those from/in the MAC CE for MTRP operation each comprising at least one TCI state/pair of TCI states associated to an indicator as specified herein in the present disclosure indicating that the corresponding/associated TCI state/pair of TCI states corresponds to the first TCI state/pair of TCI states among all the TCI states/pairs of TCI states mapped to the same TCI codepoint. After the TCI state(s) mapped to the identified TCI codepoint has become applicable—e.g., after a time duration or beam application time (BAT) upon receiving the TCI state(s) activation/deactivation/indication MAC CE(s)/DCI(s) for MTRP operation:
   For example, the UE could only use/apply the first TCI state/pair of TCI states among all the TCI states/pairs of TCI states mapped to the identified TCI codepoint for at least UE-dedicated reception on PDSCH/PDCCH or dynamic-grant/configured-grant based PUSCH or all of dedicated PUCCH resources.
   For another example, the UE could use/apply the first TCI state/pair of TCI states among all the TCI states/pairs of TCI states mapped to the identified TCI codepoint—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises at least one TCI state/pair of TCI states with the corresponding/associated indicator indicating that the at least one TCI state/pair of TCI states is the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise at least one TCI state/pair of TCI states with the corresponding/associated indicator indicating that the at least one TCI state/pair of TCI states is the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the first TCI state/pair of TCI states among all the TCI states/pairs of TCI states mapped to the identified TCI codepoint—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises a single TCI state/pair of TCI states with the corresponding/associated indicator indicating that the TCI state/pair of TCI states is the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise a single TCI state/pair of TCI states with the corresponding/associated indicator indicating that the TCI state/pair of TCI states is the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the first TCI state/pair of TCI states among all the TCI states/pairs of TCI states mapped to the identified TCI codepoint—as the first applicable TCI state(s)—and an auxiliary TCI state/pair of TCI states—as the second applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the second TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the first TCI state/pair of TCI states among all the TCI states/pairs of TCI states mapped to the identified TCI codepoint in/from the MAC CE for MTRP operation—as the first applicable TCI state(s)—and the initial TCI state/pair of TCI states as specified herein in the present disclosure—as the second applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, when the UE is indicated, e.g., via the TCI field(s) in the TCI state(s) indication DCI for MTRP operation as specified herein in the present disclosure, a TCI codepoint comprising a single TCI state/pair of TCI states, and the indicator associated to the TCI state/pair of TCI states indicates that the TCI state/pair of TCI states corresponds to the second TCI state/pair of TCI states among all the TCI states/pairs of TCI states mapped to the same TCI codepoint comprising the TCI state/pair of TCI states activated/provided/indicated in/by the unified TCI state activation/deactivation MAC CE for MTRP operation as specified herein in the present disclosure, after the indicated TCI state(s) has become applicable—e.g., after a time duration or beam application time (BAT) upon receiving the TCI state(s) activation/deactivation/indication MAC CE(s)/DCI(s) for MTRP operation.
   For example, the UE could use/apply only the indicated TCI state/pair of TCI states for at least UE-dedicated reception on PDSCH/PDCCH or dynamic-grant/configured-grant based PUSCH or all of dedicated PUCCH resources.
   For another example, the UE could use/apply the indicated TCI state/pair of TCI states—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises at least one TCI state/pair of TCI states with the corresponding/associated indicator indicating that the at least one TCI state/pair of TCI states is the first TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise at least one TCI state/pair of TCI states with the corresponding/associated indicator indicating that the at least one TCI state/pair of TCI states is the first TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises a single TCI state/pair of TCI states with the corresponding/associated indicator indicating that the TCI state/pair of TCI states is the first TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise a single TCI state/pair of TCI states with the corresponding/associated indicator indicating that the TCI state/pair of TCI states is the first TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the indicated TCI state/pair of TCI states—as the second applicable TCI state(s)—and the initial TCI state/pair of TCI states as specified herein in the present disclosure—as the first applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, the UE could identify, from the (unified) TCI state activation/deactivation MAC CE for MTRP operation as specified herein in the present disclosure, a TCI codepoint comprising at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint. In this design example, the TCI codepoint to be identified could correspond to a fixed TCI codepoint in the MAC CE for MTRP operation, e.g., the first or last TCI codepoint in the MAC CE for MTRP operation, or the only TCI codepoint in the MAC CE for MTRP operation that comprises at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint, or the lowest/highest TCI codepoint (the index of the TCI codepoint could be the lowest/highest) among one or more TCI codepoints in the MAC CE for MTRP operation, wherein the one or more TCI codepoints could correspond to all the TCI codepoints in the MAC CE for MTRP operation or the one or more TCI codepoints could correspond to those in the MAC CE for MTRP operation each comprising at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint. Optionally, the UE could be indicated/provided/configured by the network, e.g., via higher layer RRC signaling/parameter and/or MAC CE command and/or dynamic DCI based L1 signaling. (index of) the TCI codepoint to be identified among one or more TCI codepoints from/in the MAC CE for MTRP operation: for this case, the one or more TCI codepoints could correspond to all the TCI codepoints from/in the MAC CE for MTRP operation, or the one or more TCI codepoints could correspond to those from/in the MAC CE for MTRP operation each comprising at least one TCI state/pair of TCI states associated to an indicator as specified herein in the present disclosure indicating that the corresponding/associated TCI state/pair of TCI states corresponds to the second TCI state/pair of TCI states among all the TCI states/pairs of TCI states mapped to the same TCI codepoint. After the TCI state(s) mapped to the identified TCI codepoint has become applicable—e.g., after a time duration or beam application time (BAT) upon receiving the TCI state(s) activation/deactivation/indication MAC CE(s)/DCI(s) for MTRP operation:
   For example, the UE could only use/apply the second TCI state/pair of TCI states among all the TCI states/pairs of TCI states mapped to the identified TCI codepoint for at least UE-dedicated reception on PDSCH/PDCCH or dynamic-grant/configured-grant based PUSCH or all of dedicated PUCCH resources.
   For another example, the UE could use/apply the second TCI state/pair of TCI states among all the TCI states/pairs of TCI states mapped to the identified TCI codepoint—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises at least one TCI state/pair of TCI states with the corresponding/associated indicator indicating that the at least one TCI state/pair of TCI states is the first TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise at least one TCI state/pair of TCI states with the corresponding/associated indicator indicating that the at least one TCI state/pair of TCI states is the first TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the second TCI state/pair of TCI states among all the TCI states/pairs of TCI states mapped to the identified TCI codepoint—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises a single TCI state/pair of TCI states with the corresponding/associated indicator indicating that the TCI state/pair of TCI states is the first TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise a single TCI state/pair of TCI states with the corresponding/associated indicator indicating that the TCI state/pair of TCI states is the first TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the second TCI state/pair of TCI states among all the TCI states/pairs of TCI states mapped to the identified TCI codepoint—as the second applicable TCI state(s)—and an auxiliary TCI state/pair of TCI states—as the first applicable TCI state(s)—for at least UE-dedicated reception on PDSCH/PDCCH or dynamic-grant/configured-grant based PUSCH or all of dedicated PUCCH resources. Here, the auxiliary TCI state/pair of TCI states could correspond to the first TCI state/pair of TCI states (e.g., indicated by the indicator associated to the TCI state/pair of TCI states as specified herein in the present disclosure) among all the TCI states/pairs of TCI states mapped to a TCI codepoint, e.g., with the lowest/highest codepoint index (i.e., the lowest/highest TCI codepoint) or corresponding to the first/last TCI codepoint or configured/provided/indicated by the network via higher layer RRC signaling/parameter or MAC CE command or dynamic DCI based L1 signaling or the only TCI codepoint in the MAC CE for MTRP operation that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, among one or more of the TCI codepoints in the MAC CE for MTRP operation, wherein, e.g., each of those TCI codepoints could comprise multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
   Yet for another example, the UE could use/apply the second TCI state/pair of TCI states among all the TCI states/pairs of TCI states mapped to the identified TCI codepoint in/from the MAC CE for MTRP operation—as the second applicable TCI state(s)—and the initial TCI state/pair of TCI states as specified herein in the present disclosure—as the first applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, when the UE is indicated, e.g., via the TCI field(s) in the TCI state(s) indication DCI for MTRP operation as specified herein in the present disclosure, a TCI codepoint comprising multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, after the indicated TCI state(s) has become applicable—e.g., after a time duration or beam application time (BAT) upon receiving the TCI state(s) activation/deactivation/indication MAC CE(s)/DCI(s) for MTRP operation, the UE could use/apply the indicated first TCI state/pair of TCI states—as the first applicable TCI state(s)—and the indicated second TCI state/pair of TCI states—as the second applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, the UE could identify, from the (unified) TCI state activation/deactivation MAC CE for MTRP operation as specified herein in the present disclosure, a TCI codepoint comprising multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. In this design example, the TCI codepoint to be identified could correspond to a fixed TCI codepoint in the MAC CE for MTRP operation, e.g., the first or last TCI codepoint in the MAC CE for MTRP operation, or the only TCI codepoint in the MAC CE for MTRP operation that comprises multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint, or the lowest/highest TCI codepoint (the index of the TCI codepoint could be the lowest/highest) among all the TCI codepoints in the MAC CE for MTRP operation each comprising multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. Optionally, the UE could be indicated/provided/configured by the network, e.g., via higher layer RRC signaling/parameter and/or MAC CE command and/or dynamic DCI based L1 signaling. (index of) the TCI codepoint to be identified among one or more TCI codepoints from/in the MAC CE for MTRP operation: for this case, the one or more TCI codepoints could correspond to all the TCI codepoints from/in the MAC CE for MTRP operation, or the one or more TCI codepoints could correspond to those from/in the MAC CE for MTRP operation each comprising multiple (e.g., N=2) TCI states/pairs of TCI states each associated to an indicator as specified herein in the present disclosure indicating that the corresponding/associated TCI state/pair of TCI states corresponds to the first TCI state/pair of TCI states or the second TCI state/pair of TCI states among all the TCI states/pairs of TCI states mapped to the same TCI codepoint. For this design example, after the TCI state(s) mapped to the identified TCI codepoint has become applicable—e.g., after a time duration or beam application time (BAT) upon receiving the TCI state(s) activation/deactivation/indication MAC CE(s)/DCI(s) for MTRP operation, the UE could use/apply the first TCI state/pair of TCI states of the identified TCI codepoint from/in the MAC CE for MTRP operation as specified herein in the present disclosure—as the first applicable TCI state(s)—and the second TCI state/pair of TCI states of the identified TCI codepoint from/in the MAC CE for MTRP operation as specified herein in the present disclosure—as the second applicable TCI state(s)—for at least UE-dedicated reception on PDSCH/PDCCH or dynamic-grant/configured-grant based PUSCH or all of dedicated PUCCH resources. The UE could follow the first indicator as specified herein in the present disclosure to use the first and/or second applicable TCI state(s) for PDCCH reception, and/or the UE could follow the second indicator as specified herein in the present disclosure to use the first and/or second applicable TCI state(s) for PDSCH reception, and/or the UE could follow the third indicator as specified herein in the present disclosure to use the first and/or second applicable TCI state(s) for PUCCH transmission, and/or the UE could follow the fourth indicator as specified herein in the present disclosure to use the first and/or second applicable TCI state(s) for PUSCH transmission.
In yet another example, the UE could be indicated, e.g., via the TCI field(s) in the TCI state(s) indication DCI for MTRP operation as specified herein in the present disclosure, a TCI codepoint comprising one or more TCI states/pairs of TCI states, wherein the indicated TCI codepoint (and therefore, the corresponding one or more TCI states/pairs of TCI states) could be (selected/determined) from/in the unified TCI state(s) activation/deactivation MAC CE for MTRP operation as specified herein in the present disclosure.
   For example, before the TCI state(s) activated/provided/indicated in/by the TCI state(s) activation/deactivation MAC CE for MTRP operation becomes applicable/active—e.g., before a time duration or beam application time (BAT) upon receiving the TCI state(s) activation/deactivation MAC CE for MTRP operation, or before the indicated TCI state(s) becomes applicable—e.g., before a time duration or beam application time (BAT) upon receiving the TCI state(s) indication DCI for MTRP operation, the UE could use/apply the initial TCI state/pair of TCI states for at least UE-dedicated reception on PDSCH/PDCCH or dynamic-grant/configured-grant based PUSCH or all of dedicated PUCCH resources.
   For another example, after the TCI state(s) activated/provided/indicated in/by the TCI state(s) activation/deactivation MAC CE for MTRP operation has become applicable/active—e.g., after a time duration or beam application time (BAT) upon receiving the TCI state(s) activation/deactivation MAC CE for MTRP operation, and/or before the indicated TCI state(s) becomes applicable—e.g., before a time duration or beam application time (BAT) upon receiving the TCI state(s) indication DCI for MTRP operation, the UE could follow one or more of the design examples specified herein in the present disclosure to determine/use/apply the first applicable TCI state(s) and/or the second applicable TCI state(s) for at least UE-dedicated reception on PDSCH/PDCCH or dynamic-grant/configured-grant based PUSCH or all of dedicated PUCCH resources.
   Yet for another example, after the indicated TCI state(s) has become applicable—e.g., after a time duration or beam application time (BAT) upon receiving the TCI state(s) indication DCI for MTRP operation (or, after the TCI state(s) activated/provided/indicated in/by the TCI state(s) activation/deactivation MAC CE for MTRP operation has become applicable/active—e.g., after a time duration or beam application time (BAT) upon receiving the TCI state(s) activation/deactivation MAC CE for MTRP operation), the UE could follow one or more of the design examples specified herein in the present disclosure to determine/use/apply the first applicable TCI state(s) and/or the second applicable TCI state(s) for at least UE-dedicated reception on PDSCH/PDCCH or dynamic-grant/configured-grant based PUSCH or all of dedicated PUCCH resources. This design example could be for when the number of TCI state(s)/pair(s) of TCI states indicated by the TCI state(s) indication DCI for MTRP operation is one.
   Yet for another example, after the indicated TCI state(s) has become applicable—e.g., after a time duration or beam application time (BAT) upon receiving the TCI state(s) indication DCI for MTRP operation (or, after the TCI state(s) activated/provided/indicated in/by the TCI state(s) activation/deactivation MAC CE for MTRP operation has become applicable/active—e.g., after a time duration or beam application time (BAT) upon receiving the TCI state(s) activation/deactivation MAC CE for MTRP operation), the UE could follow one or more of the design examples specified herein in the present disclosure to determine/use/apply the first applicable TCI state(s) and/or the second applicable TCI state(s) for at least UE-dedicated reception on PDSCH/PDCCH or dynamic-grant/configured-grant based PUSCH or all of dedicated PUCCH resources. This design example could be for when the number of TCI state(s)/pair(s) of TCI states indicated by the TCI state(s) indication DCI for MTRP operation is greater than one (e.g., 2).

In one embodiment, a UE (e.g., the UE 116) could first operate in MTRP mode according to one or more of the conditions specified herein in the present disclosure. The UE could then switch to STRP mode according to one or more of the conditions specified herein in the present disclosure—i.e., when/if one or more of the above described/specified conditions are achieved/satisfied or hold, e.g., when/if the second indicator (or equivalently, the TCI selection field) as specified herein in the present disclosure is not present or is absent in the corresponding DCI format (e.g., DCI format 1_1/1_2)—e.g., when/if a higher layer RRC parameter tciSelection-PresentInDCI-r18 in BWP-DownlinkDedicated is not set to ‘enabled’ or set to ‘disabled’ indicating/providing that the second indicator/TCI selection field is absent in DCI format 1_1/1_2 for the DL BWP and/or when/if the second indicator/TCI selection field in DCI format 1_1/1_2 is (set to) 0 bit, and/or when/if the second indicator (or equivalently, the TCI selection field) as specified herein in the present disclosure is present in the corresponding DCI format (e.g., DCI format 1_1/1_2)—e.g., when/if the higher layer RRC parameter tciSelection-PresentInDCI-r18 in BWP-DownlinkDedicated is set to ‘enabled’ indicating/providing that the second indicator/TCI selection field is present in DCI format 1_1/1_2 for the DL BWP—but the second indicator/TCI selection field has not become applicable—e.g., before the higher layer RRC (re-)configuration and/or the higher layer RRC parameter tciSelection-PresentInDCI-r18 in BWP-Downlink Dedicated becomes applicable, and/or when/if the fourth indicator (or equivalently, the SRS resource set indicator field) as specified herein in the present disclosure is not present or is absent in the corresponding DCI format (e.g., DCI format 0_1/0_2) and/or when/if the fourth indicator/SRS resource set indicator field in DCI format 0_1/0_2 is (set to) ( ) bit according to those specified herein in the present disclosure, and/or when/if the fourth indicator (or equivalently, the SRS resource set indicator field) as specified herein in the present disclosure is present in the corresponding DCI format (e.g., DCI format 0_1/0_2) but the fourth indicator/SRS resource set indicator field has not become applicable—e.g., before the higher layer RRC (re-)configuration and/or the corresponding higher layer RRC parameter(s) becomes applicable, the UE could switch from the MTRP mode to the STRP mode, wherein the STRP mode and the MTRP mode are specified herein in the present disclosure. For this design example, under the MTRP operation mode according to one or more of the conditions specified herein in the present disclosure, the UE could first use a/the first applicable TCI state(s) and/or a/the second applicable TCI state(s) as specified herein in the present disclosure for at least UE-dedicated reception on PDSCH/PDCCH or dynamic-grant/configured-grant based PUSCH or all of dedicated PUCCH resources. The UE could then receive from the network (e.g., the network 130), a beam indication/activation MAC CE for STRP operation, e.g., unified TCI state activation/deactivation MAC CE for STRP operation, wherein the (unified) TCI states activated/provided/indicated in the MAC CE for STRP operation could be used to map up to Ncp (e.g., Ncp=8) TCI codepoints of one or more TCI fields in a beam indication DCI for STRP operation: here, each of the TCI codepoints could include or comprise or could be mapped to only a single joint/DL/UL TCI state/pair of joint/DL/UL TCI states.
In one example, when the UE is indicated, e.g., via the TCI field(s) in the TCI state(s) indication DCI for STRP operation as specified herein in the present disclosure, a TCI codepoint comprising a single TCI state/pair of TCI states, after the indicated TCI state(s) has become applicable—e.g., after a time duration or beam application time (BAT) upon receiving the TCI state(s) activation/deactivation/indication MAC CE(s)/DCI(s) for STRP operation, the UE could use/apply only the indicated TCI state/pair of TCI states for at least UE-dedicated reception on PDSCH/PDCCH or dynamic-grant/configured-grant based PUSCH or all of dedicated PUCCH resources.
In another example, the UE could identify, from the (unified) TCI state activation/deactivation MAC CE for STRP operation as specified herein in the present disclosure, a TCI codepoint comprising a single TCI state/pair of TCI states. In this design example, the TCI codepoint to be identified could correspond to a fixed TCI codepoint in the MAC CE for STRP operation, e.g., the first or last TCI codepoint in the MAC CE for STRP operation, or the only TCI codepoint in the MAC CE for STRP operation that comprises a single TCI state/pair of TCI states, or the lowest/highest TCI codepoint (the index of the TCI codepoint could be the lowest/highest) among all the TCI codepoints in the MAC CE for STRP operation each comprising a single TCI state/pair of TCI states. Optionally, the UE could be indicated/provided/configured by the network, e.g., via higher layer RRC signaling/parameter and/or MAC CE command and/or dynamic DCI based L1 signaling. (index of) the TCI codepoint to be identified among one or more TCI codepoints from/in the MAC CE for STRP operation: for this case, the one or more TCI codepoints could correspond to all the TCI codepoints from/in the MAC CE for STRP operation, or the one or more TCI codepoints could correspond to those from/in the MAC CE for STRP operation each comprising a single TCI states/pairs of TCI states. For this design example, after the TCI state(s) mapped to the identified TCI codepoint has become applicable—e.g., after a time duration or beam application time (BAT) upon receiving the TCI state(s) activation/deactivation/indication MAC CE(s)/DCI(s) for STRP operation, the UE could use/apply the TCI state/pair of TCI states of the identified TCI codepoint from/in the MAC CE for STRP operation as specified herein in the present disclosure for at least UE-dedicated reception on PDSCH/PDCCH or dynamic-grant/configured-grant based PUSCH or all of dedicated PUCCH resources.
In yet another example, the UE could be indicated, e.g., via the TCI field(s) in the TCI state(s) indication DCI for STRP operation as specified herein in the present disclosure, a TCI codepoint comprising a single TCI state/pair of TCI states, wherein the indicated TCI codepoint (and therefore, the corresponding TCI state/pair of TCI states) could be (selected/determined) from/in the unified TCI state(s) activation/deactivation MAC CE for STRP operation as specified herein in the present disclosure.
   For example, before the TCI state(s) activated/provided/indicated in/by the TCI state(s) activation/deactivation MAC CE for STRP operation becomes applicable/active—e.g., before a time duration or beam application time (BAT) upon receiving the TCI state(s) activation/deactivation MAC CE for STRP operation, or before the indicated TCI state(s) becomes applicable—e.g., before a time duration or beam application time (BAT) upon receiving the TCI state(s) indication DCI for STRP operation, the UE could use/apply the first applicable TCI state(s) and/or the second applicable TCI state(s) for at least UE-dedicated reception on PDSCH/PDCCH or dynamic-grant/configured-grant based PUSCH or all of dedicated PUCCH resources.
   For another example, after the TCI state(s) activated/provided/indicated in/by the TCI state(s) activation/deactivation MAC CE for STRP operation has become applicable/active—e.g., after a time duration or beam application time (BAT) upon receiving the TCI state(s) activation/deactivation MAC CE for STRP operation, and/or before the indicated TCI state(s) becomes applicable—e.g., before a time duration or beam application time (BAT) upon receiving the TCI state(s) indication DCI for STRP operation, the UE could follow one or more of the design examples specified herein in the present disclosure to determine/use/apply one or more TCI states—e.g., the TCI state/pair of TCI states of the identified TCI codepoint—for at least UE-dedicated reception on PDSCH/PDCCH or dynamic-grant/configured-grant based PUSCH or all of dedicated PUCCH resources.
   Yet for another example, after the indicated TCI state(s) has become applicable—e.g., after a time duration or beam application time (BAT) upon receiving the TCI state(s) indication DCI for STRP operation (or, after the TCI state(s) activated/provided/indicated in/by the TCI state(s) activation/deactivation MAC CE for STRP operation has become applicable/active—e.g., after a time duration or beam application time (BAT) upon receiving the TCI state(s) activation/deactivation MAC CE for STRP operation), the UE could follow one or more of the design examples specified herein in the present disclosure to determine/use/apply one or more TCI states—e.g., the TCI state/pair of TCI states of the identified TCI codepoint—for at least UE-dedicated reception on PDSCH/PDCCH or dynamic-grant/configured-grant based PUSCH or all of dedicated PUCCH resources.
   Yet for another example, after the indicated TCI state(s) has become applicable—e.g., after a time duration or beam application time (BAT) upon receiving the TCI state(s) indication DCI for STRP operation (or, after the TCI state(s) activated/provided/indicated in/by the TCI state(s) activation/deactivation MAC CE for STRP operation has become applicable/active—e.g., after a time duration or beam application time (BAT) upon receiving the TCI state(s) activation/deactivation MAC CE for STRP operation), the UE could follow one or more of the design examples specified herein in the present disclosure to determine/use/apply one or more TCI states—e.g., the indicated TCI state/pair of TCI states—for at least UE-dedicated reception on PDSCH/PDCCH or dynamic-grant/configured-grant based PUSCH or all of dedicated PUCCH resources.

Throughout the present disclosure, the UE could be provided/configured/indicated by the network (e.g., the network 130), e.g., via higher layer RRC signaling/parameter and/or MAC CE command and/or dynamic DCI based L1 signaling, the time duration or the beam application time (BAT) specified herein in the present disclosure. The time duration or the BAT could be determined according to one or more of:
A time offset, e.g., at least 3 ms, after receiving the TCI state(s) activation/deactivation MAC CE or starting from the slot in which the TCI state(s) activation/deactivation MAC CE is received.
A time offset starting from the first slot that is at least timeDurationForQCL symbols after the last symbol of a physical downlink control channel (PDCCH) that carries the beam indication DCI.
A time offset starting from the first slot that is at least BeamAppTime_r17 symbols after the last symbol of a physical uplink control channel (PUCCH) with hybrid automatic repeat request (HARQ)-acknowledgement (ACK) information corresponding to a PDSCH scheduled by the beam indication DCI.
A time offset starting from the first slot that is at least BeamAppTime_r17 symbols after the last symbol of a PUCCH with HARQ-ACK information corresponding to the beam indication DCI.

The first slot and the BeamAppTime_r17 symbols are both determined on a carrier with the smallest subcarrier spacing (SCS) among carriers applying the beam indication.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a processor configured to apply a reference transmission configuration indication (TCI) state for UE dedicated control and data channels; and
a transceiver operably coupled to the processor, the transceiver configured to receive, via a medium access control (MAC) control element (CE), a plurality of TCI codepoints,
wherein the processor is further configured to:
identify a reference TCI codepoint from the plurality of TCI codepoints;
determine, from the reference TCI codepoint, one or more TCI states; and
determine whether to apply the one or more TCI states or the reference TCI state for the UE dedicated control and data channels.

2. The UE of claim 1, wherein:
at least one TCI codepoint from the plurality of TCI codepoints includes at least first and second TCI states; and
the processor is further configured to identify one or more TCI codepoints from the plurality of TCI codepoints that include more than one TCI state.

3. The UE of claim 2, wherein the reference TCI codepoint corresponds to a TCI codepoint with a lowest TCI codepoint index among the identified one or more TCI codepoints.

4. The UE of claim 1, wherein the reference TCI codepoint corresponds to a TCI codepoint with a lowest TCI codepoint index among the plurality of TCI codepoints.

5. The UE of claim 4, wherein, when the reference TCI codepoint includes first and second TCI states, the processor is further configured to apply the first and second TCI states for the UE dedicated control and data channels.

6. The UE of claim 4, wherein, when the reference TCI codepoint comprises one TCI state, the processor is further configured to identify whether the one TCI state corresponds to a first TCI state or a second TCI state.

7. The UE of claim 6, wherein:
when the one TCI state corresponds to the first TCI state, the processor is further configured to apply the one TCI state as the first TCI state and the reference TCI state as a second TCI state for at least the UE dedicated control and data channels; and
when the one TCI state corresponds to the second TCI state, the processor is further configured to apply the one TCI state as the second TCI state and the reference TCI state as the first TCI state for at least the UE dedicated control and data channels.

8. The UE of claim 1, wherein:
the transceiver is further configured to receive, via a higher layer parameter PDCCH-Config, values 0 and 1 of coresetPoolIndex;
the MAC CE is associated with the value 1 of coresetPoolIndex;
the transceiver is further configured to receive, via a downlink control information (DCI) format associated with the value 1 of coresetPoolIndex, one of the plurality of TCI codepoints comprising one or more TCI states; and
the processor is further configured to apply the one or more TCI states to the UE dedicated control and data channels associated with value 1 of coresetPoolIndex.

9. A base station (BS), comprising:
a processor configured to determine a reference transmission configuration indication (TCI) state for user equipment (UE) dedicated control and data channels; and
a transceiver operably coupled to the processor, the transceiver configured to:
transmit the reference TCI state,
transmit, via a medium access control (MAC) control element (CE), a plurality of TCI codepoints,
wherein:
the plurality of TCI codepoints include a reference TCI codepoint; and
the reference TCI codepoint includes one or more TCI states.

10. The BS of claim 9, wherein at least one TCI codepoint from the plurality of TCI codepoints includes at least first and second TCI states.

11. The BS of claim 10, wherein the reference TCI codepoint corresponds to a TCI codepoint with a lowest TCI codepoint index among the identified one or more TCI codepoints.

12. The BS of claim 9, wherein the reference TCI codepoint corresponds to a TCI codepoint with a lowest TCI codepoint index among the plurality of TCI codepoints.

13. A method performed by a user equipment (UE), the method comprising:
applying a reference transmission configuration indication (TCI) state for UE dedicated control and data channels;
receiving, via a medium access control (MAC) control element (CE), a plurality of TCI codepoints;
identifying a reference TCI codepoint from the plurality of TCI codepoints;
determining, from the reference TCI codepoint, one or more TCI states; and
determining whether to apply the one or more TCI states or the reference TCI state for the UE dedicated control and data channels.

14. The method of claim 13, wherein:
at least one TCI codepoint from the plurality of TCI codepoints includes at least first and second TCI states; and
the method further comprises identifying one or more TCI codepoints from the plurality of TCI codepoints that include more than one TCI state.

15. The method of claim 13, wherein the reference TCI codepoint corresponds to a TCI codepoint with a lowest TCI codepoint index among the identified one or more TCI codepoints.

16. The method of claim 13, wherein the reference TCI codepoint corresponds to a TCI codepoint with a lowest TCI codepoint index among the plurality of TCI codepoints.

17. The method of claim 16, further comprising, when the reference TCI codepoint includes first and second TCI states, applying the first and second TCI states for the UE dedicated control and data channels.

18. The method of claim 16, further comprising, when the reference TCI codepoint comprises one TCI state, identifying whether the one TCI state corresponds to a first TCI state or a second TCI state.

19. The method of claim 18, further comprising:
when the one TCI state corresponds to the first TCI state, applying the one TCI state as the first TCI state and the reference TCI state as a second TCI state for at least the UE dedicated control and data channels; and
when the one TCI state corresponds to the second TCI state, applying the one TCI state as the second TCI state and the reference TCI state as the first TCI state for at least the UE dedicated control and data channels.

20. The method of claim 13, further comprising:
receiving, via a higher layer parameter PDCCH-Config, values 0 and 1 of coresetPoolIndex, wherein the MAC CE is associated with the value 1 of coresetPoolIndex;
receiving, via a downlink control information (DCI) format associated with the value 1 of coresetPoolIndex, one of the plurality of TCI codepoints comprising one or more TCI states; and
applying the one or more TCI states to the UE dedicated control and data channels associated with value 1 of coresetPoolIndex.
